(19) United States
(12) Patent Application Publication
(10) Pub. No.: US 2009/0103053 A1
(43) Pub. Date: Apr. 23, 2009

(54) Projection apparatus comprising spatial light modulator

(76) Inventors: Hirotoshi Ichikawa, Tokyo (JP); Yoshihiro Maeda, Tokyo (JP); Fusao Ishii, Menlo Park, CA (US)

Correspondence Address: Bo-In Lin, 13445 Mandoli Drive, Los Altos Hills, CA, 94022, US

(21) Appl. No.: 12/286,680

(22) Filed: Oct. 1, 2008

Related U.S. Application Data
(60) Provisional application No. 60/997,436, filed on Oct. 2, 2007.

(51) Int. Cl. G03B 21/14

(52) U.S. Cl. 353/33

(57) ABSTRACT

The present invention provides a projection apparatus, comprising: a light source; a plurality of spatial light modulators each comprising a micromirror for deflecting and reflecting an incident light emitted from the light source in directions between a first direction and a second direction different from the first direction, and all angles between the first and second directions; and an optical prism comprising surfaces (i), (ii), (iii) and (iv), where the surface (i) is a first optical surface with at least two lights of different frequencies are projected thereto, the surface (ii) is a second optical surface for ejecting the two lights incident to the first optical surface therefrom and a modulation light modulated by the spatial light modulator and is incident thereto, the surface (iii) is a synthesis surface for synthesizing the modulation lights modulated by a plurality of spatial light modulators into a same light path, and the surface (iv) is an ejection surface for ejecting the synthesized light synthesized on the synthesis surface, wherein the locus of deflection of the deflection light is approximately parallel to the synthesis surface when the aforementioned locus of deflection is projected onto a flat surface perpendicular to the synthesis surface.

### CROSS REFERENCE TO RELATED APPLICATIONS

This application is a Non-provisional Application claiming a Priority date of Oct. 2, 2007 based on a previously filed Provisional Application 60/997,436 and a Non-provisional patent application Ser. No. 11/121,543 filed on May 3, 2005 issued into U.S. Pat. No. 7,268,932. The application Ser. No. 11/121,543 is a Continuation In Part (CIP) Application of three previously filed Applications. These three Applications are Ser. No. 10/698,620 filed on Nov. 1, 2003, Ser. No. 10/699,140 filed on Nov. 1, 2003 now issued into U.S. Pat. No. 6,862,127, and Ser. No. 10/699,143 filed on Nov. 1, 2003 now issued into U.S. Pat. No. 6,903,860 by the Applicant of this patent applications. The disclosures made in these patent applications are hereby incorporated by reference in this patent application.

### BACKGROUND OF THE INVENTION

1. Field of the Invention

The present invention relates generally to the system configuration and methods for controlling and operating a projection apparatus. More particularly, this invention related to an image projection apparatus implemented with a plurality of spatial light modulator and an optical member for separating an illumination light emitted from the light source to the plurality of spatial light modulators and synthesizing the reflection lights from the modulators.

2. Description of the Related Art

Even though there have been significant advances made in recent years on the technologies of implementing electromechanical micromirror devices as spatial light modulator, there are still limitations and difficulties when these devices are employed to provide high quality image displays. Specifically, when the display images are digitally controlled, the image qualities are adversely affected due to the fact that the image is not displayed with a sufficient number of gray scales.

Electromechanical micromirror devices have drawn considerable interest because of their application as spatial light modulators (SLMs). A spatial light modulator requires an array of a relatively large number of micromirror devices. In general, the number of devices required ranges from 60,000 to several million for each SLM. FIG. 1A refers to a digital video system 1 disclosed in a U.S. Pat. No. 5,214,420, that includes a display screen 2. A light source 10 is used to generate light energy for the ultimate illumination of the display screen 2. Light 9 generated is further concentrated and directed toward lens 12 by mirror 11. Lens 12, 13 and 14 form a beam columnator, which operates to columnate light 9 into a column of light 8. A spatial light modulator 15 is controlled by a computer 19 through data transmitted over data cable 18 to selectively redirect a portion of the light from path 7 toward lens 5 to display on screen 2. As shown in FIG. 1B, the SLM 15 has a surface 16 that includes an array of switchable reflective elements, e.g., micromirror devices 32, such as elements 17, 27, 37, and 47 as reflective elements attached to a hinge 30. When element 17 is in one position, a portion of the light from path 7 is redirected along path 6 to lens 5, where it is enlarged or spread along path 4 to impinge onto the display screen 2, so as to form an illuminated pixel 3. When element 17 is in another position, light is not redirected towards display screen 2 and hence pixel 3 remains dark.

The on-and-off states of the micromirror control scheme, as that implemented in the U.S. Pat. No. 5,214,420 and by most of the conventional display systems, impose a limitation on the quality of the display. Specifically, in a conventional configuration of the control circuit, the gray scale (PWM between ON and OFF states) is limited by the LSB (least significant bit, or the least pulse width). Due to the ON-OFF states implemented in conventional systems, there is no way to provide a shorter pulse width than LSB. The least brightness, which determines gray scale, is the light reflected during the least pulse width. The limited gray scales lead to degradations of image display.

Specifically, in FIG. 1C shows a conventional circuit diagram of a control circuit for a micromirror according to U.S. Pat. No. 5,285,407. The control circuit includes memory cell 32. Various transistors are referred to as M*″ where “*” designates a transistor number, and each transistor is an insulated gate field effect transistor. Transistors M5, and M7 are p-channel transistors; transistors M6, M8, and M9 are n-channel transistors. The capacitances, C1 and C2, represent the capacitive loads of the memory cell 32. Memory cell 32 includes an access switch transistor M9 and a latch 32a, which is the basis of the static random access switch memory (SRAM) design. All access transistors M9 in a row receive a DATA signal from a different bit-line 31a. The particular memory cell 32 to be written is accessed by turning on the appropriate row select transistor M9, using the ROW signal functioning as a word-line. Latch 32a is formed from two cross-coupled inverters, M5/M6 and M7/M8, which permit two stable states. State 1 is Node A high and Node B low, and state 2 is Node A low and Node B high.

The dual states switching, as illustrated by the control circuit, controls the micromirrors to position either at an ON or an OFF angular orientation, as that shown in FIG. 1A. The brightness, i.e., the gray scales of display for a digitally control image system is determined by the length of time the micromirror stays at an ON position. The length of time a micromirror is controlled at an ON position is in turned controlled by a multiple bit word. For simplicity of illustration, FIG. 1D shows the “binary time intervals” when controlled by a four-bit word. As shown in FIG. 1D, the time durations have relative values of 1, 2, 4, 8 that in turn define the relative brightness for each of the four bits, where 1 is for the least significant bit and 8 is for the most significant bit. According to the control mechanism as shown, the minimum controllable difference between gray scales is a brightness represented by a “least significant bit” that maintains the micromirror at an ON position.

When adjacent image pixels are shown with a great degree of difference in the gray scales due to a very coarse scale of controllable gray scale, artifacts are shown between these adjacent image pixels. That leads to image degradations. The image degradations are especially pronounced in bright areas of display where there are “bigger gaps” between gray scales of adjacent image pixels. For example, it can be observed in an image of a female model that there are artifacts shown on the forehead, the sides of the nose, and the upper arm. The artifacts are generated by technical limitations in that the digitally controlled display does not provide sufficient gray scales. Thus, in bright areas of the display, (e.g., the forehead, the sides of the nose, and the upper arm) the adjacent pixels are displayed with visible gaps of light intensities.

As the micromirrors are controlled to have a fully on and fully off position, the light intensity is determined by the length of time the micromirror is at the fully on position. In order to increase the number of gray scales of a display, the speed of the micromirror must be increased such that the digital control signals can be increased to a higher number of bits. However, when the speed of the micromirrors is increased, a stronger hinge is necessary for the micromirror to sustain the required number of operational cycles for a designated lifetime of operation. In order to drive micromirrors supported on a stronger hinge, a higher voltage is required. In this case, the voltage may exceed twenty volts, and may even be as high as thirty volts. Micromirrors manufactured by applying the CMOS technologies would probably not be suitable for operation this higher range of voltages, and therefore, DMOS micromirror devices may be required. In order to achieve higher degree of gray scale control, more complicated manufacturing processes and larger device areas are necessary when DMOS micromirrors are implemented. Conventional modes of micromirror control are therefore facing a technical challenge in that accuracy of gray scale has to be sacrifice for the benefit of smaller and more cost effective micromirror displays, due to the operational voltage limitations.

There are many patents related to light intensity control. These patents include U.S. Pat. Nos. 5,589,852, 6,232,963, 6,592,227, 6,648,476, and 6,819,064. There are further patents and patent applications related to the different shapes of light sources. These patents includes U.S. Pat. Nos. 5,442,414, 6,036,318, and Application 20030147052. U.S. Pat. No. 6,746,123 discloses special polarized light sources for preventing light loss. However, these patents and patent application do not provide an effective solution to overcome the limitations caused by insufficient gray scales in the digitally controlled image display systems.

Furthermore, there are many patents related to spatial light modulation including U.S. Pat. Nos. 2,025,143, 2,682,010, 2,681,423, 4,087,810, 4,292,732, 4,405,209, 4,454,541, 4,592,628, 4,767,192, 4,842,396, 4,907,862, 5,214,420, 5,287,096, 5,506,597, and 5,489,952. However, these inventions have not addressed and provided direct resolution for a person of ordinary skill in the art to overcome the limitations and difficulties discussed above.

Therefore, a need still exists in the art of image display systems, applying digital control of a micromirror array as a spatial light modulator, for new and improved systems such that the difficulties and limitations discussed above can be resolved.

### SUMMARY OF THE INVENTION

Therefore, one aspect of the present invention is to provide improved configurations and control methods for miniaturizing a mirror device and implementing the miniaturized mirror device in a projection apparatus such that the above discussed problems and limitations may be resolved.

A first exemplary embodiment of the present invention is a projection apparatus, comprising: a light source; a plurality of spatial light modulators each comprising a micromirror capable of deflecting an incident light emitted from the light source in directions between a first direction and a second direction that is different from the first direction, with the first and second directions inclusive; and an optical prism comprising surfaces (i), (ii), (iii) and (iv), where (i) is a first optical surface to which at least two of the incident lights with mutually different frequencies are incident, (ii) is a second optical surface from which the incident light incident to the first optical surface is ejected and to which the modulation light modulated by the spatial light modulator is incident, (iii) is a synthesis surface on which the modulation lights respectively modulated by a plurality of spatial light modulators are synthesized into the same light path, and (iv) is an ejection surface from which the synthesized light synthesized on the synthesis surface is ejected, wherein the locus of deflection of the modulation light is approximately parallel to the synthesis surface when the aforementioned locus of deflection is projected onto a flat surface that is perpendicular to the synthesis surface.

A second exemplary embodiment of the present invention is the projection apparatus according to the first exemplary embodiment, further comprising a light absorption member placed on the extension of the optical axis of the modulation light deflected in the second direction and outside of the optical prism or in the vicinity of a constituent surface of the optical prism other than the second optical surface thereof.

A third exemplary embodiment of the present invention is the projection apparatus according to the first exemplary embodiment, further comprising radiation means placed on the extension of the optical axis of the modulation light deflected in the second direction and outside of the optical prism or in the vicinity of a constituent surface of the optical prism other than the second optical surface thereof.

A fourth exemplary embodiment of the present invention is the projection apparatus according to the first exemplary embodiment, wherein the optical prism comprises a triangle columnar joinder prism that is obtained by joining together first and second triangle columnar prisms that is mutually approximately symmetrical about the synthesis surface, wherein the first optical surface is either or both of the two triangular side surfaces of the triangle columnar joinder prism; the second optical surface is a side surface of the triangle columnar joinder prism formed by arranging, on the same flat surface or parallel flat surfaces, one of the rectangular side surface of the first triangle columnar prism with one of the rectangular side surface of the second triangle columnar prism; and the ejection surface is one of two side surfaces of the triangle columnar joinder prism, a surface that is different from the second optical surface.

A fifth exemplary embodiment of the present invention is the projection apparatus according to the first exemplary embodiment, wherein the optical prism comprises a triangle columnar joinder prism obtained by joining together first and second triangle columnar prisms that are mutually approximately symmetrical about the synthesis surface and a third triangle columnar prism that is joined together, or opposite to, either or both of the two triangle side surfaces of the triangle columnar joinder prism, wherein the first optical surface is one flat surface of the side surfaces of the third triangle columnar prism other than the joinder surface or opposite surface thereof; the second optical surface is one side surface of the triangle columnar joinder prism that is formed by arranging, on the same flat surface or parallel flat surfaces, one of the rectangular side surface of the first triangle columnar prism with one of the rectangular side surface of the second triangle columnar prism; and the ejection surface is one of two rectangular side surfaces of the triangle columnar joinder prism, the surface that is different from the second optical surface.

A sixth exemplary embodiment of the present invention is the projection apparatus according to the fifth exemplary embodiment, wherein the joinder surface or opposite surface is a side surface of the third triangle columnar prism including the longest edge of the triangle side surface thereof, wherein the first optical surface is different from the joinder surface or opposite surface and is a side surface that is far from the second optical surface among the rectangular side surfaces of the third triangle columnar prism.

A seventh exemplary embodiment of the present invention is the projection apparatus according to the first exemplary embodiment, wherein the width of the ejection surface or synthesis surface in a direction parallel to the second optical surface and to the locus of deflection of the modulation light is approximately equal to the diameter of the incidence pupil of the projection optical system.

An eighth exemplary embodiment of the present invention is the projection apparatus according to the first exemplary embodiment, wherein the plurality of spatial light modulators is placed on the same substrate.

A ninth exemplary embodiment of the present invention is the projection apparatus according to the eighth exemplary embodiment, wherein a fixed point at which the plurality of spatial light modulators is fixed on the same substrate is in the vicinity of the position of an intersection at which a virtual surface that is the extension of the synthesis surface crosses the substrate.

A tenth exemplary embodiment of the present invention is the projection apparatus according to the first exemplary embodiment, wherein the plurality of spatial light modulators and the control means for controlling at least one of the spatial light modulators and light source are placed on the same substrate.

An eleventh exemplary embodiment of the present invention is the projection apparatus according to the first exemplary embodiment, wherein two of the incident lights are incident, wherein one of the incident lights includes only one frequency component, and the other of the incident lights includes a first frequency component and a second frequency component with mutually different polarizing directions.

A twelfth exemplary embodiment of the present invention is the projection apparatus according to the eleventh exemplary embodiment, further comprising a polarization conversion member for sequentially changing over the polarizing directions of the first frequency component and the second frequency component.

A thirteenth exemplary embodiment of the present invention is the projection apparatus according to the first exemplary embodiment, wherein an angle of incidence to the constituent surface of the optical prism other than the second optical surface, with the constituent surface existing on the extension of the optical axis of the modulation light deflected in the second direction, is no larger than the critical angle.

A fourteenth exemplary embodiment of the present invention is a projection apparatus, comprising: a light source; a plurality of spatial light modulators each comprising a micromirror capable of deflecting an incident light emitted from the light source in directions between a first direction and a second direction that is different from the first direction, with the first and second directions inclusive; and an optical prism comprising surfaces (i), (ii), (iii) and (iv), where (i) is a first optical surface to which at least two of the incident lights with mutually different frequencies are incident, (ii) is a second optical surface from which the incident light incident to the first optical surface is ejected and to which the modulation light modulated by the spatial light modulator is incident, (iii) is a synthesis surface on which the modulation lights respectively modulated by a plurality of spatial light modulators are synthesized into the same light path, and (iv) is an ejection surface which is formed at a position approximately opposite to a projection lens and from which the synthesized light synthesized on the synthesis surface is ejected, wherein the synthesis surface is a flat surface that is approximately perpendicular to the first optical surface.

A fifteenth exemplary embodiment of the present invention is a projection apparatus, comprising: a plurality of spatial light modulators; and an optical member for performing at least either of separating an illumination light emitted from the light source to the plurality of spatial light modulators and synthesizing the reflection lights incoming therefrom, wherein the present apparatus is so configured as to cancel out a shift in individual projection images caused by the plurality of spatial light modulators due to the change of environmental temperatures of the spatial light modulators and optical member.

### BRIEF DESCRIPTION OF THE DRAWINGS

The present invention is described in detail below with reference to the following figures.

FIG. 1A is a functional block diagram showing the configuration of a projection apparatus according to a conventional technique;

FIG. 1B is a top view for showing the configuration of a mirror element of the projection apparatus according to a conventional technique;

FIG. 1C is a functional block circuit schematic diagram showing the configuration of the drive circuit of a mirror element of the projection apparatus according to a conventional technique;

FIG. 1D is a timing diagram showing the format of image data used in the projection apparatus according to a conventional technique;

FIG. 2 is a side view for showing the assembly of optical components of a multi-panel system;

FIG. 3A is side view for illustrating the etendue in light transmission using a discharge lamp light source and projecting an image by way of an optical device;

FIG. 3B is a side view for illustrating the use of a discharge lamp light source and the projection of an image by way of an optical device;

FIG. 3C is a side view for illustrating the use of a laser light source and the projection of an image by way of an optical device;

FIG. 4 is a side view for showing the configuration for limiting a mirror deflection angle in a conventional mirror device;

FIG. 5 is a diagram exemplifying the configuration for regulating a mirror deflection angle in a conventional mirror device;

FIG. 6 is a diagram exemplifying the configuration for regulating a mirror deflection angle in a conventional mirror device;

FIG. 7 is a diagram exemplifying the configuration for regulating a mirror deflection angle in a conventional mirror device;

FIG. 8A is a diagram exemplifying the configuration of the mirror element of a mirror device according to a preferred embodiment of the present invention;

FIG. 8B is a diagram delineating the state in which incident light is reflected towards a projection optical system by deflecting the mirror of a mirror element;

FIG. 8C is a diagram delineating the state in which incident light is not reflected towards a projection optical system by deflecting the mirror of a mirror element;

FIG. 8D is a diagram delineating the state in which incident light is reflected towards and way from a projection optical system repeatedly by free-oscillating the mirror of a mirror element;

FIG. 9A is a top view of an exemplary modification of the mirror element of a mirror device according to the embodiment of the present invention;

FIG. 9B is an outline diagram showing a cross-section of the exemplary modification of the mirror element of a mirror device according to the embodiment of the present invention;

FIG. 10A is a top view showing another form of an electrode included in the mirror element of a mirror device according to the embodiment of the present invention;

FIG. 10B is a side view diagram showing another form of an electrode included in the mirror element of a mirror device according to the embodiment of the present invention;

FIG. 11 is a diagram showing another form of an electrode included in the mirror element of a mirror device according to the embodiment of the present invention;

FIG. 12 is a diagram showing another form of an electrode included in the mirror element of a mirror device according to the embodiment of the present invention;

FIG. 13A is a top view diagram showing another form of an electrode included in the mirror element of a mirror device according to the embodiment of the present invention;

FIG. 13B is a side view diagram showing another form of an electrode included in the mirror element of a mirror device according to the embodiment of the present invention;

FIG. 14 is a side view diagram showing another form of an electrode included in the mirror element of a mirror device according to the embodiment of the present invention;

FIG. 15A is a side view diagram showing another form of an electrode included in the mirror element of a mirror device according to the embodiment of the present invention;

FIG. 15B is a side view diagram showing another form of an electrode included in the mirror element of a mirror device according to the embodiment of the present invention;

FIG. 16A is a side view diagram showing another form of an electrode included in the mirror element of a mirror device according to the embodiment of the present invention;

FIG. 16B is a side view diagram showing another form of an electrode included in the mirror element of a mirror device according to the embodiment of the present invention;

FIG. 17A is a side view diagram showing another form of an electrode included in the mirror element of a mirror device according to the embodiment of the present invention;

FIG. 17B is a side view diagram showing another form of an electrode included in the mirror element of a mirror device according to the embodiment of the present invention;

FIG. 17C is a side view diagram showing another form of an electrode included in the mirror element of a mirror device according to the embodiment of the present invention;

FIG. 18 is a diagram exemplifying steps 1 through 9 of the production process of a mirror device according to the embodiment of the present invention;

FIG. 19 is a diagram exemplifying steps 10 through 13 of the production process of a mirror device according to the embodiment of the present invention;

FIG. 20 is a diagram exemplifying a dicing method used in a production process of a mirror device according to the embodiment of the present invention;

FIG. 21 is a functional block diagram showing the configuration of a single-panel projection apparatus according to the embodiment of the present invention;

FIG. 22A is a functional block diagram showing the configuration of a multi-panel projection apparatus according to the embodiment of the present invention;

FIG. 22B is a functional block diagram showing the configuration of an exemplary modification of a multi-panel projection apparatus according to the embodiment of the present invention;

FIG. 22C is a functional block diagram showing the configuration of an exemplary modification of a multi-panel projection apparatus according to another preferred embodiment of the present invention;

FIG. 23A is a functional block diagram exemplifying the configuration of a control unit includes in a single-panel projection apparatus according to the embodiment of the present invention;

FIG. 23B is a functional block diagram exemplifying the configuration of a control unit in a multi-panel projection apparatus according to the embodiment of the present invention;

FIG. 24A is a functional block diagram exemplifying the configuration of a light source drive circuit includes in a projection apparatus according to the embodiment of the present invention;

FIG. 24B is a functional block diagram showing an exemplary modification of the configuration of a light source drive circuit included in a projection apparatus according to the embodiment of the present invention;

FIG. 25 is a chart exemplifying the setup of a light source pulse pattern in controlling a mirror by means of binary data performed in a projection apparatus according to the embodiment of the present invention;

FIG. 26 is a chart showing the relationship between the emission light intensity and the applied current to a light source drive circuit used in the embodiment of the present invention;

FIG. 27A is a functional block diagram exemplifying the configuration of a mirror device according to the embodiment of the present invention;

FIG. 27B is an outline diagram of the cross-section of the mirror element of a mirror device according to the embodiment of the present invention;

FIG. 28 is a chart showing the transition time in a pulse width modulation of the mirror of a spatial light modulator according to the embodiment of the present invention;

FIG. 29 is a functional block diagram exemplifying a placement of ROW lines for controlling mirrors of a spatial light modulator according to the embodiment of the present invention;

FIG. 30A is a functional block diagram showing the data structure of image data used in the embodiment of the present invention;

FIG. 30B is a functional block diagram showing the data structure of image data used in the embodiment of the present invention;

FIG. 31 is a chart exemplifying the setup of a light source pulse pattern used for controlling a mirror by means of non-binary data performed in a projection apparatus according to the embodiment of the present invention;

FIG. 32 is a chart exemplifying the setup of a light source pulse pattern used for controlling a mirror by means of binary data performed in a projection apparatus according to the embodiment of the present invention;

FIG. 33 is a chart showing an exemplary modification of a light source pulse pattern used for controlling a mirror by means of binary data performed in a projection apparatus according to the embodiment of the present invention;

FIG. 34 is a chart showing an exemplary modification of a light source pulse pattern used for controlling a mirror by means of non-binary data performed in a projection apparatus according to the embodiment of the present invention;

FIG. 35 is a chart showing an exemplary modification of the control for a spatial light modulator using non-binary data in the embodiment of the present invention;

FIG. 36A is a chart exemplifying a control signal of a projection apparatus according to the embodiment of the present invention;

FIG. 36B is a chart exemplifying a control signal of a projection apparatus according to the embodiment of the present invention;

FIG. 36C is a chart exemplifying a control signal, which is shown by enlarging a part thereof, of a projection apparatus according to the embodiment of the present invention;

FIG. 37 is a chart exemplifying a control signal of a chirp modulation of a projection apparatus according to the embodiment of the present invention;

FIG. 38 is a chart exemplifying a control signal, using binary data, of a projection apparatus according to the embodiment of the present invention;

FIG. 39 is a chart exemplifying a control signal, using binary data, of a projection apparatus according to the embodiment of the present invention;

FIG. 40A is a chart exemplifying a control signal of a projection apparatus according to the embodiment of the present invention;

FIG. 40B is a chart exemplifying a control signal of a projection apparatus according to the embodiment of the present invention;

FIG. 41A is a chart exemplifying a control signal of a projection apparatus according to the embodiment of the present invention;

FIG. 41B is a chart exemplifying a control signal of a projection apparatus according to the embodiment of the present invention;

FIG. 42 is a chart exemplifying a control signal of a projection apparatus according to the embodiment of the present invention;

FIG. 43 is a chart exemplifying a control signal of a projection apparatus according to the embodiment of the present invention;

FIG. 44 is a chart exemplifying a control signal of a projection apparatus according to the embodiment of the present invention;

FIG. 45 is a chart exemplifying a control signal of a projection apparatus according to the embodiment of the present invention;

FIG. 46 is a chart describing the principle of γ correction of video image data;

FIG. 47 is a chart showing the principle of γ correction by controlling the emission light intensity of a light performed in a projection apparatus according to the embodiment of the present invention;

FIG. 48 is a chart describing an example of the conversion of binary data into non-binary data performed in a projection apparatus according to the embodiment of the present invention;

FIG. 49 is a chart describing an example of the conversion of binary data into non-binary data performed in a projection apparatus according to the embodiment of the present invention;

FIG. 50 is a chart describing an example of the conversion of binary data into non-binary data performed in a projection apparatus according to the embodiment of the present invention;

FIG. 51 is a chart describing an example of the conversion of binary data into non-binary data performed in a projection apparatus according to the embodiment of the present invention;

FIG. 52 is a chart showing a γ correction of a brightness input in eight-bit non-binary data, by exemplifying the implementation in four stages, performed in a projection apparatus according to the embodiment of the present invention;

FIG. 53A is a chart exemplifying a γ correction by means of intermittent pulse emission performed in a projection apparatus according to the embodiment of the present invention;

FIG. 53B is a chart exemplifying a γ correction by means of intermittent pulse emission performed in a projection apparatus according to the embodiment of the present invention;

FIG. 53C is a chart exemplifying a γ correction by means of intermittent pulse emission performed in a projection apparatus according to the embodiment of the present invention;

FIG. 53D is a chart exemplifying a γ correction by means of intermittent pulse emission performed in a projection apparatus according to the embodiment of the present invention;

FIG. 54A is a chart exemplifying a γ correction by means of an intermittent pulse emission, thereby increasing the effects of the correction on the lower brightness side, performed in a projection apparatus according to the embodiment of the present invention;

FIG. 54B is a chart exemplifying the γ correction curve performing a γ correction by means of a light source pulse pattern exemplified in FIG. 54A, thereby increasing the effects of the correction on the lower brightness side;

FIG. 55A is a chart exemplifying the case of performing a γ correction in consideration of human visual characteristic perception, by means of an intermittent pulse emission in a projection apparatus according to the embodiment of the present invention;

FIG. 55B is a chart exemplifying the γ correction curve performing a γ correction in consideration of human visual characteristic perception, by means of the light source pulse pattern exemplified in FIG. 55A;

FIG. 56 is a chart exemplifying the case of performing a gray scale control by keeping a mirror in a constant ON state and controlling the intensity of emission of a light source, which is performed in a multi-panel projection apparatus according to the embodiment of the present invention;

FIG. 57 is a chart exemplifying the case of performing a gray scale control by keeping a mirror in a constant ON state and controlling the pulse emission of a light source, which is performed in a multi-panel projection apparatus according to the embodiment of the present invention;

FIG. 58 is a chart exemplifying the case of performing a gray scale control by keeping a mirror in a constant ON state and controlling the intensity of emission of a light source, which is performed in a single-panel projection apparatus according to the embodiment of the present invention;

FIG. 59 is a chart exemplifying the case of performing a gray scale control by keeping a mirror in a constant ON state and controlling the pulse emission of a light source, which is performed in a single-panel projection apparatus according to the embodiment of the present invention;

FIG. 60 is a diagram describing the principle of increasing the range of a gray scale control by a combination of the ON/OFF control of a mirror and the emission intensity control of a light source, which is performed in a single-panel projection apparatus, according to the embodiment of the present invention;

FIG. 61 is a chart exemplifying the case of preventing a color break by a combination of the ON/OFF control of a mirror and the oscillation control of the mirror, performed in a single-panel projection apparatus, according to the embodiment of the present invention;

FIG. 62A is a front cross-sectional diagram of an assembly body that packages a mirror device using a cover glass and a package substrate;

FIG. 62B is a top view diagram of the assembly body shown in FIG. 62A, with the cover glass and support member removed;

FIG. 62C is a top view diagram of the assembly body shown in FIG. 62A;

FIG. 62D is a bottom view diagram of the assembly body shown in FIG. 62A, with a columnar thermal transfer member placed at the center of the bottom surface of a device substrate;

FIG. 62E is a bottom view diagram of the assembly body shown in FIG. 62A, with a thermal transfer member placed along a side of the bottom surface of a device substrate;

FIG. 63A is a front cross-sectional diagram of an assembly body that packages a mirror device using a package substrate having an opening part;

FIG. 63B is a bottom view diagram of the assembly body shown in FIG. 63A;

FIG. 64 is a front cross-sectional diagram of an assembly body that packages a mirror device so as to be electrically connected to a device substrate by equipping a cover glass with a circuit-wiring pattern by using a package substrate having a cavity;

FIG. 65A is a front cross-sectional diagram of an assembly body that packages two mirror devices by using a package substrate;

FIG. 65B is a top view diagram of the assembly body shown in FIG. 65A, with a cover glass and an intermediate member removed;

FIG. 65C is a top view diagram of the assembly body shown in FIG. 65A;

FIG. 66A is a front view diagram of a two-panel projection apparatus comprising a plurality of mirror devices packaged by a single package;

FIG. 66B is a rear view diagram of the two-panel projection apparatus shown in FIG. 66A;

FIG. 66C is a side view diagram of the two-panel projection apparatus shown in FIG. 66A;

FIG. 66D is a top view diagram of the two-panel projection apparatus shown in FIG. 66A;

FIG. 67 is a front view diagram of an exemplary modification of a two-panel projection apparatus shown in FIG. 66A;

FIG. 68A is a top view diagram of another exemplary modification of the two-panel projection apparatus shown in FIG. 66A;

FIG. 68B is a side view diagram of another exemplary modification of the two-panel projection apparatus shown in FIG. 66A;

FIG. 69 is a top view diagram of the mirror array of a spatial light modulator according to the present embodiment;

FIG. 70A shows a cross-section of a mirror element that is configured to be formed with only one address electrode and one drive circuit, as another embodiment of the mirror element of a mirror device according to the embodiment of the present invention;

FIG. 70B is an outline diagram of the mirror element shown in FIG. 70A;

FIG. 71A shows a top view diagram, and a cross-sectional diagram, both of a mirror element structured such that the area size S1 of a first electrode part of one address electrode is greater than the area size S2 of a second electrode part (S1>S2), and such that the connection part between the first and second electrode parts is in the same structural layer as the first and second electrode parts;

FIG. 71B shows a top view diagram, and a cross-sectional diagram, both of a mirror element structured such that the area size S1 of a first electrode part of one address electrode is greater than the area size S2 of a second electrode (S1>S2), and such that the connection part between the first and second electrode parts is in a different structural layer from that of the first and second electrode parts;

FIG. 71C shows a top view diagram, and a cross-sectional diagram, both of a mirror element structured such that the area size S1 of a first electrode part of one address electrode is equal to the area size S2 of a second electrode (S1=S2), and such that the distance G1 between a mirror and the first electrode part is less than the distance G2 between the mirror and the second electrode part (G1<G2);

FIG. 72 is a diagram showing the data inputs to a mirror element shown in FIG. 71A, the voltage application to an address electrode, and the deflection angles of the mirror, in a time series;

FIG. 73 is a functional block diagram illustrating the control of a spatial light modulator according to the present embodiment;

FIG. 74 is an illustrative diagram showing the configuration of a multi-panel projection apparatus comprising three spatial light modulators;

FIG. 75 illustrates the relationship between the deflection of a mirror and the reflecting direction of an illumination light in the configuration of FIG. 69;

FIG. 76 is an illustrative diagram showing diffraction light generated when a mirror reflects the light;

FIG. 77 is an illustrative cross-sectional diagram depicting a situation in which an f/2.4 light flux is reflected by a conventional spatial light modulator, for which the deflection angles of the ON light state and OFF light state of a mirror are set at ±12 degrees, respectively;

FIG. 78A is an illustrative cross-sectional diagram depicting a situation in which an f/10 light flux, which possesses a coherent characteristic, is reflected by a spatial light modulator, for which the deflection angles of the ON light state and OFF light state of a mirror are set at ±3 degrees, respectively;

FIG. 78B is a diagram further showing an expansion of diffraction light by depicting, in three dimensions, the relationship between the deflection angle of the mirror and the light flux thereof shown in FIG. 78A;

FIG. 79 is an illustrative cross-sectional diagram depicting a situation in which an f/10 light flux emitted from a light source, which possesses a coherent characteristic, is reflected by a spatial light modulator, for which the deflection angles of the ON light state and OFF light state of the mirror shown in FIG. 78A are set at ±13 degrees, respectively;

FIG. 80A is a top view diagram of a mirror array, with the deflection axis of the mirror shown in FIG. 69A changed;

FIG. 80B is an illustrative diagram that shows the relationship between the deflection of the mirror and the reflecting direction of light in the configuration shown in FIG. 80A;

FIG. 81 is a diagram further showing the expansion of diffraction light by depicting, in three dimensions, the relationship between the deflection angle of the mirror shown in FIG. 79 and the light flux, in the case in which the directions of deflection axis of a mirror element are changed, as shown in FIG. 80A;

FIG. 82 is an illustrative cross-sectional diagram depicting a situation in which an f/10 light flux emitted from a light source, which possesses a coherent characteristic, is reflected by a spatial light modulator, for which the deflection angles of the ON light state and OFF light state of a mirror are set at +13 degrees and −3 degrees, respectively; and

FIG. 83 is an illustrative cross-sectional diagram depicting a situation in which an f/10 light flux emitted from a light source, which possesses a coherent characteristic, is reflected by a spatial light modulator, for which the deflection angles of the ON light state and OFF light state of a mirror are set at +3 degrees and −13 degrees, respectively.

FIG. 84 is a chart exemplifying the operation of a projection apparatus according to a preferred embodiment of the present invention;

FIG. 85 is a chart exemplifying the operation of a projection apparatus according to a preferred embodiment of the present invention;

FIG. 86 is a chart exemplifying the operation of a projection apparatus according to a preferred embodiment of the present invention;

FIG. 87 is a chart showing the principle of the control of a color balance in a projection apparatus according to a preferred embodiment of the present invention;

FIG. 88 is a chart showing the principle of the control of a color balance in the ON/OFF control of a mirror in a projection apparatus according to a preferred embodiment of the present invention;

FIG. 89 is a chart showing the principle of the control of a color balance in the case of combining between the ON/OFF control and oscillation control of a mirror in a projection apparatus according to a preferred embodiment of the present invention;

FIG. 90 is a chart exemplifying an operation in the case of combining between the ON/OFF control and oscillation control of a mirror in a projection apparatus according to a preferred embodiment of the present invention;

FIG. 91 is a chart exemplifying an operation in the case of combining between the ON/OFF control and oscillation control of a mirror in a projection apparatus according to a preferred embodiment of the present invention;

FIG. 92 is a diagram describing an example of the control operations for a spatial light modulator and a variable light source in a conventional three-panel projection apparatus;

FIG. 93 is a diagram describing an example of the control operations for a spatial light modulator and a variable light source in a projection apparatus according to a preferred embodiment of the present invention;

FIG. 94 is a diagram showing an exemplary modification of the control operations for the spatial light modulator and variable light source shown in FIG. 93;

FIG. 95 is a diagram showing another modified embodiment of the control operations for the spatial light modulator and variable light source shown in FIG. 93;

FIG. 96 is a diagram exemplifying the control operations for the spatial light modulator and variable light source when the control signal for a mirror element is non-binary data;

FIG. 97 is an upper plain view diagram of an exemplary configuration of a projection apparatus according to an embodiment 9-1;

FIG. 98 is a diagram illustrating another exemplary configuration of a projection apparatus according to the embodiment 9-1;

FIG. 99A is a diagram showing an exemplary modification of an optical prism comprised in an exemplary configuration of a projection apparatus according to a preferred embodiment 9-3;

FIG. 99B is a diagram describing an exemplary modification of an optical prism comprised in an exemplary configuration of a projection apparatus according to the embodiment 9-3;

FIG. 99C is a diagram describing an exemplary modification of an optical prism comprised in an exemplary configuration of a projection apparatus according to the embodiment 9-3;

FIG. 100 is a diagram illustrating an exemplary configuration of a projection apparatus according to an embodiment 9-4;

FIG. 101A is a diagram illustrating an exemplary configuration of an optical prism comprised in an exemplary configuration of the projection apparatus according to the embodiment 9-4;

FIG. 101B is a diagram illustrating an exemplary configuration of an optical prism comprised in an exemplary configuration of the projection apparatus according to the embodiment 9-4;

FIG. 102 is a diagram showing an exemplary configuration of the projection apparatus according to the embodiment 9-4;

FIG. 103 is a diagram exemplifying the case of equipping constituent components on the same substrate in another exemplary configuration of the projection apparatus according to the embodiment 9-4;

FIG. 104 is a graph illustrating the semi-ON state of a light source, performing on an electric current drive, comprised in a projection apparatus according to a preferred embodiment of the present invention;

FIG. 105 is a graph illustrating a semi-ON state when a light source is made to perform pulse emission synchronously with the control of a mirror of a spatial light modulator according to a preferred embodiment of the present invention, the spatial light modulator constituted by mirror elements;

FIG. 106 is a diagram illustrating an oscillation of a light modulation element of a spatial light modulator when operating a wobbling device according to the present embodiment;

FIG. 107 is a diagram illustrating a situation in which the even field of an interlace signal is wobbled in the vertical direction after displaying the odd field thereof in a projection apparatus according to a preferred embodiment the present invention;

FIG. 108 is a graph illustrating the synchronization between a light source and the change in mirror positions of a mirror device by means of a wobbling within one frame, performed in a projection apparatus according to a preferred embodiment of the present invention;

FIG. 109 is a graph illustrating the synchronization between a light source and the deflection angle of each mirror element performed in a projection apparatus according to a preferred embodiment of the present invention;

FIG. 110 is a graph illustrating carrying out one OFF operation of each mirror element within one frame while synchronizing a light source with each mirror element performed in a projection apparatus according to a preferred embodiment the present invention;

FIG. 111A shows the configuration of one mirror element, in the initial state, of a mirror device according to a preferred embodiment of the present invention;

FIG. 111B shows the configuration of one mirror element, in an ON state, of a mirror device according to a preferred embodiment of the present invention;

FIG. 111C shows the configuration of one mirror element, in an OFF state, of a mirror device according to a preferred embodiment of the present invention;

FIG. 111D shows the configuration of one mirror element, in an oscillation state, of a mirror device according to a preferred embodiment of the present invention;

FIG. 112 shows the configuration of one mirror element when materials with different permittivity values are used, between the first electrode part and second electrode part of the upper parts of a single address electrode of one mirror element of a mirror device according to a preferred embodiment of the present invention;

FIG. 113 is a timing diagram for illustrating turning off a light source synchronously with a dummy operation of each mirror element performed in a projection apparatus according to a preferred embodiment of the present invention;

FIG. 114 is a graph illustrating the synchronization between a light source and the deflection angle of each mirror element performed in a projection apparatus according to a preferred embodiment of the present invention; and

FIG. 115 is a graph illustrating the synchronization among a light source, an address electrode and the deflection angle of each mirror element performed in a projection apparatus according to a preferred embodiment of the present invention.

### DESCRIPTION OF THE PREFERRED EMBODIMENTS

Image projection apparatuses implemented with a spatial light modulator (SLM), such as a transmissive liquid crystal, a reflective liquid crystal, a mirror array and other similar image modulation devices, are widely known.

A spatial light modulator is formed as a two-dimensional array of optical elements, ranging in number from tens of thousands to millions of miniature modulation elements, with the individual elements enlarged and displayed, as the individual pixels corresponding to an image to be displayed, onto a screen by way of a projection lens.

Spatial light modulators generally used for projection apparatuses primarily include two types: 1.) a liquid crystal device, formed by sealing a liquid crystal between transparent substrate, for modulating the polarizing direction of incident light and providing them with a potential and 2.) a mirror device deflecting miniature micro electro mechanical systems (MEMS) mirrors with electrostatic force and controlling the reflecting direction of illumination light.

One embodiment of the above described mirror device is disclosed in U.S. Pat. No. 4,229,732, in which a drive circuit using MOSFET and deflectable metallic mirrors are formed on a semiconductor wafer substrate. The mirror can be deformed by electrostatic force supplied from the drive circuit and is capable of changing the reflecting direction of the incident light.

Meanwhile, U.S. Pat. No. 4,662,746 has disclosed an embodiment in which one or two elastic hinges retain a mirror. If the mirror is retained by one elastic hinge, the elastic hinge functions as a bending spring. If two elastic hinges retain the mirror, they function as torsion springs to incline the mirror, and thereby deflecting the reflecting direction of the incident light.

As described above, the on-and-off state of the micromirror control scheme as that implemented in U.S. Pat. No. 5,214,420 and in most of the conventional display systems, impose a limitation on the quality of a display. Specifically, in conventional configurations of control circuits, the gray scale (PWM between ON and OFF states) is limited by the LSB (least significant bit, or the least pulse width). Due to the ON-OFF states implemented in the conventional systems, it is impossible to provide a shorter pulse width than LSB. The least brightness, which determines gray scale, is the light reflected during the least pulse width. A limited number of gray scales lead to degradation in the image quality of a display.

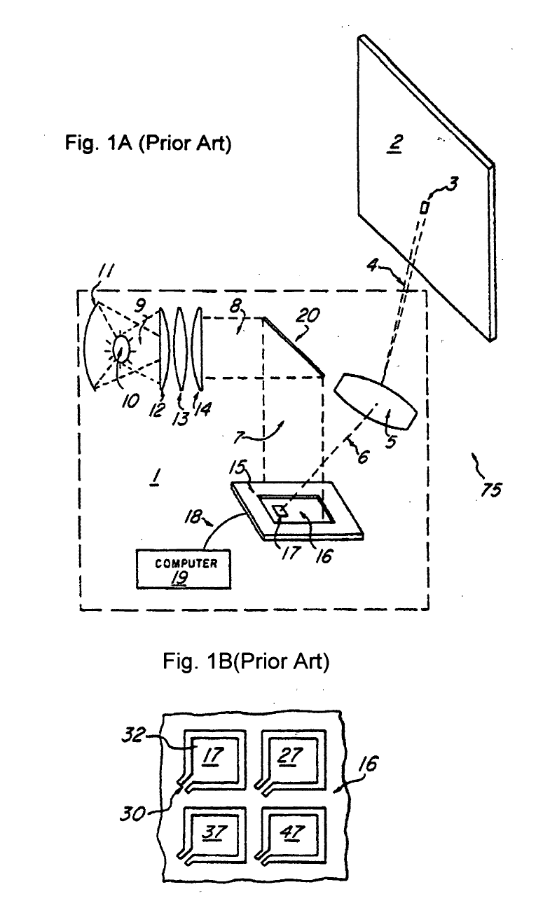

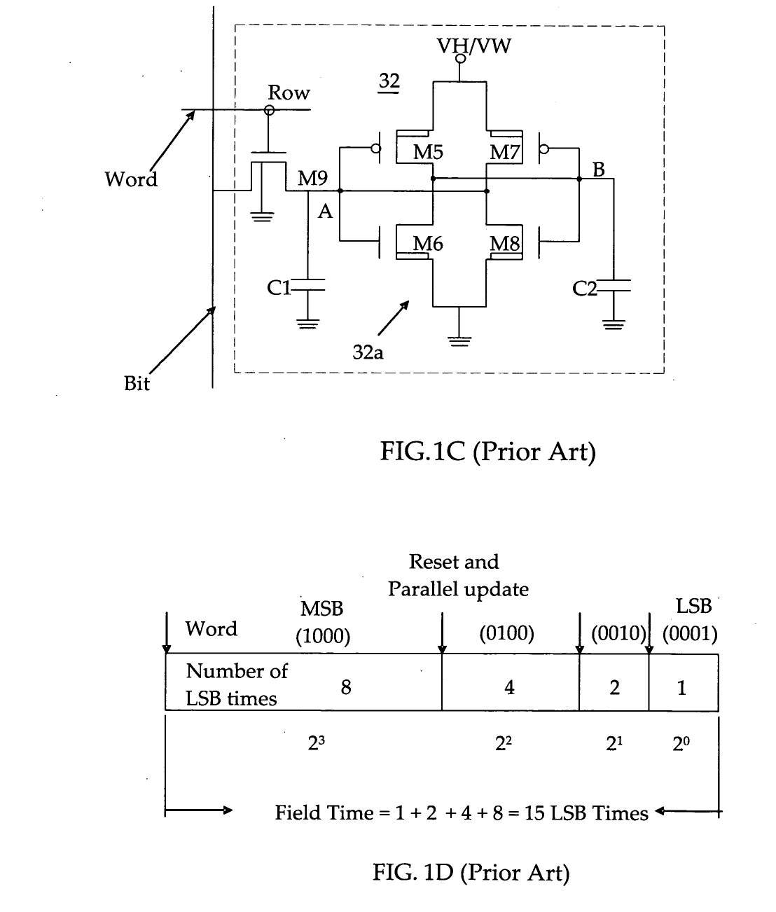

Specifically, FIG. 1C exemplifies a circuit diagram of a conventional control circuit for a micromirror, according to U.S. Pat. No. 5,285,407. The control circuit includes memory cell 32. Various transistors are referred to as “M*”, where “*” denotes a transistor number, and each transistor is an insulated gate field effect transistor. Transistors M5, and M7 are p-channel transistors; transistors M6, M8, and M9 are n-channel transistors. The capacitances, C1 and C2, represent the capacitive loads of the memory cell 32. The memory cell 32 includes an access switch transistor M9 and a latch 32a, which is the basis of the static random access switch memory (SRAM) design. All access transistors M9 in a ROW receive a DATA signal from a different bit-line 31a. The particular memory cell 32 is accessed and written by turning on the appropriate row select transistor M9, using the row signal functioning as a word line. Latch 32a is formed from two cross-coupled inverters, M5/M6 and M7/M8, which permit two stable states. State 1 is Node A high and Node B low, and state 2 is Node A low and Node B high.

The mirror, driven by a drive electrode, abuts a landing electrode structured differently from the drive electrode, and thereby a prescribed tilt angle is maintained. A “landing chip”, which possesses a spring property, is formed on the point of contact between the landing electrode and the mirror, so that an the deflection of the mirror to the reverse direction, upon change in the control, is assisted. The parts forming the landing chip and the landing electrode are maintained at the same potential, so that contact will not cause a shorting or other similar disruption.

### Outline of PWM Control

As described above, switching between the dual states, as illustrated by the control circuit, controls the micromirrors to position either at an ON or an OFF angular orientation, as shown in FIG. 1A. The brightness, i.e., the gray scales of display for a digitally control image system, is determined by the length of time the micromirror stays at an ON position. The length of time a micromirror is controlled at an ON position is in turned controlled by a multiple bit word. For simplicity of illustration, FIG. 1D shows the “binary time intervals” when controlled by a four-bit word. As shown in FIG. 1D, the time durations have relative values of 1, 2, 4, 8 that in turn define the relative brightness for each of the four bits, where 1 is for the least significant bit and 8 is for the most significant bit. According to the control mechanism shown, the minimum controllable difference between gray scales is a brightness represented by a “least significant bit” that maintains the micromirror at an ON position.

In a simple exemplary display system operated with a n bits brightness control signal for controlling the gray scales, the frame time is divided into 2ⁿ−1 equal time slices. For a 16.7 milliseconds frame period and n-bit intensity values, the time slice is 16.7/(2ⁿ−1) milliseconds.

Having established these time slices for controlling the length of time for displaying each pixel in each frame, the pixel intensities are determined by the number of time slices represented by each bit. Specifically, a display of a black pixel is represented by 0 time slices. The intensity level represented by the LSB is 1 time slice, and maximum brightness is 2ⁿ−1 time slices. The number time slices that a micro mirror is controlled to operate at an On-state in a frame period determines a specifically quantified light intensity of each pixel corresponding to the micromirror reflecting a modulated light to that pixel. Thus, during a frame period, each pixel corresponding to a modulated micromirror controlled by a control word with a quantified value of more than 0 is operated at an on state for the number of time slices that correspond to the quantified value represented by the control word. The viewer's eye integrates the pixels' brightness so that the image appears the same as if it were generated with analog levels of light.

For addressing deformable mirror devices, a pulse width modulator (PWM) receives the data formatted into “bit-planes”. Each bit-plane corresponds to a bit weight of the intensity value. Thus, if each pixel's intensity is represented by an n-bit value, each frame of data has n bit-planes. Each bit-plane has a 0 or 1 value for each display element. In the example described in the preceding paragraphs, each bit-plane is separately loaded during a frame. The display elements are addressed according to their associated bit-plane values. For example, the bit-plane representing the LSBs of each pixel is displayed for 1 time slice.

### Outlines of Mirror Size and Resolution

The size of a mirror for constituting such a mirror device is between 4 μm and 20 μm on each side. The mirrors are placed on a semiconductor wafer substrate in such a manner as to minimize the gap between adjacent mirrors. Smaller gaps reduce random and interfering reflection lights from the gap to prevent such reflections from degrading the contrast of the displayed images. The mirror device is formed a substrate that includes an appropriate number of mirror elements. Each mirror element is applied to modulate a corresponding image display element known as a pixel. The appropriate number of image display elements is determined according to image display standards in compliance to the resolution of a display specified by the Video Electronics Standards Association (VESA) and to the television-broadcasting standard. For example, in the case of configuring a mirror device in compliance with the WXGA (with the resolution of 1280×768) as specified by VESA and in which the size of each mirror is 10 μm, the diagonal length of the display area will be about 0.61 inches, thus producing a sufficiently small mirror device

### Outline of Projection Apparatus

The projection apparatuses using deflection-type (“deflectable”) light modulators are primarily categorized into two types: 1.) a single-panel projection apparatus includes a single spatial light modulator, changing the frequency of a projection light in time series and displaying a color image, and 2.) a multi-panel projection apparatus includes a plurality of spatial light modulators, constantly modulating illumination light with different frequencies by means of individual spatial light modulators and displaying a color image by synthesizing these modulated lights.

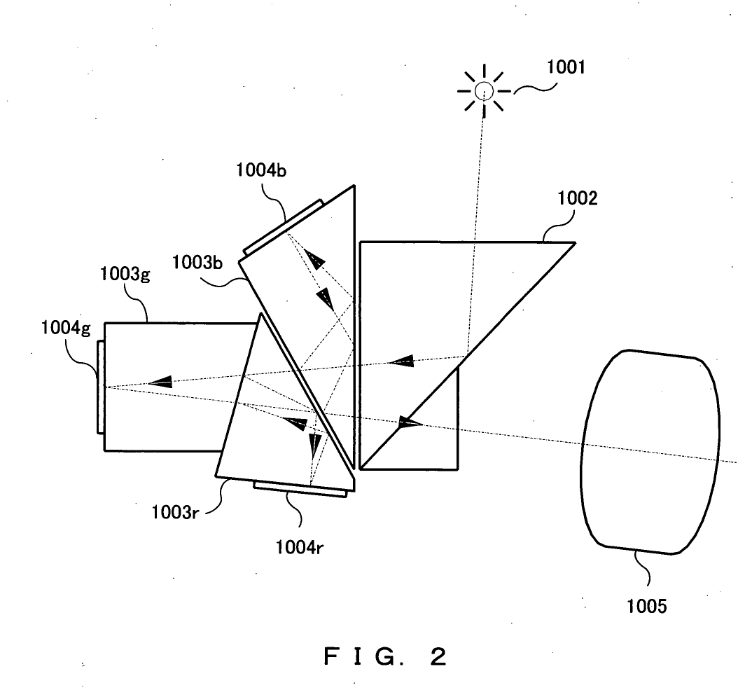

The single-panel projection apparatus is configured as described above in reference to FIG. 1A. In contrast, FIG. 2 shows an example of the optical configuration of a multi-panel system.

Referring to FIG. 2, the illumination light from a light source 1001 is projected to the total reflection surface of a total internal reflection (TIR) prism 1002 at a critical angle (or higher) and is directed to a prism for color synthesis and separation. The TIR prism 1002 is used for separating the light paths of the light between the illumination light and the light modulated by a deflectable spatial light modulator. The color separation/synthesis prism is includes configured by placing a first color separation/synthesis prism 1003b and a first junction prism made by joining a second color separation/synthesis prism 1003r to a third color separation/synthesis prism 1003g. A first dichroic film, which reflects only the blue light of the illumination light and transmits other colors, is placed on the emission surface of the first color separation/synthesis prism 1003b. The blue illumination light reflected by the first dichroic film is totally reflected by the incidence surface of the first color separation/synthesis prism 1003b and is incident to a first spatial light modulator 1004b at a desired incident angle. The modulation light reflected towards the ON light by the first spatial light modulator 1004b, proceeding in a perpendicular direction to the first spatial light modulator 1004b, is totally reflected by the incident surface of the first color separation/synthesis prism 1003b and reflected by the first dichroic film towards the projection light path. The red and green illumination lights transmitting through the first dichroic film pass through an air layer and enter the second color separation/synthesis prism 1003r. A second dichroic film, which reflects only red light, is placed on the junction surface between the second color separation/synthesis prism 1003r and third color separation/synthesis prism 1003g. Therefore, the second dichroic film reflects the red light of the illumination light to the second color separation/synthesis prism 1003r. The reflected red illumination light is totally reflected by the light incident surface of the second color separation/synthesis prism 1003r and enters into a second spatial light modulator 1004r. The light modulated by the second spatial light modulator 1004r is reflected by the incident surface and second dichroic film to proceed towards the projection light path. The green light passes through the second dichroic film is modulated by a third spatial light modulator 1004g and is reflected towards the projection light path. The individual color lights modulated by the first through third spatial light modulators 1004b, 1004r and 1004g and reflected toward the same light path transmit through the total reflection surface of the TIR prism 1002 and are projected by a projection lens 1005 onto the projection surface.

The multiple panel configurations prevent the problems of a color break. Unlike a single-panel projection apparatus, color break problem is resolved because each primary color is constantly projected. Further, this configuration produces images with a higher level of brightness because the light from a light source is effectively utilized. On the other hand, the processes of assembling the multi-panel projection apparatus are a more complicated. For example, the spatial light modulators must be placed in proper locations corresponding to the respective colors and the assembling processes require more alignment adjustments. There are further problems do to the size increase of such apparatus.

### Outline of the Introduction of Laser Light Source

In the projection apparatus implemented with a reflective spatial light modulator configured as the above-described mirror device, there is a close relationship among the numerical aperture (NA) NA1 of an illumination light path, the numerical aperture NA2 of a projection light path, and the tilt angle α of a mirror.

Assuming that the tilt angle α of a mirror is 12 degrees. When a modulated light reflected by the mirror and incident to the pupil of the projection light path is set perpendicular to a device substrate, the illumination light is incident at an angle inclined by 2α, that is, 24 degrees, relative to the perpendicular axis of the device substrate. For the light beam reflected by the mirror to be most efficiently incident to the pupil of the projection lens, it is desirable for the numerical aperture of the projection light path to be equal to the numerical aperture of the illumination light path. If the numerical aperture of the projection light path is smaller than that of the illumination light path, the illumination light cannot be sufficiently transmitted into the projection light path. On the other hand, if the numerical aperture of the projection light path is larger than that of the illumination light path, the illumination light can be entirely transmitted onto the projection lens becomes excessively large, which increases the inconvenience in terms of configuring the projection apparatus. Furthermore, in this case, the light fluxes of the illumination light and projection light must be directed apart from each other because the optical members of the illumination system and those of the projection system must be physically placed in separate locations in an image display system. From the above considerations, when a spatial light modulator with the tilt angle of a mirror at 12 degrees is used, the numerical aperture (NA) NA1 of the illumination light path and the numerical aperture NA2 of the projection light path are preferably set as follows:

NA1=NA2=sin α=sin 12°

Letting the F-number of the illumination light path be F1 and the F-number of the projection light path be F2, the numerical aperture can be converted into an F-number as follows:

F1=F2=1/(2*NA)=1/(2*sin 12°)=2.4

In order to maximize the transmission of illumination light emitted from a light source with non-directivity in the emission direction of light, such as a high-pressure mercury lamp or xenon lamp, which are generally used for a projection apparatus, it is necessary to maximize the projection angle of light on the illumination light path side. Since the numerical aperture of the illumination light path is determined by the specific tilt angle of a mirror to be used, the tilt angle of the mirror needs to be large in order to increase the numerical aperture of the illumination light path.

Increasing of the tilt angle of mirror, however, requires a higher drive voltage and a larger distance between the mirror and the electrode for driving the mirror because a greater physical space needs to be secured for tilting the mirror. The electrostatic force F generated between the mirror and electrode is derived by the following equation:

F=(ε*S*V²)/(2*d²),

where “S” is the area size of the electrode, “V” is the voltage, “d” is the distance between the electrode and mirror, and “ε” is the permittivity of vacuum.

The equation makes clear that the drive force is decreased in proportion to the second power of the distance d between the electrode and mirror. It is possible to increase the drive voltage to compensate for the decrease in the drive force associated with the increase in the distance; conventionally, however, the drive voltage is about 5 to 10 volts in the drive circuit, by means of a CMOS process used for driving a mirror, and therefore a relatively special process such as a DMOS process is required if a drive voltage in excess of about 10 volts is needed. A DMOS process would increase the cost of a mirror device and hence, is undesirable.

Furthermore, for the purpose of cost reduction, it is desirable to obtain as many mirror devices as possible from a single semiconductor wafer substrate in order to improve the productivity. That is, shrinking the pitch between mirror elements reduces the size of the mirror device overall. However, it is clear that the area size of an electrode is reduced in association with the a size reduction of the mirror, which also leads to less driving power.

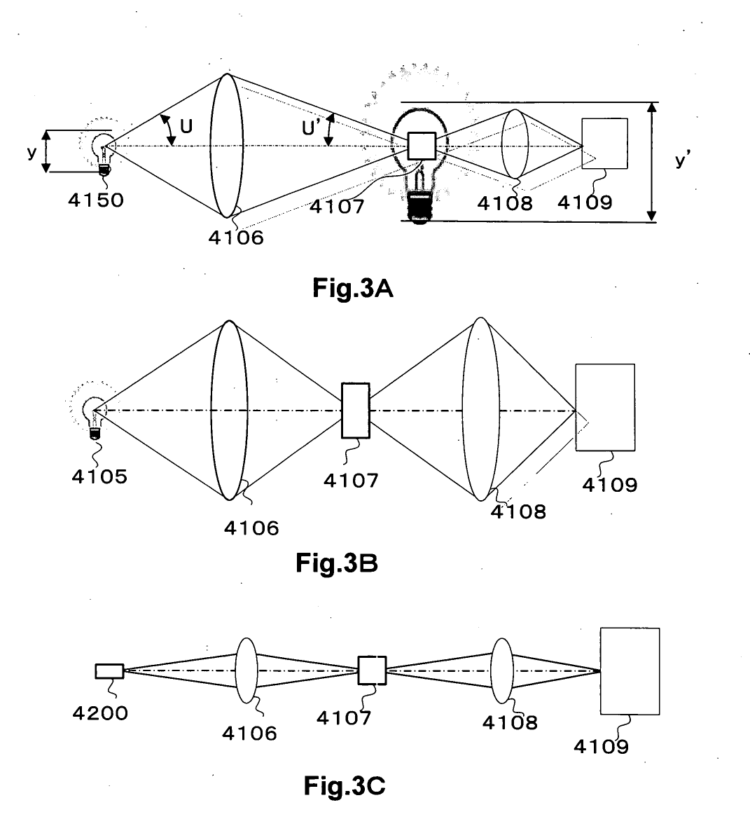

Along with these requirements for miniaturizing a mirror device, there is a design tradeoff for further consideration because of the fact that the larger a mirror device, the brighter is the display image when the conventional light lamp is used as the light source. Attributable to a optical functional relationship generally known as etendue, the efficiency of the non-polarized light projected from the conventional lamp may be substantially reduced. The adverse effects must be taken into consideration as an important factor for designing and configuring an image projection system, particularly for designing the light sources. FIG. 3A is diagram for explaining an optical parameter etendue by exemplifying the case of using an arc discharge lamp light source and projecting an image by way of an optical device.

Let “y” represent the size of a light source 4150 and “u” represent the angle of light with which an optical lens imports the light from the light source. Further, let “u′” be the converging angle on the image side converged by using the optical lens 4106, and “y′” be the size of an image projected onto a screen 4109, by way of a projection lens 4108 after using an optical device 4107 for the converged light. Specifically, there is a relationship known as the etendue among the size y of the light source 4150, the import angle u of light, the converging angle u′ on the image side, and the size y′ of an image, as follows:

y*u=y′*u′

Based on this relationship, the smaller the optical device 4107 attempting to image the light source 4150, the smaller the import angle u of light becomes. Because of this, when the optical device 4107 is made smaller, the image becomes darker as a result of limiting the import angle u of light. Therefore, when using an arc discharge lamp with low directivity, the import angle u of light needs to be appropriately large in order to maintain the brightness of an image.

FIG. 3B is a diagram illustrating the use of an arc discharge lamp light source and the projection of an image by way of an optical device. The light output from an arc discharge lamp light source 4105 is converged by using an optical lens 4106, and irradiated onto the optical device 4107. Then, the light passing through the optical device 4107 is projected onto a screen 4109 by way of a projection lens 4108.

The larger the optical lens used in this case, the higher the converging capacity and the better the usage efficiency of light. However, increasing the size of the optical device 4107 is contradictory to the demand for shrinking the spatial light modulator or making the projection apparatus more compact.

In contrast, a laser light source has a higher directivity of light and a smaller expansion of light flux than those of a discharge lamp light source. Therefore, a projected image can be made sufficiently bright without the need to increase the size of the optical lens or optical device. Further, if the projected image is not sufficiently bright, the brightness can be increased by increasing the output of the laser light source. Also in this case, because of the high directivity of laser light, the light intensity can be increased without allowing a substantial expansion of light flux.

FIG. 3C is a diagram illustrating the use of a laser light source and the projection of an image by way of an optical device.

The laser light emitted from a laser light source 4200 is made to be incident to an optical device 4107 by way of an optical lens 4106. Then, the light passing through the optical device 4107 is projected onto a screen 4109 by way of a projection lens 4108.

In this case, the usage efficiency of light for the optical lens 4106 and optical device 4107 is improved by taking advantage of the high directivity of the laser light. A projected image can be made brighter without a need to increase the size of the optical lens 4106 or optical device 4107. This eliminates the problem of etendue, making it possible to miniaturize the optical lens 4106 and optical device 4107, leading to a more compact projection apparatus.

### Outline of Resolution Limit

An examination of the limit value of the aperture ratio of a projection lens used for a projection apparatus, which displays the display surface of a spatial light modulator in enlargement, in view of the resolution of an image to be projected, leads to the following.

Where “Rp” is the pixel pitch of the spatial light modulator, “NA” is the aperture ratio of a projection lens, “F” is an F-number, and “λ” is the wavelength of light, the limit “Rp” with which any adjacent pixels on the projection surface are separately observed is derived by the following equation:

Rp=0.61*λ/NA=1.22*λ*F

When the pitch between mirror elements is decreased by using a miniaturized mirror, the relationship among the aperture ratio NA, which is theoretically required for resolving individual mirrors, the F-number for the projection lens, and the corresponding deflection angle of the mirror, is given by the following tables for the wavelength of light at λ=400 nm, the green light (at λ=650 nm) and the red light (at λ=800 nm), respectively.

The NA required for resolving, in the projected image, adjacent mirror elements and the tilt angle of a mirror for separating the illumination light and projection light with the respective NA:

### At λ=400 nm

| Mirror | Aperture | F-number for | |
|---|---|---|---|
| device pixel | ratio: | projection | Deflection angle |
| pitch: μm | NA | lens | of mirror: degrees |
| 4 | 0.061 | 8.2 | 3.49 |
| 5 | 0.049 | 10.2 | 2.79 |
| 6 | 0.041 | 12.3 | 2.33 |
| 7 | 0.035 | 14.3 | 2.00 |
| 8 | 0.031 | 16.4 | 1.75 |
| 9 | 0.027 | 18.4 | 1.55 |
| 10 | 0.024 | 20.5 | 1.40 |
| 11 | 0.022 | 22.5 | 1.27 |

### At λ=650 nm:

| Mirror | Aperture | F-number for | |
|---|---|---|---|
| device pixel | ratio: | projection | Deflection angle |
| pitch: μm | NA | lens | of mirror: degrees |
| 4 | 0.099 | 5.0 | 5.67 |
| 5 | 0.079 | 6.3 | 4.54 |
| 6 | 0.066 | 7.6 | 3.78 |
| 1 | 0.057 | 8.8 | 3.24 |
| 8 | 0.050 | 10.1 | 2.84 |
| 9 | 0.044 | 11.3 | 2.52 |
| 10 | 0.040 | 12.6 | 2.27 |
| 11 | 0.036 | 13.9 | 2.06 |

### At λ=800 nm:

| Mirror | Aperture | F-number for | |
|---|---|---|---|
| device pixel | ratio: | projection | Deflection angle |
| pitch: μm | NA | lens | of mirror: degrees |
| 4 | 0.122 | 4.1 | 6.97 |
| 5 | 0.098 | 5.1 | 5.58 |
| 6 | 0.081 | 6.1 | 4.65 |
| 7 | 0.070 | 7.2 | 3.99 |
| 8 | 0.061 | 8.2 | 3.49 |
| 9 | 0.054 | 9.2 | 3.11 |
| 10 | 0.049 | 10.2 | 2.79 |
| 11 | 0.044 | 11.3 | 2.54 |

Based on the above tables, it is clear that a sufficient F-number for a projection lens required for resolving, in the projected image, individual pixels with, for example, 10 μm pixel pitch is theoretically F=20.5. The projection lens has an extremely small aperture when the wavelength of illumination light is λ=400 nm. In the meantime, the mirror would have a sufficient deflection angle of mere 1.4 degrees to provide the required resolution. The mirror device can be controlled and the mirror elements may be driven with a very low drive voltage.

However, as discussed above, the image brightness would be significantly reduced when a conventional non-coherent lamp as light source is implemented with an illumination lens matched with such a projection lens. Accordingly, a laser light source is implemented to circumvent the above-described problem attributable to the etendue. The implementation of the laser light source makes it possible to increase the F-number for the illumination and projection optical systems to the number indicated in the table and to reduce the deflection angle of a mirror element as a result, thus enabling the configuration of a compact mirror device with a low drive voltage. F-number

Furthermore, the introduction of a laser light source provides the benefit of lowering the drive voltage by introducing the laser light source, making it possible to further reduce the thickness of the circuit-wiring pattern of the control circuit controlling the mirror. It is possible to further reduce power consumption by setting the deflection angle of the mirror at a minimum for each frequency of light as the target of modulation. That is, the deflection angle of the mirror can be reduced for a mirror device modulating, for example, blue light as compared to the deflection angle of a mirror modulating red light. It is thus possible for a projection apparatus to be configured without increasing the sizes of the optical components used in the apparatus when, for example, single color laser light sources are used for light sources, the respective illumination light paths are individually provided, and the optimal NAs are set for the respective illumination light paths.

It is also possible to cause the laser light source to perform pulse emission by configuring a circuit that alternately emits the pulse emission of the ON and OFF lights for a predetermined period. Controlling the pulse emission of the light source makes it possible to adjust intensity in accordance with the image signal (that is, in accordance with the brightness and hue of the entire projection image) and to express the finer gradations of the display image. Further, lowering the output of the laser light makes it possible to vary the dynamic range of an image and to darken the entire screen in response to a dark image.

Furthermore, performing a pulse control makes it possible to turn OFF a laser light source as appropriate during a period where no image is displayed or during a period of changing the colors of a display image in one frame. As a result, a temperature rise due to the irradiation of extraneous light onto a mirror device can be alleviated.

### Outline of Oscillation Control

US Patent Application 20050190429 discloses another method other than the method of minimizing the tilt angle of the mirror for reducing a drive voltage. In this disclosure, a mirror is controlled to freely oscillate in an oscillation state. The oscillation has an inherent oscillation frequency. The mirror operated in oscillating state projects an intensity of light that is about 25% to 37% of the emission light intensity when a mirror is controlled under a constant ON state.

According to such a control, it is no longer required to drive the mirror at a high speed to achieve a higher resolution of gray scale. A high level of gray scale resolution is achievable with a hinge of a low spring constant for supporting the mirror. The drive voltage may be reduced. This method, combined with the method of decreasing the drive voltage by decreasing the deflection angle of a mirror, as described above, would produce even greater improvements.

As described above, the use of a laser light source makes it possible to decrease the deflection angle of a mirror and to shrink the mirror device without causing a degradation of brightness, and further, the use of the above described oscillation control enables a higher level of gradation without causing an increase in the drive voltage.

However, if an electrode for driving the mirror and a stopper for determining the deflection angle of the mirror are individually configured, as in the conventional method, the problem of inefficient space usage remains.

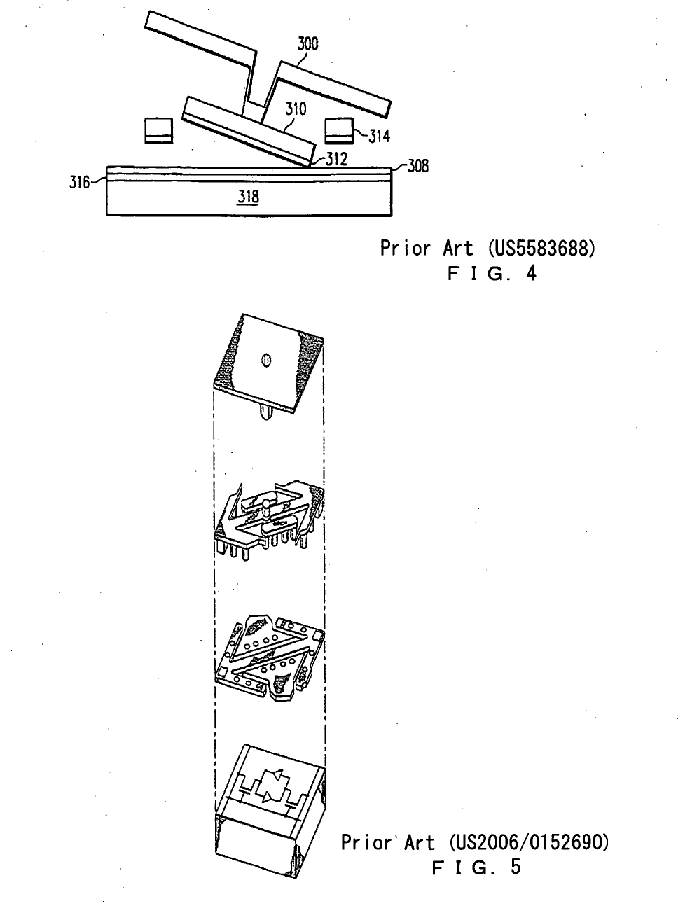

FIG. 4 is a cross sectional view for showing the structure of a mirror device for controlling a mirror deflection angle in the conventional mirror device, as disclosed in U.S. Pat. No. 5,583,688. This mirror device includes a landing yoke 310, which is connected to a mirror 300. The yoke 310 deflects with the mirror 300. The yoke 310 includes a tip 312 formed in a part of the landing yoke 310. The tip 312 contacts a metallic layer, which is formed separately from the address electrode 314 to stop the mirror before the mirror 300 deflects to an angular position to come into contact with the address electrode 314, thereby regulating the deflection angle of the mirror 300. In such a configuration, the landing yoke and tip occupy part of the space available for placing an electrode, making it difficult to increase the size of the address electrode.

FIG. 5 shows the structure for regulating a mirror deflection angle in the conventional mirror device, as disclosed in US Patent Application 20060152690. Although this patent application discloses a structure that has eliminated the landing yoke, however, the mirror device still has a tip as a separate component for determining the deflection angle of the mirror. The tip functioning as a stopper is disposed in the space that would be available for placing an address electrode. In a mirror device with configuration shown in FIG. 3, it would be difficult to increase the size of the address electrode.

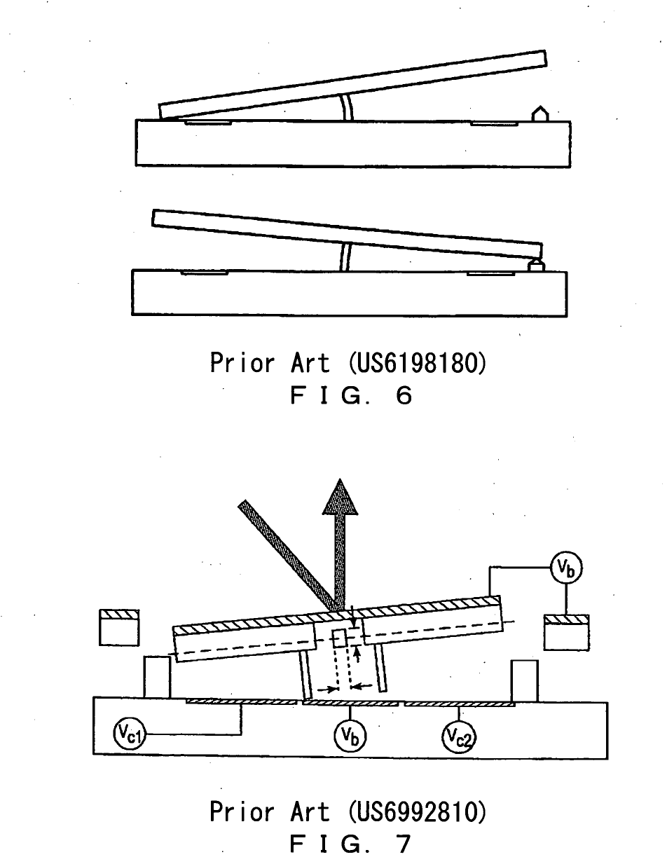

FIG. 6 shows cross sectional views of a mirror to illustrate the structure for regulating a mirror deflection angle in the conventional mirror device, as disclosed in U.S. Pat. No. 6,198,180. In the mirror device disclosed by the patent, the configuration includes a stop post, which is separate from a capacitor panel to define the maximum deflection angle of the mirror. Therefore, the electrode size is still limited by the extra space occupied by the capacitor stop post and the capacitor panel.

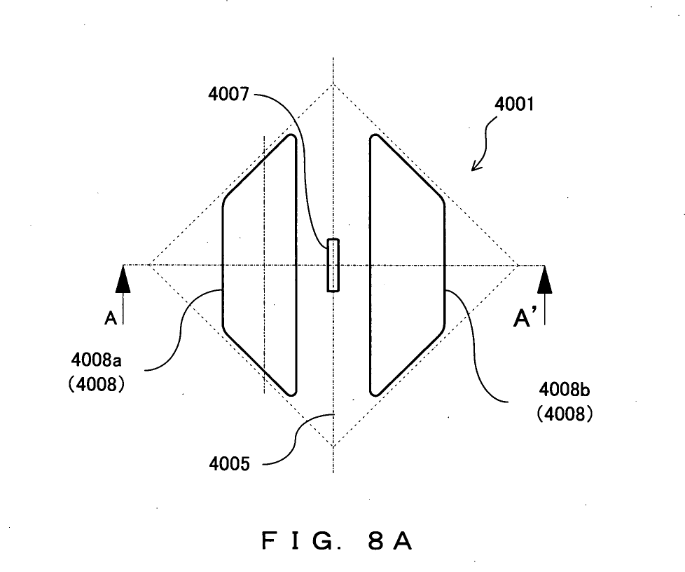

FIG. 7 shows a cross section view of a mirror device for illustrating the structure for regulating a mirror deflection angle in the conventional mirror device, as disclosed in U.S. Pat. No. 6,992,810. The mirror device includes a mechanical stop element, which regulates the deflection angle of a mirror, directly under the mirror. The mechanical stop element abuts on a landing electrode that is maintained at the same potential as the mirror. This disclosure also makes it difficult to increase the electrode size.

In order to resolve the problems noted above, the first embodiment of the present invention is accordingly configured to integrate the electrode used for driving the mirror element with the stopper used for determining the maximum deflection angle of the mirror in a mirror device.

### Embodiment 1

The following is a detail description of a mirror device according to the present embodiment.

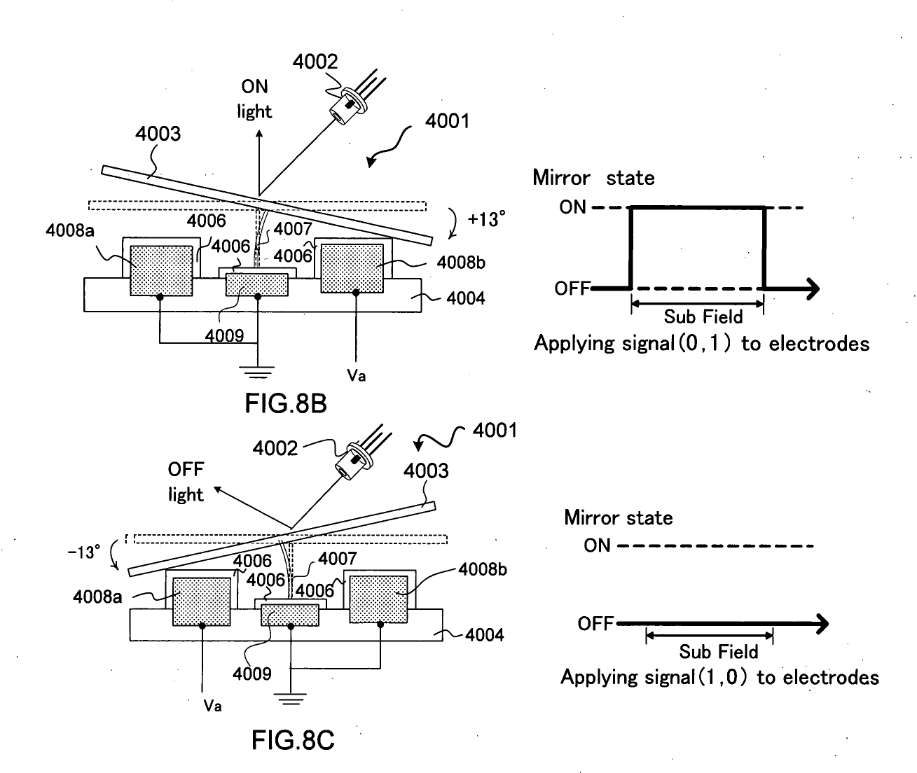

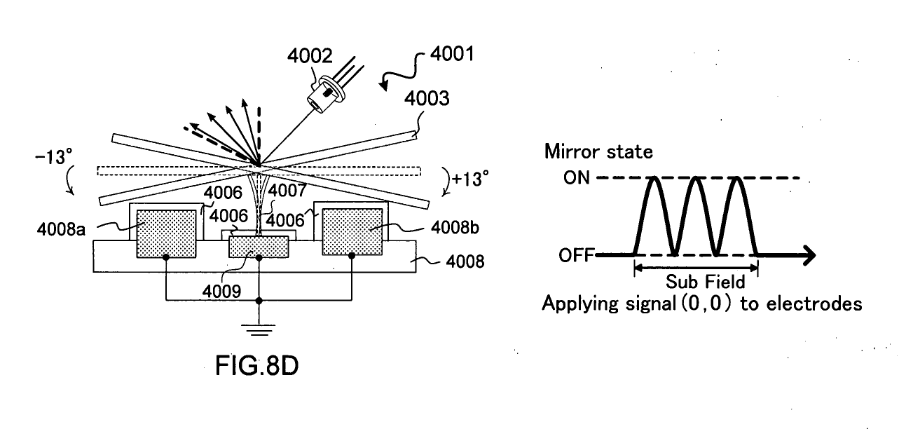

FIGS. 8A, 8B, 8C and 8D are diagrams for depicting the configuration of the mirror element of a mirror device according to the present embodiment. FIG. 8A is a top view diagram of a mirror element with the mirror omitted. FIGS. 8B, 8C and 8D are outline diagrams of a cross-section of a mirror element taken along the A-A′ line of FIG. 8A, showing the position of the mirror in different deflection states. The deflection states of the mirror exemplified in FIGS. 8B, 8C and 8D are described in detail later.

In the mirror element 4001 shown in FIGS. 8A through 8D, the mirror 4003 is made of a highly reflective material, such as aluminum or gold, and is supported by the elastic hinge 4007. The entirety or a part of the hinge (e.g., the connection part with a fixing part, the connection part with a moving part or the intermediate part) is made of a silicon material, a metallic material, or the like, and is placed on the device substrate 4004. Specifically, the silicon material may include poly-silicon, single crystal silicon, amorphous silicon, and the like; while the metallic material may include aluminum, titanium, or an alloy of them. Alternatively, a composite material produced by layering different materials may be used. Further, the elastic hinge 4007 may be made of ceramics or glass.

The mirror 4003 is formed in the approximate shape of a square, with the length of one side, for example, between 4 μm and 10 μm. The mirror pitch is, for example, anywhere between 4 μm and 10 μm. The deflection axis 4005 of the mirror 4003 is on the diagonal line thereof. The lower end of the elastic hinge 4007 is connected to the device substrate 4004, includes a circuit for driving the mirror 4003. The upper end of the elastic hinge 4007 is connected to the lower surface of the mirror 4003. An electrode for securing conductivity and/or an intermediate member for strengthening a member or for strengthening the connection may be placed between the elastic hinge 4007 and device substrate 4004 or between the elastic hinge 4007 and mirror 4003.

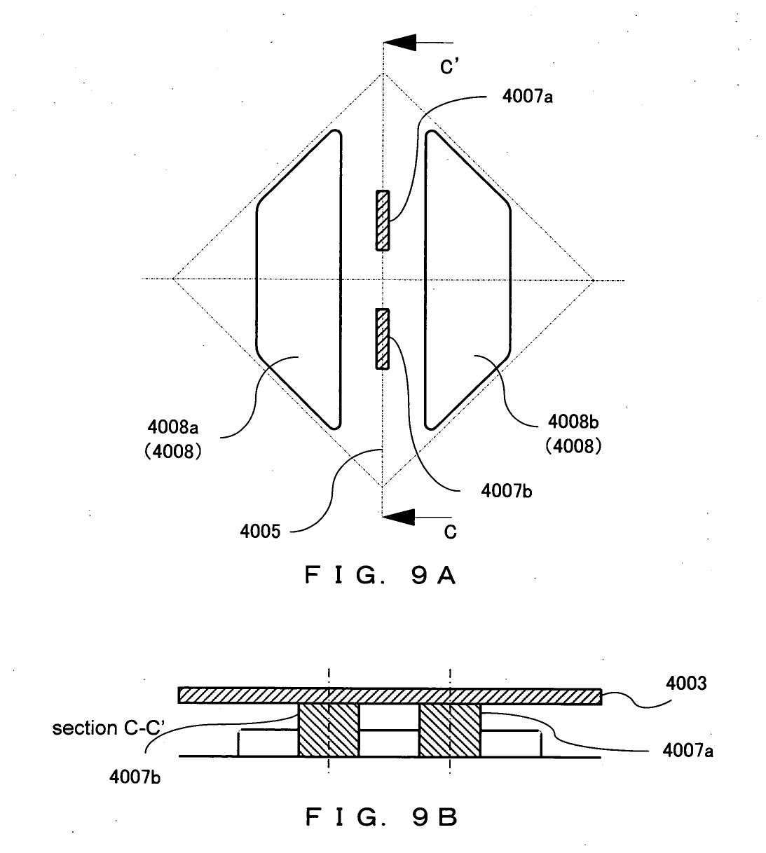

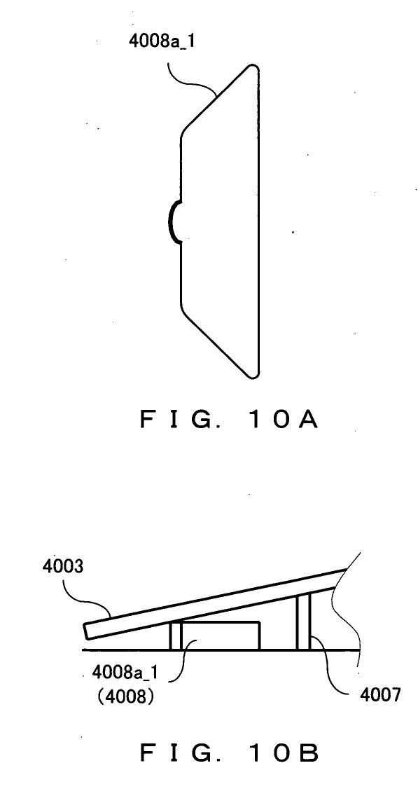

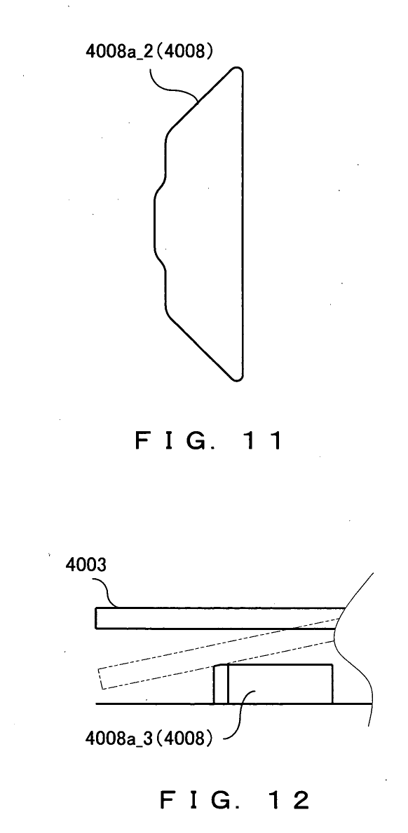

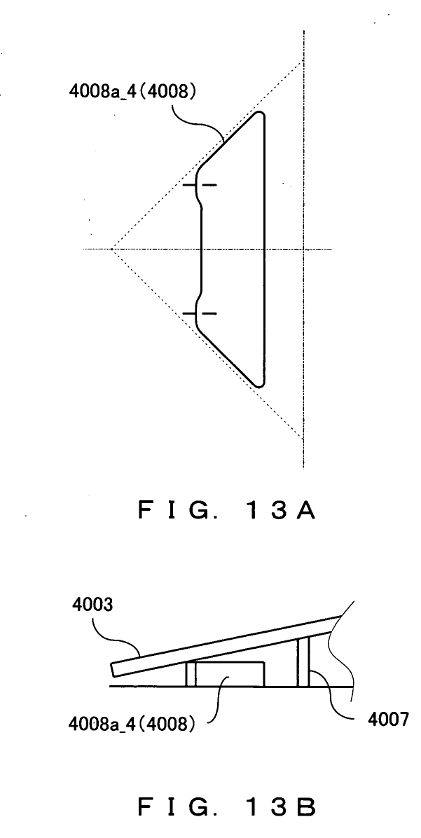

FIGS. 9A and 9B are diagrams showing an exemplary modification of a mirror element of a mirror device according to the present embodiment. FIG. 9A is a top view diagram of the mirror element with the mirror removed. FIG. 9B is an outline diagram showing a cross-section of the mirror element taken along the line C-C′ depicted in FIG. 9A.

Note that multiple elastic hinges (refer to 4007a and 4007b) may be placed along the deflection axis 4005 of the mirror 4003, as shown in FIGS. 9A and 9B. Such a placement of elastic hinges stabilizes the deflecting direction when the mirror is deflected. When multiple elastic hinges are employed, as shown in FIGS. 9A and 9B, the interval between each of the elastic hinges, or between each of the intermediate members placed between the hinge and substrate, should be as large as possible, preferably no less than 30% of the deflection axis length of the mirror.

As exemplified in FIG. 8B, the electrodes 4008 (4008a and 4008b) used for driving the mirror 4003 are placed on the top surface of the device substrate 4004 and opposite to the bottom surface of the mirror 4003. The form of the address electrodes 4008 may be symmetrical or asymmetrical relative to the deflection axis 4005. The address electrodes 4008 are made of aluminum, tungsten, or other similar material.

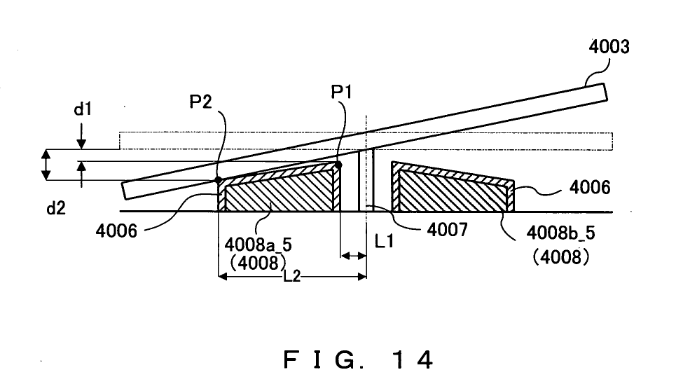

FIGS. 10A, 10B, 11, 12, 13A, 13B, 14, 15A, 15B, 16A, 16B, 17A, 17B and 17C are diagrams that describe the different forms of address electrodes included in the mirror element 4001 according to the present embodiment.

The present embodiment is configured such that the address electrode 4008 also functions as a stopper for determining the deflection angle of the mirror. The deflection angle of the mirror is the angle determined by the aperture ratio of a projection lens that satisfies a theoretical resolution determined by the pitch of adjacent mirrors on the basis of the equation below:

Rp=0.61*λ/NA=1.22*λ*F

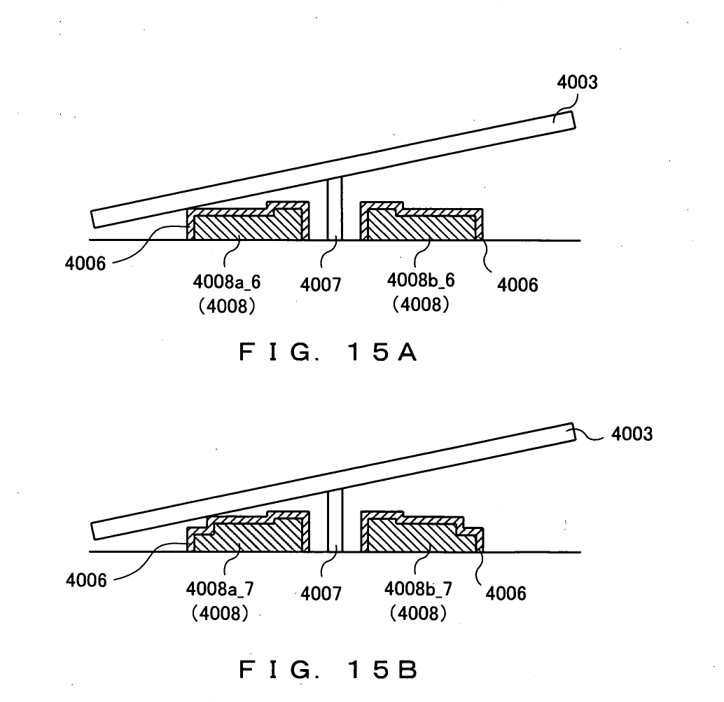

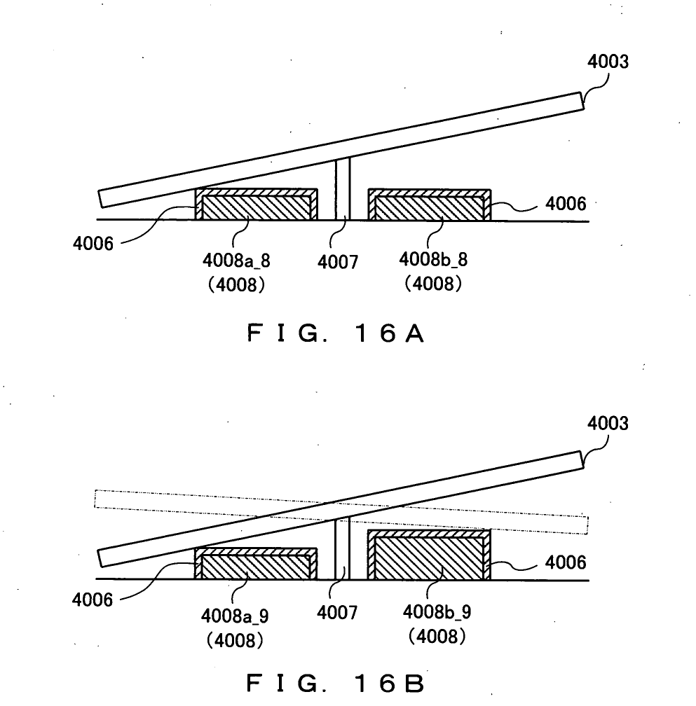

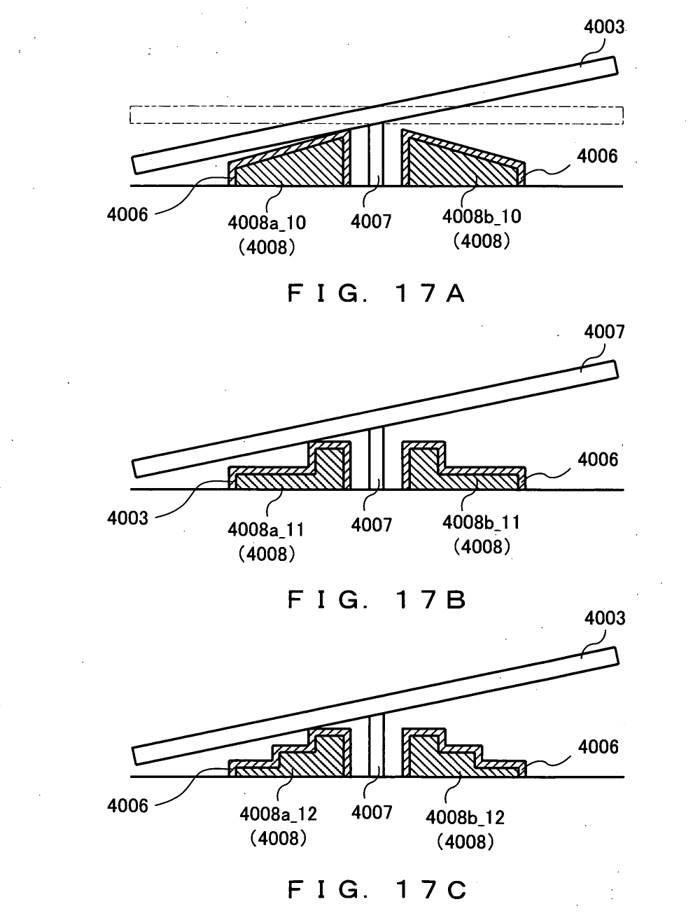

In another word, the deflection angle of a mirror may not be set at a lower angle than the determined angle. Since a laser light is transmitted with a uniform phase, the diffracted light has a higher light intensity than the light emitted from a mercury lamp. Therefore, the adverse effects of the diffracted light generally occurs to the non-coherent light projected from a lamp as a light source can be prevented by setting the deflection angle of mirror at a larger angle than the appropriate angle calculated from the numerical aperture NA of the light flux of a laser light source and the F-number for a projection lens, thereby preventing the diffracted light from being reflected towards the projection lens. In an exemplary embodiment, the deflection angle of a mirror may be 10 to 14 degrees, or 2 to 10 degrees, relative to the horizontal state of the mirror 4003. In, a configuration in which the address electrode also serves as a stopper, the space available for the electrode is significantly increased compared to a conventional configuration with the address electrode formed separately from the stopper. The mirror device implemented with such mirror element can therefore be further miniaturized. “Stiction” is a well-known phenomenon in which a mirror 4003 sticks to the contact surface between the mirror 4003 and address electrode 4008 (i.e., also a stopper) due to surface tension or intermolecular force when the mirror is deflected. Accordingly, part of the address electrode 4008 may be configured as a circular arc, as shown in FIGS. 10A and 10B, so as to reduce contact with the mirror 4003 to a single point, or to a line of contact, as shown in FIG. 11, in order to reduce stiction between the mirror 4003 and address electrode 4008. The performance of the mirror elements in the mirror device may be adversely affected as a result of excessive contact force between the parts of the address electrode in contact with the mirror 4003. In order to prevent the adverse effects, the mirror may be configured to incline in the same angle as the tilt angle of the mirror 4003 to adjust the contact pressure, as shown in FIG. 12. Note that the address electrode 4008 contacts with the mirror 4003 face to face in a single spot in the example shown in FIG. 12. The address electrode 4008 may also contact the mirror 4003 in multiple places, as shown in FIGS. 13A and 13B, and is not limited to a single spot. The configuration as shown in FIGS. 13A and 13B is preferable because the deflecting direction of the mirror is stably maintained. In this case, the individual contact points are preferably placed apart from each other at a distance no less than 30% of the diagonal size of the mirror.

Further, a part of the address electrode 4008, including at least the part contacting the mirror 4003, may be provided with an inactive surface material, such as halide, in order to reduce the occurrence of stiction between the mirror 4003 and address electrode 4008.

Moreover, an elastic member formed as an integral part of the electrode may be used as a stopper.

The address electrode is configured to have a shape of a trapezoid includes a top and a bottom side, which are approximately parallel to the deflection axis 4005. The trapezoid further includes sloped sides approximately parallel to the contour line of the mirror 4003 of the mirror device, in which the deflection axis 4005 of the mirror 4003 is matched with the diagonal line thereof, as shown in FIG. 9A. Since the electrode and stopper are not separately manufactured as in the conventional method, the electrode-stopper may be conveniently manufactured. The electrode may also be configured by dividing the above-described trapezoid into multiple parts. In order to prevent undesirable reflection light from entering into the projection light path, at least a part of the electrode may be covered with a low reflectance material or a thin film layer having the film thickness substantially equivalent to ¼ of the wavelength λ of the visible light.

A difference in potentials needs to be generated between the mirror and electrode to drive the mirror by electrostatic force. The present embodiment using the electrode also as stopper is configured to provide the surface of the electrode and/or the rear surface of the mirror with an insulation layer(s) in order to prevent an electrical shorting at the point of mirror contact with the electrode. If the surface of the electrode is provided with an insulation layer, the configuration may also be such that the insulation layer is provided to only a part of the electrode, including the part in contact with the mirror. FIGS. 8B, 8C and 8D exemplify the case of providing the surface of the address electrode 4008 (i.e., 4008a and 4008b) with an insulation layer 4006. The insulation layer is made of an oxidized compound, azotized compound, silicon, or silicon compound, e.g., SiC, SiO₂, Al₂O₃, and Si. The material and thickness of the insulation layer is determined so that the dielectric strength voltage is maintained at no less than the voltage required to drive the mirror, preferably no less than 5 volts. For example, the dielectric strength voltage may be configured to be two times the drive voltage of the mirror or higher, 3 volts or higher, or 10 volts or higher. Further, selecting an insulation material resistant to the etchant used in the production process makes it possible for the material to also function as the electrode protective film in the process of etching a sacrificial layer in the production process (which is described in detail later), thereby simplifying the production process.

The following description is for an exemplary embodiment to show the size and shape of an address electrode.

Referring to FIG. 14, where “L1” is the distance between the deflection axis and the edge of the electrode on the side closer to the deflection axis of the mirror 4003, “L2” is the distance between the deflection axis and the edge of the electrode on the side farther from the deflection axis, and “d1” and “d2” are the distances between the mirror's bottom surface and the electrode at the respective edges. “P1” is a representative point on the electrode edge on the side closer to the deflection axis of the mirror, and “P2” is a representative point on the electrode edge on the side farther from the deflection axis.

The exemplary embodiment as shown in FIG. 17 is a case in which the electrode is formed so that: d1<d2. In this configuration, the stopper that determines the tilt angle of the mirror 4003 is preferably placed at the point “P2”, in consideration of a production variance of the electrode height that influences the deflection angle of the mirror. The present embodiment is accordingly configured to satisfy the relationship of:

d1>(L1*d2)/L2

This configuration provides an efficient space utilization of the space under the mirror and maintains a stable deflection angle of the mirror.

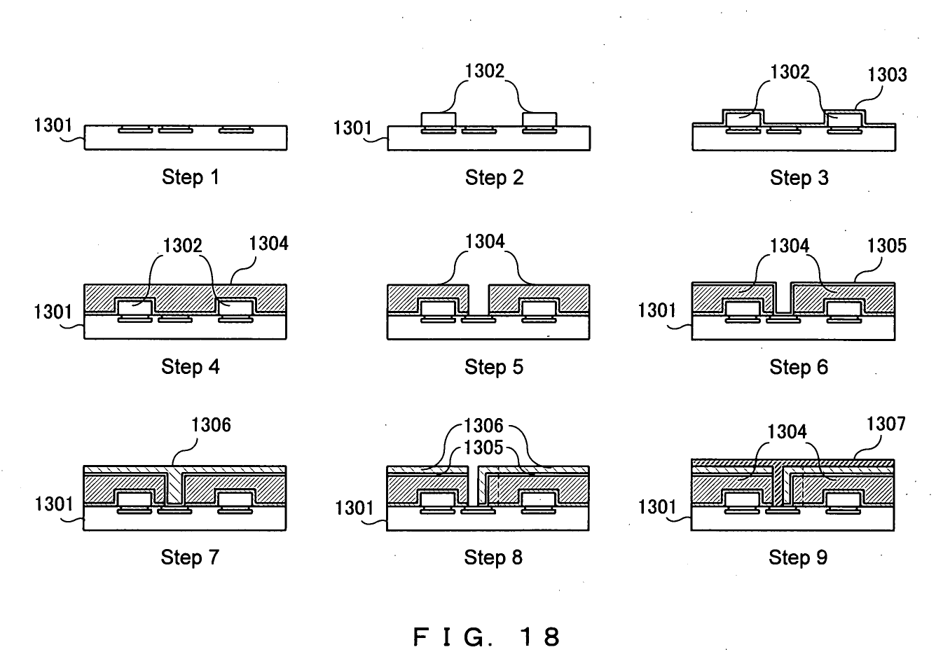

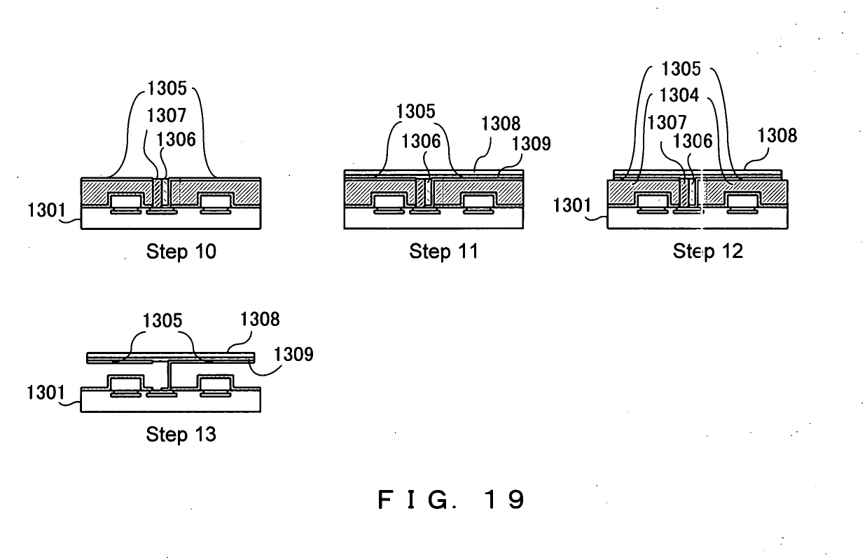

Note that, while in the example shown in FIG. 14, the points P1 and P2 form a continuous slope, an electrode with a stepped slop may also be formed, as shown in FIGS. 15A and 15B, for ease of production.

Furthermore, it is possible to configure the electrode that the deflection angle of the mirror 4003, when it comes into contact with the electrode on one side, is the same as the deflection angle of the mirror 4003, when it comes in contacts with the electrode on the other side, as shown in FIG. 16A, or such that the aforementioned two deflection angles are different, as shown in FIG. 16B.

When the reduction of stiction between the electrode and mirror is a consideration, the closer the contact point to the deflection axis, the more advantageous it is because the momentum impeding the motion of the mirror due to stiction is smaller. If stiction is still a concern, even when an address electrode is coated with a layer for preventing stiction, the configurations as shown in FIGS. 17A, 17B and 17C are viable. In FIGS. 17A, 17B and 17C the stoppers are not formed closer to the deflection axis, i.e. not on the external parts of the electrode farthest from the deflection axis.

When the electrode is configured so that d1=d2, the point on the electrode determining the deflection angle of the mirror is P2, and the configuration is determined to satisfy the following equation:

cot θ=d2/L2

Next is a step-by-step description of the production process of the mirror device according to the present embodiment.

FIGS. 18 and 19 illustrate the production process of the mirror device according to the present embodiment.

In step 1 of FIG. 18, a drive circuit and a wiring pattern (both not shown in the drawing), used in driving and controlling the mirror, are formed on a semiconductor wafer substrate 1301.

Subsequently, an address electrode 1302, which is to be connected to the drive circuit, is formed in step 2. Then, the drive circuit formed on the substrate 1301 is tested to confirm whether or not there is an abnormality in the operation of the drive circuit or in the electrical continuity of the address electrode 1302. If there is no abnormality in the drive circuit or address electrode 1302, the process proceeds to the next step.

In step 3, an insulation layer 1303 is formed on the address electrode 1302. The insulation layer 1303 prevents an electric shorting during the operation of the mirror and also prevents the electrode from being corroded by the etching in the following process. The insulation layer may be made from Si₃N₄ or Si or other similar material.

Then in step 4, a first sacrificial layer 1304 is deposited on the semiconductor wafer substrate 1301, on which the drive circuit and address electrode 1302 have previously been formed. The first sacrificial layer 1304 may be made of SiO₂ or the like, and is used in forming a mirror surface (to be formed in a later step) by providing a space between the semiconductor wafer substrate 1301 and mirror. The thickness of the first sacrificial layer 1304 eventually determines the height of the elastic hinge supporting the mirror, in the present embodiment.

Then in step 5, a part of the first sacrificial layer 1304 is removed by etching. This step will determine the height and form of the elastic member (to be formed in a later step).

In step 6 an elastic member 1305, including a part that connects the elastic member 1305 to the semiconductor wafer substrate 1301, is formed on the semiconductor wafer substrate 1301 and on the first sacrificial layer 1304 formed in step 4. In the present embodiment, the elastic member 1305 eventually constitutes an elastic hinge used in supporting the mirror and is constituted by, for example, a silicon material such as single crystal silicon, poly-silicon, and amorphous silicon (a-Si), or a metallic material such as aluminum, titanium, or an alloy of these metallic materials. Note that the amount of material deposited to form the elastic member, in this step, will determine the eventual thickness of the elastic hinge.

Then in step 7, a photoresistant layer 1306 is deposited on the structure on the semiconductor wafer substrate 1301 formed in the previous step.

In step 8, the photoresist 1306 is exposed to light by using a mask to transfer a desired form of the structure, and then the elastic member 1305 deposited on the semiconductor wafer substrate 1301 is etched, and thereby the desired form of the structure is obtained. Further, by applying etchant in the present step, the elastic member 1305 deposited on the semiconductor wafer substrate 1301 in step 6 is divided into individual elastic hinges, corresponding to the respective mirrors for the mirror elements constituting the mirror device.

Then in step 9, a second sacrificial layer 1307 is further deposited on the structure (resulting from step 8) on the semiconductor wafer substrate 1301. The second sacrificial layer 1307 may be made of a similar composite to that of the first sacrificial layer 1304 or made of, for example, SiO₂. Specifically, the second sacrificial layer 1307 is deposited so as to be higher than the top surface of the part that will constitute the elastic hinge.

Then, turning to FIG. 19, the photoresist 1306 and second sacrificial layer 1307 are polished in step 10 until the top surface of the elastic member 1305 that will constitute the elastic member is exposed.

Then in step 11, a mirror layer 1308 is deposited so as to be connected to the top surface of the photoresist 1306 and elastic member 1305, which have been exposed in step 10. The mirror layer 1308 in this process is made of, for example, aluminum, gold, silver, or the like. In this process, a mirror support layer 1309, which is constituted by a material different from that of the mirror, may also be formed between the mirror layer and elastic member in order to reinforce the connection to the elastic hinge by supporting the mirror layer 1308, or to make it difficult for the stopper to stick to the mirror when the mirror deflects. The mirror support layer 1309 is made of, for example, titanium and tungsten.

In step 12, a photoresist (not shown in the drawing) is coated on the mirror layer 1308, deposited in step 11, and etched after exposure to a mirror pattern using a mask. Thus, individual mirrors are separated.

In the present step (i.e., 12), the first sacrificial layer 1304, photoresist 1306 and second sacrificial layer 1307 still exist under the mirror, and therefore no direct external force is applied to the elastic member 1305. Although the mirror layer, in its original state, can be divided into sections as individual mirrors, it is preferable to further form a protective layer on the top surface of the mirror layer 1308 in order to prevent a decrease in the reflectivity due to causes such as the attachment of foreign materials onto or damage to the top surface of the mirror layer 1308. A protective layer on the mirror layer 1308 also makes it possible to prevent foreign materials from attaching to (and causing the breakage of) the elastic member 1305 or to the mirror and damaging the mirror during the dicing process that divides the structure formed on the semiconductor wafer substrate 1301 into individual mirror devices.

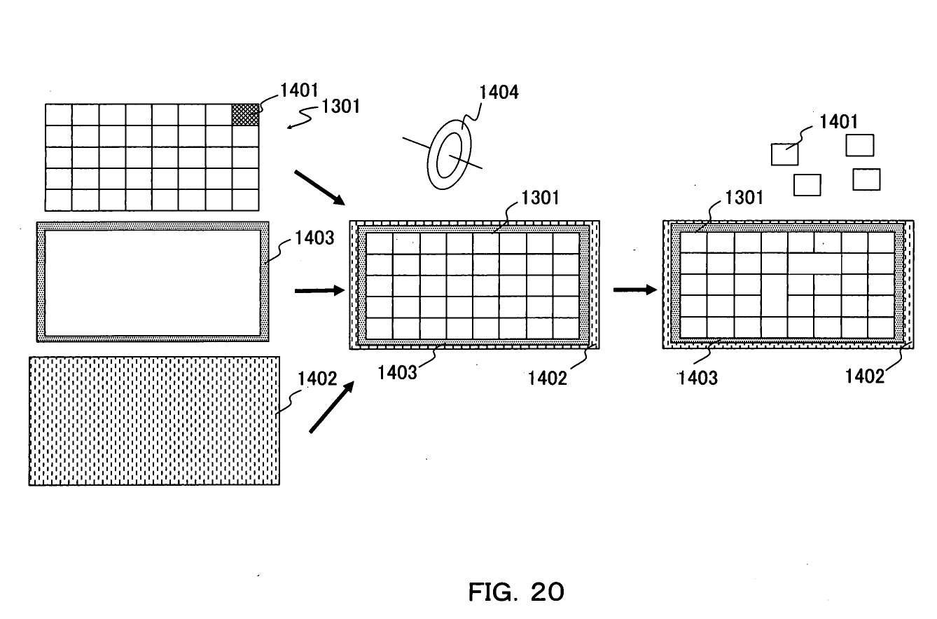

The dicing process, the process by which the plurality of mirror devices formed on the semiconductor wafer substrate 1301 is divided into individual mirror devices are exemplified in FIG. 20. The dicing method shown in FIG. 20 uses at least one auxiliary member to maintain the same alignment, as that of the plurality of mirror devices 1401 formed on the semiconductor wafer substrate 1301 pre-division. The present embodiment shown in FIG. 20 is configured to use, as one of the auxiliary members, a special tape (i.e., a UV tape) 1402, such as an adhesive tape, which is commonly used in a semiconductor process and which loses its adhesive property by emitting an ultraviolet light. In FIG. 20, the aforementioned UV tape 1402 is first attached to the bottom surface of the semiconductor wafer substrate 1301, comprising the plurality of mirror devices 1401, then, the entirety of the semiconductor wafer substrate 1301, along with the UV tape 1402 attached to the bottom surface, is fixed onto a frame 1403 of a dicing apparatus. The plurality of mirror devices 1401 is cut with a circular saw known as a diamond saw 1404. The UV tape 1402 is expanded along with the individual devices after dividing the individual mirror devices 1401 from the semiconductor wafer substrate 1301, and thereby, the cut mirror devices 1401 are expanded, together with the tape 1402, to generate gaps and completely divide into the individual mirror devices 1401. Then, as an ultraviolet light is emitted onto the bottom surface of the UV tape 1402, which is attached to the bottom surfaces of the completely divided individual mirror devices 1401, the adhesive property is lost and the UV tape 1402 is easily peeled off of the mirror devices 1401.

In addition to the diamond saw 1404 described above, the dicing process may also be carried out by another method, such as laser cutting, high pressure water jet cutting, cutting by further etching scribe lines using another etchant, and a cutting of the semiconductor wafer substrate 1301 after forming scribe lines.

Returning to FIG. 19, when step 12 is completed, the first sacrificial layer 1304, photoresist 1306, second sacrificial layer 1307, and protective layer are removed in step 13 by using an appropriate etchant to form the deflectable mirrors, which have been protected by the aforementioned layers. By applying this process, the elastic member 1305 and mirror layer 1308 is formed on the semiconductor wafer substrate 1301 and the drive circuit and electrode are formed to deflect the mirrors.

Afterwards, an anti-stiction process is applied to prevent the moving parts from sticking to one another, that is, to prevent a state in which a normal control for a mirror is disabled by the mirror coming in contact with and being retained by, the electrode.

Then, the completed mirror device is sealed into a package, and along with the package, becomes the end product.

Note that the semiconductor wafer substrate 1301, address electrode 1302, insulation layer 1303, elastic member 1305 and mirror layer 1308, which are shown in FIG. 19 correspond, respectively, to the device substrate 4004, address electrodes 4008a and 4008b, insulation layer 4006 and mirror 4003, which are shown in FIG. 8B.

The following description outlines the natural oscillation frequency of the oscillation system of a mirror device according to the present embodiment.

The reduction of the drive voltage is applied to achieve a higher resolution of gray scales by controlling the mirrors in a free oscillation are already described above. For a mirror device controlled by a pulse width modulator to operate with a free oscillation intermediate state by applying a control word with a LSB, there is a functional relationship between the length of time represented by the LSB and the natural frequency of the oscillation for a mirror supported on a hinge. The natural oscillation cycle T of an oscillation system=2*π*√(I/K)=LSB time/X [%]; where:
I: the rotation moment of an oscillation system,
K: the spring constant of an elastic hinge,
LSB time: the LSB cycle at displaying n bits, and
X [%]: the ratio of the light intensity obtained by one oscillation cycle to the Full-ON light intensity of the same cycle
   Note that:
“I” is determined by the weight of a mirror and the distance between the center of gravity and the center of rotation;
“K” is determined from the thickness, width, length, material and cross-sectional shape of an elastic hinge;
“LSB time” is determined from one frame time, or one frame time and the number of reproduction bits, in the case of a single-panel projection method;
“X” is determined as described above, particularly from the F-number of a projection lens and the intensity distribution of an illumination light. For example, when a single-panel color sequential method is employed, the ratio of emission intensity by one oscillation is assumed to be 32%, and the minimum emission intensity in a 10-bit grayscale is to be obtained by an oscillation, then “I” and “K” are designed so as to have a natural oscillation cycle as follows:

T=1/(60*3*2¹⁰*0.32)≈17.0 μsec.

In contrast, when a conventional PWM control is employed to make the changeover transition time t_{M} of a mirror approximately equal to the natural oscillation frequency of the oscillation system of the mirror and the LSB is regulated so that a shortage of the light intensity in the interim can be sufficiently ignored, the gray scale reproducible with the above described hinge is about 8-bit, even if the LSB is set at five times the changeover transition time t_{M}. That is, a 10-bit grayscale can be reproduced by using the elastic hinge that would have made it possible to reproduce about an 8-bit grayscale according to the conventional control.

In the single-panel projection apparatus described above, an example configuration attempting to obtain, for example, 13-bit grayscale is as follows:

LSB time=( 1/60)*(⅓)*(½¹³)=0.68 μsec

If a configuration is such that the light intensity obtained in one cycle for the optical projection system is 38% of the intensity obtained from controlling a mirror in a constant ON state for the same cycle, the oscillation cycle T is as follows:

T=0.68/0.38%=1.8 μsec

In contrast, when attempting to obtain an 8-bit grayscale in the multi-panel projection apparatus described above, an example comprisal is as follows:

LSB time=( 1/60)*(⅓)*(½⁸)=21.7 μsec

If a configuration is such that the light intensity obtained in one cycle for the optical projection system is 20% of the intensity obtained from controlling a mirror in a constant ON state for the same cycle, the oscillation cycle T is as follows:

T=21.7/20%=108.5 μsec.

As described above, the present embodiment is configured to set the natural oscillation cycle of the oscillation system, which includes an elastic hinge, between 1.8 μsec and 110 μsec; and to use three deflection state, i.e., a first deflection state, in which the light modulated by the mirror element is reflected towards the projection light path, a second deflection state, the light is reflected in a direction away from the projection light path, and a third deflection state, in which the mirror oscillates between the first and second deflection states. A higher resolution of gray scales is achievable without increasing the drive voltage of the mirror element.

As described above, the present embodiment is configured to make the electrode also function as stopper for defining and limiting the maximum deflection angle of the mirror. Space utilization is improved when the mirror element is miniaturized with expanded area to form the electrode.

### Embodiment 2

The following detail description is provided for the preferred embodiment of the present invention with reference to the accompanying drawings.

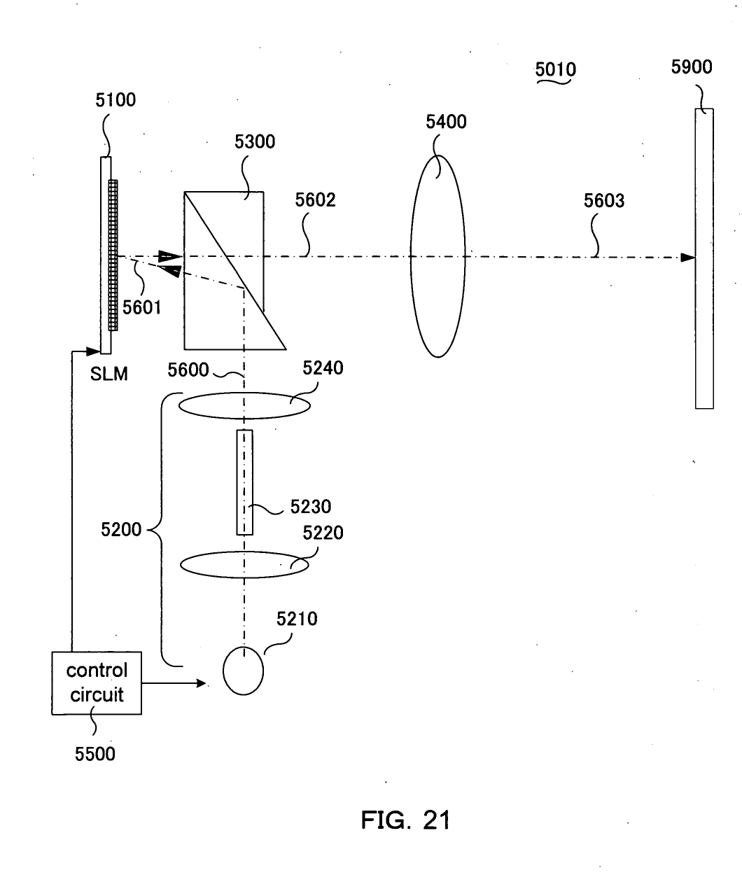

FIG. 21 is a functional block diagram for showing the configuration of a projection apparatus according to a preferred embodiment of the present invention.

A projection apparatus 5010, according to the present embodiment, is a so-called single-panel projection apparatus 5010 comprising a single spatial light modulator (SLM) 5100, a control unit 5500, a Total Internal Reflection (TIR) prism 5300, a projection optical system 5400, and a light source optical system 5200, as exemplified in FIG. 21.

The projection optical system 5400 includes the spatial light modulator 5100 and TIR prism 5300 in the optical axis of the projection optical system 5400, and the light source optical system 5200 is positioned in such a manner that the optical axis thereof matches that of the projection optical system 5400.

The TIR prism 5300 directs the illumination light 5600, which is incoming from the light source optical system 5200 placed on the side towards the spatial light modulator 5100 at a prescribed inclination angle as incident light 5601 and transmits a reflection light 5602, reflected by the spatial light modulator 5100, to the projection optical system 5400.

The projection optical system 5400 projects the reflection light 5602, coming in from the spatial light modulator 5100 and TIR prism 5300, onto a screen 5900 as projection light 5603.

The light source optical system 5200 includes a variable light source 5210 for generating the illumination light 5600. The light source system further includes a condenser lens 5220 for focusing the illumination light 5600, a rod type condenser body 5230, and a condenser lens 5240.

The variable light source 5210, condenser lens 5220, rod type condenser body 5230, and condenser lens 5240 are sequentially placed in the aforementioned order on the optical axis of the illumination light 5600 projected from the variable light source 5210 into the side face of the TIR prism 5300.

The projection apparatus 5010 employs a single spatial light modulator 5100 for projecting a color display on the screen 5900 by applying a sequential color display method. That is, the variable light source 5210, comprising a red laser light source 5211, a green laser light source 5212, and a blue laser light source 5213 (which are not shown in the drawing) that allows independent controls for the light emission states, divides one frame of display data into multiple sub-fields (in this case, three sub-fields: red (R), green (G) and blue (B)) and makes each of the light sources emit each respective light in a time series at the time band corresponding to the sub-field of each color. This process will be described in greater detail later.

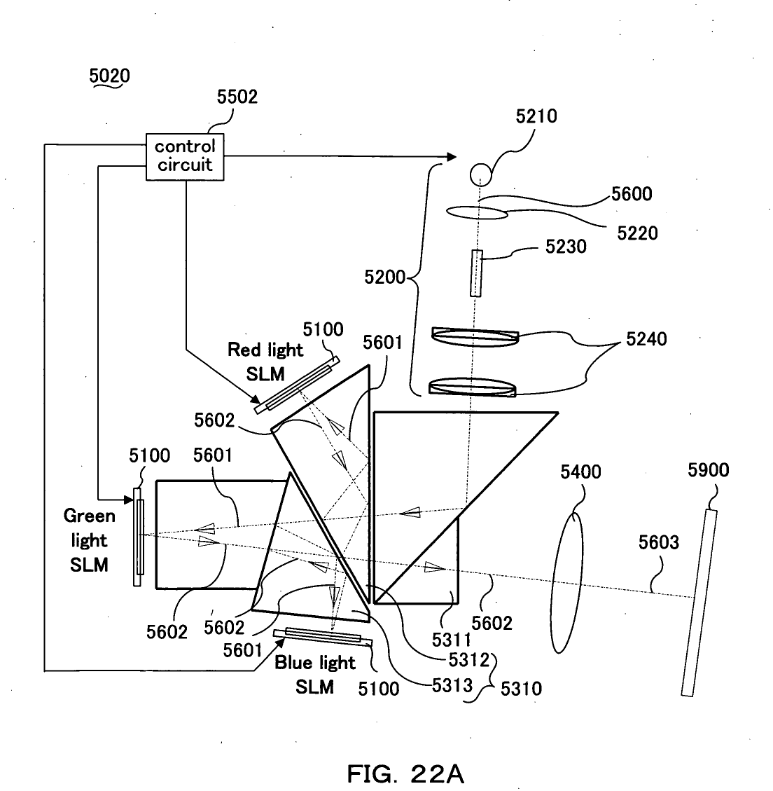

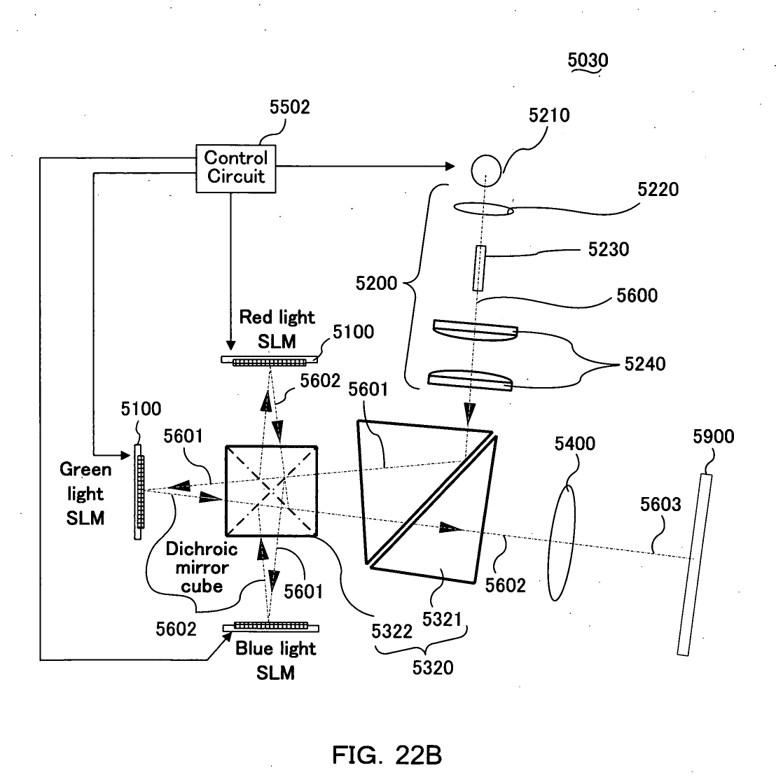

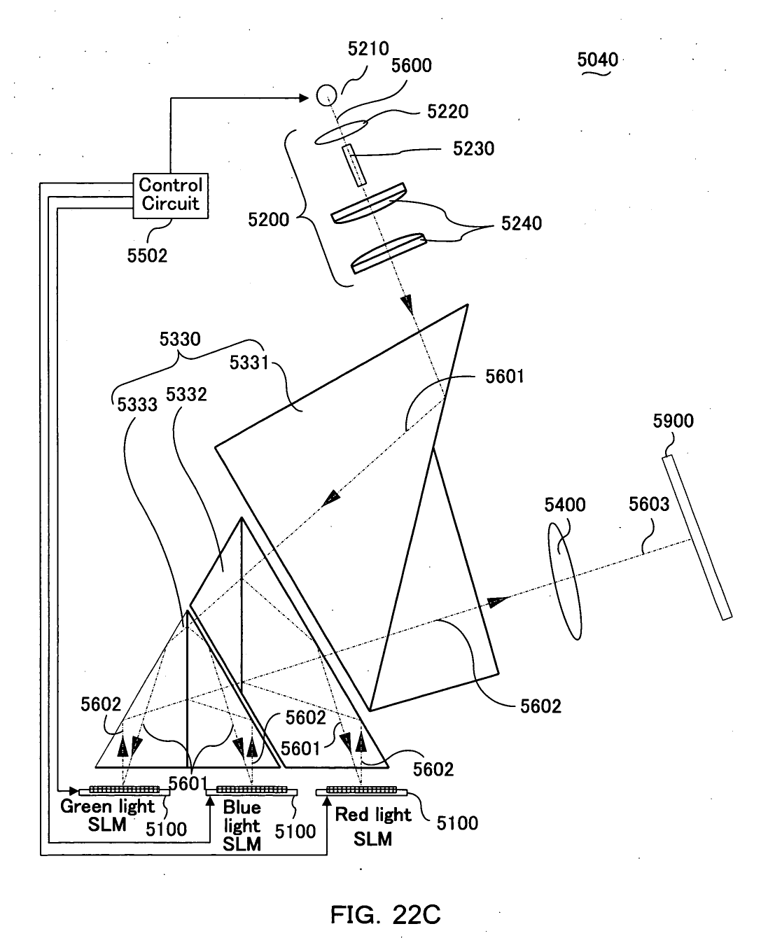

FIG. 22A is a functional block diagram for showing the configuration of a projection apparatus according to another preferred embodiment of the present invention.

The projection apparatus 5020 is a commonly known as multiple-plate projection apparatus comprising a plurality of spatial light modulators 5100, which is the main difference from projection apparatus 5010 described above. Further, the projection apparatus 5020 includes a control unit 5502 in place of the control unit 5500.

The projection apparatus 5020 includes a plurality of spatial light modulators 5100, and further includes a light separation/synthesis optical system 5310 disposed between the projection optical system 5400 and each of the spatial light modulators 5100.

The light separation/synthesis optical system 5310 includes a TIR prism 5311, a prism 5312 and a prism 5313.

The TIR prism 5311 directs the illumination light 5600, incident from the side of the optical axis of the projection optical system 5400, to the spatial light modulator 5100 as incident light 5601.

The prism 5312 has separates the red (R) light from an incident light 5601, incident by way of the TIR prism 5311 and, making the red light incident to the red light-use spatial light modulators 5100, directs the reflection light 5602R of the red light to the TIR prism 5311.

Likewise, the prism 5313 separates the blue (B) and green (G) lights from the incident light 5601, passing through the TIR prism 5311 to project onto the blue color-use spatial light modulators 5100 and green color-use spatial light modulators 5100, directs the reflection light 5602 of the green light and blue light to the TIR prism 5311.

Therefore, the spatial light modulations of the three color lights R, G and B are carried out simultaneously at three spatial light modulators 5100, respectively, and the reflection lights resulting from the respective modulations are projected onto the screen 5900 as the projection light 5603, by way of the projection optical system 5400; thus a color display is carried out.

Note that various modifications are possible for a light separation/synthesis optical system and are not limited to the light separation/synthesis optical system 5310.

FIG. 22B is a functional block diagram for showing the configuration of a modified embodiment of a multi-panel projection apparatus according to another preferred embodiment of the present invention.

The alternate embodiment includes a light separation/synthesis optical system 5320 in place of the above described light separation/synthesis optical system 5310. The light separation/synthesis optical system 5320 includes a TIR prism 5321 and a cross-dichroic mirror 5322.

The TIR prism 5321 directs an illumination light 5600, projected from the lateral direction of the optical axis of the projection optical system 5400, to the spatial light modulators 5100 as incident light 5601.

The cross dichroic mirror 5322 separates red, blue and green lights from the incident light 5601, incoming from the TIR prism 5321, making the incident lights 5601 of the three colors enter the red-use, blue-use and green-use spatial light modulators 5100, respectively, and also converging the reflection lights 5602, reflected by the respective color-use spatial light modulators 5100, and directing the light towards the projection optical system 5400.

FIG. 22C is a functional block diagram for showing the configuration of yet another modified embodiment of a multi-panel projection apparatus according to the present embodiment.

The projection apparatus 5040 is configured, in contrast from the above described projection apparatuses 5020 and 5030, to place, so as to be adjacent to one another in the same plane, a plurality of spatial light modulators 5100 corresponding to the three colors R, G and B on one side of a light separation/synthesis optical system 5330. This configuration makes it possible to consolidate the multiple spatial light modulators 5100 into the same packaging unit, and thereby saving space.

The light separation/synthesis optical system 5330 includes a TIR prism 5331, a prism 5332 and a prism 5333. The TIR prism 5331 has the function of directing, to spatial light modulators 5100, the illumination light 5600, incident in the lateral direction of the optical axis of the projection optical system 5400, as incident light.

The prism 5332 serves the functions of separating a red color light from the incident light 5601 and directing it towards the red color-use spatial light modulator 5100, and of capturing the reflection light 5602 and directing it to the projection optical system 5400.

Likewise, the prism 5333 serves the functions of separating the green and blue incident lights from the incident light 5601, making them incident to the individual spatial light modulators 5100 implemented for the respective colors, and of capturing the green and blue reflection lights 5602 and directing them towards the projection optical system 5400.

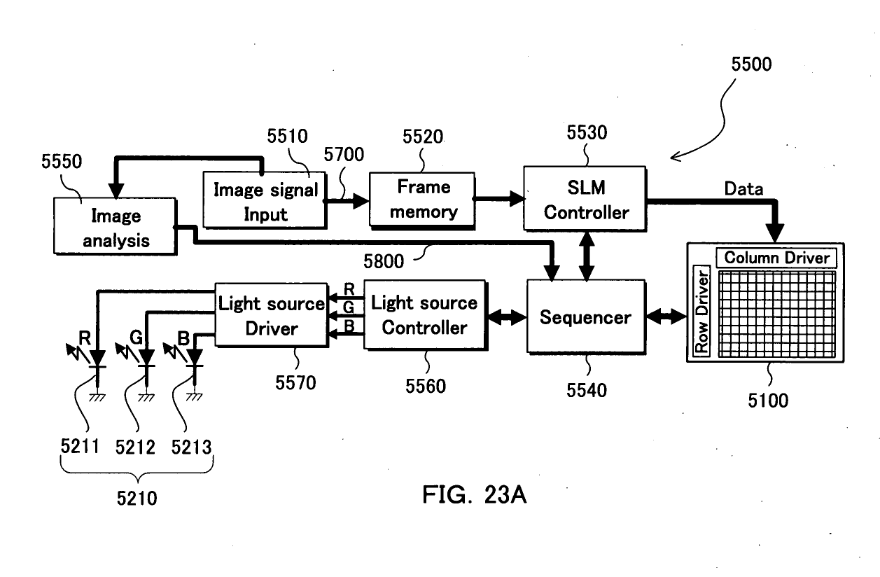

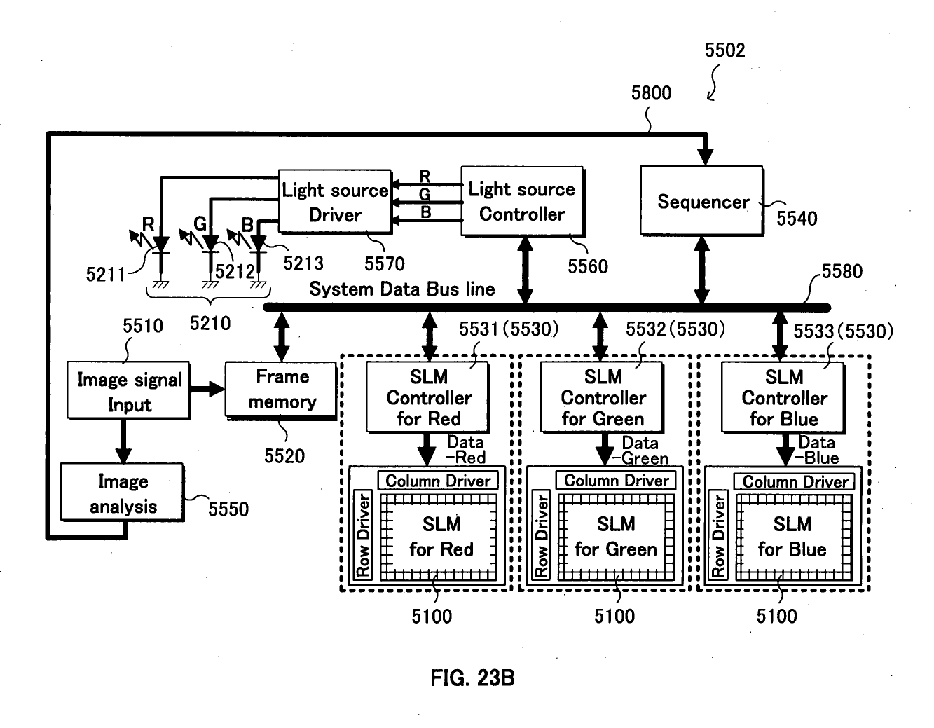

FIG. 23A is a functional block diagram exemplifying the configuration of the control unit 5500 as disclosed in the above described single-panel projection apparatus 5010. The control unit 5500 includes a frame memory 5520, an SLM controller 5530, a sequencer 5540, (a video image analysis unit 5550,) a light source control unit 5560, and a light source drive circuit 5570.

The sequencer 5540, implemented by a microprocessor to control the operation timing of the entire control unit 5500 and spatial light modulators 5100. The frame memory 5520 stores one frame of input digital video data 5700 received from an external device (not shown in the drawing), connected to a video signal input unit 5510. The input digital video data 5700 is updated in real time every time the display of one frame is completed.

The SLM controller 5530 processes the input digital video data 5700 received from the frame memory 5520 (which are described later), separates the read data into multiple sub-fields 5701 through 5703, and outputs the data to the spatial light modulators 5100 as binary data 5704 and non-binary data 5705, which are used for implementing the ON/OFF control and oscillation control (which are described later) of a mirror 4003 of the spatial light modulator 5100.

The sequencer 5540 outputs a timing signal to the spatial light modulators 5100 in sync with the generation of the binary data 5704 and non-binary data 5705 at the SLM controller 5530.

The video image analysis unit 5550 provides output data of a light source profile control signal 5800, used for generating various light source patterns (which are described later), on the basis of the input digital video data 5700 inputted from the video signal input unit 5510.

The light source control unit 5560 controls the light source drive circuit 5570 to control the operation of the variable light source 5210 for projecting the illumination light 5600 according to a light source profile control signal. The light source profile signal is generated from the light source profile control signal taking into account of the input of the light source profile control signal 5800, received from the video image analysis unit 5550 through the sequencer 5540. The sequencer further generates light source pulse patterns 5801 through 5811 as will be described later.

The light source drive circuit 5570 drives the red laser light source 5211, the green laser light source 5212 and the blue laser light source 5213 of the variable light source 5210 to emit light to generate the light source pulse patterns 5801 through 5811 (which are described later), which are input from the light source control unit 5560.

A single light source drive circuit 5570 drives the laser light sources is depicted in an exemplary configuration as shown at of The three colors; such a configuration may be flexibly configured. An alternative configuration may be such that the three laser light sources (5211, 5212, and 5213) are driven by three independent light source drive circuits.

The variable light source 5210 shown here further includes a red laser light source 5211, a green laser light source 5212 and a blue laser light source 5213. The configuration may be flexibly adjusted with an alternative configuration includes a single light source capable for emitting light containing all wavelengths corresponding to colors, including, red (R), green (G) and blue (B).

Further, shown here is such that the operation of the variable light source 5210 is controlled by the input of the light source profile control signal 5800, which is generated by the video image analysis unit 5550, into the light source control unit 5560 by way of the sequencer 5540. The video image analysis unit 5550, however, is not necessarily required. In the absence of the video image analysis unit 5550, the sequencer 5540 may also generate the light source profile control signal 5800 and input it into the light source control unit 5560.

FIG. 23B is a functional block diagram exemplifying the configuration of the control unit of a multi-panel projection apparatus according to the present embodiment.

The control unit 5502 includes a plurality of SLM controllers 5531, 5532 and 5533, which control each of the plurality of spatial light modulators 5100 implemented for the colors R, G and B. The comprisal of the controllers is the main difference from the above described control unit 5500; otherwise they are similar.

That is, the SLM controller 5531, SLM controller 5532 and SLM controller 5533, corresponding to the respective color-use spatial light modulators 5100, are included on the same substrate as those of the respective spatial light modulators 5100. This configuration makes it possible to place the individual spatial light modulators 5100 and the corresponding SLM controller 5531, SLM controller 5532 and SLM controller 5533 close to each other, thereby enabling a high speed data transfer rate.

Further, a system bus 5580 is formed for commonly connecting the frame memory 5520, light source control unit 5560, sequencer 5540, and SLM controllers 5531 through 5533, in order to speed up and simplify the connection path of each connecting element.

Note that the exemplary configuration shown here is such that a single light source drive circuit 5570 drives the laser light sources of the respective colors; such a configuration is arbitrary. An alternative configuration may be such that the three laser light sources (5211, 5212, and 5213) are driven by three independent light source drive circuits.

Also, the variable light source 5210 shown here is constituted by the red laser light source 5211, green laser light source 5212, and blue laser light source 5213; the configuration is arbitrary. An alternative configuration may be a single light source capable of emitting light containing all wavelengths corresponding colors, including, red (R), green (G) and blue (B).

Also, FIG. 23B exemplifies the case of inputting the light source profile control signal 5800, which is generated by the video image analysis unit 5550, into the light source control unit 5560 by way of the sequencer 5540. The video image analysis unit 5550, however, is not necessarily required. In the absence of the video image analysis unit 5550, the sequencer 5540 may also generate the light source profile control signal 5800 and inputs it into the light source control unit 5560.

FIG. 23B also shows each of the spatial light modulators 5100 of the three colors implemented with their individual SLM controllers; such a configuration is arbitrary. An alternative configuration may be such that a single SLM controller is used to control the multiple spatial light modulators 5100. In this case, a single chip SLM controller is capable of controlling multiple spatial light modulators 5100, thereby making it possible to produce a more compact apparatus.

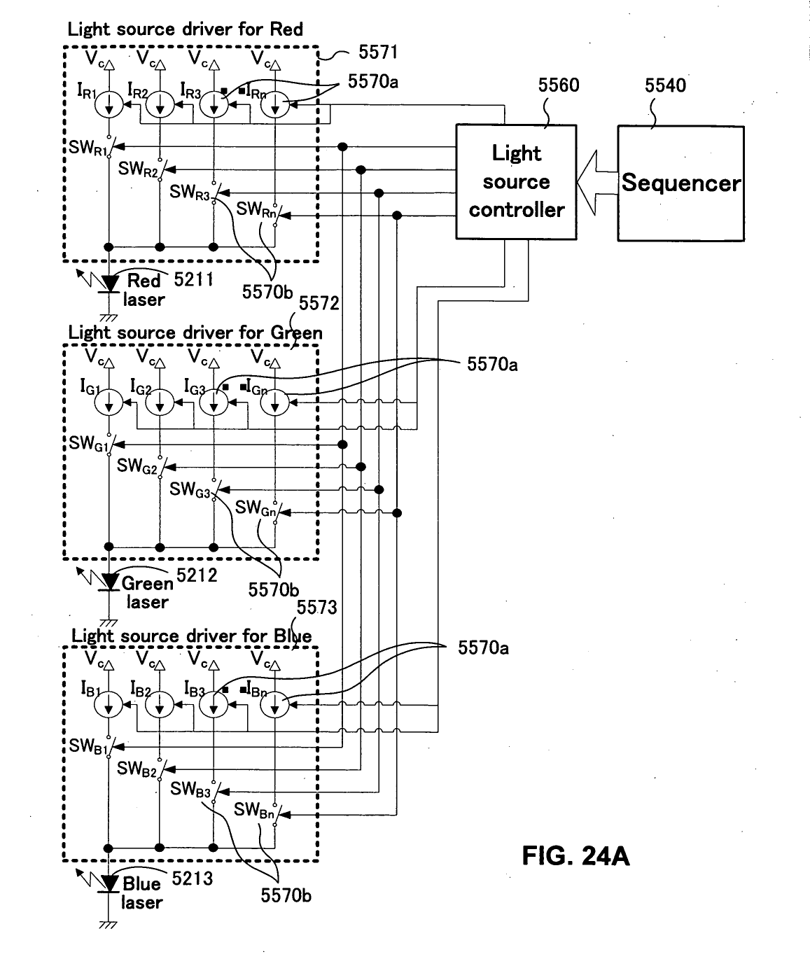

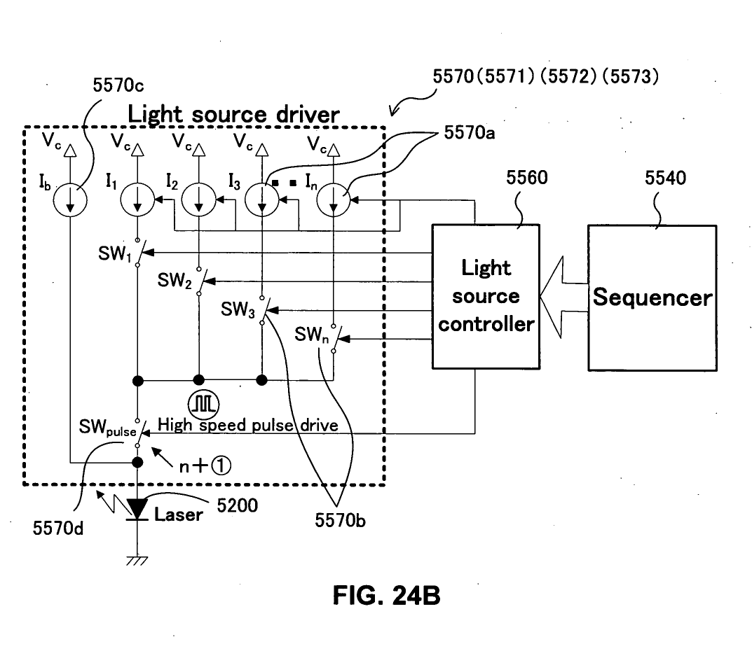

FIG. 24A is a functional block diagram for showing the configuration of the light source drive circuit 5570 (i.e., the light source drive circuits 5571, 5572 and 5573) according to the present embodiment. Note that the configuration here exemplifies the case of equipping the light source drive circuit for each of the colors: red (R), green (G) and blue (B).

The light source drive circuit showed in FIG. 24A includes a plurality of constant current circuits 5570a (i.e., I (R, G, B)₁ through I (R, G, B)ₙ) and a plurality of switching circuits 5570b (i.e., switching circuits SW (R, G, B)₁ through SW (R, G, B)ₙ), which correspond to the respective constant current circuits 5570a, in order to obtain the desired light intensities of emission P₁ through Pₙ for the light source optical system 5200 (i.e., the red laser light source 5211, green laser light source 5212 and blue laser light source 5213).

The switching circuit 5570b carries out a switching operation in accordance with a designated emission profile of the light source optical system 5200 (i.e., the red laser light source 5211, green laser light source 5212 and blue laser light source 5213).

The setup values of the output current of the constant current circuits 5570a (i.e., constant current circuits I (R, G, B)ₙ), when the gray scale of the emission intensity of the light source optical system 5200 is designated at N bits (where N≧n), are as follows:

I(R,G,B)₁=Iₜₕ+LSB

I(R,G,B)₂=LSB+1

I(R,G,B)₃=LSB+2

. . .

. . .

I(R,G,B)ₙ=MSB

Specifically, what is shown is an example of a gray scale display on the basis of an emission intensity; a similar gray scale display is achievable even if the emission period (i.e., an emission pulse width), and the emission interval (i.e., an emission cycle) are variable.

The relationship between the emission intensity of the variable light source and drive current for each color is as follows. Note that “k” is an emission efficiency corresponding to the drive current:

P₁=k*(Iₜₕ+I₁)

P₂=k*(Iₜₕ+I₁+I₂)

. . .

. . .

Pₙ=k*(Iₜₕ+I₁+I₂+ . . . +Iₙ₋₁+Iₙ)

FIG. 24B is a functional block diagram for showing an alternate embodiment of the configuration of the light source drive circuit according to the present embodiment.

For simplicity, FIG. 24B shows the constant current circuits 5570a (I (R, G, B)₁ through I (R, G, B)ₙ) as I₁ through Iₙ and the switching circuits 5570b (SW (R, G, B)₁ through SW (R, G, B)ₙ) as switching circuits 5570b (SW₁ through SWₙ).

As will described later, the light source drive circuits 5570 according to the present embodiment is configured to make the individual constant current circuit 5570a (i.e., I (R, G, B)₁ in this case) supply a current value equivalent to the threshold current Iₜₕ of the light source optical system 5200, or a current value close to the aforementioned threshold current, as a bias current I_{b} when a semiconductor laser or the like is used as the light source optical system 5200, because a high speed current drive is required. This makes it possible to stabilize the respective switching operation of the light source drive circuits 5570 of the present embodiment and also enable a high speed emission.

The light source drive circuits 5570 (i.e., the light source drive circuits 5571, 5572, and 5573) exemplified in FIG. 24B includes bias current circuits 5570c, which are continuously connected to the light source optical systems 5200 (i.e., the red laser light source 5211, green laser light source 5212 and blue laser light source 5213), are used for applying a bias current I_{b}, in addition to the constant current from the constant current circuits 5570a.

Further, the connection of the constant current circuits 5570a to the entirety of the light source optical systems 5200 is configured by means of a switching circuit 5570d (SWₚᵤₗₛₑ) included in the downstream side of the switching circuits 5570b.

FIG. 24B shows the configuration wherein the relationship between the emission intensity Pₙ and drive current of the variable light source for each wavelength is as follows, where “k” is the emission intensity in terms of drive current:

P_{b}=k*I_{b}(I_{b}≈Iₜₕ)

P₁=k*(Iₜₕ+I₁)

P₂=k*(Iₜₕ+I₁+I₂)

. . .

. . .

Pₙ=k*(Iₜₕ+I₁+I₂+ . . . +Iₙ₋₁+Iₙ)

The relationship between each switching operation and emission output is as follows:

SWₚᵤₗₛₑ=OFF:P_{b}=k*I_{b}≈0[mW] (where I_{b}≈Iₜₕ)

SW₁:P₁=k*(I_{b}+I₁)

SW₂:P₂=k*(I_{b}+I₁+I₂)

. . .

. . .

SWₙ:Pₙ=k*(I_{b}+I₁+I₂+ . . . Iₙ₋₁+Iₙ)

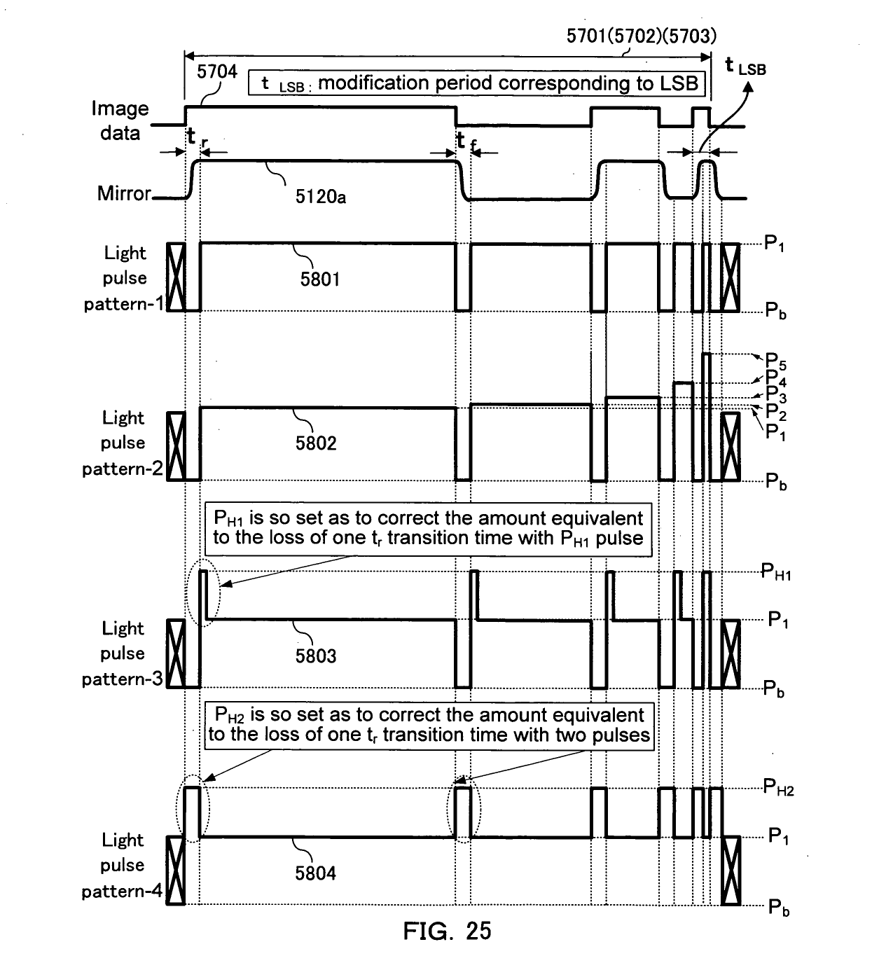

With this, it is possible to achieve an emission profile that has an emission intensity P_{b} nearly zero, as shown in FIG. 25.

The use of the switching circuits 5570d as that shown in FIG. 24B makes it possible to implement a circuit operation unaffected by a drive current switching over caused by the switching circuits 5570b (SW₁ through SWₙ) that are connected to the respective constant current circuits 5570a. Particularly, a further effect is expected if the above-described switching circuits (SW₁ through SWₙ) are switched over when the variable light source (i.e., the variable light source 5210) is not emitting light.

While the bias current value is designated at a fixed current value in the configuration of FIG. 24B, it is also possible to connect the bias current circuits 5570c to the light source control unit 5560 to generate a variable bias current.

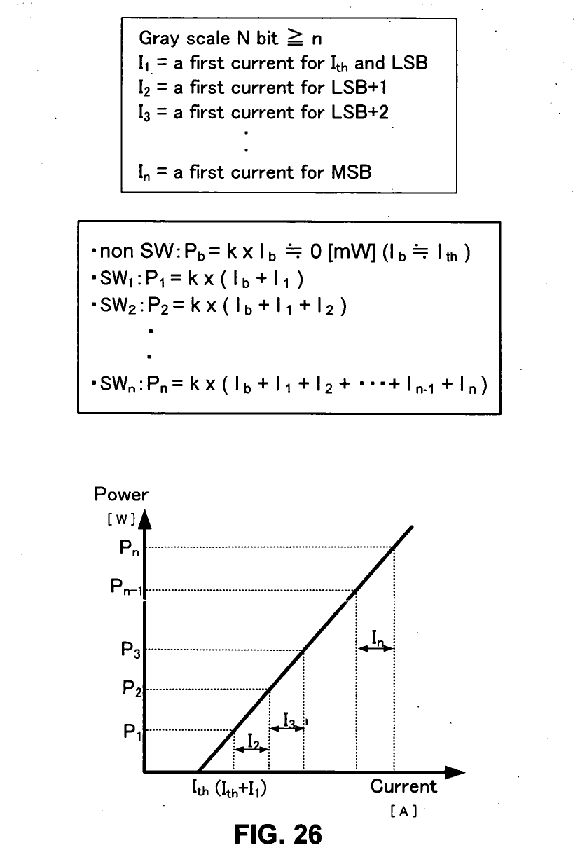

FIG. 26 is a diagram for showing the relationship between the applied current I and the emission intensity Pₙ in the light source drive circuit described for FIG. 24A. Note that the relationship between the applied current from the constant current circuits 5570a of the light source drive circuit (shown in FIG. 24B) and the emission light intensity Pₙ is similar. In the case of the light source drive circuit, however, the threshold current Iₜₕ shown in FIG. 26 is replaced with a bias current I_{b}. An emission light intensity corresponding to the current I_{b} is an emission light intensity P_{b} that is nearly zero (“0”).

FIGS. 24A and 24B exemplify the case of changing the emission profiles of the variable light source for each sub-frame corresponding to each gray scale bi.; A parallel use with the display gray scale function of the spatial light modulators 5100 reduces the number of required current levels, making it possible to not only reduce the number of constant current circuits 5570a and switching circuits 5570b but also to attain the same grade of gray scale of the display gray scales, or higher.

Next is a description, in detail, of one exemplary configuration of the spatial light modulator 5100 according to the present embodiment. The spatial light modulator 5100 according to the present embodiment is a deflective mirror device arraying a plurality of mirror elements.

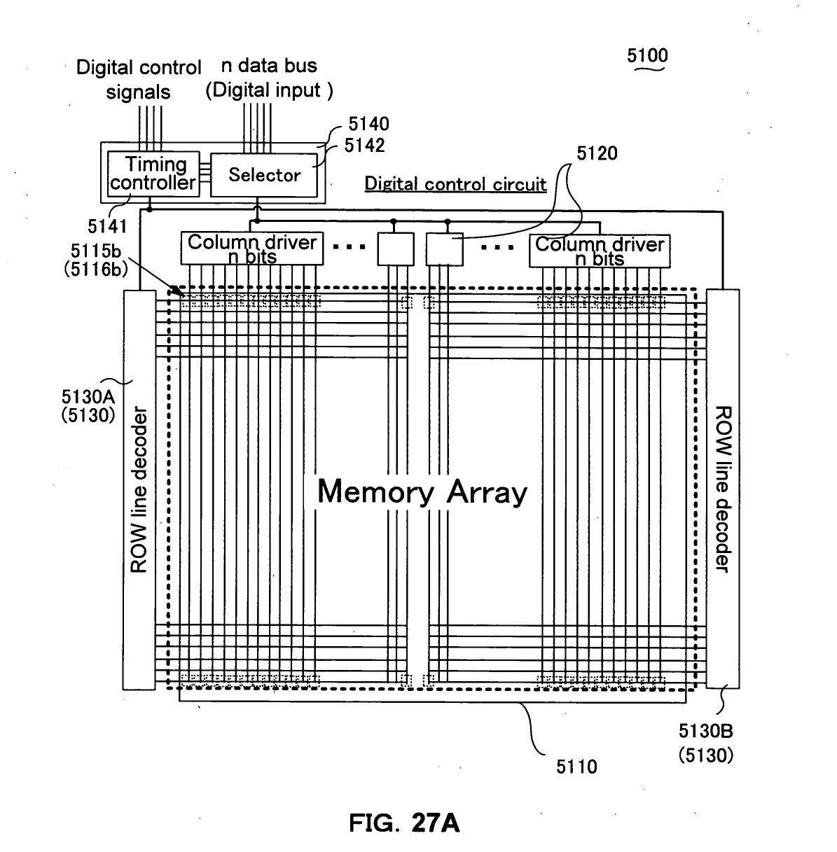

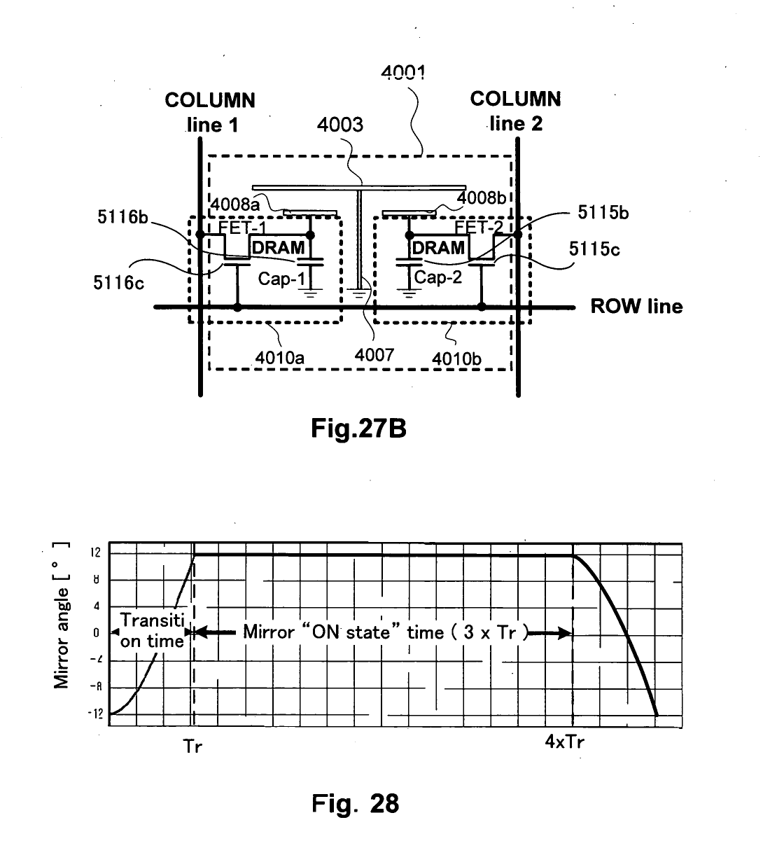

FIG. 27A is a functional block diagram exemplifying the internal configuration of a spatial light modulator 5100 according to the present the embodiment.

FIG. 27B is a functional block diagram exemplifying the configuration of each pixel unit constituting the spatial light modulator 5100 according to the embodiment.

As exemplified in FIG. 27A, the spatial light modulator 5100 according to the present embodiment includes a mirror element array 5110, column drivers 5120, ROW line decoders 5130, and an external interface unit 5140.

The external interface unit 5140 includes a timing controller 5141 and a selector 5142. The timing controller 5141 controls the ROW line decoder 5130 on the basis of a timing signal from the SLM controller 5530. The selector 5142 supplies the column driver 5120 with digital signal incoming from the SLM controller 5530.

In the mirror element array 5110, a plurality of mirror elements 4001 is arranged in arrays at the positions where individual COLUMN lines, which are vertically extended respectively from the column drivers 5120, crosses individual ROW lines which are horizontally extended respectively from the ROW decoders 5130.

Note that the present exemplary configuration shows the ROW line decoder 5130 includes two ROW line decoders 5130a and 5130b that are provided on either side, with the mirror element array 5110 sandwiched between. One half of the mirror elements 4001, arrayed in the mirror element array 5110, are controlled by the ROW line decoder 5130a, and the other half are controlled by the ROW line decoder 5130b, and thereby the loading time of the electric charge to the capacitor, by way of the gate transistor is reduced, and the operation of tilting the mirrors can be accomplished at a higher speed.

Alternatively, the ROW line decoder 5130 may be formed on only one side of the mirror element array 5110 to control all the mirror elements 4001.

As exemplified in FIGS. 8A through 8D, the individual mirror element 4001 includes a mirror 4003 supported on the device substrate 4004 via the elastic hinge 4007. Furthermore, a cover glass (not shown) covers and protects the mirror 4003.

Address electrodes 4008a and 4008b are placed on the device substrate 4004 symmetrically about the elastic hinge 4007, sandwiched in the middle.

When a predetermined potential is applied to the address electrode 4008a, it attracts the mirror 4003 with a coulomb force and tilts the mirror 4003 so that the mirror 4003 abuts the address electrode 4008a. This causes the incident light 5601 incident to the mirror 4003 to be reflected towards the light path of an OFF position, that is, shifted from the optical axis of a projection optical system 5400.

When a predetermined potential is applied to the address electrode 4008b, it attracts the mirror 4003 with a Coulomb force and tilt the mirror 4003 so that the mirror 4003 abuts the address electrode 4008b. This causes the incident light 5601 incident to the mirror 4003 to be reflected towards the light path of an ON position, matching the optical axis of the projection optical system 5400.

Further, while not shown in a drawing an OFF stopper and an ON stopper may be equipped in the device. In that case, the mirror 4003 reflects the incident light 5601 when abutting the OFF stopper (in place of the address electrode 4008a) or abutting the ON stopper (in place of the address electrode 4008b.)

FIG. 28 is a chart showing the transition time between the ON state and OFF state of the mirror 4003. In a transition from the OFF state, in which the mirror 4003 abuts the address electrode 4008a, to the ON state in which the mirror 4003 is abuts the address electrode 4008b, a rise time tᵣ, in the early stage of starting the transition, is required before the mirror 4003 fully reaches the ON state; in a transition from the ON state to the OFF state, a fall time t_{f} is likewise required before the mirror fully reaches the OFF state.

Since the reflection light 5602 is in the transition state during both the rise time tᵣ and the fall time t_{f}, the control using the ON/OFF states generates an error in the grayscale display. Therefore, the present embodiment is configured to suppress the emission of the variable light source 5210 in the transition state, thereby eliminating the use of the reflection light 5602 in the transition state.

When using a nondirective light source, such as a conventional high pressure mercury lamp or xenon lamp, the expansions of incident light 5601 and reflection light 5602 are large, and therefore the tilt angle of the mirror 4003 needs to be set at about ±12 degrees (24 degrees total) in order to increase the contrast by avoiding the interference between the aforementioned two lights 5601 and 5602. Consequently, both the rise time tᵣ₂₄ and fall time t_{f24} are extended in the ON/OFF control of the mirror 4003, and the voltage (V₂₄) applied to the ON electrode 5115 and OFF electrode 5116, to tilt the mirror 4003 by means of static electric attraction, is also increased.

In contrast, the projection apparatus according to the present embodiment employs the variable light sources 5210, the red laser light source 5211, green laser light source 5212 and blue laser light source 5213. The coherent lights as implemented allow the projection system to properly function with smaller tilt angle θ. The mirror 4003 is now controlled to operate in a range of about ±8 degrees (=16 degrees total). As a result, the rise time tᵣ₁₆ and fall time t_{f16} can also be reduced from the conventional rise time tᵣ₂₄ and fall time t_{f24}.

Also, the voltage (V₁₆) to be applied to the ON electrode 5115 and OFF electrode 5116 can also be reduced from the conventional voltage (V₂₄) because the distance between the mirror 4003 and either of the aforementioned electrodes is shortened, as described later.

FIG. 27B shows a mirror device 4003 includes a mirror element 4001 supported on an elastic hinge 4007 for retaining the mirror 4003; address electrodes 4008a and 4008b; and two memory cells, i.e., a first memory cell 4010a and a second memory cell 4010b, which apply a voltage to the address electrodes 4008a and 4008b in order to control the mirror 4003 under a desired deflection state.

The first and second memory cells 4010a and 4010b each have a dynamic random access memory (DRAM) structure comprising field effect transistors (FETs) and a capacitance in this configuration. The structures of the individual memory cells 4010a and 4010b are not limited as such and may instead be configured as, for example, a static random access memory (SRAM) structure.

Furthermore, the individual memory cells 4010a and 4010b are connected to the respective address electrodes 4008a and 4008b, the COLUMN line 1, the COLUMN line 2, and a ROW line.

In the first memory cell 4010a, an FET-1 (i.e., a gate transistor 5116c) is connected to the address electrode 4008a, the COLUMN line 1, and the ROW line. A capacitance Cap-1 (i.e., an OFF capacitor 5116b) is connected between the address electrode 4008a and GND (i.e., the ground). Likewise in the second memory cell 4010b, an FET-2 (i.e., a gate transistor 5115c) is connected to the address electrode 4008b, the COLUMN line 2, and the ROW line. A capacitance Cap-2 (i.e., an ON capacitor 5115b) is connected between the address electrode 4008b and GND.

Application of a predetermined voltage to the address electrodes 4008 thus controlling the signals on the COLUMN line 1 and ROW line for deflecting the mirror 4003 towards the address electrode 4008a. Likewise, controlling the signals on the COLUMN line 2 and ROW line applies a predetermined voltage to the address electrode 4008b, thereby making it possible to tilt the mirror 4003 towards the address electrode 4008b.

More specifically, the turning on and off of both the gate transistor 5116c and gate transistor 5115c is controlled by the ROW line. That is, the mirror elements 4001 on one horizontal line aligned with an arbitrary ROW line are simultaneously selected and the charging/discharging the electrical charge to/from the OFF capacitor 5116b and ON capacitor 5115b are controlled by the COLUMN lines 1 and 2. As a result the ON/OFF states of the mirror 4003 of the individual mirror elements aligned on one horizontal line are carried out.

Note that a drive circuit for each of the memory cells 4010a and 4010b is commonly formed internally in the device substrate 4004. Controlling the respective memory cells 4010a and 4010b, in accordance with the signal of image data, enables the control of the deflection angle of the mirror 4003 and the demodulation and reflection of the incident light.

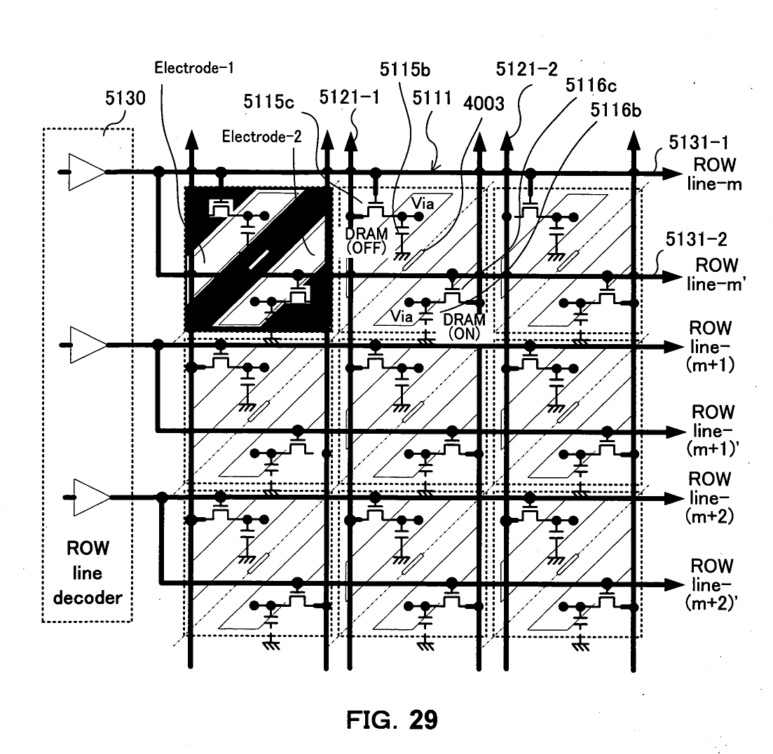

FIG. 29 is a functional block diagram exemplifying a placement of ROW lines to control mirrors of a spatial light modulator according to an exemplary modification of the present embodiment.

In the case of the exemplary modification, ROW lines 5131-1 and 5131-2 can be implemented to simultaneously drive the gate transistors 5115c and 5116c, respectively, as exemplified in FIG. 29.

The ROW lines 5131-1 and 5131-2 are driven from the row line decoders 5130 using a common drive circuit (not shown in the drawing).

As described above, the ROW lines 5131-1 and 5131-2, driving the gate transistor 5115c and gate transistor 5116c, make it possible to reduce the loading time of charge to the ON capacitor 5115b and OFF capacitor 5116b, by way of the gate transistor 5115c and 5116c, respectively, and accomplish a high speed operation of tilting the mirror 4003, such as an ON/OFF and oscillation.

The following is a description of an example operation of a projection apparatus according to the present embodiment.

Input digital video data 5700 inputted into a video signal input unit 5510 is outputted to frame memory 5520 and also to a video image analysis unit 5550.

An SLM controller 5530 reads the input digital video data 5700 from the frame memory 5520, converts the read data into, for example, binary data 5704 that is pulse width-modulated, or into non-binary data 5705, and inputs the converted data to a column driver 5120 by way of an external interface unit 5140, as a control signal to the spatial light modulator 5100 for the ON/OFF control or oscillation control of the mirror 4003.

The pulse width-modulated binary data 5704 is data possessing a pulse width in accordance with the weighting value of each bit.

The non binary data 5705 is the data obtained by converting the input digital video data 5700 into a bit string that includes continuous bits of “1” corresponding to a brightness value, with each bit of the non-binary data 5705 having the same weighting (e.g., “1”).

Further, a sequencer 5540 outputs a synchronous signal, such as VSYNC, which is outputted from the SLM controller 5530 in sync with the input digital video data 5700, to the ROW line decoder 5130 of the spatial light modulator 5100.

With this, the displaying/updating of one screen (i.e., one frame) is carried out by the ROW line decoder 5130 controlling, in sync with each scan line of the input digital video data 5700, the ON/OFF or oscillation states of the mirrors 4003 and the mirror elements 4001 belonging to one ROW line.

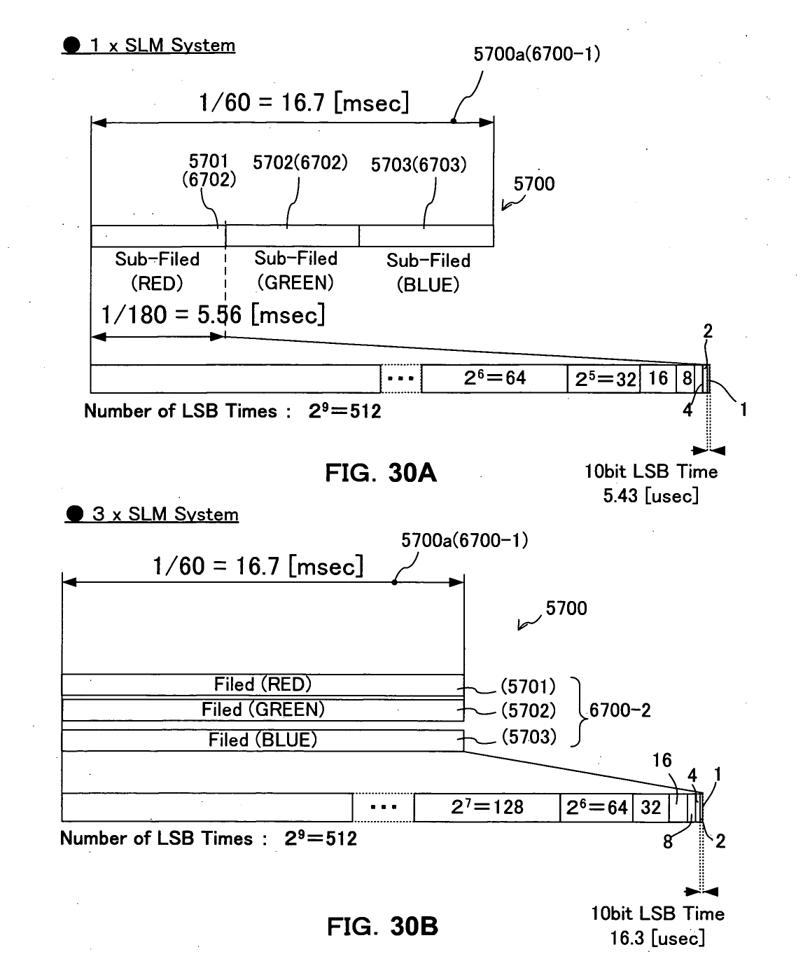

Note that, when carrying out a color display in a color sequence method using a single-panel projection apparatus (comprising one SLM) 5010 exemplified in FIG. 21, one frame (i.e., a frame 5700-1) of the input digital video data 5700 is constituted by multiple subfields, i.e., the subfields 5701, 5702 and 5703, which are aligned in a time series corresponding to the respective colors R, G and B, as exemplified in FIG. 30A. The above described binary data 5704 or non-binary data 5705, or a mixed data (not shown in the drawing) obtained by combining these pieces of data, is generated for each of the aforementioned subfields.

When using a multi-panel projection apparatuses (comprising three SLMs) 5020, 5030 and 5040, a plurality of subfields 5700-2 (which are equivalent to subfields 5701, 5702 and 5703) corresponding to the respective colors R, G and B are simultaneously outputted to the plurality of spatial light modulators 5100, respectively, as exemplified in FIG. 30B, and the spatial light modulations for the respective colors are simultaneously performed.

Also in this case, the above described binary data 5704 or non-binary data 5705 is generated for each field 5700-2.

The present embodiment is configured such that the video image analysis unit 5550 of the control unit 5500 detects the timing of the change in signal waveform of the binary data 5704 or non-binary data 5705 from the input digital video data 5700, generates a light source profile control signal 5800 to control the red laser light source 5211, green laser light source 5212 and blue laser light source 5213, of the variable light source 5210, and inputs the generated signal to the light source control unit 5560 by way of the sequencer 5540.

This configuration implements the control for the variable light source 5210 in sync with the timing of the change in signal waveforms of the binary data 5704 or non-binary data 5705 of the input digital video data 5700, as described later.

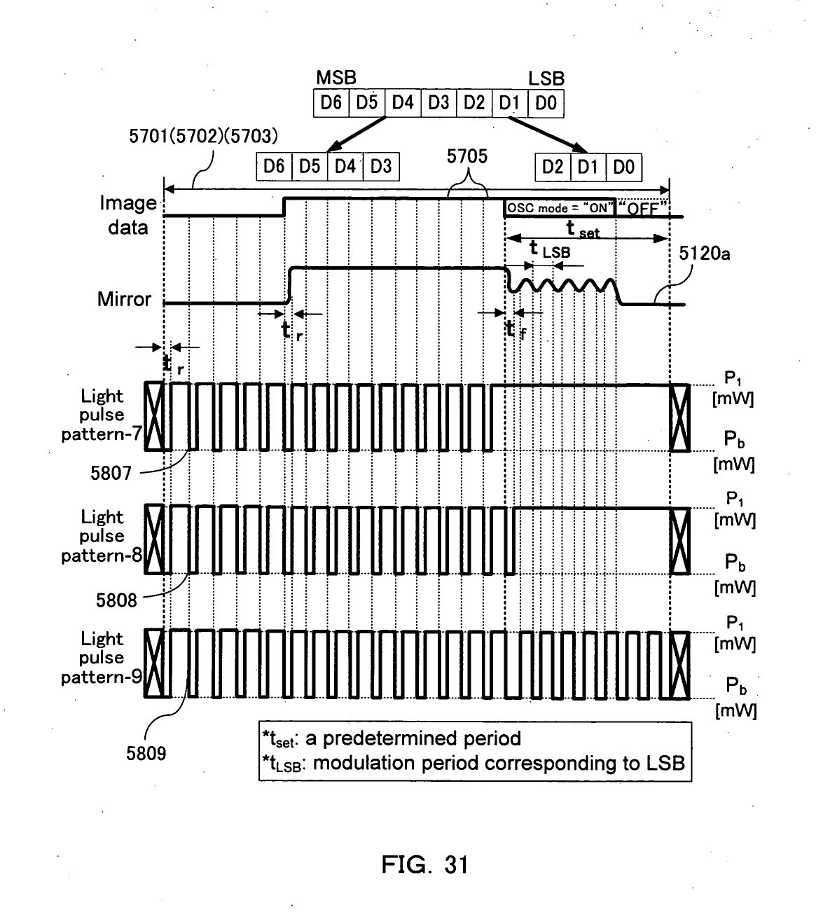

That is, as exemplified in FIGS. 25 and 31, the projection apparatus according to the present embodiment is configured such that the SLM controller 5530 controls the spatial light modulator 5100 so that at least two mirror elements (i.e., mirror elements 4001) perform a modulation corresponding to the least significant bit (LSB) within a predetermined period of one frame. Further, the light source control unit 5560 (i.e., the video image analysis unit 5550) changes the emission profiles of the variable light source in a period equal to or less than the predetermined period and obtains the minimum grayscale output.

The emission profile shows the emission state change of the variable light source 5210, such as the emission intensity, emission period, emission pulse width, emission interval, and the number of emission pulses.

This configuration makes it possible to control each mirror element 4001. The modulation control signals are corresponding to the LSB of all mirror elements 4001 in each group occur within a predetermined period of time when the mirror element array 5110 of a spatial light modulator 5100, or a plurality of mirror elements 4001 of the mirror element array 5110, are controlled by dividing into a plurality of groups, and to control the emission profile of the variable light source 5210 in high speed within a period in which the modulation states of desired mirror elements match.

As a result, the projection apparatus of the present embodiment is enabled to achieve a higher resolution of gray scales that is even higher than that of the spatial light modulator 5100 controlled by using a greater number of bits.

Note that light source control unit 5560 includes a larger number of types of emission profiles than the number of display grayscale bits of the spatial light modulator 5100.

In the case of the present embodiment, when carrying out a gray scale display of binary image data by using sub-frames having periods corresponding to the weighting of individual data bits for each frame by means of a pulse width modulation (PWM), the influence of the transition period of the modulation states is different for each frame. Further, each sub-frame period is different in accordance with the corresponding display grayscale bit as described above, and therefore, the emission profile for each sub-frame is different. Further, when performing a grayscale display in excess of the display grayscale of the spatial light modulator 5100, the number of sub-frames will further increase.

FIG. 25 exemplifies the control of the variable light source 5210 for controlling the spatial light modulator 5100 by means of binary data 5704.

In this case, the ON/OFF state of the mirror 4003 changes as indicated by a mirror modulation control waveform 5120a by tracing the waveform of the binary data 5704, the change in the rise, and the change in the fall, of the mirror modulation control waveform 5120a, however, are delayed by the respective amount of the rise time tᵣ and fall time t_{f} relative to the binary data 5704.

The present embodiment is configured to control the variable light source 5210 so as to be turned on only for the period in which the ON section of the binary data 5704 overlaps with the ON period of the mirror modulation control waveform 5120a with the rise time tᵣ and fall time t_{f} removed, in at least an LSB-corresponding modulation period t_{LSB}, as indicated by the light source pulse patterns 5801, 5802 and 5803.

With this control, the variable light source 5210 is turned off during the transition periods of the rise time tᵣ, in which the mirror 4003 shifts from the OFF to ON states, and of the fall time t_{f}, in which the mirror 4003 shifts from the ON to OFF states. This configuration better enables an implementation of high gradation, as compared to the performance of the spatial light modulator 5100, by reducing, for example, an error factor in the LSB-corresponding modulation period t_{LSB}.

That is, in the case of the present embodiment, the light source control unit 5560 controls the variable light source 5210 so that the period in which the modulation states of the spatial light modulator 5100 shift, influencing the display image, is reduced.

The spatial light modulator 5100 attains a desired display gray scale by changing the voltages applied to the individual mirror elements 4001 and the deflection state of the mirror 4003. The transition action of the spatial light modulator 5100 between the respective modulation states has been a limiting factor in the resolution and linearity of the display gray scale and the minimum display gray scale.

With an aim towards preventing the degradation of the resolution and linearity, the present embodiment is configured to use a variable light source 5210 capable of being controlled in a higher speed than the modulation state transition period of the spatial light modulator 5100 and to change the emission profiles of the variable light source 5210 in high speed within the transition period, thereby improving the display gray scale accuracy in a projection apparatus.

The light source pulse pattern 5801 exemplifies the case of controlling the variable light source 5210 so as switch between the switch-off state with the emission intensity P_{b} and the switch-on state with the constant emission intensity P₁.

The light source pulse pattern 5802 exemplifies the case of controlling the emission intensity of the variable light source 5210 during the switch-on period so that the emission intensity gradually increases stepwise from an emission intensity P₁ (corresponding to the MSB) to an emission intensity P₂, to an emission intensity P₃, to an emission intensity P₄, to an emission intensity P₅ (corresponding to the LSB), in accordance with the pulse widths of the binary data 5704, for which the switch-on period gradually decreases from the MSB toward the LSB, depending on the weightings of respective bits.

Further, the light source pulse pattern 5803 exemplifies the case of performing a control so as to compensate for a light volume loss during the period the emission is suppressed in the section of one rise time tᵣ by locally adding the pulse of an emission intensity Pₕ₁, which is larger than the emission intensity P₁, immediately after the rise time tᵣ of the mirror modulation control waveform 5120a.

The light source pulse pattern 5804 exemplifies the case of compensating for a light volume loss during the period of one rise time tᵣ by adding two pulses of emission intensity Pₕ₂.

These controls can be implemented by selectively turning ON the above described switching circuit 5570b.

Such control of the light source pulse pattern 5802 makes it possible to compensate for a shortage of emission intensity due to a switch-off in the period of a rise time tᵣ and fall time t_{f} on the LSB side, in which the pulse width is small and the influences of the aforementioned rise time tᵣ and fall time t_{f} increases.

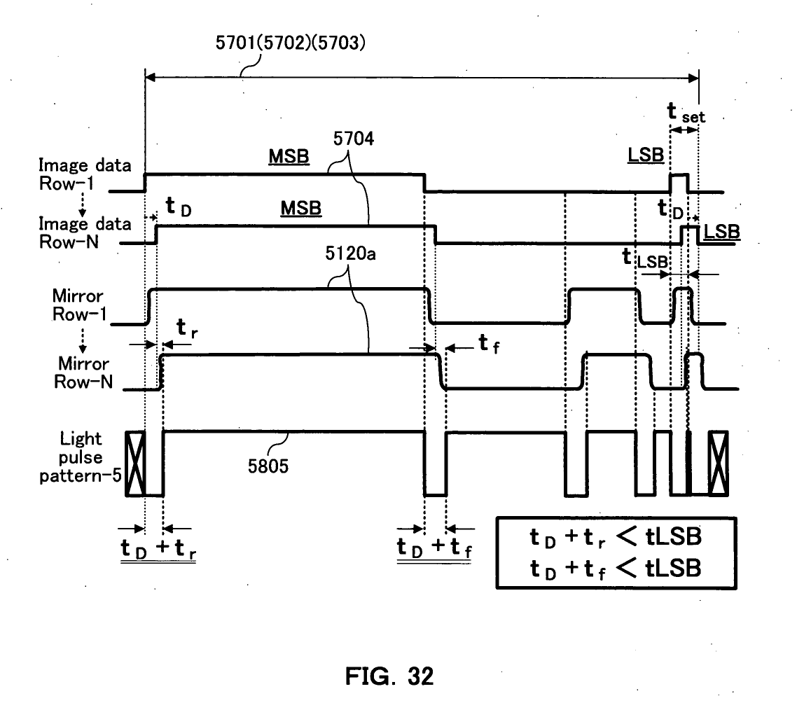

Considering the N string of rows of the mirror element array 5110 corresponding to the N lines of horizontal scan lines, as exemplified in FIG. 32, there is the difference between the first row (Row-1) and the last row (Row-N) in the delay time t_{D} of the control start timings of the mirror modulation control waveform 5120a.

For such a case, a configuration is accordingly devised in which the switch-on timing is shifted by the [rise time tᵣ+delay time t_{D}] for the rise side of the pulse and by the [fall time t_{f}+delay time t_{D}] for the fall side of the pulse, and thereby the ON period of the mirror modulation control waveform 5120a overlaps with the ON period of the light source pulse pattern 5805, at least during the period of the LSB-corresponding modulation period t_{LSB}.

In this case, In order to secure an overlap in the LSB-corresponding modulation period t_{LSB}, the following conditions must be satisfied:

[delay time t_{D}+rise time tᵣ]<LSB-corresponding modulation period t_{LSB}, and

[delay time t_{D}+fall time t_{f}]<LSB-corresponding modulation period t_{LSB}

Therefore, the present embodiment is configured such that the SLM controller 5530 groups the mirror elements 4001 of the spatial light modulator 5100 so that the emission period of the changed emission profile is less than the modulation period corresponding to the least significant bit and controls the mirror elements 4001 in units of the group.

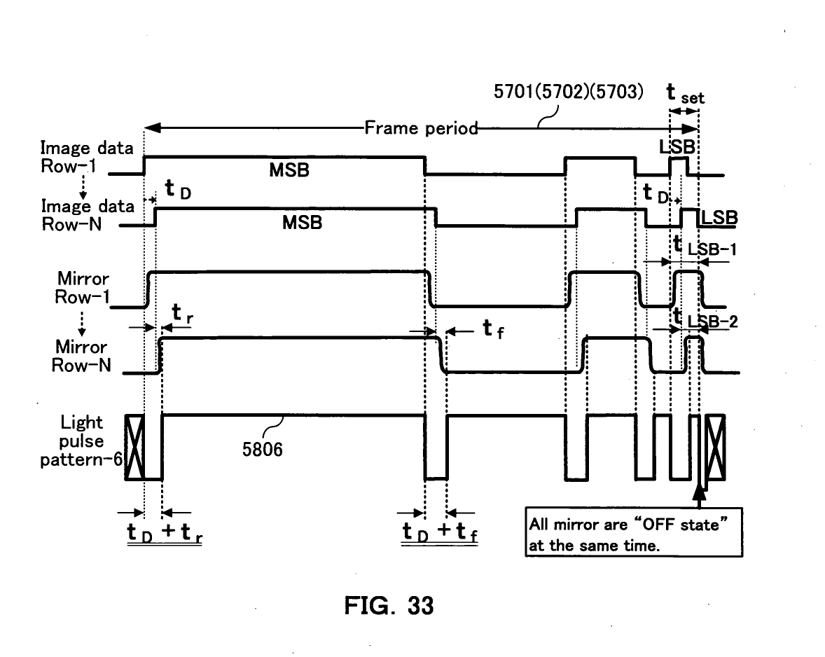

Further, the SLM controller 5530 changes the modulation periods corresponding to the least significant bit (LSB) of the individual mirror elements (i.e., LSB-corresponding modulation period t_{LSB-1} and LSB-corresponding modulation period t_{LSB-2}) on an as needed basis so that the modulation periods corresponding to the least significant bit (LSB) (i.e., LSB-corresponding modulation period t_{LSB}) of the individual mirror elements 4001 overlap at least in a part, as exemplified in FIG. 33.

Next is a description of the case of controlling a spatial light modulator (SLM) using non-binary data, with reference to FIGS. 31, 34 and 35.

In this example, the SLM controller 5530 controls the spatial light modulator 5100 using non-binary image data (i.e., non-binary data 5705).

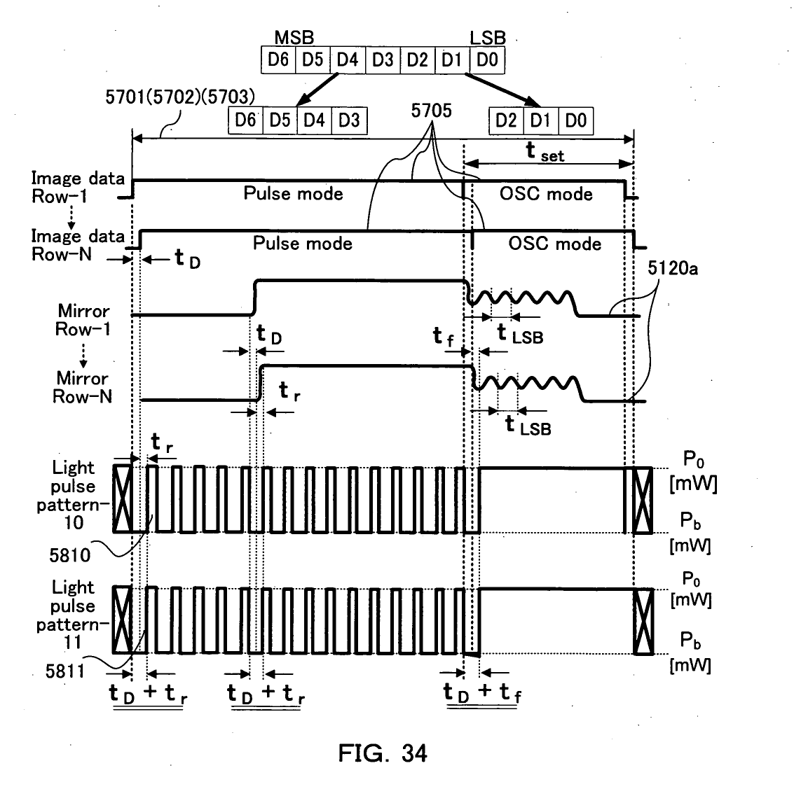

As shown in FIGS. 31 and 34, when a modulation control for the spatial light modulator 5100 is carried out by using the non-binary data 5705, which has been obtained by converting image data from a binary form into a non-binary form, it is predicted that a plurality of sub-frames, in which the display gray scale to be displayed is the same, will be generated because each bit of the non-binary data 5705 has the same weight. When such a spatial light modulator is controlled, the emission profiles of a variable light source 5210 corresponding to sub-frames, of which the display grayscales to be displayed are the same, are the same profile, and therefore the emission profile does not need to be changed for each sub-frame.

The examples in FIGS. 31 and 34 illustrate the case of assigning the upper four bits (D6 through D3) from the MSB to the ON/OFF control of the mirror 4003 and the lower three bits (D2 through D0) from the LSB to the oscillation control, thereby implementing a gray scale control.

Focusing on one mirror 4003 (i.e., the mirror element 4001), FIG. 31 exemplifies the case of turning on and off (i.e., flashing) the variable light source 5210 by means of the ON/OFF control at a predetermined cycle during the ON period of the mirror 4003 (i.e., the mirror modulation control waveform 5120a) in the light source pulse pattern 5807. The start timing of an ON/OFF cycle, however, is controlled to be synchronous with the ON period of a mirror modulation control waveform 5120a by avoiding the rise time tᵣ of the present mirror modulation control waveform 5120a.

Further, the light source pulse pattern 5807 exemplifies the case of controlling the variable light source 5210 to be continuously turned on during the period in which the ON period of the mirror modulation control waveform 5120a shifts to the oscillation (OSC) control mode and during the period of the oscillation control mode.

As described above, controlling the cycle of flashing of the variable light source 5210 during the ON period of the mirror 4003 makes it possible to attain a minute display gray scale equivalent to, or more than, the ON/OFF control of the mirror 4003.

The light source pulse pattern 5808 exemplifies the case of continuously turning on the variable light source 5210 after turning it off once function synchronously with the fall time t_{f} when the mirror modulation control waveform 5120a shifts from the ON state to oscillation state. In this case, the column driver 5120 is turned off during a transition from the ON state of the mirror modulation control waveform 5120a to the oscillation state, and thereby noise can be reduced in the aforementioned transition period.

The light source pulse pattern 5809 exemplifies the case of flashing the variable light source 5210 in a predetermined cycle independent of the ON/OFF state or oscillation state of the mirror modulation control waveform 5120a. However, the variable light source 5210 is controlled, by the flashing cycle and start timing, to be turned off during the rise time tᵣ and fall time t_{f} of the mirror modulation control waveform 5120a. This configuration makes it possible to reduce the noise attributed to light emission during the rise time tᵣ and fall time t_{f}.

FIG. 34 exemplifies the case of controlling the timing of flashing and turning on the variable light source 5210, by taking a delay time t_{D} into consideration when the aforementioned delay time t_{D} occurs in the control timing of a mirror element 4001 belonging to a different row of the mirror element array 5110, in the case of controlling the spatial light modulator 5100 using non-binary data 5705.

The light source pulse pattern 5810 exemplifies the case of controlling the variable light source 5210 in a predetermined cycle by delaying [delay time t_{D}+rise time tᵣ] and [delay time t_{D}+fall time t_{f}] relative to the ON period of the mirror modulation control waveform 5120a. Further, the light source pulse pattern 5810 makes the end of a switch-off and the end of the oscillation mode of the first row (Row-1) match one other.

In contrast, the light source pulse pattern 5811 differs from the above described light source pulse pattern 5810 in that the former makes the end of a switch-off and the end of the oscillation mode of the last row (Row-N) match each other, otherwise the two patterns are similar to each other.

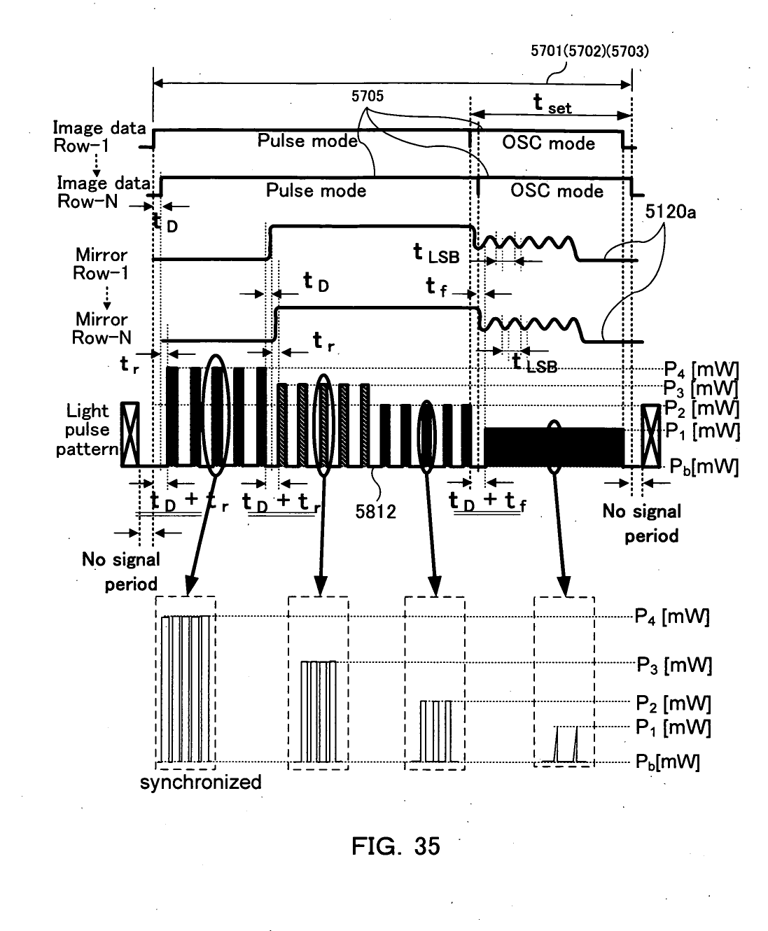

FIG. 35 exemplifies a modified embodiment of the control of the spatial light modulator 5100 using non-binary data.

In the light source pulse pattern 5812, the heights of the flashing pulse (that is, the emission intensity) of the variable light source 5210 are changed so as to gradually decrease stepwise in each of the OFF states, ON states, and oscillation states of the mirror modulation control waveform 5120a.

The variable light source 5210 is controlled by pulses to flash (noted as “flashing pulse” hereinafter) so as to emit light in the emission intensity P₄ during, for example, the OFF period of the mirror modulation control waveform 5120a, and is controlled to flash so as to emit light in the emission intensity P₃ during the first half of the ON period of the mirror modulation control waveform 5120a and also in the emission intensity P₂ in the second half of the ON period thereof. Further, the variable light source 5210 is controlled under a flashing pulse so as to emit light in the emission intensity P₁ during the oscillation period of the mirror modulation control waveform 5120a.

Further, the switch-on pulse for the emission light intensities P₄, P₃, P₂ and P₁ are constituted by the flashing pulse in finer minute cycles.

Controlling the variable light source 5210 by means of the light source pulse pattern 5812 makes it possible to attain a display gray scale with finer gradations than the single gray scale display of the spatial light modulator 5100.

Specifically, the pulse emission characteristic of the variable light source 5210 for implementing the above-described control according to the present embodiment is examined.

In the multi-panel projection apparatus which includes the spatial light modulators 5100 for each of the colors and which uses the variable light source 5210 comprising the red laser light source 5211, green laser light source 5212 and blue laser light source 5213, as shown in FIG. 22A, the display period of a sub-frame corresponding to the least significant bit (LSB) for attaining a 10-bit individual color display grayscale is 16.3 [μsec] (refer to FIG. 30B).

In order to limit the influence of the transition period between the individual deflection states of a mirror to no more than the equivalent of ⅕*LSB in a common mirror device, it is necessary to achieve “LSB display period”=4*tᵣ (where tᵣ is a rise time) as shown in FIG. 28, requiring the transition time of the mirror 4003 be limited to no more than 4.1 [μsec].

Even when using a mirror device capable of achieving such a characteristic, the pulse emission needs to possess a pulse emission characteristic of 9.2 [μsec] in order to have at least 75% steady state for the variable light source 5210 to attain the aforementioned pulse emission, such as the light source pulse pattern 5801 (i.e., Light pulse pattern-1) exemplified in FIG. 25 of the present embodiment.

Therefore, the present embodiment includes the variable light source 5210 and light source control unit 5560, which possess at least a pulse emission characteristic of 9.2 [μsec].

The following describes a similar examination of the single-panel projection apparatus according to the present embodiment, as exemplified in FIG. 21.

In the projection apparatus 5010 using the R, G and B variable light sources and a single spatial light modulator 5100, as shown in FIG. 21, the display period of a sub-frame corresponding to the least significant bit (LSB) for attaining a 10-bit individual color display grayscale is 5.43 [μsec] (refer to FIG. 30A).

In order to limit the influence of the transition period between the individual deflection states of the mirror 4003 to no more than the equivalent of 1/5*LSB in a common mirror device, it is necessary to achieve “LSB display period”=4*tᵣ (where tᵣ is a rise time) as shown in FIG. 28, requiring the transition time of the mirror 4003 be limited to no more than 1.36 [μsec].

Even when using a mirror device capable of achieving such a characteristic, the pulse emission needs to possess a pulse emission characteristic of at least 3.1 [μsec] in order for the variable light source 5210 to attain the pulse emission such as the light source pulse pattern 5801 (i.e., Light pulse pattern-1) exemplified in FIG. 25 of the present embodiment.

Therefore, in the projection apparatus 5010, the present embodiment includes the variable light source 5210 and light source control unit 5560, which possess at least a pulse emission characteristic of 3.1 [μsec].

What follows is a description an example of and reason for setting the displacement angle of the mirror 4003, which constitutes the spatial light modulator 5100, in each deflection period and deflection state at no more than ±8 degrees, as in the case of the present embodiment.

As described above, the present embodiment allows a use of color laser light sources, for example, a semiconductor laser for the red laser light source 5211, green laser light source 5212 and blue laser light source 5213, as the variable light source 5210.

When a mirror device as described above is used as the spatial light modulator 5100 for a projection apparatus, such as the above described projection apparatuses 5010, 5020, 5030 and 5040, and if a semiconductor laser is selected for the variable light source 5210, as described above, the semiconductor laser enables a reduction of the deflection angle of the mirror 4003 required for obtaining the desired contrast, as compared with a case using a conventional light source, such as a high pressure mercury lamp.

As a result, in the structure of the spatial light modulator 5100 constituted by a mirror device, the distance between the mirror 4003 and address electrodes, such as the address electrodes 4008b and 4008a, can be reduced, and therefore a coulomb force maintaining or changing the deflection state(s) of the mirror 4003 is reduced in proportion to the second power of the distance between the mirror 4003 and address electrode. This reduction makes it possible to apply a sufficient voltage to the address electrodes, such as the address electrodes 4008b and 4008a, and also to control the mirror 4003 by taking advantage of a larger coulomb force, thereby shortening the mirror transition time, the rise time tᵣ and fall time t_{f}, which are noted in FIG. 28.

As described above, the present embodiment is configured to change the emission profiles of the variable light source 5210 so as to reduce the influence of the mirror transition periods, rise time tᵣ and fall time t_{f}.

If the variable light source 5210 is controlled to emit no light or a reduced emission intensity level of light during the transition period of the mirror 4003 as, for example, the light source pulse patterns 5801 through 5803 (i.e. the Light pulse patterns 1 through 3), which are exemplified in FIG. 25, a light intensity obtained in one frame period (or a light intensity obtained by an entire “white” display) will be reduced (i.e., lost) by the amount of the transition period of the mirror 4003.

Therefore, decreasing the deflection angle of the mirror 4003, as in the present embodiment, reduces a loss of the light intensity obtained in one frame period and therefore increases light-usage efficiency, accuracy, the gradation of the display image.

Further, the present embodiment is configured to reduce the tilt angle of the mirror to no more than ±8 degrees, making it possible to reduce the difference in potentials (noted as “potential difference” hereinafter), to be applied between the mirror 4003 and address electrodes (i.e., the address electrodes 4008b and 4008a) to start up and drive the mirror 4003 of the spatial light modulator 5100, to no higher than 5 volts, and more desirably, no higher than 3.3 volts.

That is, there is a relationship between the voltage, which is to be applied between the mirror 4003 and address electrodes, and the deflection angles of the mirror 4003 between the respective deflection states, and therefore, the spatial light modulator 5100, which is enabled for a low-voltage drive, attains a high light-usage efficiency, high accuracy, high-grade gradation image display.

Further, the miniaturization of the mirror 4003 and, accordingly, that of the mirror array 5110, are accompanied by the capability of driving the mirror 4003 with a lower applied voltage.

### Embodiment 3

The following is a description, in detail, of the preferred embodiment of the present invention with reference to the accompanying drawings.

The following describes various embodiments, with the configurations and operations of the projection apparatuses exemplified above taken into consideration. Note that the same reference symbols are assigned to the same constituent components as the above-described configurations, and an overlapping description will not be provided.

In the case of the single-panel projection apparatus (1×SLM; comprising a single SLM), exemplified in the above described FIG. 21, in the case of the present embodiment, one frame of input digital video data 5700 (i.e., a frame 6700-1) is constituted by a plurality of sub-frames 6701, 6702 and 6703 in a time series corresponding to the respective colors R, G and B, and binary data 6704 or non-binary data 6705 is generated for each subfield as described above, as exemplified in FIG. 30A.

Meanwhile, in the case of the above described multi-panel projection apparatus (3×SLM; comprising three SLMs) 5020, 5030 and 5040, a plurality of subfields 6700-2 (i.e., equivalent to subfields 6701, 6702 and 6703) corresponding to the respective colors R, G and B are simultaneously outputted to the respective spatial light modulators 5100, and the spatial light modulation for the respective colors are carried out simultaneously during the display period of one frame (i.e., a frame 6700-1) as exemplified in FIG. 30B.

Also in this case, the above described binary data 6704 or non-binary data 6705 is generated for each subfield 6700-2 of each respective color.

The present embodiment is configured such that the video image analysis unit 5550 of the control unit 5500 detects, from the input digital video data 5700, the timing of a change of the signal waveforms of the binary data 6704 or non-binary data 6705, generates a light source profile control signal 6800, used to control the ON/OFF of the red laser light source 5211, green laser light source 5212 and blue laser light source 5213 of the variable light source 5210, and inputs the signal to the light source control unit 5560 by way of the sequencer 5540.

This configuration implements the ON/OFF control (which is described later) of the variable light source 5210 in sync with the timing of a change in the signal waveforms of the binary data 6704 or non-binary data 6705 of the input digital video data 5700.

### Embodiment 3-1

A sequencer 5540 of the control unit 5500 exemplified in FIG. 23A includes the function of receiving, as input, control signals, including a mirror control profile 6710 and a mirror control profile 6720, such as binary data 6704 or non-binary data 6705, which are outputted to a spatial light modulator 5100 from a SLM controller 5530, generating a light source profile control signal 5800 used to make a light source control unit 5560 control the emission of the variable light source 5210, such as light source pulse patterns 6801 through 6811 (which are described later), and outputting the generated signals 5800 to the light source control unit 5560.

Note that, while the variable light source 5210 is constituted by the red laser light source 5211, green laser light source 5212 and blue laser light source 5213 in FIG. 23A; the light source pulse patterns 6801 through 6817 (described later) exemplify the case of the variable light source 5210 constituted by a single light source capable of emitting light containing all wavelengths corresponding to the colors red (R), green (G) and blue (B).

In the case of the present embodiment, an image signal to be displayed is inputted, as input digital video data 5700, to a display apparatus, and the image signal is stored in the frame memory 5520 for each frame. The SLM controller 5530 generates drive signals, such as mirror control profiles 6710 and 6720, from the input digital video data 5700 stored in the frame memory 5520. The spatial light modulator 5100 is driven with the drive signal.

Meanwhile, the drive signal generated by the SLM controller 5530 is also inputted to the sequencer 5540 controlling the operation of the system. The sequencer 5540 transmits, to the light source control unit 5560, the light source profile control signal 5800 in accordance with the drive signal input from the SLM controller 5530, so that the light source control unit 5560 controls the light source drive circuit 5570 in regards to the timing and light intensity of light emission from, the variable light source 5210. The variable light source 5210 emit the illumination light 5600 in response to the timing and light intensity driven by the light source drive circuit 5570.

Note that, the light source profile control signal 5800 has been described as a configuration that is generated by the sequencer 5540; alternately, it may be generated, as described above, by the light source control unit 5560 shown in FIG. 23A.

The present embodiment makes it possible to continuously adjust the intensity of emission of the variable light source 5210 while the spatial light modulator 5100 is driven, that is, during the display of an image onto the screen 5900. It also makes it possible to change the brightness of a pixel to be displayed, thereby enabling a control of the gradation characteristic of the display video image. Further, the present embodiment is configured to adjust the emission intensity of the variable light source 5210 using a drive signal used for driving the spatial light modulator 5100, eliminating extraneous emission of the variable light source 5210, thereby reducing the heat generated and the power consumed.

### Embodiment 3-2

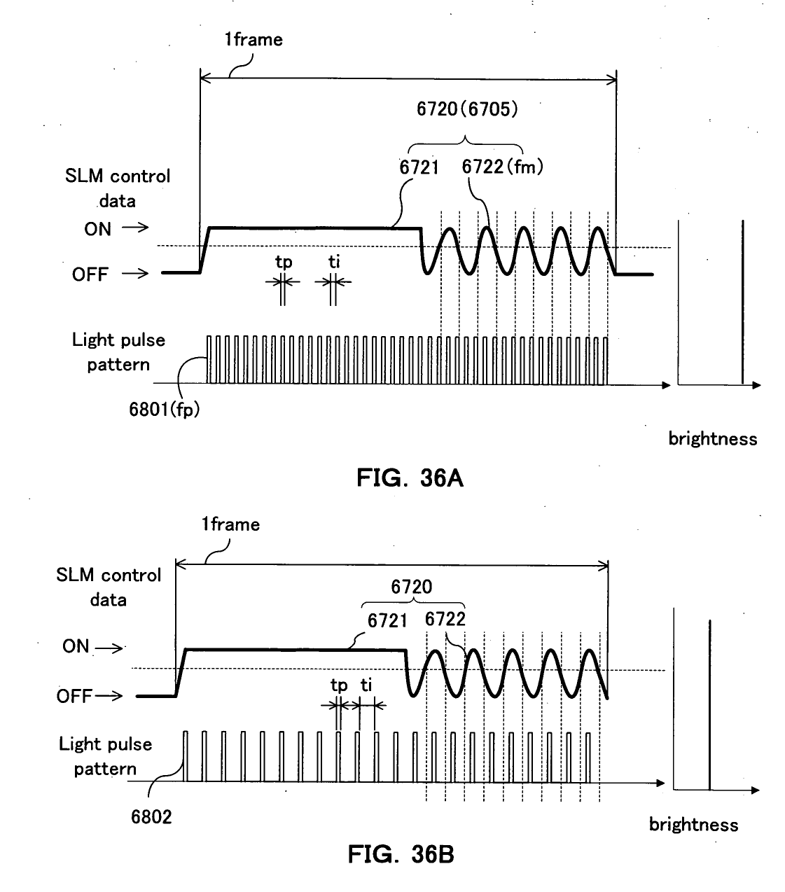

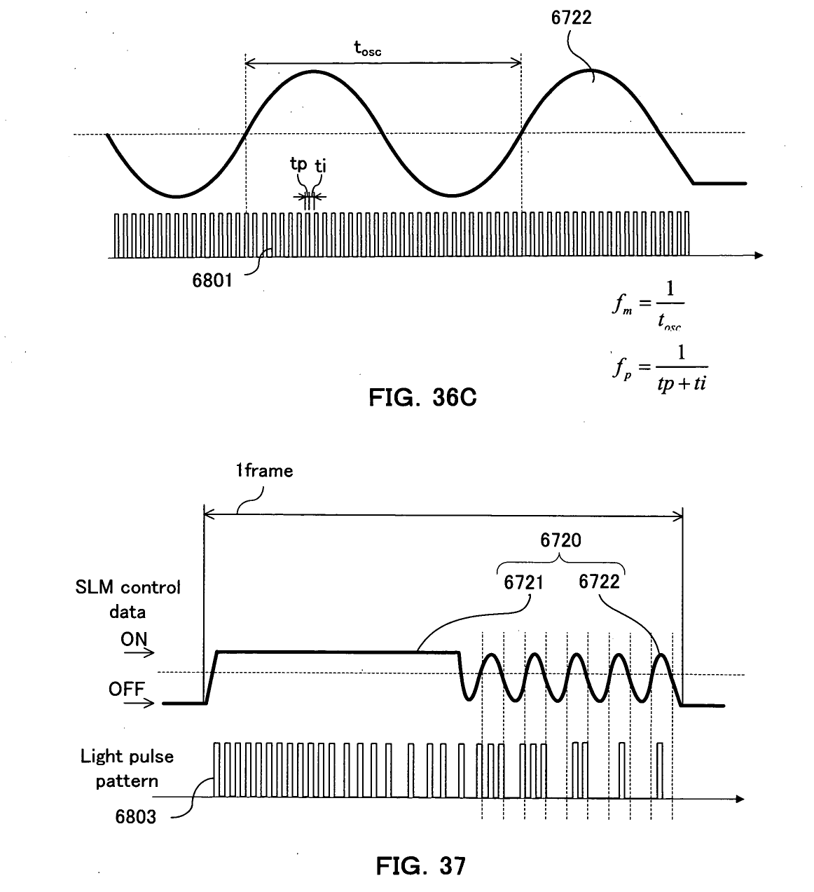

FIG. 36A exemplifies a waveform of a mirror control profile 6720 that is a control signal output from a SLM controller 5530 to a spatial light modulator 5100 and an example of the waveform of a light source pulse pattern 6801 generated by a light source control unit 5560 from a light source profile control signal 5800 corresponding to the aforementioned mirror control profile 6720.

In this case, one frame of the mirror control profile 6720 is constituted by the combination of a mirror ON/OFF control 6721 on the frame head side and a mirror oscillation control 6722 on the tail end side and is used for controlling the tilting operation of the mirror 4003 corresponding to the gray scale of the present frame.

That is, the mirror ON/OFF control 6721 controls the mirror 4003 in either of the ON and OFF states, and the mirror oscillation control 6722 controls the mirror 4003 in an oscillation state, in which the mirror 4003 oscillates between the ON state and the OFF state.

The present embodiment is configured such that the light source control unit 5560 controls the frequencies of the pulse emission of the variable light source 5210 in accordance with the signal (i.e., mirror control profile 6720) driving the spatial light modulator 5100. The spatial light modulator 5100 performs a display of the illumination light 5600 through a spatial light modulation by means of a large number of mirrors 4003 corresponding to the pixels to be displayed and the tilting operation of the mirrors 4003.

Note that for the mirror oscillation control 6722, the pulse emission frequency fp of the variable light source 5210 emitting the illumination light 5600 is preferably either higher (in the case of the light source pulse pattern 6801 shown in FIG. 36A) by ten times, or more, than the oscillation frequency fm of the oscillation control for the mirror 4003, or lower (in the case of the light source pulse pattern 6802 shown in FIG. 36B) by one tenth, or less, than the frequency fm. The reason is that if the oscillation frequency fm of the mirror 4003 and the pulse emission frequency fp of the variable light source 5210 are close to each other, a humming occurs, which may hamper a correct display of gray scales by means of the mirror oscillation control 6722.

FIG. 36C is a chart exemplifying the above described light source pulse pattern 6801, which is shown by enlarging the part corresponding to the mirror oscillation control 6722.

The mirror oscillation control 6722 oscillates at an oscillation cycle t_{osc} (1/fm), and, in contrast the light source pulse pattern 6801, performs pulse emission at a pulse emission frequency fp (1/(tp+ti)) with [emission pulse width tp+emission pulse interval ti] as one cycle. In this case, the condition is: fp>(fm*10)

That is, in the example of FIG. 36C, about 32 pulses of emission is carried out during the oscillation cycle of the mirror oscillation control 6722.

The present embodiment is configured to change the frequencies of the pulse emission of the variable light source 5210, thereby making it possible to adjust the intensity of the illumination light 5600 emitted.

FIG. 37 exemplifies the case of a light source pulse pattern 6803 performing a chirp modulation, in which the pulse emission frequencies fp of the variable light source 5210 are continuously changed from a high frequency to a low frequency while the spatial light modulator 5100 is driven.

The continuous changing of the pulse emission frequencies fp, as exemplified by the light source pulse pattern 6803, makes it possible to extend the number gray scales in the darker part of an image and thereby allowing the details in the darker part of the image to be displayed without saturating the brighter parts of the image.

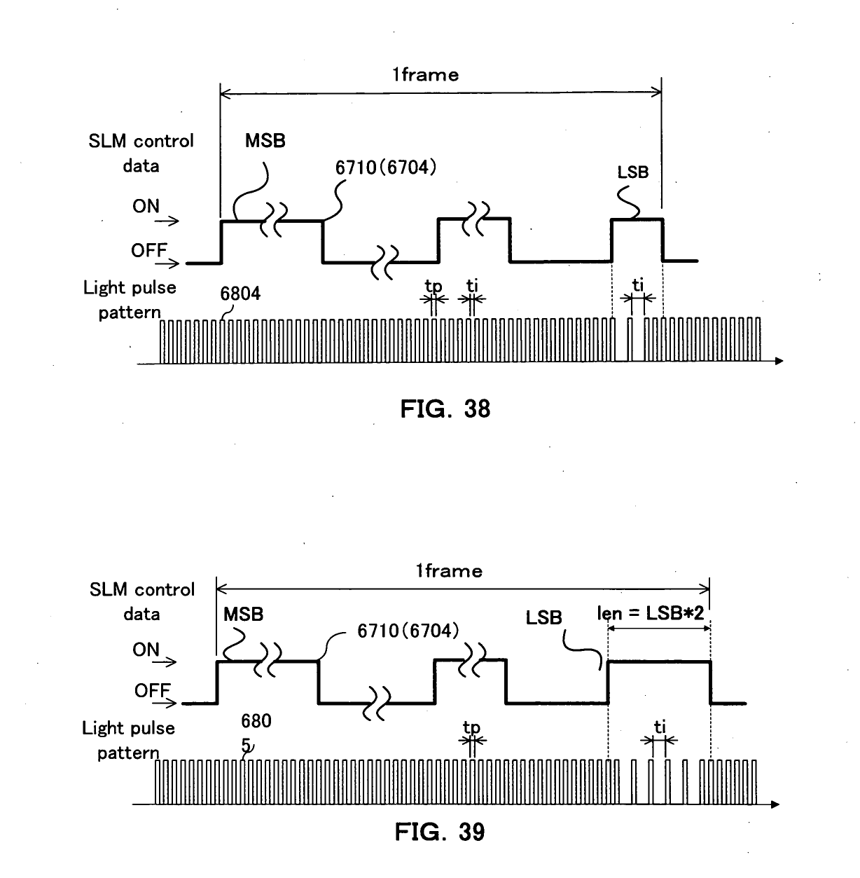

FIG. 38 exemplifies the case in which the spatial light modulator 5100 is driven with a mirror control profile 6710, comprised of binary data 6704 generated by the SLM controller 5530 and in which the pulse emission frequencies fp of the variable light source 5210 are changed during a period corresponding to the LSB of the binary data 6704.

FIG. 38 exemplifies the case of lowering the pulse emission frequency fp by increasing an emission pulse interval ti, while keeping the emission pulse width tp fixed in the section of the LSB.

The configuration makes it possible to adjust the light intensity of the light source by changing the pulse emission frequencies fp of the variable light source 5210 in the LSB period, that is, the minimum period for driving the mirror 4003, and therefore to increase the number of bits of gray scales.

FIG. 39 exemplifies the case of a light source pulse pattern 6805 in which the spatial light modulator 5100 is driven with a mirror control profile 6710, includes the binary data 6704 generated by the SLM controller 5530, and in which the pulse emission frequency fp of the variable light source 5210 is changed to half during the period of the LSB of the mirror control profile 6710.

As described above, the changing of the pulse emission frequency fp of the light source pulse pattern 6805 to half during the LSB period of the mirror control profile 6710 to make the light intensity of the variable light source 5210 halved unique language makes it possible to increase the drive time of the mirror 4003 to two times the LSB period. That is, a use of common light source intensity obtains the same light intensity of the illumination light as the light intensity obtained during the LSB period.

In this case, the period of drive time of the mirror 4003 can be increased to two times the LSB period, and therefore, the control of the spatial light modulator 5100 can be simplified. Alternatively, it is possible to increase the number of bits of gray scales.

### Embodiment 3-3

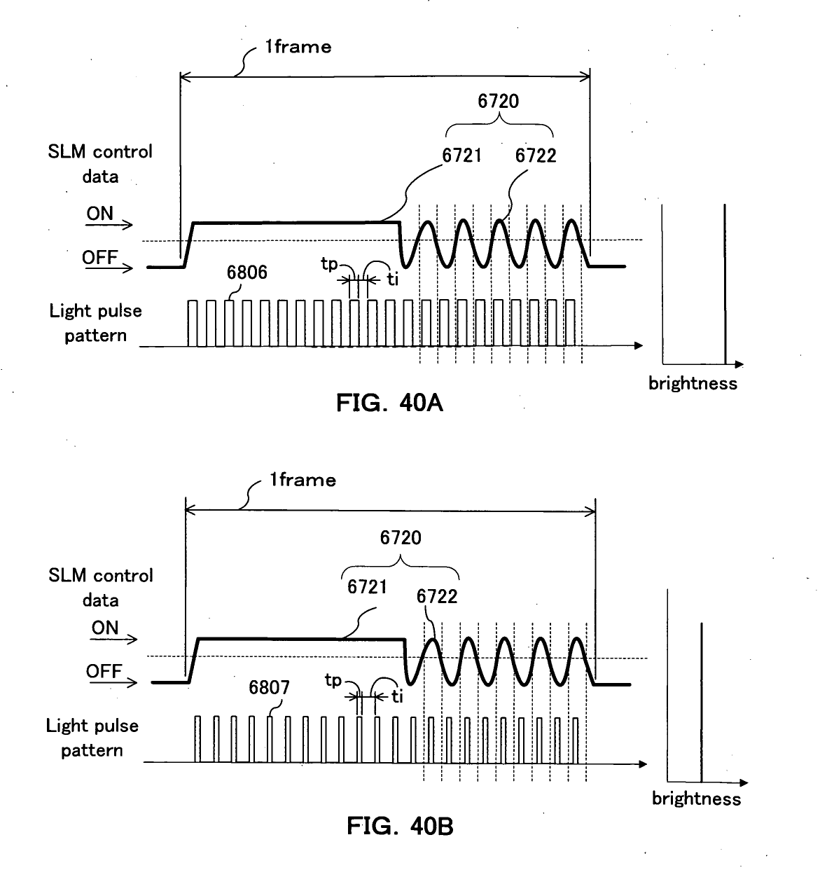

FIGS. 40A and 40B exemplify the case of changing the emission pulse widths tp of the pulse emission of the variable light source 5210 in accord with a signal driving the spatial light modulator 5100.

That is, the control is such as to relatively increase the emission pulse width tp like the light source pulse pattern 6806 exemplified in FIG. 40A, or relatively decrease the emission pulse width tp like the light source pulse pattern 6807 exemplified in FIG. 40B, depending on the mirror control profile 6720 constituted by the mirror ON/OFF control 6721 and mirror oscillation control 6722.

As described above, increasing of the emission pulse width tp while keeping the pulse emission frequency fp constant (tp+ti=constant) makes it possible to increase the emission intensity of the illumination light 5600 emitted from the variable light source 5210.

The present embodiment is configured to change the emission pulse widths tp of the pulse emission of the variable light source 5210 with the pulse emission frequency fp kept constant, thereby making it possible to adjust the emission intensity of the illumination light 5600, such as a laser light, emitted from the variable light source 5210.

### Embodiment 3-4

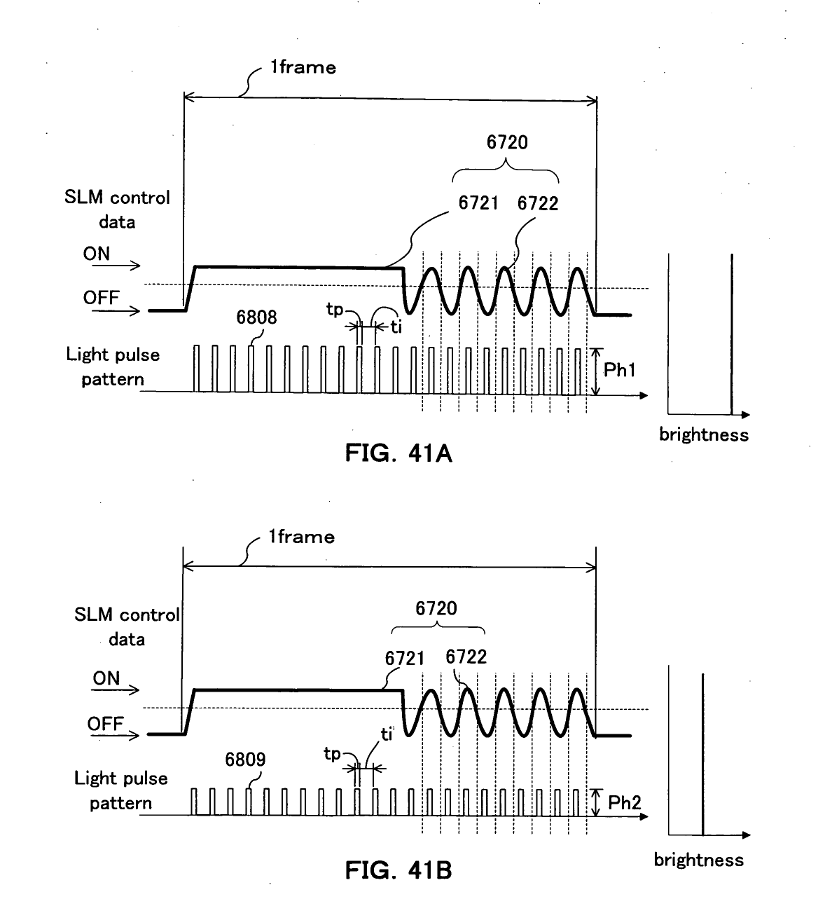

FIGS. 41A and 41B exemplify the case of changing the emission light intensities of the emission pulse of the variable light source 5210 in accordance with a mirror control profile 6720 driving the spatial light modulator 5100.

That is, the light source pulse pattern 6808 exemplified in FIG. 41A controls, in sync with the mirror control profile 6720, the emission intensity by using the emission pulse width tp, emission pulse interval ti and emission intensity Ph1.

Further, the light source pulse pattern 6809 exemplified in FIG. 41B controls, in sync with the mirror control profile 6720, the emission intensity by using an emission intensity Ph2 (<emission intensity Ph1) with the emission pulse width tp and emission pulse interval ti held constant.

The present embodiment is configured to change the emission light intensities of the emission pulse, thereby making it possible to adjust the emission intensity of the variable light source 5210, such as a laser.

### Embodiment 3-5

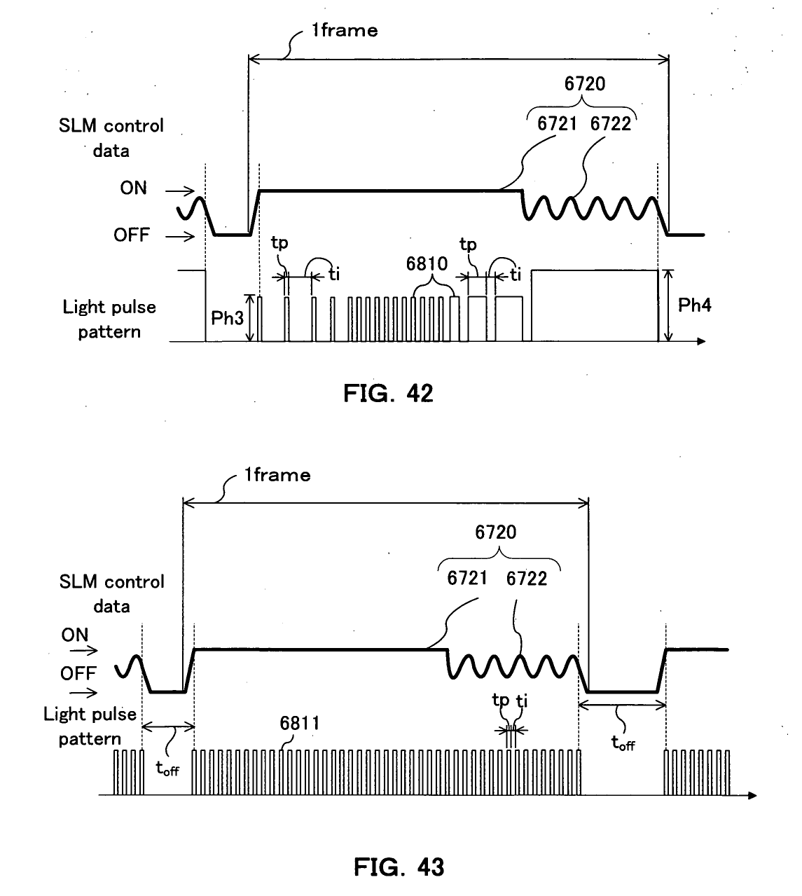

FIG. 42 exemplifies the case of changing the emission light intensities using any of the following parameters: the pulse emission frequency, emission pulse width, and emission intensity of a pulse or a discretionary combination of any plural parameters from among the aforementioned parameters. 637 has an extra sentence fragment here

That is, the light source pulse pattern 6810 shown in FIG. 42 exemplifies the case of changing the pulse emission frequency fp, emission pulse width tp, emission intensity Ph3 and emission intensity Ph4, in sync with the mirror control profile 6720.

That is, the light source pulse pattern 6810 performs a control such that, in the display period of one frame, first, the pulse emission frequency fp is gradually increased while the emission intensity Ph3 and emission pulse width tp are kept constant and then, in the latter part of the frame, the emission pulse width tp is increased, of the section of mirror ON/OFF control 6721.

Further, in the section of mirror oscillation control 6722, the emission intensity is increased to the emission intensity Ph4 (which is larger than the emission intensity Ph3) and the emission pulse width tp is also increased to a value that is equal to the width of the oscillating section 6722.

Controlling the light source pulse pattern 6810 makes it possible to expand the gray scales in, for example, a darker part of a video display, enabling a display of details in a darker part of the image without saturating the brighter parts of the video image.

The present embodiment enables control of the gray of a displayed image, by changing the parameters of the pulse emission of the variable light source 5210, such as pulse emission frequency fp, emission pulse width tp, and emission light intensities Ph3 and Ph4 of the pulse emission of the variable light source 5210.

### Embodiment 3-6

FIG. 43 exemplifies the control data for making a variable light source 5210 perform pulse emission only during the period in which the entire pixels of a spatial light modulator 5100 are driven and suppressing the pulse emission of the variable light source 5210 during the period in which the entire pixels of the spatial light modulator 5100 are not driven.

That is, the light source pulse pattern 6811 shown in FIG. 43 is generated in sync with the mirror control profile 6720, which makes the variable light source 5210 perform pulse emission during the period of driving the mirror 4003 by means of the mirror control profile 6720 and suppresses the pulse emission during the switch-off period t_{off} between frames.

The present embodiment is configured to make the variable light source 5210 emit light only when the spatial light modulator 5100 is driven, and therefore the power consumption of the projection apparatus and the heat generation of the variable light source 5210 can be suppressed.

### Embodiment 3-7

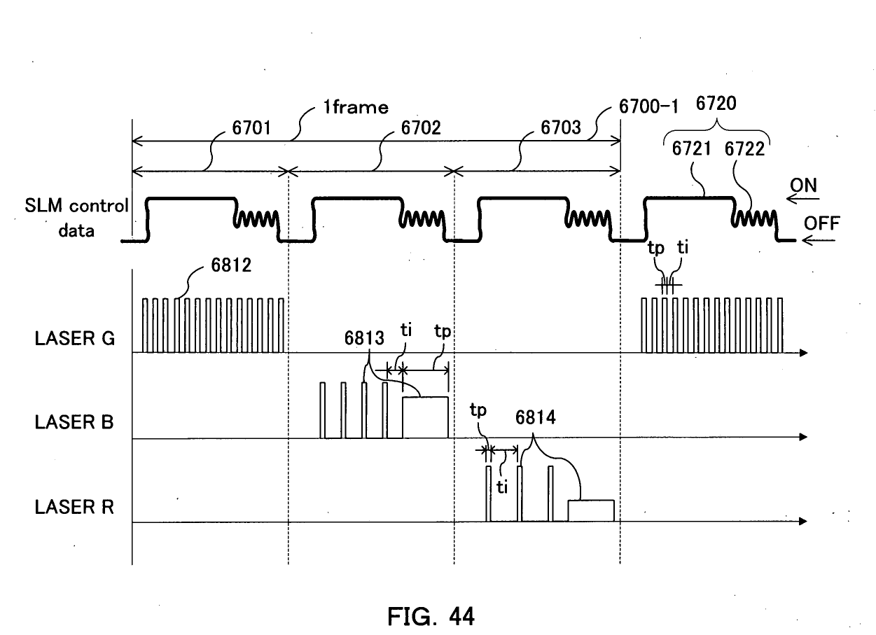

FIG. 44 is a chart exemplifying control data for projecting a color display, by means of a color sequence control using a control unit 5500 configured as exemplified in FIG. 23A, in a single-panel projection apparatus comprising a single spatial light modulator exemplified in the above described FIG. 21.

As exemplified in FIG. 23A, the light source control unit 5560 generates a control signal for driving the light sources of the respective colors R, G and B, on the basis of the light source profile control signal 5800 inputted from the sequencer 5540, and the light source drive circuit 5570 causes the light sources of the respective colors R, G and B to perform pulse emission.

The display period of one frame (i.e., frame 6700-1) is further divided, in a time series, to the subfields 6701, 6702 and 6703, corresponding to the respective colors G, R and B.

Then, the pulse emission of the green laser light source 5212 is controlled in accordance with a light source pulse pattern 6812 in the green (G) subfield 6701; the pulse emission of the red laser light source 5211 is controlled in accordance with a light source pulse pattern 6813 in the red (R) subfield 6703; and the pulse emission of the blue laser light source 5213 is controlled in accordance with a light source pulse pattern 6814 in the blue (B) subfield 6702 very slight difference.

As described above, the light source drive circuit 5570 performs a control so as to adjust the emission light intensities for the red laser light source 5211, green laser light source 5212 and blue laser light source 5213 of the respective colors R, G and B in accordance with the mirror control profile 6720 generated by the SLM controller 5530.

The present embodiment makes it possible to expand the gradation very slight difference of the respective colors R, G and B in a color display on a color sequential projection apparatus.

### Embodiment 3-8

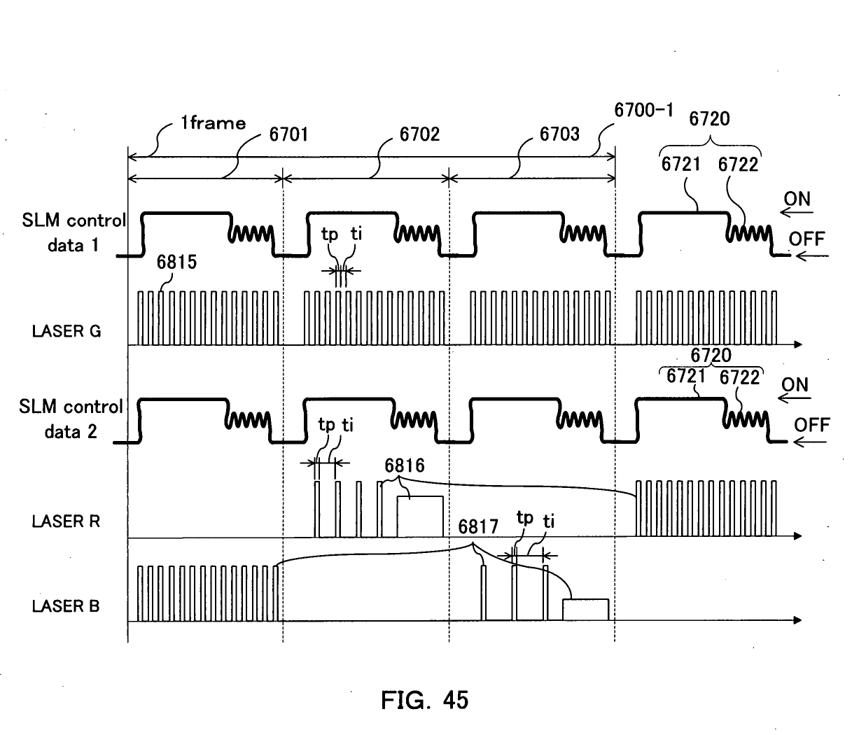

FIG. 45 is a chart showing the waveforms of control signals of a projection apparatus according to the present embodiment 3-8.

The drive signal (i.e., a mirror control profile 6720 shown in FIG. 45) generated by the SLM controller 5530 drives a plurality of spatial light modulators 5100 accommodated in a device package (not shown here).

The light source control unit 5560 generates a light source profile control signal 5800 corresponding to the mirror control profile 6720, which is the signal driving the respective spatial light modulators 5100, and inputs the generated profile 6720 to the light source drive circuit 5570, which in turn adjusts the intensity of the laser lights (i.e., the illumination lights 5600) emitted respectively from the red laser light source 5211, green laser light source 5212 and blue laser light source 5213.

The control unit implemented in the projection apparatus, according to the present embodiment 3-8, is an exemplary modification of the control unit exemplified in FIG. 23A, in which one SLM controller 5530 driving a plurality of spatial light modulators 5100 makes it possible to irradiate an illumination light 5600 in the optimal light intensity for each respective spatial light modulator 5100 without a need to includes a light source control unit 5560 or a light source drive circuit 5570 for each of the spatial light modulators 5100. This configuration simplifies the circuit configuration of the control unit 5500.

As exemplified in FIG. 45, the light source control unit 5560 and light source drive circuit 5570 drive the red laser light source 5211, green laser light source 5212 and blue laser light source 5213 so as to adjust the emission intensities of individual lasers (i.e., the illumination light 5600) of the respective colors R, G and B in sync with the respective SLM drive signal (i.e., the mirror control profile 6720) that are generated by the SLM controller 5530.

In this case, a color sequence control is employed for the two colors B and R sharing one spatial light modulator 5100.

That is, one frame is constituted by a plurality of subfields 6701, 6702 and 6703, and the same light source pulse pattern 6815 is repeated in the respective subfields for one spatial light modulator 5100 corresponding to green (G).

Meanwhile, the pulse emissions of the red laser light source 5211 and blue laser light source 5213, sharing one spatial light modulator 5100, are controlled so as to use the subfields, i.e., subfields 6701 through 6703, alternately in a time series as indicated by the light source pulse patterns 6816 and 6817, respectively.

The present embodiment makes it possible to increase the gradation levels for the respective colors R, G and B.

### Embodiment 4

The following is a description, in detail, of the preferred embodiment of the present invention with reference to the accompanying drawings.

The following description provides various embodiments, with the configurations and operations of the projection apparatuses described above taken into consideration. Note that the same reference symbols are assigned to the same constituent component as that included in the above-described configurations, and an overlapping description is not provided here.

Incidentally, a spatial light modulator 5100 comprising a mirror device used in a projection apparatus according to the present embodiment is configured to perform a linear gradation display, unlike a conventional display apparatus such as a CRT.

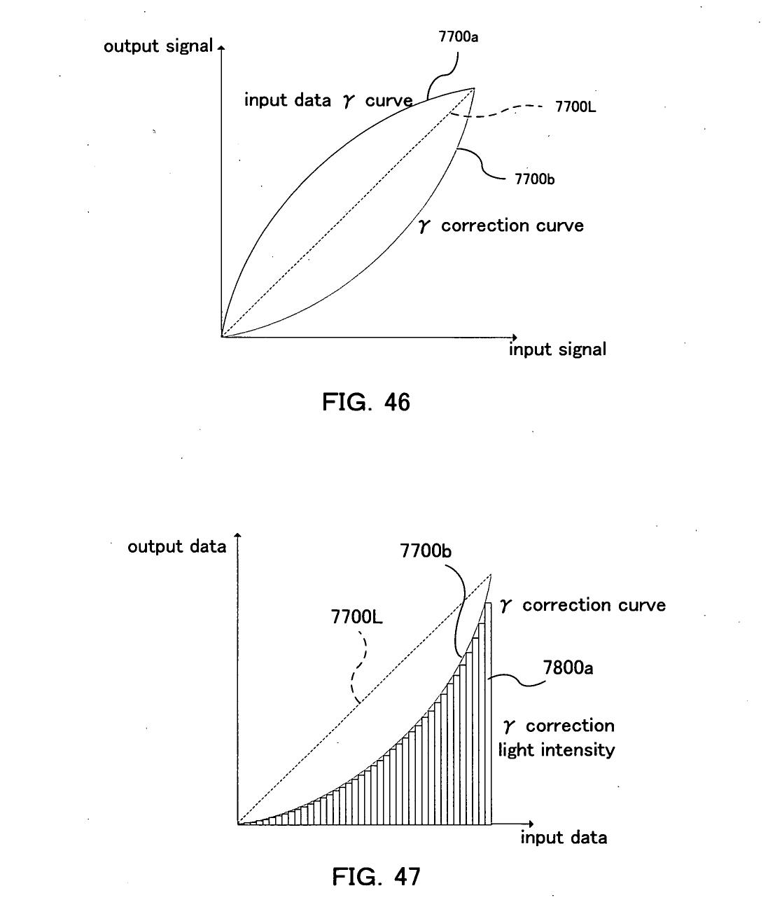

Therefore, as exemplified in FIG. 46, when a γ collection, such as an input data γ curve 7700a, is applied to a piece of input digital video data 5700 at the transmission source (i.e., where the imaging is carried out), assuming a display in the CRT, a projection apparatus comprising a display device other than the CRT is required to restore the characteristics of a gradation display back to the original state (e.g., a conversion line 7700L for performing a linear conversion of a brightness signal in terms of an input data signal) by means of a correction, such as a γ correction curve 7700b and/or to perform various γ corrections in accordance with the characteristics of the projection apparatuses 5010, 5020, 5030 and 5040.

In such a case, a mathematical operation for the input digital video data 5700, as it is performed in a conventional display device, causes the circuit scale of the control unit 5500 to increase, leading to a higher production cost.

The present embodiment is accordingly configured such that the above described video image analysis unit 5550 changes the emission pattern of the illumination light 5600 emitted from a variable light source 5210 to the profile, as indicated by a γ correction light intensity variation 7800a, so as to follow the above noted γ correction curve 7700b, as exemplified in FIG. 47. Thereby, a linear gradation display, as indicated by the conversion line 7700L, is attained by negating the influence of the input data γ curve 7700a performed at the transmission source, without requiring a mathematical operation of the input digital video data 5700.

Note that this configuration makes it possible to not only restore the linearity by negating the influence of the input data γ curve 7700a but also to change, intentionally nonlinearly, the emission intensities of the variable light source 5210 within one frame, thereby enabling various and highly precise gradation displays in excess of the original gradation control capability of the spatial light modulator 5100.

As an example, a video image output (i.e., the input digital video data 5700) contains various scenes such as a dark scene, a bright scene, a generally bluish scene and a generally reddish scene such as a sunset. The projection apparatus according to the present embodiment is configured to control the gradation of the emission output of the variable light source 5210 most optimally depending on the particular scene (with actual control carried out in units of frame), thereby making it possible to attain higher quality video images.

Incidentally, when a γ correction of the input digital video data 5700 (i.e., the input data γ curve 7700a) is implemented by means of a temporal change in emission intensities of the variable light source 5210, as described above, a precise emission control of the variable light source 5210 is difficult if an ON/OFF control of the mirror 4003, through a pulse width modulation (PWM) using binary data 7704 included in the input digital video data 5700, is carried out.

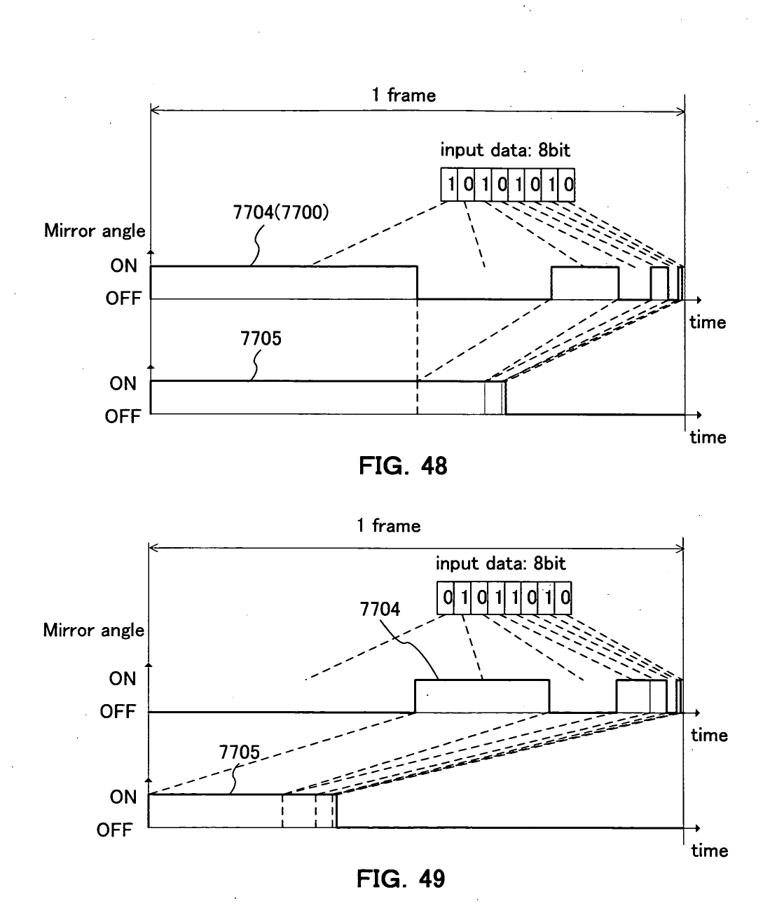

Accordingly, the SLM controller 5530 according to the present embodiment is configured to carry out an ON/OFF control of the mirror 4003 using non-binary data 7705 obtained by converting binary data 7704, as exemplified in FIGS. 48, 49, 50 and 51.

That is, FIG. 48 exemplifies the case of generating non-binary data 7705, which is a bit string having an equal weighting factor for each digit, from the binary data 7704 that is constituted by, for example, 8-bit “10101010”, and a control is carried out for turning ON the mirror 4003 only for the period in which the bit string continues. Note that FIG. 48 exemplifies the case of converting the non-binary data 7705 so that the bit string is packed forward within the display period of one frame, controlling the mirror 4003 to be turned ON for a predetermined period, in accordance with the bit string number from the beginning of a frame display period.

Likewise, FIG. 49 exemplifies the case of converting 8-bit “01011010” binary data 7704 into non-binary data 7705, a forward-packed bit string.

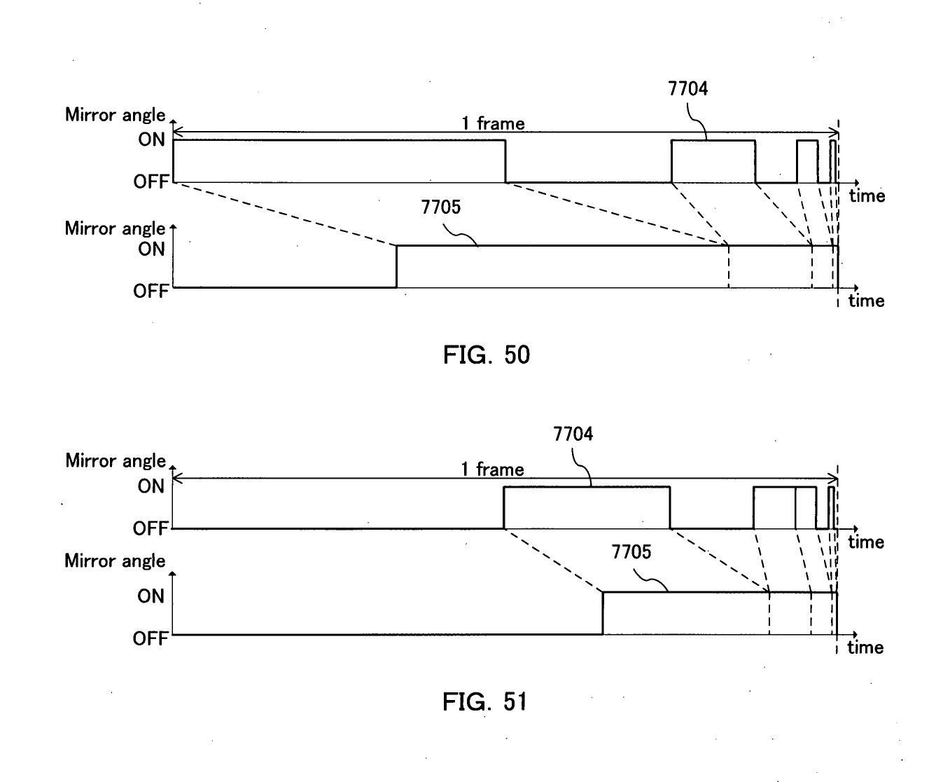

Further, FIG. 50 exemplifies the case of converting the binary data 7704, exemplified in FIG. 48, into a bit string of non-binary data 7705 with the digits packed backward. In this case, the mirror 4003 is controlled so as to be turned ON only in the period of time corresponding to the bit string number starting from the middle of a frame display period until the end.

Likewise, FIG. 51 exemplifies the case of converting binary data 7704, exemplified in FIG. 49, into a bit string of non-binary data 7705, with the digits packed backward and controlling the ON/OFF of the mirror 4003.

When the ON/OFF is controlled by the non-binary data 7705 as described above, the ON period of the mirror 4003 becomes continuous, and therefore it is easier to control the emission intensity of the variable light source 5210 in sync with the aforementioned ON period.

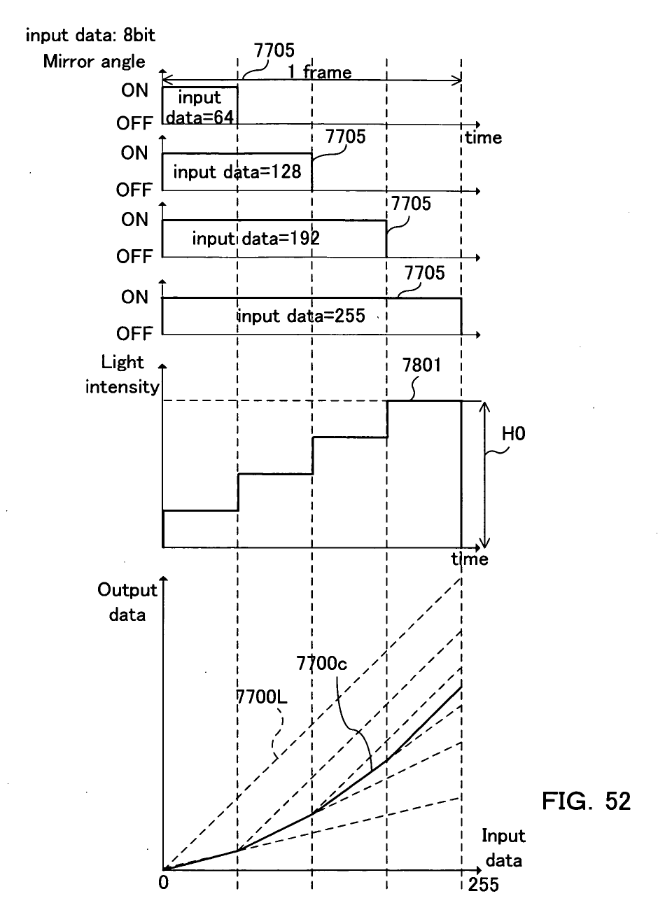

FIG. 52 exemplifies the case of dividing the brightness input of 8-bit non-binary data 7705 into, for example, four steps, i.e., 64, 128, 192 and 255, as shown in the upper rows of FIG. 52, and obtaining a γ correction curve 7700c, as shown in the lower row of the drawing, through a four-step control of the output intensity of the variable light source 5210 in response to each of the aforementioned levels, as indicated by a light source pulse pattern 7801 shown in the middle row of the drawing.

For simplicity, FIG. 52 exemplifies the case of performing a control in four steps. A further minute grouping of the non-binary data 7705 makes it possible to obtain a smoother curve than the γ correction curve 7700c.

Note that the example of FIG. 52 shows that the correction amount of the γ correction curve 7700c is in shortage on the brighter side when compared with the conversion line 7700L correction curve flattens out in comparison with the conversion line as the brightness of the image increases. Therefore, the emission pattern of the variable light source may be controlled so as to cause the γ correction curve 7700c to more closely approach the conversion curve 7700L by increasing the emission light intensity of the light source pulse from an emission intensity H0 to an emission intensity H1 on the tail end of the display period of one frame.

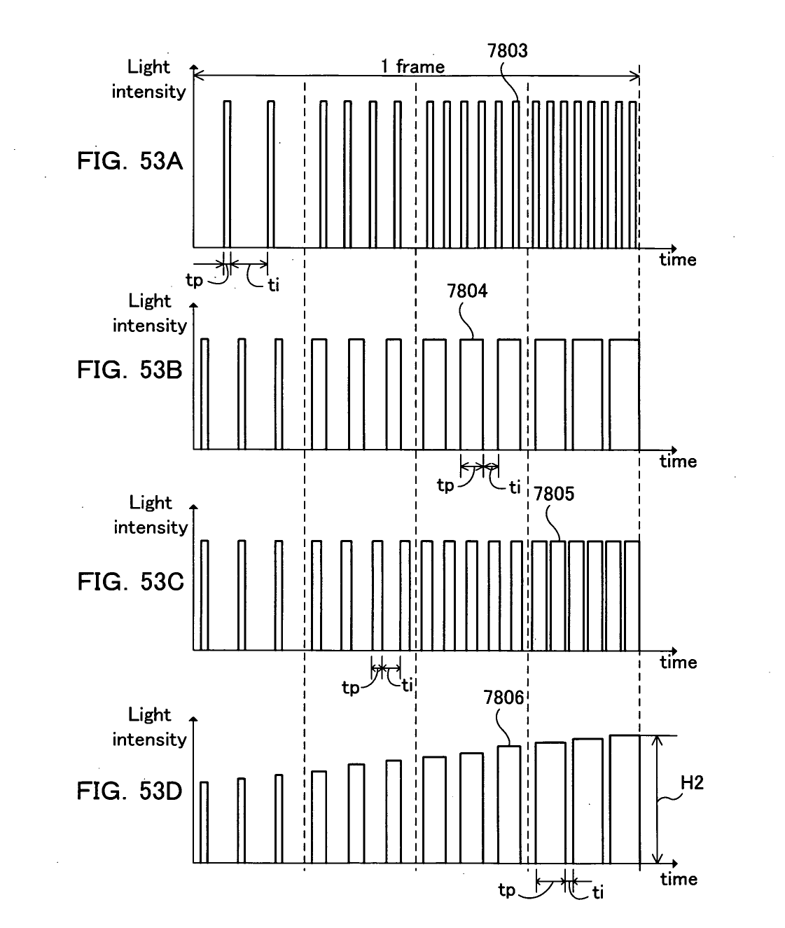

FIG. 52 exemplifies the case of performing a γ correction by changing the emission intensity while the variable light source 5210 continuously emits light, as indicated by the light source pulse pattern 7801. Alternately, the control may be performed by means of an intermittent pulse emission. FIGS. 53A, 53B, 53C and 53D exemplify a control by means of an intermittent pulse emission. A light source pulse pattern 7803 exemplified in FIG. 53A generates emission pulses having an emission pulse width tp intermittently in intervals of emission pulse intervals ti and increases the number of emission pulses per unit of time by gradually decreasing the emission pulse interval ti between the beginning and end of the display period of one frame, thereby attaining an effect similar to the continuous light source pulse pattern 7801 described in FIG. 52.

The light source pulse pattern 7804 exemplified in FIG. 53B shows the gradual increase of the emission pulse width tp between the beginning and end of the display period of one frame.

The light source pulse pattern 7805 exemplified in FIG. 53C shows the gradual decrease of the emission pulse intervals ti and the gradual increase of the emission pulse width tp between the beginning and end of the display period of one frame.

The light source pulse pattern 7806 exemplified in FIG. 53D shows the gradual increase of both the emission pulse width tp and emission intensity H2 between the beginning and end of the display period of one frame.

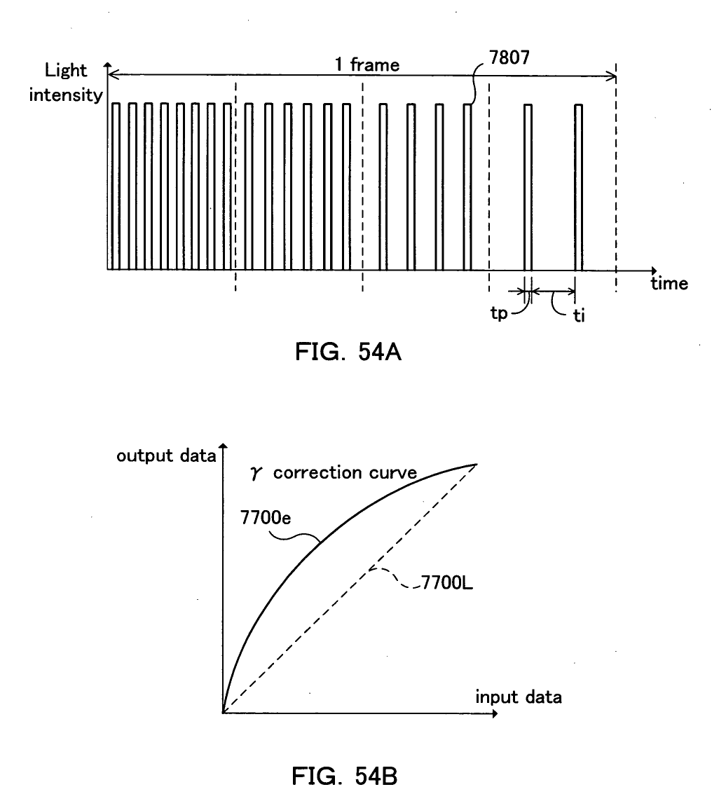

FIGS. 54A and 54B exemplify the case of attaining a γ correction curve 7700e by performing γ correction to increase the correction effect on the lower brightness values by means of a light source pulse pattern 7807.

That is, the light source pulse pattern 7807 shown in FIG. 54A controls the emission pattern of the variable light source 5210 so as to densely generate a plurality of emission pulses having a constant emission pulse width tp densely (that is, the emission pulse interval is small) near the beginning of the display period of one frame, and to gradually decrease the number of pulses (that is, the emission pulse interval ti gradually increases) towards the end of the display period.

As exemplified in FIG. 54B, this control makes it possible to attain a convex γ correction curve 7700e to the top and left of the conversion line 7700L and which, accordingly, provides a large correction effect, i.e., increasing brightness, on the values/data/input with lower brightness values.

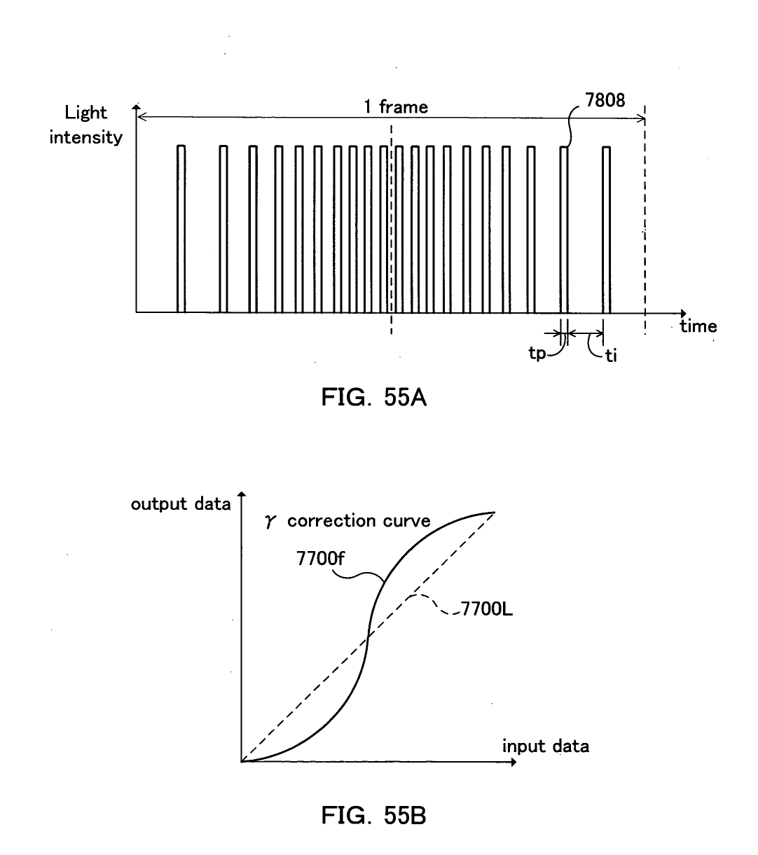

FIGS. 55A and 55B exemplify the case of a γ correction which takes into consideration the visual perception of humans by controlling the variable light source 5210 with a light source pulse pattern 7808. That is, the human eye is known to possess higher sensitivity to the values in the middle of the brightness range. Accordingly, a γ correction is performed by controlling the variable light source 5210 with the light source pulse pattern 7808 to densely emit pulses having the same emission pulse width tp (i.e., making the emission pulse interval ti small) at the center of the display period of one frame and gradually decreasing the density of the emission pulse on either side, as exemplified in FIG. 55A.

This control attains a γ correction using a γ correction curve 7700f that is below the conversion line 7700L on the lower brightness side in the lower brightness values and above the line on the higher brightness side in the higher brightness values. This correction makes it possible to obtain a modulated and clear projection image, as seen by the human eye.

Next is an example of expanding the number of display gray scales by performing a modulation control of the accumulated maximum light intensity in the display period of one frame corresponding to the variable light source 5210 of each color, so as to obtain a desired output light intensity corresponding to the pixel data indicating the maximum brightness.

The maximum gray scale output provided by a spatial light modulator 5100 comprising a mirror device is determined by the operation speed of the ON/OFF control of a mirror (more specifically, it is affected by other factors such as a single-panel comprisal versus a multi-panel comprisal and the number of sub-frame divisions).

For example, if an 8-bit gray scale output is the maximum according to the operation speed of the mirror 4003, a 256-step gray scale, i.e., “0” through “255”, can be outputted. If a single color gradation is displayed, the gradation is 256 steps; the gradation recognition capability of human being exceeds these steps. Thus, the display will not be viewed as a smooth gradation, but as stepwise borders. It is believed that to match the gradation recognition capacity of the human eye, a 12-bit scale is required.

In practice, however, there are few scenes that utilize the entire gray scale of “0” through “255”. For example, in a movie, only “0” through “128” may be outputted, or even only the values for the darker gradations. The visual recognition capability of human being is greater in discerning the difference between gradations in darker areas of a display than that in brighter areas of a display, and therefore a person tends to recognize even a minute difference in the brightness of a dark scene as a line.

The present embodiment is accordingly configured to perform a modulation control of an accumulated maximum light intensity in the display period of one frame corresponding to the spatial light modulator 5100 of each color, so that a desired output light intensity corresponding to the maximum brightness pixel data is obtained. This control makes it possible to express brightness through a whole range of gradations, from the brightest part (i.e., the pixel) to the total absence of light (i.e., “0” brightness) of a scene (i.e., frame) by the maximum gray scale output of a mirror, thereby displaying a higher resolution video image, especially in a dark scene.

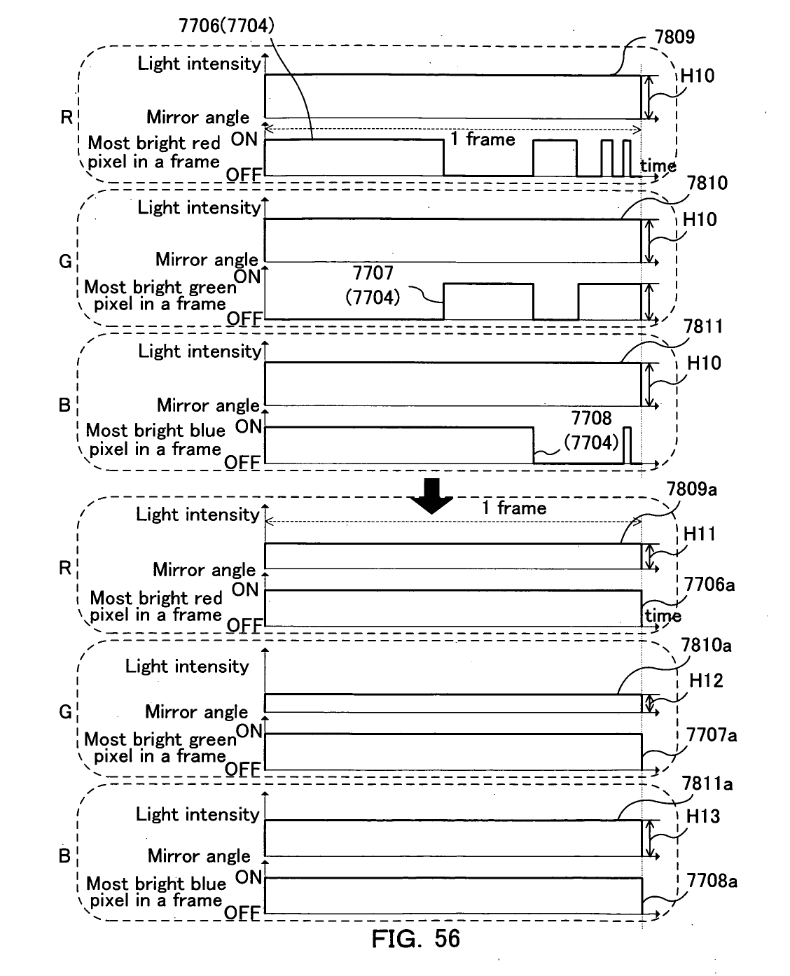

The top half of FIG. 56 shows the case of making the variable light sources 5210 (i.e., the red 5211, green 5212, and blue laser light source 5213) emit light continuously at a constant emission intensity, H10, in the gradation display control of each color in, for example, the multi-panel projection apparatuses 5020, 5030 and 5040, and turning ON/OFF the mirrors 4003 in accordance with the mirror control profiles 7706 (for red), 7707 (for green) and 7708 (for blue) by means of the PWM. Thereby, a gradation a higher resolution display is attained.

When performing a gray scale control by means of the ON/OFF control of the mirror 4003 by the conventional method, in some cases a smooth gradation cannot be expressed because the expression depends on the gradation expression. Graduated expression of the data width of the input digital video data 5700. Further, the light sources for each color are in a constant emission state, independent of the gradation change of the colors, wasting emission energy.

In contrast, the present embodiment is configured to maintain the mirror 4003 of a pixel, which indicates the maximum brightness, continuously in the ON state (in accordance with the mirror control profiles 7706a, 7707a and 7708a) and to set the variable light sources 5210 (i.e., the red 5211, green 5212, and blue laser light source 5213), which output the illumination light 5600, at emission intensities H11 (for red), H12 (for green) and H13 (for blue), which correspond to the gray scale data indicating the maximum brightness, in the gray scale control of each color, as exemplified in the bottom half of FIG. 56. Thereby the gradation can be expressed by the maximum gray scale output (that is, a continuous ON state in one frame period) of the mirror 4003, displaying a higher resolution and higher quality video image, especially in a dark scene.

Further, the brightness of the colors R, G and B are attained by the increase/decrease in the intensity of the illumination light 5600 output from the corresponding variable light sources 5210 (i.e., the red 5211, green 5212, and blue laser light source 5213), saving energy, reducing an unnecessary light component, and improving the contrast in the video image.

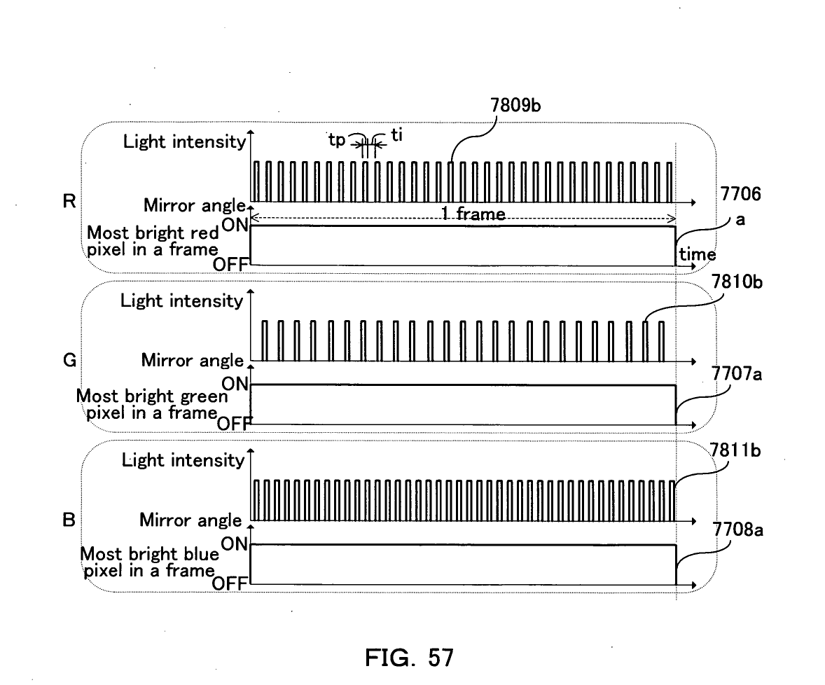

Note that, while the above described FIG. 56 exemplifies the case of controlling the variable light sources 5210 to be continuously turned on at the emission intensities H11, H12 and H13, in the gray scale control of the respective colors, the variable light sources 5210 may be controlled with an intermittent emission pulse, as shown in FIG. 57.

In FIG. 57, the mirror 4003 of a pixel indicating the maximum brightness is maintained at a continuous ON in one frame period, as represented by the mirror control profiles 7706a, 7707a and 7708a in the display control of each color, whereas the variable light sources 5210 are configured to emit pulses in accordance with the emission pulse width tp and emission pulse interval ti, as represented by light source pulse patterns 7809b (for red), 7810b (for green) and 7811b (for blue).

In this event, the number of emission pulses is controlled so that the total intensity of the emission pulse is equivalent to the gray scale data of a pixel indicating the maximum brightness.

Also in this case, the gradation can be expressed by the maximum gray scale output (that is, a continuous ON state in one frame period) of the mirror 4003, producing a higher quality and higher resolution video image, especially in a dark scene.

Further, the brightness of the colors R, G and B are attained by the increase/decrease in the intensity of the corresponding variable light sources 5210 (i.e., the red 5211, green 5212, and blue laser light source 5213), saving energy, reducing an unnecessary light component, and improving the contrast in the video image.

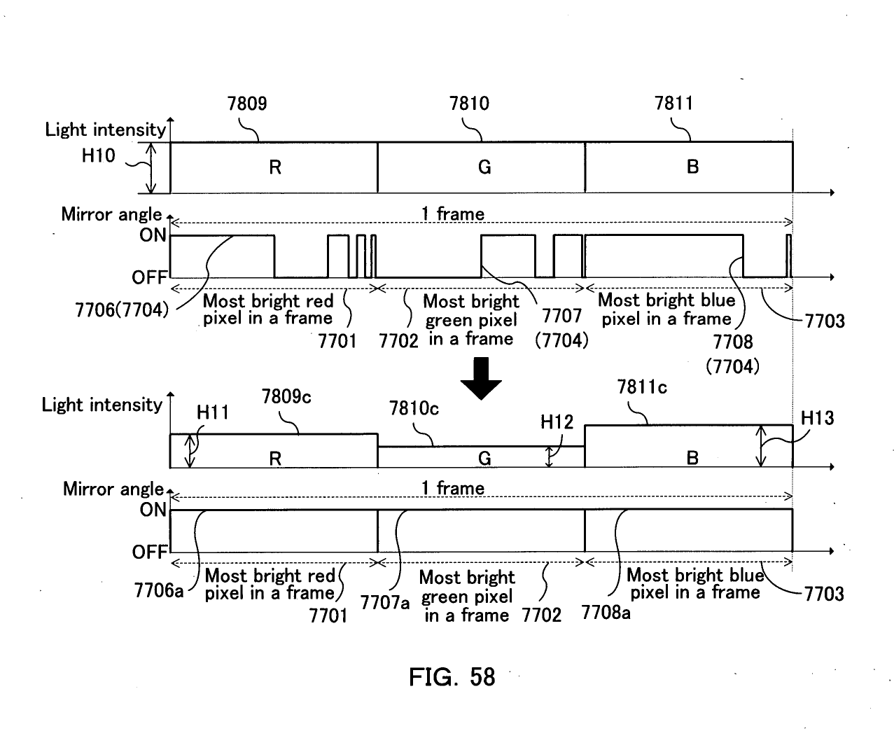

FIG. 58 exemplifies the case of performing a gray scale control when the gray scale control exemplified in the above described FIGS. 56 and 57 are applied to a single-panel projection apparatus.

In this case, the display period of one frame is divided into a plurality of subfields 5701, 5702 and 5703 corresponding to the respective colors R, G, and B, and a color display is attained by a color sequence method.

In the case of the conventional method, the ON/OFF control for the mirror 4003 is performed, by means of a PWM, in accordance with the mirror control profiles 7706 (for red), 7707 (for green) and 7708 (for blue) in the respective subfields, and the variable light sources 5210 perform a continuous emission at a constant intensity level in accordance with the light source pulse patterns 7809, 7810 and 7811, thereby performing a gray scale control, as shown in the top half of FIG. 58. In this case, a gray scale expression depends on the data width of input digital video data 5700, and therefore there is a possibility that a smooth gradation expression cannot be attained.

In contrast, as shown in the bottom half of FIG. 58, the present embodiment is configured to perform a control so that the mirror 4003 of a pixel indicating the maximum brightness is controlled to the ON state in the entire display period of one frame (i.e., the entire subfields) in accordance with the mirror control profiles 7706a, 7707a and 7708a, and so that the intensity of the variable light sources 5210 are set at intensity equivalent to the gray scale data of a pixel indicating the maximum brightness (i.e., the emission intensities H11 (for red), H12 (for green) and H13 (for blue)), and thereby the gray scale can be expressed by the maximum gray scale output (that is, a continuous ON state during the period of one frame) of the mirror 4003, thus smoothing out and beautifying the video image especially in a dark scene.

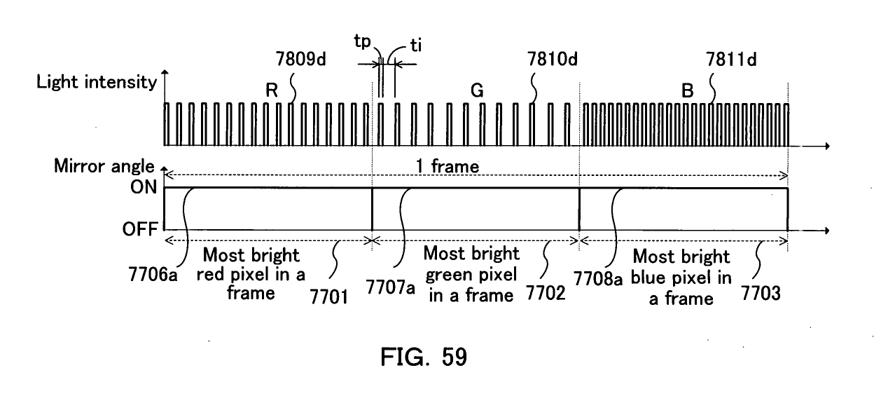

FIG. 59 shows the case of attaining an intensity equivalent to the above described emission intensities H11, H12 and H13 by adjusting the emission pulse width tp and emission pulse interval ti of the emission pulse by means of an intermittent pulse emission of the variable light sources 5210 in the respective subfields of red, green and blue. Also in this case, an effect similar to the case of the above-described FIG. 58 is obtained.

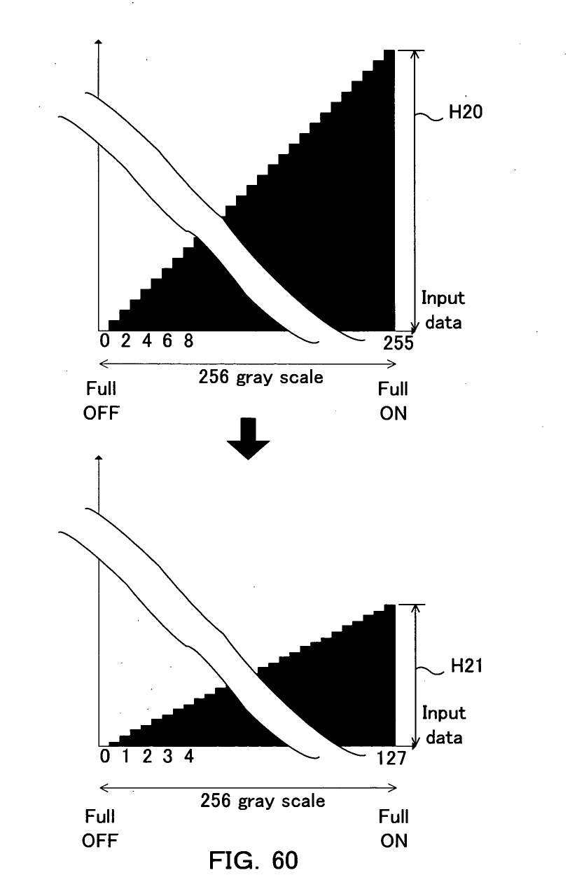

FIG. 60 shows a capability of a grayscale control with a wide dynamic range than the case of making the emission intensity of the variable light source 5210 constant by combining the ON/OFF control of the mirror 4003 and the emission intensity control of the variable light source 5210 in the above described various control examples.

That is, if the emission intensity level of the variable light source 5210 is constant at the emission intensity H20, with a gray scale expression in 256 steps, that is, “0” through “255”, in accordance with, for example, input digital video data 5700 only being possible in the range between the full ON and full OFF of the mirror 4003 and a pixel indicating the maximum brightness being a half light intensity, i.e., “0” through “127”; then a 128-step gray scale, i.e., “0” through “127”, can only be expressed, as shown on the upper part of FIG. 60.

In contrast, when the emission intensity of the variable light source 5210 is controlled, the maintaining of the emission intensity H21 of the variable light source 5210 at one half of the emission intensity H20, as in the present embodiment, makes it possible to attain a 256-step grayscale expression, i.e., “0” through “255”, in the range between the full ON and full OFF of the mirror 4003, as shown on the lower part of FIG. 60.

That is, the width of the grayscale expression can be represented more minutely in excess of the designation range of the input digital video data 5700, thus improving the image quality.

Next is a description of an example of countermeasures to a color break. In the case of a multi-panel projection apparatus comprising a plurality of spatial light modulators 5100, as in the above described projection apparatuses 5020, 5030 and 5040, there is a concern that, if the output time for each color is different, a state in which only a certain color is output is created, resulting in the occurrence of a color break, in which the individual colors R, G and B are singularly visible to some people.

Accordingly, the present embodiment is configured to equip the SLM controller 5530 controlling the spatial light modulators 5100 with the function of controlling the mirror 4003 of the spatial light modulators 5100 to either condition of the changeover between the ON state and OFF state and the intermediate output state, in which the mirror 4003 oscillates between the ON and OFF states.

Further, if the brightness output value to be modulated is no smaller than the brightness output of a case in which the intermediate output state is continued in the entire display period of one frame for each color, the modulation is performed in the combination between the ON state and intermediate output state of the mirror 4003 for the display period of one frame for each color.

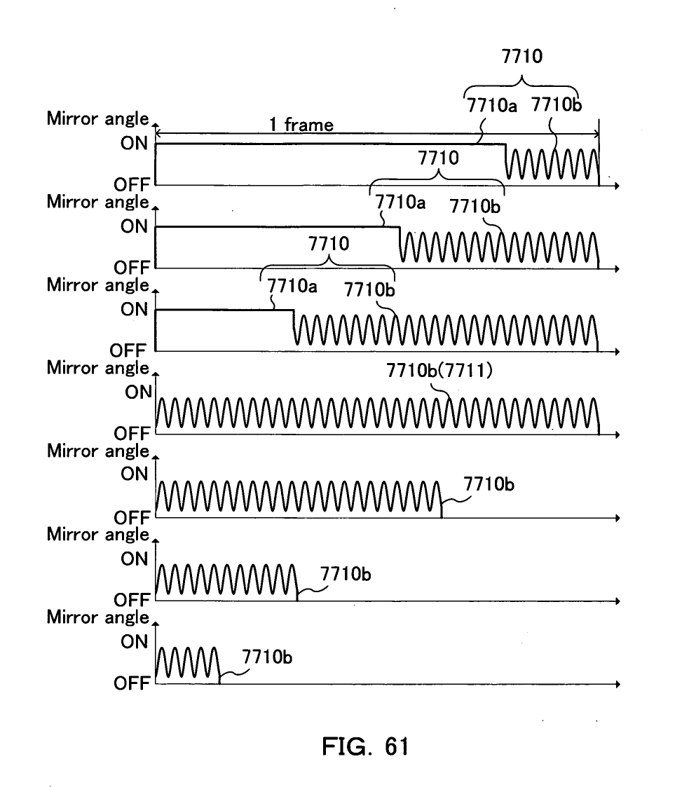

FIG. 61 exemplifies the control for such a countermeasure to a color break. A mirror control profile 7711 drawn at the center of FIG. 61 indicates the case of a brightness output carrying out a mirror oscillation control 7710b in the entire display period of one frame for each color.

Further, the present embodiment is configured to continue to output light in the entire display period of one frame by the combination between a mirror ON/OFF control 7710a and the mirror oscillation control 7710b as indicated by the mirror control profile 7710 on the top side of FIG. 61 in the case in which the brightness output is no less than the mirror control profile 7711.

In contrast, in the case in which the brightness output is no more than the mirror control profile 7711, a required brightness output is attained by controlling a continuation time period of the mirror oscillation control 7710b during the display period of one frame as shown on the lower side of FIG. 61.

The control exemplified in FIG. 61 makes it easy to align the output time for each color, thereby reducing a possibility of the occurrence of a color break in the projection apparatuses 5020, 5030 and 5040, each of which includes a plurality of spatial light modulators 5100.

Note that, if a grayscale control is carried out by controlling the intensity by setting the emission pulse width tp and emission pulse interval ti of the variable light source 5210, as in the above described FIGS. 57, 59, et cetera, the light source control unit 5560 is also capable of performing a control so as to increase the maximum brightness of the variable light source 5210 by selectively narrowing the emission pulse interval ti within a specific unit time during a one-frame period for a frame of a specific condition of the input digital video data 5700 when the output of the illumination light 5600 is modulated by varying the emission pulse interval ti (i.e., the emission interval cycle) of the pulse emission of the variable light source 5210.

As such, the taking advantage of so-called peak brightness of the variable light source 5210 widens the dynamic range of a video image output, thereby making it possible to obtain a further powerful video image.

That is, the configuration is for increasing the peak brightness of the variable light source 5210 by putting it in over-drive only when displaying a scene (i.e., a frame) in which, for example, only a small part of a screen is very bright, or the like scene, as described above because a continuous setup of the maximum brightness will adversely affects the life, et cetera, of the variable light source 5210.

### Embodiment 5

A mirror device can be further miniaturized by reducing the mirror size of a mirror element. As an example, a miniaturized mirror device is constituted by comprising a plurality of mirror elements each consisting of approximate square mirrors of which one side is between about 4 μm and 10 μm. The mirror in this case has an aperture ratio of about 80% or larger and the reflectance of about 80% or higher. Further, the individual mirror elements are configured such that the gap between adjacent mirrors is set at 0.5 μm to 1 μm, with the pitch between the adjacent mirrors set at 4 μm to 10 μm, in order to prevent a pair of reflection light of the adjacent mirrors from interfering with each other. Provided that the structure of an elastic hinge is such as to prevent an interference with the adjacent mirror, the gap between the mirrors may be smaller, such as 0.1 μm to 0.5 μm. If the gap between mirrors is as such, the aperture ratio of the reflection surface of the mirror will be improved to 90% or higher. Furthermore, the energy of the light led through the gap between the mirrors and emitted onto a device substrate will also be decreased.

Then, the diagonally measured size of a mirror array for use in a full high definition (Full HD) television (TV) can be miniaturized to 10.16 mm to 22.098 mm (0.4 inches to 0.87 inches) by arraying a plurality of mirror elements described above.

When about 1 mm, respectively, for a land and the like, which are used for the circuit wiring driving each mirror element, are secured in the mirror array in which the mirror size is miniaturized as described above, the size of the device substrate is approximately as follows.

For a 6 μm pixel pitch and 4: 3 XGA screen, the mirror array is about 7.62 mm (0.30 inches) and the devise substrate is about 10.16 mm (0.4 inches).

For a 7 μm pixel pitch and 4: 3 XGA screen, the mirror array is about 8.89 mm (0.35 inches) and the devise substrate is about 11.43 mm (0.45 inches).

For a 7 μm pixel pitch and 16: 9 Full HD screen, the mirror array is about 15.24 mm (0.6 inches) and the devise substrate is about 17.78 mm (0.70 inches).

For a 9 μm pixel pitch and 16: 9 Full HD screen, the mirror array is about 19.81 mm (0.78 inches) and the devise substrate is about 22.098 mm (0.87 inches).

Enabling a miniaturization of the device substrate in association with the miniaturization of the mirror device reduces the volume of the device substrate. Therefore, an increase in the volume of the device substrate due to thermal expansion is reduced from the device substrate of a 0.95-inch mirror array conventionally used.

In a mirror device, it is possible to prevent undesirable light from being projected by deflecting a mirror to a large deflection angle, for example, between minus 13 degrees and plus 13 degrees. For example, it is possible to change over between the state (i.e., the ON state), in which the reflection light is incident to a projection lens, and the state (i.e., the OFF state) in which the reflection light is not incident to the projection lens. This operation makes it possible to improve the contrast of an image to be projected.

Note that the deflection angle is defined as “0” degrees when the mirror is horizontal, the angle in clockwise direction (CW) is defined as plus (+) and that in counterclockwise direction is defined as minus (−), as reference of the deflection angle of a mirror in the present specification document.

Meanwhile, when using a light flux, such as a laser light source, which has a small diffusion angle of light from the light source and which is approximately parallel, the numerical aperture NA of an illumination light flux can be reduced on the basis of the relationship of etendue, and therefore a mirror size can be reduced. As a result, it is possible to obtain a configuration avoiding the mutual interference between the projection light path and illumination light path, and therefore the deflection angle of the mirror can be reduced to ±10 degrees or smaller. Thus, the changeover between the ON state and OFF state can be carried out by making the deflection angle of the mirror small. Moreover, the adopting of such a deflection angle of the mirror minimizes a decrease in contrast.

Furthermore, reducing the deflection angle to ±10 degrees or smaller makes it possible to lower the drive voltage due to the decrease in distance between the address electrode and mirror on a device substrate.

As an example, when the deflection angle of the mirror in the ON state is +13 degrees and the deflection angle thereof in the OFF state is −13 degrees, with a drive voltage required for deflecting the mirror being 16 volts, a reduction in the deflection angle to ±6 degrees, respectively, decreases the distance between the mirror and address electrode to a half. Specifically, the electrostatic force (i.e., a coulomb force) functioning between the address electrode and mirror when deflecting the mirror is inversely proportional to the second power of the distance between the address electrode and mirror. Therefore, a drive voltage applied to the address electrode will be one quarter of the voltage, that is, 4 volts, when the deflection angle of the mirror used to be ±13. As such, the reduction of the deflection angle of the mirror to ±10 or smaller makes it possible to lower the drive voltage which is to be applied to the address electrode and which is required to deflect the mirror.

The drive voltage applied to the address electrode is lowered by miniaturizing the mirror size to about 4 μm to 10 μm and accordingly decreasing the drive voltage to be applied to the address electrode. This configuration makes it possible to thin the circuit-wiring pattern of the control circuit controlling the mirror. The circuit-wiring pattern can be thinned from, for example, 0.25 μm to 0.13 μm. Rest is unique Then, the deflection of the mirror of which the deflection angle is reduced to ±10 degrees or smaller can be controlled by applying a drive voltage of 5 volts or lower to the address electrode. As a result, the voltage applied to the address electrode can be lowered, as compared to the conventional technique, and thereby the voltage resistance of a transistor constituting the address electrode can be lowered.

Meanwhile, it is also possible to control the intensity of reflection light towards the projection light path by causing the mirror to perform a free oscillation between the deflection angle of the ON state and the OFF state. Controlling the intensity of a light source can improve a gradation.

As an example, let it be assumed that the deflection angle of the ON state is +13 degrees, and the deflection angle in the OFF state is −13 degrees. The ON state and OFF state is frequently changed over by the mirror performing a free oscillation between the deflection angle of the ON state and that of the OFF state. As a result, a lower light intensity can be made to be incident to the projection lens than the intensity when the mirror is maintained in a continuous ON state, in a given period of time. Therefore, the intensity of a projection light can be adjusted by controlling the number of free oscillations and the deflection angle when performing the free oscillation, and thereby, a freely gradated video image can be projected. Note that the mirror can also be put into a free oscillation at other angles, such as ±8 degrees, ±4 degrees, et cetera.

Further, extraneous light irradiated onto the mirror device can be reduced by synchronizing the free oscillation of a mirror with the timing of the emission of a light source. As a result, the heat generation by the light can be effectively reduced.

Next is a description of a laser light source for irradiating the light onto a mirror device.

The laser light source for irradiating light onto a mirror device preferably has a numerical aperture NA of 0.07 to 0.14 and emits the laser light at no less than 3 watts.

The numerical aperture NA has a large effect on the usage efficiency of light and the resolution of a projection optical system. The numerical apertures NA of an illumination light flux and of a projection light flux, in the case where a conventional light source, for example a mercury lamp, is used, is between about 0.18 and 0.24. In contrast, the numerical aperture NA in the case of employing a laser light source can be configured to be the same as (for example, about 0.22 for a 13-degree deflection angle of a mirror) or smaller than the case of the mercury lamp, depending on the deflection angle of the mirror. For example, the NA is 0.14 for an 8-degree deflection angle and the 0.07 for a 4-degree deflection angle.

Further, when using a laser light source, the optical system can be set so as to form a light flux with a numerical aperture of 0.07 to 0.14 in comprehension of a resolution taking into consideration the resolution and a decrease in a modulation transfer function (MTF). As a result, the usage efficiency of light can be improved when using a laser light source versus a mercury lamp. Note that a laser light source rated at about 3 watts to 5 watts is employed for a rear projection system or other similar system, and a high-output laser light source rated at tens watts is employed for a theater-use projection apparatus.

Yet another reason for using a laser light source is a possibility of reducing the problem of etendue by the capability of irradiation with a single wavelength, high directivity and approximately parallel light flux, unlike a mercury lamp and the like. Therefore, the brightness of light can be increased by increasing the intensity, per unit area, of the laser light irradiated onto a mirror device, and therefore the brightness of light will not be reduced even if the mirror array of the mirror device is miniaturized.

Furthermore, a laser light source can be configured to includes an illumination intensity variable circuit and emit an intermediate intensity between the ON light and OFF light. Configuring as such makes it possible to change the intensities of the laser light source. Therefore, the controlling of the laser light source makes it possible to adjust the light intensity to be modulated and reflected by a mirror element in accordance with an image signal. Particularly, the laser light source is preferred to possess an emission state in which an intensity that is 50%, or lower, of the maximum intensity (i.e., the ON light).

Further, a laser light source can be made to perform pulse emission for a predetermined period of time by equipping it with a circuit used for performing the pulse emission of the ON light and OFF light alternately.

For example, the intensity of light can be adjusted in accordance with an image signal (i.e., in accordance with the brightness and/or color (or hue) of the entire projection image) by elongating the interval of the OFF light or elongating that of the ON light, such a control is enabled by making the laser light source perform the pulse emission. Further, the utilizing of the pulse emission makes it possible to turn off the laser light source appropriately when the colors of an image are changed over. Such a configuration enables a reduction in the incidence of light to the mirror device other than is necessary. As a result, it is possible to alleviate a temperature rise due to an extraneous irradiation of light onto the mirror device even a little. Note that dimming of a laser light makes it possible to make the dynamic range of an image variable and darken the entirety of a screen in accordance with a dark image. Considering this, it is preferred to configure the laser light allowing to be turned off at least one time during the display of one frame.

Further, a single laser light source may be constituted by a plurality of sub-laser light sources. Configuring as such and adjusting the number of sub-laser light sources to emit enable an adjustment of the intensity. Note that such a plurality of sub-laser light sources may includes some number of sub-laser light sources, each of which emits a laser light in a desired single wavelength with the tolerance of a few nanometers.

When a mirror device is irradiated with a laser light by such a laser light source, however, the light enters the device substrate as a result of the absorption of the light on a mirror surface and the transmission thereof through the gap between the mirrors. Then, the light is absorbed in the device substrate. As a result, heat is accumulated in the mirror device. The heat causes the thermal expansions of the individual constituent components of the mirror device, shifting the position of a mirror and possibly causing the mirror device to fail to function normally.

What is accordingly provided is a packaging for the mirror device capable of protecting the above described mirror device from a damage and dust, which cause an operation failure, absorbing or transmitting the light diffusely reflected by the mirror device and radiating heat effectively.

Further, if a material of which the coefficient of linear expansion is significantly different from those of other constituent components and circuit wiring pattern, which constitute the mirror device, is used for the package of the mirror device, the package may break or the adhesively-attached components may come apart from each other due to the difference in the coefficients. Therefore, the package uses, for packaging the mirror device, a material of which the melting point is lower than those of the materials used for the constituent components and wiring, which constitute the mirror device, and of which the coefficient is approximately the same. The material for the package includes, for example, transparent glass, silicon, ceramics and a metallic material.

### Embodiment 5-1

A description of the configuration of a package according to a preferred embodiment 5-1 is provided.

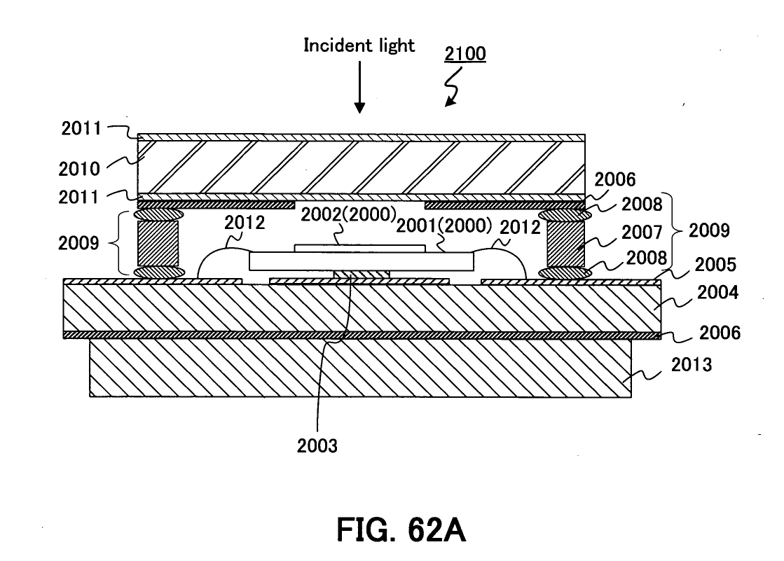

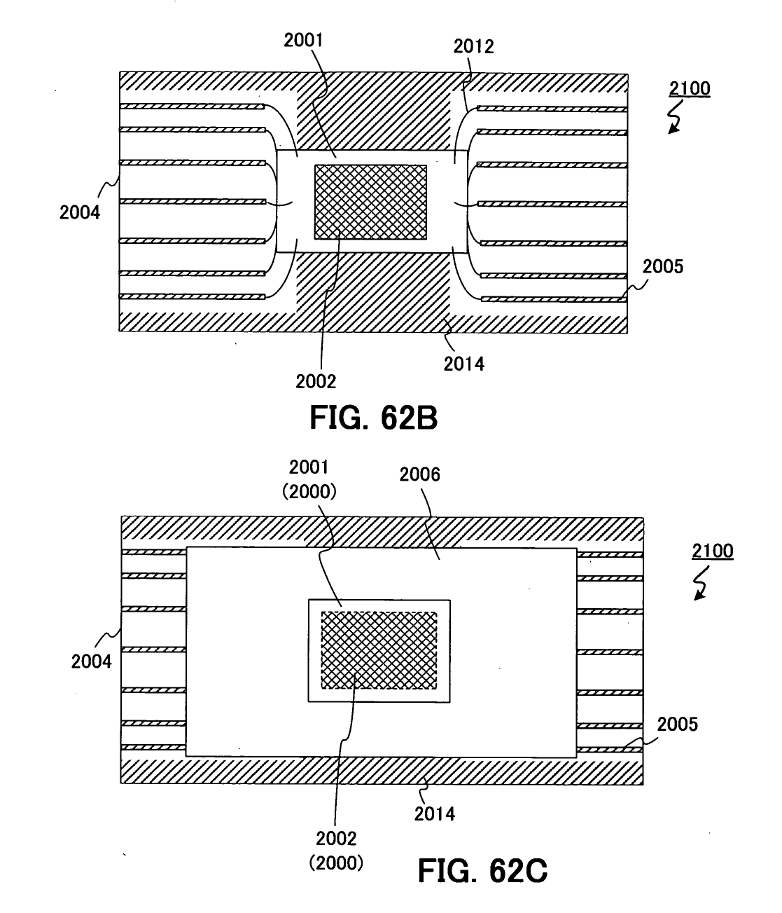

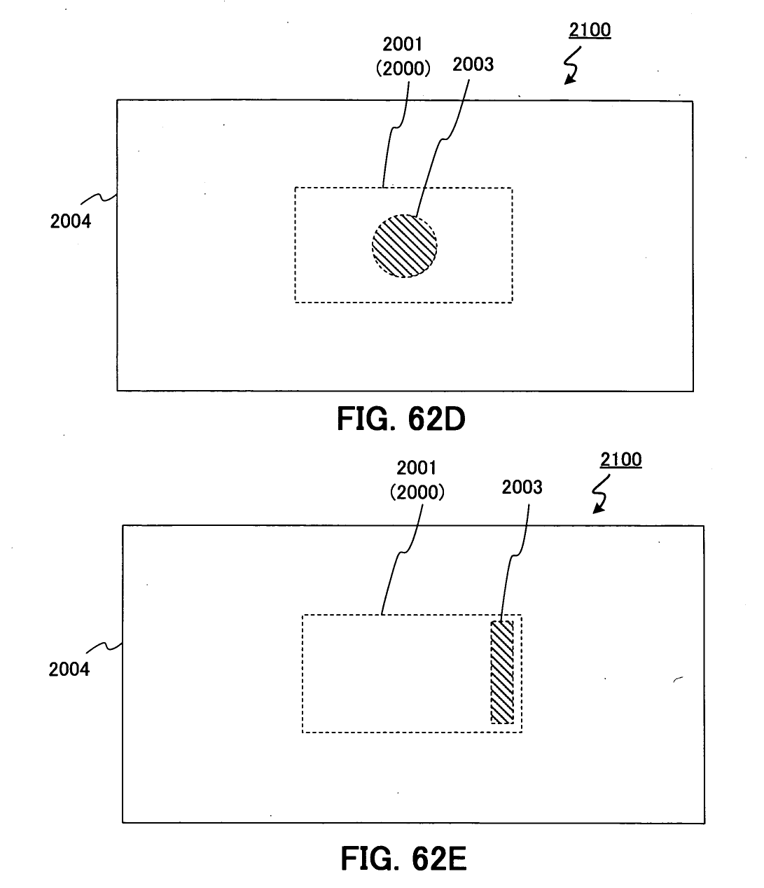

FIGS. 62A, 62B, 62C, 62D, 62E show an assembly body 2100 that packages a mirror device 2000 using glass. FIG. 62A is a front cross-sectional diagram of the assembly body 2100 that packages a mirror device 2000 using glass.

The assembly body 2100 includes a package substrate 2004 constituted by a glass material, a cooling/radiation member (heat sink) 2013, an intermediate member 2009, a thermal conduction member 2003, a mirror device 2000 and a cover glass 2010. Specifically, the “package” represents the formation constituted by the constituent components excluding the mirror device 2000. As an example, the formation constituted by the package substrate 2004 (which is constituted by a glass material), cooling/radiation member (heat sink) 2013, intermediate member 2009, thermal conduction member 2003 and cover glass 2010, which are shown in FIG. 62A, are called the package.

The following is a description of each constituent member of the assembly body 2100 shown in FIG. 62A.

### [Package Substrate]

The package substrate 2004 constituted by a glass material is joined to the cooling/radiation member 2013 used for radiating the conducted heat, to the thermal conduction member 2003 to which heat is conducted, and to the intermediate member 2009 used for creating a sealed space together with the cover glass 2010.

A circuit wiring pattern 2005, which is used for forming an electrical conduction to the device substrate 2001 of the mirror device 2000, and a radiation circuit wiring pattern 2014 (refer to FIG. 62B), which is used for radiating the heat in inside of the package to outside thereof, are formed on the upper surface of the package substrate 2004. A large number of circuit wiring patterns 2005 is thusly placed (i.e., wired) on the upper surface of the package substrate 2004. As a result, the pitch between the individual wiring is narrowed. Therefore, a ground-use wiring is preferably placed between individual wirings to prevent noise between the wirings. Moreover, an insulation layer containing silicon (Si) or the like is preferably coated on the upper surface of the package substrate 2004, and the circuit wiring patterns 2005 is preferably placed on the coated surface.

Incidentally, the “inside of the package” noted in the present specification document represents a space sealing the mirror device 2000. As an example, the space in which the mirror device 2000 is sealed by the package substrate 2004, cover glass 2010 and intermediate member 2009 is called an “inside of the package” in FIG. 62A.

Further, a light shield layer 2006 used for absorbing extraneous light, which has transmitted the upper surface of the package substrate 2004, is placed on the bottom surface of the transparent package substrate 2004 that is made of a glass material. It is easy to radiate heat to the outside by equipping the light shield layer 2006, which is capable of absorbing extraneous light and which has good thermal conductivity, on the bottom surface of the package substrate 2004 as described above.

Further, a cooling/radiation member (heat sink) 2013 comprising a radiation plate formed with a fan and a metallic radiation member can possibly be joined onto the bottom surface of the package substrate 2004 in order to radiate the heat conducted from the package substrate 2004 to the outside efficiently.

Note that the wider the surface area of the package substrate 2004, the further the radiation can be improved.

Further, a glass material for the package substrate 2004 is preferred to use a material with better thermal conductivity. For example, soda ash glass with the thermal conductivity being about 0.55 to 0.75 W/mK, and Pyrex (a registered trademark; used to be manufactured by Corning, Inc.; now by World Kitchen, LLC) exceeding 1 W/mK, are available.

Further, the package substrate 2004 may be made of, silicon, ceramics, metal or a composite body of these materials, in addition to being made of glass.

### [Circuit Wiring Pattern and Radiation Circuit Wiring Pattern]

The circuit-wiring pattern 2005 is the wiring of a control circuit for controlling the mirror device 2000 and is electrically connected to the device substrate 2001.

The radiation circuit-wiring pattern 2014 fills the role of radiating the heat inside of the package to the outside.

The radiation circuit wiring-pattern 2014 having large wiring widths is placed across inside and outside of the package on the package substrate 2004. Such a configuration makes it possible to radiate the heat in the inside of the package to the outside by way of the radiation circuit wiring-pattern 2014. The heat can also be radiated by way of the circuit wiring-pattern 2005 having a large number of small-width wirings.

Considering radiation, a metallic material constituting the radiation circuit wiring-pattern 2014 preferably uses tungsten (W), aluminum (Al), gold (Au), silver (Ag), copper (Cu), silicon (Si) or magnesium (Mg), with 150 W/mK or higher thermal conductivity. Incidentally, these metallic materials can be used as thermal conductive members.

Further, the radiation circuit wiring pattern 2014 will serve a double purpose, i.e., radiation and electrical connection, which aims at removing noise from the device substrate 2001.

When driving the mirror device 2000 comprising mirror elements of one million to four million pixels, or more, in high-level gray scale such as 10 bits, there is a very large number of data. Therefore, a high-speed data transfer is required. The resistance value on a circuit wiring and the floating capacity of a capacitor greatly affect the data transfer. Considering this, the circuit wiring pattern 2005 preferably uses a material with a small resistance value in the temperature range 0° through 100° C., for example, aluminum (2.5 to 3.55*10⁻⁸ Ωm), tungsten (4.9 to 7.3*10⁻⁸ Ωm), gold (2.05 to 2.88*10⁻⁸ Ωm) and copper (1.55 to 2.23*10⁻⁸ Ωm).

### [Cooling/Radiation Member]

The cooling/radiation member (heat sink) 2013 fills the role of externally radiating the heat conducted from the package substrate 2004 and the like.

The cooling/radiation member 2013 is constituted by, for example, a radiation plate formed with one or a plurality of fans or a metallic radiation member. The metallic radiation member may be attached directly to the bottom surface of the package substrate 2004 or may be attached to another member made of a material of which a coefficient of linear expansion is approximately the same as that of the package substrate 2004. Moreover, the cooling/radiation member 2013 may be thermally connected to the package substrate 2004 by way of a Via by penetrating with a metallic Via or embedding it.

Further, a metallic cooling/radiation member 2013, made as a black light shield layer, may be formed on the bottom surface of the package substrate 2004. Such a configuration serves dual functions as light shield and radiation.

### [Intermediate Member (Support Member)]

The intermediate member 2009 is placed on the top surface of the package substrate 2004 and fills the role of supporting the cover glass 2010 for providing a sealed space between the package substrate 2004 and cover glass 2010, or the role as a member for joining the respective constituent components.

Dust may sometimes be attached to the product in the production process of the mirror device 2000 or that of the projection apparatus comprising it. If the dust or the like attached to the top or bottom surface of the cover glass 2010 is projected, the quality of the projection image will be damaged. Therefore, when a sealed space is provided between the package substrate 2004 and cover glass 2010, the intermediate member is preferred to be designed in such a manner so that the distance between the top surface of the mirror of the mirror device 2000 and the cover glass 2010 is no less than several in the edit, she says “seven” times a depth of focus of a projection optical system. For example, the intermediate member is preferred to be designed such that the distance between the top surface of the mirror of the mirror device 2000 and cover glass 2010 is no less than 0.5 mm.

Moreover, configuring the thickness of the cover glass 2010 to be 1 mm to 3 mm makes it possible to make a projected dust attached to the surface of the cover glass 2010 inconspicuous should the dust be projected.

The intermediate member 2009 is constituted by a support member 2007 for determining the height of the cover glass 2010 and by a seal material 2008 made of fritted glass (i.e., granulated glass), epoxy resin, or a low melting point metallic material such as solder. Note that the support part 2007 may use fritted glass or the same material as that of the seal member 2008. Further, the package substrate 2004 may be configured as a cavity form and as a formation by integrating the package substrate 2004 with the intermediate member 2009.

The cover glass 2010 is joined to the package substrate 2004, which is made from a glass material, by welding with the fritted glass (i.e., granulated glass) which is the seal member 2009, or with epoxy resin or a low-melting point metallic material such as solder, which is the seal member 2008. For example, the fritted glass is coated, as the seal member 2008, on the joinder surface between the package substrate 2004 and support part 2007. Then, they are put into a furnace such as an electric furnace. Then, the joinder surface is sandwiched from the top and bottom with a hot heater or the like and is welded, and thereby the joining is accomplished.

In particular, the seal member 2008 is preferred to use glass with a low-melting point, i.e., the glass transition temperature being no higher than 400° C., or a metallic material with a melting point being no higher than 400° C. The reason is that an aluminum circuit wiring and the like are formed on the device substrate 2001 in a semiconductor process, and that the constituent components of the device substrate 2001 is unable to withstand the temperature of no lower than 400° C. for an extended period of time.

For example, the mirror of a mirror element is made of an aluminum layer of the thickness of about 1500 angstroms to 3000 angstroms and is supported by an elastic hinge of 200 angstroms to 700 angstroms thick. The elastic hinge also uses aluminum or the like. Therefore, the mirror and elastic hinge alike are unable to withstand a temperature of no lower than 400° C. for an extended period of time, likewise the aluminum circuit wiring. If a temperature of no lower than 400° C. continues for an extended period of time, the heat will cause the internal stress of the elastic hinge to be changed because the gap between the individual mirrors of the mirror array 2002 is very narrow, e.g., 0.1 μm to 0.5 μm. As a result, the positions of the mirror may be changed to possibly lose the function of the mirror device.

Further preferably, the seal member 2008 uses a low-melting point glass with the glass transition temperature no higher than 300° C. or a metallic material with the melting point no higher than 300° C. The usage of such a low-melting point material makes it easy to carry out welding.

Low-melting point glass includes seal member made of, for example, fritted glass. While the fritted glass allows different melting points and thermal expansion, depending on the material; generally used in many cases include barium oxide (BaO)-series and lead oxide (PbO)-series lead glass with good fluidity and sealing property.

Further, glass not including lead, that is, unleaded glass, with a glass transition temperature between 300° C. and 400° C. has been developed in recent years. The unleaded glass includes a material obtained, for example, by adding TeO₂ or P₂O₂ to, a V₂O₅—ZnO—BaO component-series material. The coefficient of linear expansion of this material, i.e., about 6- to 7*10⁻⁶/K, has good fluidity and sealing property.

Several materials with a melting point between about 200° and 400° C. are available as a low-melting point metallic material. For example, an Au 80-Sn 20 alloy has a melting point between about 260° and 320° C. In addition, an alloy such as Sn 80-Ag 20 that is a tin series high-temperature solder has a melting point between 220° and 370° C., and likewise, Sn 95-Cu 5 has a melting point between 230° and 370° C. Further additionally, indium (In) has a melting point about 157° C.

The use of the seal member 2008 made of the above described low melting point material makes it easy to carry out welding.

The intermediate member 2009 is preferred to use a material possessing a coefficient of linear expansion approximately the same as that of a non-alkali glass such as the material used for the package substrate 2004 and that of a silicon substrate used for the device substrate 2001, or a material possessing a coefficient of linear expansion between the aforementioned those coefficients of linear expansion.

Meanwhile, the package substrate 2004 may be configured to have a cavity structure comprising the support parts 2007 that constitute walls on four sides. Then, a use of a material, which is similar to that of the package substrate 2004, for the support parts 2007 makes it possible to reduce the constituent components of the package, which require a consideration for the coefficient of linear expansion.

In such a case, the device substrate 2001 is placed by providing, with a concave part, the center part of the package substrate 2004, in which the device substrate is placed by applying etching. Further, the protrusion parts on four corners, on which the device substrate 2001 is placed, can be used as the support parts 2007.

Furthermore, the package substrate 2004 may be constituted by the same silicon material as that of the device substrate 2001. In such a case, the package substrate 2004 is opaque and has the same coefficient of linear expansion as the device substrate 2001 does. The using of a silicon material as such makes it easy to make the package substrate a cavity structure. Further, the center part of the package substrate 2004 made of a silicon material can be etched in the semiconductor process. Further, a cavity structure can be formed by depositing a silicon material or the like on the package substrate 2004 made of a silicon material. The silicon material may use an 8-inch- to 10-inch silicon wafer for use in a semiconductor process. Although the package substrate 2004 may be constituted by an inexpensive glass material, the use of such a silicon material makes it easy to handle for forming a three-dimensional cavity. Furthermore, the package substrate 2004 may use a ceramic material when forming a three-dimensional form using a mold. Moreover, the package substrate 2004 may use a metallic material.

The package according to the present embodiment is configured to join the cover glass 2010 with the package substrate 2004, which includes the miniaturized mirror device, by using the seal member 2008. Further, the seal member 2008 for the joinder parts uses a material most suitable in terms of the coefficient of linear expansion and melting point, thereby enabling the most optimal package.

### [Thermal Conduction Member]

The thermal conduction member 2003 is joined to the device substrate 2001 and package substrate 2004. Further, the thermal conduction member 2003 fills the role of receiving heat, and the like, generated by the light irradiated on the device substrate 2001 following its passing the gap between mirrors of the mirror device 2000 and conducting the heat to the radiation circuit wiring pattern 2014 and package substrate 2004, thereby mediating for externally radiating the heat.

Referring to FIG. 62A, the light absorbed in the surface of the mirror and the light passing through the gap between mirrors and absorbed by the device substrate 2001 are turned into heat. Then, the heat is conducted to, and radiated from, the top surface of the package substrate 2004 that is joined with the thermal conduction member 2003 by way of the thermal conduction member 2003 that is joined to the bottom surface of the device substrate 2001. In this case, the thermal conduction member 2003 can also fill the role of the radiation circuit wiring-pattern 2014.

The thermal conduction member 2003 uses a material possessing a good thermal conductivity to the device substrate 2001 and package substrate 2004. It is particularly preferred to use a material containing a substance (e.g., tungsten, silicon, aluminum, gold, silver and magnesium) with the thermal conductivity of no less than 150 W/mK. Note that the silicon (Si) that is the primary element constituting the device substrate 2001 possesses thermal conductivity of 168 W/mK.

Furthermore, the thermal conduction member 2003 is preferred to select a material also in consideration of a coefficient of linear expansion. For example, at the ambient temperature (i.e., 20° C.), tungsten possesses the coefficient of linear expansion of 4.5*10⁻⁶/K, while tantrum possesses that of 6.3*10⁻⁶/K. Further, a tungsten silicide, which is produced by the reaction between tungsten and silicon (Si), and a tantrum silicide, which is produced by the reaction between tantrum and Si, possess the coefficients of linear expansion close to that of the material used for the device substrate 2001, which contains Si possessing the coefficients of linear expansion being 2.6*10⁻⁶/K, or close to the coefficient of linear expansion of the package substrate 2004 made of a silicon material or glass material. Therefore they are suitable to the thermal conduction member 2003.

### [Mirror Device]

The mirror device 2000 is primarily constituted by the device substrate 2001 and mirror array 2002. Further, the mirror device 2000 is placed on the thermal conduction member 2003 joined with the package substrate 2004 or directly thereon.

In FIG. 62A, the bottom surface of the device substrate 2001 of the mirror device 2000 is joined with the thermal conduction member 2003, and the thermal conduction member 2003 joined with the mirror device 2000 is placed on the package substrate 2004. Then, an electrode pad formed on the top surface of the device substrate 2001 is connected, by a wire 2012, to an electrode formed in the circuit wiring-pattern 2005 on the top surface of the package substrate 2004.

For example, the material for the wire 2012 is preferred to be a high-thermal conductive material, such as gold, so that the heat of the device substrate 2001 can also be radiated through the wire 2012.

Further, the mirror array 2002 constituted by arraying a plurality of mirror elements, in two dimensions, on the device substrate 2001 fills the role of reflecting the light emitted from a light source, and then transmitting through the cover glass, and of controlling the direction of the reflection light.

The heat of the light absorbed in the individual mirrors of the mirror array 2002 is conducted to the device substrate 2001 by way of the structures such as elastic hinge and post, which constitute the mirror element. Then, the heat is conducted from the device substrate 2001 to the thermal conduction member 2003, and then radiated to outside of the package from the package substrate 2004 and other members. Therefore, the elastic hinge and post are preferred to use a material possessing high thermal conductivity.

For example, the elastic hinge, which is formed to be a few hundred angstroms thick and a few micrometers wide, is preferred to use a material containing any of Al, W and Si, which possess good thermal conductivity, in order to prevent a deformation due to the heat. As the good thermal conductivity material, particularly a silicon material possessing thermal conductivity of 168 W/mK, an aluminum material of about 236 W/mK and the like are appropriate.

Specifically, a silicon material is available in several crystallization states such as amorphous silicon, poly-silicon and single crystal silicon, from which the most optimal material is preferably to be selected in consideration of a property such as a modulus of elasticity.

Further, in consideration of thermal conduction, other members linked to the elastic hinge are preferred to use a material possessing thermal conductivity being at least 150 W/mK.

Therefore, it is possible to conduct the heat of the light absorbed in the mirror and the heat generated by the operation of the mirror element effectively to the device substrate 2001 by selecting the material described above for the elastic hinge or the member linked thereto. Accordingly, this configuration is capable of radiating heat from the device substrate 2001 to the outside by way of the thermal conduction member 2003 and the related components.

### [Cover Glass]

The cover glass 2010 is designed to be smaller than the package substrate 2004 so as to cover the upper side of the mirror device 2000, and is joined to the package substrate 2004 using the intermediate member 2009. The cover glass 2010 mainly fills the roles of protecting the mirror device 2000 from external dust, shielding extraneous incident light so as to prevent the extraneous incident light from entering the mirror device 2000 and generating heat within the package, and of preventing the light reflected by the mirror array 2002 from reflecting diffusely within the package.

An anti-reflection (AR) coating 2011 is applied to the top and bottom surfaces of the cover glass 2010 and thereby the light reflected by the top surface of the cover glass 2010 is not reflected toward the projection lens. Further, the AR coating 2011 prevents the light reflected by the mirror array 2002 from being further reflected by the bottom surface of the cover glass 2010 and thereby a diffuse reflection of the light is prevented.

Further, either one of the top and bottom surfaces of the cover glass 2010, or both surfaces thereof, are partially formed with the light shield layer 2006 for preventing extraneous light from entering the mirror device 2000. In FIG. 62A, the light shield layer 2006 is formed on the bottom surface of the AR coating 2011, which is applied to the bottom surface of the cover glass 2010.

While a cover glass is placed in the form of nearly touching a liquid crystal layer in a liquid crystal device; in a mirror device, a cover glass is preferred to be placed by maintaining the distance of, for example, 1 mm to 5 mm between the mirror and the bottom surface of the cover glass. Such a setup makes it possible to allow a certain degree of freedom for the roughness of the cover glass surface. For example, the roughness, about 0.15 μm to 0.3 μm/20 mm, of the bottom surface of the cover glass is permissible. Further, the cover glass surface may be polished to about 0.05 μm to 0.15 μm/20 mm.

### [Anti-Reflection (AR) Coating]

An anti-reflection (AR) coating 2011 is applied to either one of the top and bottom surfaces of the cover glass 2010, or both surfaces thereof, for preventing a reflection on the surface of the cover glass 2010 and preventing the light reflected by the mirror array 2002 from diffusely reflecting internally within the package.

The AR coating 2011 can be applied, for example, by coating magnesium fluoride (Mg₂F) on a glass surface, or applying a processed glass material as a nano-structure. This can produce the reflectance of an incident light to be no higher than 0.4%.

A coating on a glass surface applies a multi-coating so as to eliminate dependence on various wavelengths and the incident angle. Note that a multi-coating corresponding to wide wavelength range is also viable.

When processing a nano-structure, fine particles are layered with a gelatinous material and then metallic particles are thermally removed, and thereby a fine form can be formed. Note that the adopting of the method for processing a nano-structure makes it possible to make the layer respond to a wide wavelength range easier than the multi-coating layering an inorganic material is.

The application of such AR coating 2011 reduces the reflection light intensity oriented to the projection lens from the cover glass 2010, thereby improving a contrast. Further, a large volume of light is incident to the mirror array 2002. Considering this fact, the AR coating 2011 is preferred to be applied so as to lower the reflection of the wavelength of the incident light.

Meanwhile, the intensities of light incident to the device substrate 2001 or package substrate 2004 of the mirror device are changed depending on the AR coating 2011 and the aperture ratio and reflectance of the mirror of a mirror element.

For example, when using a mirror, of which the aperture ratio is 80% and the reflectance is 80%, with the mirror reflecting 1% by means of the AR coating, then about 58% of the incident light is reflected by the mirror, and the remaining 42% of the light enters the device substrate or package substrate.

When using a mirror, of which the aperture ratio is 90% and the reflectance is 85%, with the mirror reflecting 0.4% by means of the AR coating, then about 73% of the incident light is reflected by the mirror, and the remaining 27% of the light enters the device substrate or package substrate.

Based on the above, a package can possibly be designed to attain an intensity of light incident to the device substrate of package substrate in a range of approximately 27% to 42%.

In a projection apparatus comprising the mirror device 2000 of which the mirror size is, for example, 11 μm, the illumination lights of the respective colors, that is, red (R), green (G) and blue (B), are modulated by the mirror array 2002 corresponding to image signals to project a color image. In such a projection apparatus, some apparatus makes the image brighter by enhancing the intensity of green light (G) even by unbalancing the other colors respective colors of R, G and B. In such a case, the image can be made brighter effectively by providing the most optimal AR coating 2011 for the green light.

In the meantime, a multi-panel projection apparatus comprising a plurality of the mirror devices 2000 corresponding to a plurality of illumination lights such as R, G and B is preferred formed with AR coatings 2011, in multi-coating or single layer coating, which are most optimal to the respective illumination lights.

Further, if a light source used for a projection apparatus is another light source such as a mercury lamp and the like, the numerical aperture NA of the light is larger than that of a laser light source and the light contains many wavelengths as green light. In such a case, the deflection angle of a mirror of the mirror device 2000 is set, for example, at ±13 degrees. When there is this degree of difference in angles of the deflection angle between the incident light and reflection light on the basis of the deflection angle of the mirror, the dependence on the incident angle is reduced by applying a multi-coating by considering the optical path lengths of the incident light and reflection light passing through the cover glass.

In contrast, in the case of a laser light source, the numerical aperture NA is smaller than that of a mercury lamp and the light has a single wavelength, and therefore the deflection angle of the mirror of the mirror device 2000 can be reduced to the range of ±4 degrees and ±8 degrees. Therefore, the angular difference between the incident light and reflection light can be reduced from the case of using the mercury lamp. As a result, the optical path lengths of the incident light and reflection light passing through the cover glass can be shortened from the case of using the mercury lamp. Therefore, a sufficient effect can be obtained by applying a single layer coating of the thickness of ¼ wavelength of the incident light so as to optimize it with the wavelength of the incident light.

Furthermore, when the deflection angles of a mirror in the ON state and OFF state are respectively ±13 degrees, the total deflection angle of the mirror is 26-degree. Specifically, if the deflection angle is reduced to the range of ±4 degrees and ±8 degrees, the total deflection angle is reduced to the range of ±8 degrees and ±16 degrees. This configuration makes it possible to reduce the difference in light transmission between the incident light and reflection light passing through the AR coating 2011 provided on the cover glass.

### [Light Shield Layer]

The light shield layer 2006 fills the role of absorbing the extraneous light irradiated onto the mirror device 2000 and the undesirable light reflected by it, thereby increasing a temperature within the package.

In the configuration of FIG. 62A, the light shield layer 2006 is formed on the bottom surface of the package substrate 2004. Further, the light shield layer absorbs a portion of the light passing inside of the package, thereby improving the radiation efficiency to the outside thereof.

The light shield layer 2006 is constituted by, for example, a black film layer containing carbon, or by a multiple layer comprising a black film layer and a metallic layer. Alternatively, a layer to well pass light may be formed by applying a film coating with the AR coating 2011.

### [Cover Glass and Package Substrate]

The material for the cover glass 2010 and package substrate 2004 can use glass. Any of non-alkali glass, which is used for a thin-film transistor (TFT) liquid crystal, et cetera, and in which an alkali component is limited to 1% or less, soda ash glass, used for a super twist nematic (STN) liquid crystal, et cetera, and high strain point glass used for a plasma display, et cetera, may be used. A circuit and glass, however, are practically in touch with each other in a liquid crystal, et cetera, and therefore a protective film made of SiO₂ needs to be provided on a glass surface for preventing the elution of an alkali component from the glass if the soda ash glass is used.

As an example, Laid-Open Japanese Patent Application Publication No. 2006-301153 has disclosed that a material possessing the coefficient of linear expansion of 10*10⁻⁶/K is used for a support member of a diffraction grating type device filled in a protective member. In contrast, the present embodiment is configured to use a material possessing a coefficient of linear expansion smaller than 10*10⁻⁶/K in order to widen a limit range of the temperatures of environment in which the mirror device is used. Although there are various types of non-alkali glass, the coefficients of linear expansion of many types fall in 4.6- to 4.8*10⁻⁶/K, with some of them falling in 3.7- to 3.8*10⁻⁶/K. Meanwhile, common soda ash glass and high strain point glass fall in 7.8- to 8.5*10⁻⁶/K. Furthermore, Laid-Open Japanese Patent Application Publication No. H11-116271 has disclosed a fritted glass of which the coefficient of linear expansion falls in about 7.2- to 9*10⁻⁶/K. Among the above described, the glass to be used for the cover glass 2010 and package substrate 2004 is preferred to possess the coefficient of linear expansion between 3.5-8.5*10⁻⁶/K.

Further, the device substrate 2001 of the mirror device 2000 is cut from a wafer made of a single crystal silicon material. The coefficient of linear expansion of silicon (Si) that is the main component of the device substrate 2001 is 2.6*10⁻⁶/K at normal temperature (20° C.). Specifically, if non-alkali glass possessing the coefficient of linear expansion of 3.5- to 4.8*10⁻⁶/K is used for the cover glass 2010 and package substrate 2004, the difference in coefficients of linear expansion between them and device substrate 2001 is small. Furthermore, if the coefficient of linear expansion of the intermediate member 2009 is also the same as that of the cover glass 2010 and package substrate 2004, it is preferable since a sufficient permissible stress exists against the deformation of the member due to temperature. Therefore, it is preferable to use the material(s) possessing approximately the same coefficient of linear expansion for the cover glass 2010 and package substrate 2004, and it is further preferable to use a material possessing a coefficient of linear expansion of no higher than 5*10⁻⁶/K.

Further, it is also possible to equalize the thermal influence on the glass on the top and bottom by configuring both the thickness of the cover glass 2010 and that of the package substrate 2004, which is made of glass, between 1 mm and 3 mm.

### [Spade Inside of Package]

The space inside of the package may be filled with a gas, or vacuum. If the space is filled with a high thermal conductivity gas, the radiation efficiency is improved since the heat is easily transferred to the individual constituent components of the package. Heat transfers (to the individual constituent components of the package) are improved by filling the space with, for example, an inert gas such as a nitrogen gas. Note that the thermal conductivity of the nitrogen gas is 2.4*10⁻² Wm/K that of a helium gas is 14.2*10⁻² Wm/K, and that of a xenon gas is 0.52*10⁻² Wm/K.

FIG. 62B is a top view diagram of the assembly body 2100 shown in FIG. 62A, with the cover glass 2010 and intermediate member 2009 removed.

The mirror array 2002 is placed on the device substrate 2001. Further, the device substrate 2001 is connected, via the wire 2012, to the circuit wiring-pattern 2005 placed on the package substrate 2004.

The thermal conduction member 2003 (not shown in this drawing) is placed on the bottom surface of the device substrate 2001, and the configuration is such that the heat is conducted from the thermal conduction member 2003 to the package substrate 2004 and radiation circuit wiring pattern 2014, and is radiated to outside of the package.

FIG. 62C is a top view diagram of the assembly body 2100 shown in FIG. 62A. The comprising of the cover glass 2010 and intermediate member 2009 on the upper side of the assembly body 2100 (cf. FIG. 62B) enables the light shield layer, which is applied to the bottom surface of the cover glass 2010, to absorb the light irradiated onto regions other than the mirror array 2002. The configuration further makes it possible to radiate the heat inside of the package from the radiation circuit wiring pattern 2014 extending from the inside to outside of the package.

FIGS. 62D and 62E are bottom view diagrams of the assembly body 2100 shown in FIG. 62A. Incidentally, the delineation of the cooling/radiation member (heat sink) 2013, light shield layer 2006 and circuit wiring pattern 2005 is omitted here for drawing the form of the thermal conduction member 2003. The form of the thermal conduction member 2003 is arbitrary and so is the position of the device substrate 2001. The form and placement of the thermal conduction member 2003, however, need to consider the change in shapes due to thermal expansion, since the thermal conduction member 2003 is closely placed with the device substrate 2001.

As an example, FIG. 62D exemplifies the case of placing the columnar thermal conduction member 2003 at the center of the bottom surface of the device substrate 2001.

Adding heat to such a columnar thermal conduction member 2003 generates thermal expansion so that the thermal conduction member 2003 expands in the form of a concentric column. This phenomenon causes the positions of the device substrate 2001 placed on the thermal conduction member 2003 to change, further creating a change of the positions of a mirror of the mirror array 2002. The configuration, however, is contrived in such manner that columnar thermal conduction member 2003 deforms at the center of the device substrate 2001 and therefore a shift in the optical axis at the center of the screen can be limited to a minimum. Further, the device substrate 2001 is stabilized by placing the thermal conduction member 2003 at the center of gravity position of the device substrate 2001, which is the center thereof.

In FIG. 62E on the other hand, a rectangular-shaped thermal conduction member 2003 is placed in line with the bottom surface of the device substrate 2001. Such a configuration makes the other side of the device substrate 2001 a free end. Therefore, if the device substrate 2001 and package substrate 2004 are expanded by the heat, an influence caused by different degrees of expansion between the device substrate 2001 and package substrate 2004 on either of them can be alleviated. This fact widens a degree of freedom in selecting a glass material and broadens the temperature range of the environment in which the device substrate is used.

Note that one piece of the thermal conduction member 2003 is preferred to be placed for a part of one piece of the device substrate 2001. The reason is that a placement of a plurality creates a need to consider the degrees of deformation of those thermal conduction members 2003.

### Embodiment 5-2

A package according to an embodiment 5-2 is a modified embodiment of that of the embodiment 5-1.

The package according to the embodiment 5-2 has a separate package substrate, or the package substrate has an opening part, which is the difference from the package of the embodiment 5-1. Further, the package improves radiation efficiency by placing the opening part of the package substrate so that the opening part is under the mirror device. It is configured to generate a sealed space by joining the package substrate 2004, which has an opening part including the circuit wiring pattern 2005, and the bottom part of the device substrate 2001 by means of welding a seal member 2008 (e.g., a solder) of an intermediate member, and thereby the inside of the package is isolated from the outside.

The other comprisals of the embodiment 5-2 are similar to the embodiment 5-1 and therefore the description is not provided here.

Further, a thermal conduction member is connected to the bottom surface of the device substrate of the mirror device, and thereby heat can be externally radiated from the device substrate by way of the thermal conduction member. Note that the comprisal may exclude the thermal conduction member.

Furthermore, the radiation efficiency can also be improved by comprising a cooling/radiation member (heat sink) formed with fins in the opening part of the package substrate.

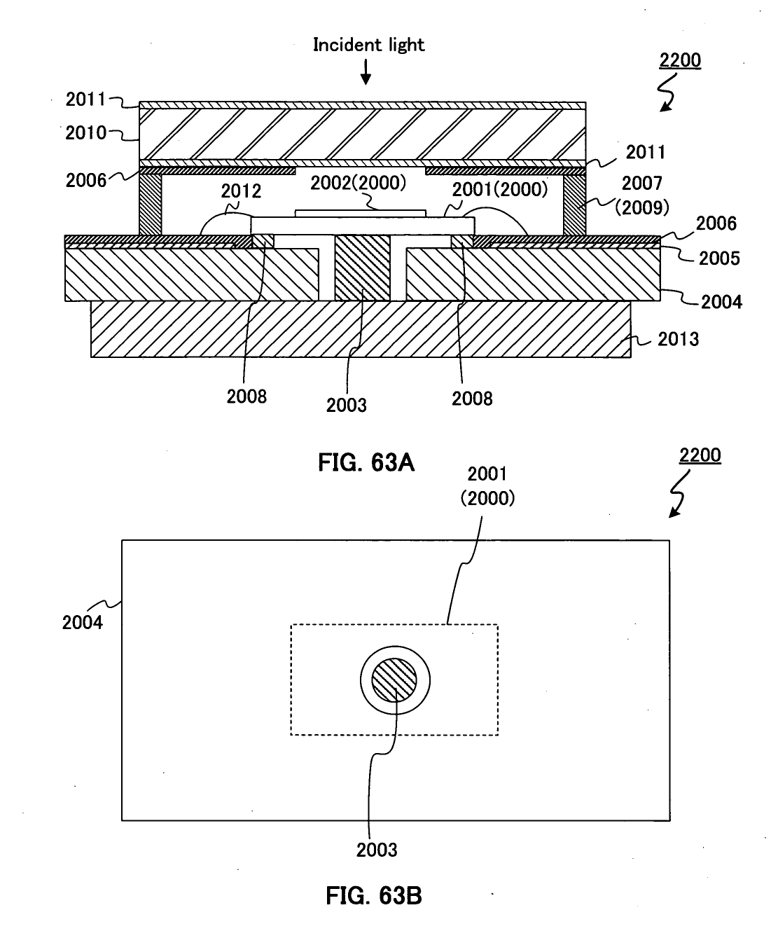

FIGS. 63A and 63B show an assembly body 2200 that packages a mirror device 2000 by using a package substrate 2004 having an opening part, as a preferred embodiment 5-2.

FIG. 63A is the front cross-sectional diagram of the assembly body 2200 that packages the mirror device 2000 by using the package substrate 2004 having an opening part.

In the assembly body 2200 shown in FIG. 63A, the package substrate 2004 has an opening part, and a thermal conduction member 2003 joined to the mirror device at the center of the opening part is placed. The present embodiment is configured to join the top surface of the thermal conduction member 2003 to a device substrate 2001 and join the bottom surface of the thermal conduction member 2003 to a cooling/radiation member (heat sink) 2013. Configuring as such makes it possible to externally radiate the heat from the device substrate 2001 directly without an intervention of the package substrate.

The present embodiment includes a space between the opening part of the package substrate 2004 and the thermal conduction member 2003. It is also possible to radiate from such a space by way of the thermal conduction member 2003 and cooling/radiation member (heat sink) 2013. An alternative configuration may be such that a space is not provided between the thermal conduction member 2003 and the opening part of the package substrate 2004, that is, the opening part of the package substrate 2004 is joined by the thermal conduction member 2003.

The present embodiment is further configured such that a light shield layer 2006 is overlapped on the top surface of the package substrate 2004 including a circuit wiring-pattern 2005. The equipping of the light shield layer 2006 on the top surface of the package substrate 2004 enables an instant absorption of the light that is incident to inside of the package and not reflected by the mirror array 2002. As a result, a diffuse reflection of light can be suppressed. Further, the heat accumulation efficiency of the circuit wiring pattern 2005 existing under the light shield layer 2006 is improved and the radiation to the outside of the package is improved.

The light shield layer 2006 is made of, for example, a black material containing carbon. Further, an insulation layer (not shown in a drawing herein) is preferred to be placed between the circuit wiring pattern 2005 and light shield layer 2006.

FIG. 63B is the bottom plain view diagram of the assembly body 2200 shown in FIG. 63A. Note that the drawing omits the cooling/radiation member (heat sink) 2013, light shield layer 2006 and circuit wiring pattern 2005 for showing the opening part of the package substrate 2004.

The columnar opening part exists at the center of the package substrate 2004, and the columnar thermal conduction member 2003, which has a similar figure to the opening part and which is connected to the bottom surface of the device substrate 2001, is formed at the center of the opening part. Note that the forms of the opening part and thermal conduction member 2003 are not limited as described above.

In FIG. 63B, the package substrate 2004 does not contact with the thermal conduction member 2003 so that there is a space between them. Further, the top surface of the thermal conduction member 2003 is connected to the bottom surface of the device substrate 2001, and the bottom surface of the thermal conduction member 2003 is connected to the cooling/radiation member (heat sink) 2013 (not shown here).

Configuring as such makes the thermal conduction member 2003 exposed to outside of the package, thereby making it possible to radiate the heat received from the device substrate 2001 without an intervention of the package substrate.

Further, it is easy for the device substrate 2001 to absorb light by being formed with the light shield layer (not shown here). As a result, the heat accumulation in the device substrate 2001 is improved; and the thermal conduction from the device substrate 2001 to the thermal conduction member 2003 is improved by a larger difference in temperatures between the device substrate 2001 and thermal conduction member 2003.

As described above, the use of the package as shown in FIGS. 63A and 63B enables an improvement in the radiation efficiency.

### Embodiment 5-3

A package according to an embodiment 5-3 is a further modified embodiment of that of the embodiment 5-1.

The package according to the embodiment 5-3 differs from the package of the embodiment 5-1 where the former includes a substrate which is made of a silicon material, a metallic material or a ceramic material and which has a cavity. It is further configured to form an electrical connection between a device substrate and a cover glass by equipping it with a circuit wiring-pattern. The other comprisals of the embodiment 5-3 are similar to those of the package according to the embodiment 5-1, and therefore the description is not provided here.

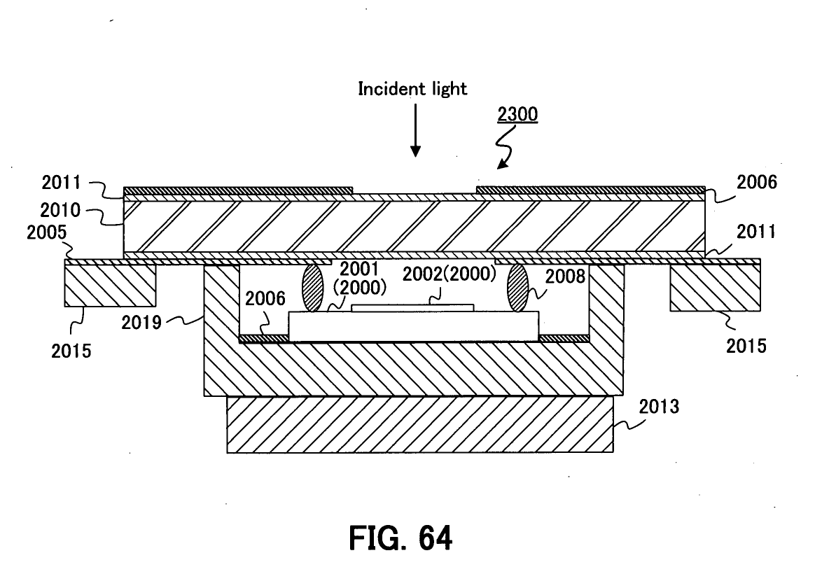

FIG. 64 is a front cross-sectional diagram of an assembly body 2300 which includes a package substrate 2019 and which packages a mirror device 2000 so as to be electrically connected to a device substrate 2001 by equipping a cover glass 2010 with a circuit wiring pattern 2005.

The assembly body 2300 shown in FIG. 64 is configured to equip a light shield layer 2006 on the top surface of the cover glass 2010 and equip the circuit wiring-pattern 2005 on the bottom surface of the cover glass 2010.

The light shield layer 2006 formed on the top surface of the cover glass 2010 pre-limits the region of light irradiated onto the mirror device 2000. The limiting of the light incident to inside of the package makes it difficult to accumulate the heat generated by the incident light.

Further, the circuit wiring pattern 2005 extends from inside of the package to outside thereof and is connected to a circuit substrate on the outside of the package. On the other hand, the circuit wiring pattern 2005 is electrically connected to an intermediate member 2009 possessing good electrical conductivity, e.g., a seal member 2008 such as solder, which is formed on the device substrate 2001 inside of the package. Configuring as such enables the control circuit as included in a circuit board 2015 to electrically connect the mirror device 2000 by way of the circuit wiring-pattern 2005.

Further, different from the embodiment 5-1, the light shield layer 2006 is provided on the top surface of the package substrate 2019, while a light shield layer 2006 is not provided on the bottom surface of the package substrate 2019.

Alternatively, the circuit board 2015 may be provided with an opening part, and the cover glass may be retained as a flange by inserting the package substrate 2019 into the opening part.

### Embodiment 5-4

A package according to an embodiment 5-4 is a package storing a control circuit for controlling a plurality of mirror devices, or one or a plurality of mirror devices.

A plurality of mirror devices and the control circuit are placed directly on a package substrate. The package substrate is, for example, glass substrate, silicon substrate, metallic substrate or ceramic substrate.

When a device substrate is placed on a package substrate, the package substrate and cover glass, which are formed in an approximate similar form to the outer shape of a mirror device, are generally placed. When a device substrate is placed in a package constituted by a package substrate made of glass and by a cover glass made of glass, or a plurality of device substrate is placed on a single package substrate, however, a preferred configuration is such that the outer shape of the package substrate is not parallel to that of the device substrate so as to cause the incident light to enter from the direction of a side of the package substrate. In the case of using, for example, a square mirror element, the placement is such that each side of the mirror element forms a 45-degree angle with a side of the package substrate so as to make the side of the package substrate parallel to the deflection axis of the mirror element. The positioning and assembly of the device substrate and optical elements can be easily carried out by placing them in such a manner that any of the sides of the optical elements placed on the package substrate is not parallel to the side of the package substrate. Particularly, when a plurality of mirror devices is placed inside of a single package, the illumination lights corresponding to the respective mirror devices may be made to be incident from the directions of different sides or from the same direction. Such a placement enables an improvement in the freedom of layout for individual constituent components within a projection apparatus.

Based on the above description, the preferred placement of a light source is such that a plurality of mirror devices does not have a side in parallel to the outer circumference of a single package substrate and also such that the optical axis of the incident light is perpendicular to any of the sides of the package substrate in the plane direction of the mirror array.

Note that an alternative configuration may be such that a thermal conduction member 2003 as noted in the embodiment 5-1 is joined to a plurality of mirror devices and/or the control circuit so as to enable radiation by way of the package substrate.

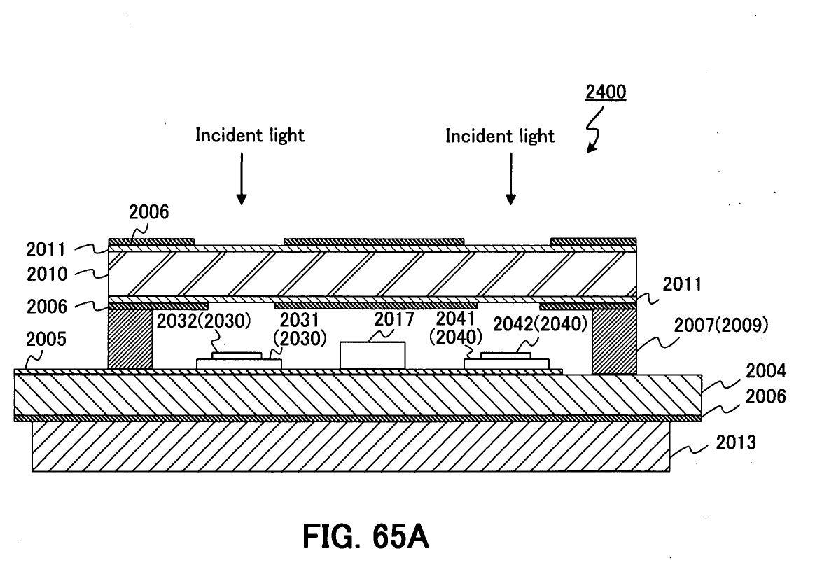

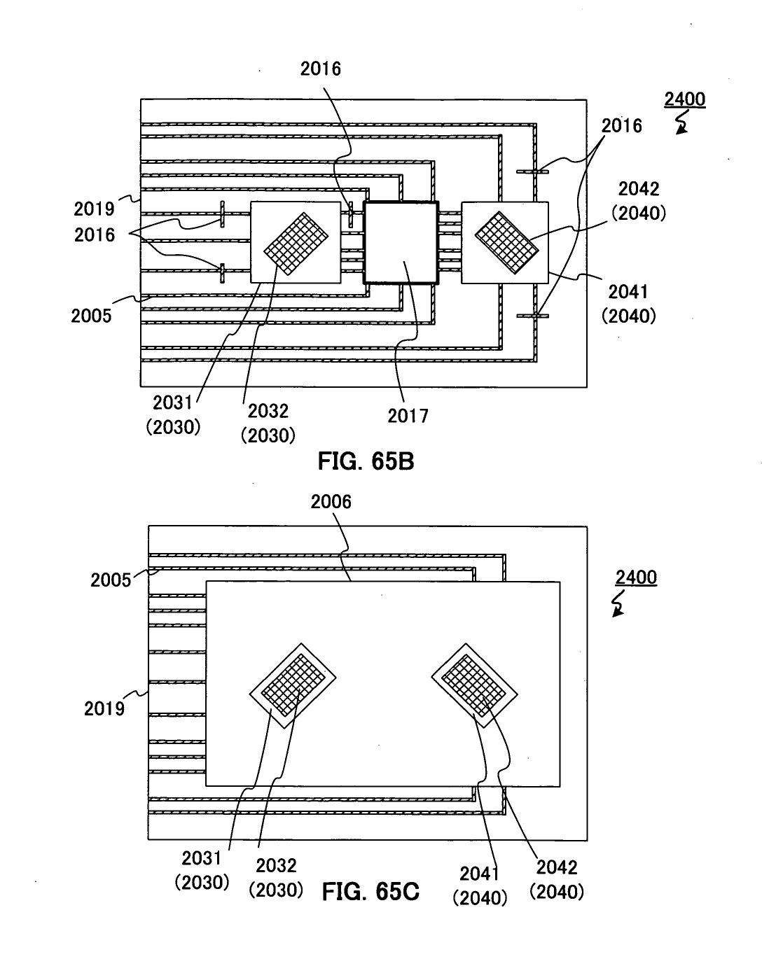

As an example, FIGS. 65A, 65B and 65C show an assembly body that packages a plurality of mirror devices and a control circuit used for controlling the mirror devices in one package shown in the embodiment 5-1.

FIG. 65A is a front cross-sectional diagram of an assembly body 2400 that packages two mirror devices 2030 and 2040 and a control circuit 2017 in one package substrate 2004.

The assembly body 2400 includes the package substrate 2004 made of a silicon material, and includes two mirror devices 2030 and 2040 and a control circuit 2017 on the package substrate 2004.

Further, a circuit wiring pattern 2005 is configured to collect the circuit wiring pattern 2005 only in one direction, that is, only in the left direction in the example shown in FIG. 65A.

Then, a part of the top and bottom surfaces, respectively, of a cover glass 2010 are provided with light shield layers 2006 so as to not irradiate any region other than the mirror arrays 2032 and 2042 of the respective mirror devices 2030 and 2040.

The other constituent components of the embodiment 5-4 are the same as those of the embodiment 5-1 and therefore the descriptions are not provided here. Note that the package as shown in FIG. 65A, is capable of further accommodating many mirror devices, control circuits and the like.

When a plurality of mirror devices is placed in one package as described above, it is easy to align the heights from the top surface of the package substrate 2004 and the intervals between mirror devices. For example, the plurality of mirror devices 2030 and 2040 can be placed on the same package substrate 2004 in the same process, with the placement performed against the same positioning part as reference. Therefore, the placements of the plural mirror devices are easy. Furthermore, the positional relationship with a synthesis optical system used for synthesizing the reflection lights from individual mirror devices can also be carried out easily.

Further, a video image projected by a projection apparatus comprising such an assembly body 2400 suffers little degradation of resolution because the pixels of the respective mirror devices 2030 and 2030 will overlap with each other. Furthermore, the colors reflected by the respective mirror devices 2030 and 2040 are observed with a less amount of blur.

Further, the equipping of the control circuit 2017 inside of the package makes it possible to place the circuit wiring pattern 2005, which includes a very large number of lines, of the control circuit 2017 on a single package substrate. This produces a result of greatly reducing the floating capacity and the like of the circuit wiring-pattern 2005. Furthermore, the control circuit 2017 controlled in higher speed than a video signal can be placed at a position equally distanced from the respective mirror devices 2030 and 2040, and the differences in the resistance values and floating capacity of the respective circuit wiring patterns 2005 connected to the individual mirror devices 2030 and 2040 are reduced. This enables the use of a mirror device comprising many mirror elements and a mirror device for which a data processing volume is large and which is capable of control in higher number of gray scales. This accordingly enables an image in a high level of gradation and high resolution. Further, the shortening of the circuit wirings to the respective mirror devices makes it easy to synchronize the timing, for controlling the mirror devices, between the respective mirror devices.

Furthermore, the thermal environments of the plural mirror devices placed on a single package substrate are the same and thereby the positional shifts due to thermal expansion of mirror elements of the respective mirror devices become approximately the same. Therefore, the projection conditions can be made to be identical. Further, the controls for the respective mirror devices can also be handled as the same environment so that the control conditions such as an analogical control for the mirror and the voltage value of memory can be made the same for the mirror devices.

FIG. 65B is a top view diagram of the assembly body 2400 shown in FIG. 65A, with the cover glass and the intermediate member removed.

The circuit wiring-pattern 2005 is placed on the package substrate 2004, and the circuit wiring-pattern 2005 is directly connected to the device substrates 2031 and 2041 of the respective mirror devices, and to the control circuit 2017.

The circuit wiring pattern 2005 is configured to collect the pattern only in one direction, that is, only in the left direction in FIG. 65B. Alternatively, the circuit wiring-pattern 2005 may be configured to place evenly in the left and right directions depending on the number of wirings.

Further, a positioning pattern 2016 is provided for positioning the two mirror devices 2030 and 2040 or control circuit 2017 on the package substrate 2004. In FIG. 65B, the positioning pattern 2016 is formed by using the circuit wiring pattern 2005. Then, the positional relationship among mirror devices 2030 and 2040 and control circuit 2017 can be determined in high precision by measuring the positioning pattern 2016 provided on the package substrate 2004 optically with a charge-coupled device (CCD) camera, et cetera.

Furthermore, a collation of the placement of the positioning pattern with the mirror device and control circuit can be carried out by using, for example, a marker provided on the mirror of the mirror device, or taking the circuit wiring pattern formed on the outer circumference of the device substrate, or a land, as reference. Assuming the width of the circuit wiring pattern 2005 and positioning pattern 2016 is 0.1 μm, a positioning can be performed in the accuracy of one half of the width of the wiring or higher, that is, 0.05 μm or better.

Incidentally, while the positioning pattern 2016 is formed by using the circuit wiring pattern 2005 in the configuration of FIG. 65B, a positioning pattern may be formed by using a material different from that of the circuit wiring pattern 2005. Such a positioning can also be provided in the case of using a substrate made of a glass or ceramic material as a package substrate 2004. Further, the positioning pattern 2016 may also function as the circuit wiring pattern 2005 and/or radiation circuit wiring pattern.

As yet another positioning method, it is possible to provide an uneven part (i.e., a concave-convex part) for positioning the device substrates 2031 and 2041 in relation to the package substrate 2004 by applying an etchant to the package substrate 2004, made of a silicon material, in the semiconductor process.

Further, the mirror devices 2030 and 2040 may be placed in a concave part provided at the center part of the package substrate 2004.

FIG. 65C is a top view diagram of the assembly body 2400 shown in FIG. 65A.

Equipping a cover glass 2010 and an intermediate member 2009 on the assembly body 2400 shown in FIG. 65A enables light shield layers 2006, which are respectively provided on the top and bottom surfaces of the cover glass 2010, to absorb the light irradiated onto parts other than the respective mirror arrays 2032 and 2042.

The circuit wiring pattern 2005 connected, respectively, to the mirror devices 2030 and 2040 extends from inside of the package to outside thereof and fills the role of conducting the heat inside of the package and radiating it to the outside.

### [Projection Apparatus]

Next is a description of a projection apparatus comprising a light modulation device packaged as described above. The light modulation device is, for example, a mirror device.

The projection apparatus according to the present embodiment includes a laser light source, an illumination optical system, a light modulation device, a package and a projection lens.

The laser light source is preferably the laser light source as described above.

The illumination optical system fills the role of enlarging the light flux emitted from the laser light source.

The light modulation device fills the role of modulating the light flux enlarged by the illumination optical system. The light modulation device is constituted by a light modulation array of which the diagonal size is 10.41 mm to 22.098 mm (0.41 inches to 0.87 inches) and in which, for example, no less than two million pixels of light modulation elements are arrayed in two dimensions, with the pitch between individual light modulation elements 4.6 μm to 10 μm, on a device substrate. The light modulation device is, for example, a mirror device, and the light modulation element is, for example, a mirror element. The mirror element contains aluminum. The device substrate is, for example, a silicon substrate.

The package protects the light modulation device. The package includes a support substrate for supporting the device substrate of the light modulation device, a transparent cover glass and an intermediate member for joining the support substrate and cover glass together

The support substrate is, for example, a glass substrate, a silicon substrate or a metallic substrate, as described above. Other constituent members are preferably configured by using the material noted above as much as possible. Particularly, a package configured by using glass selects an appropriate material so as to minimize the difference in coefficients of linear expansion between the glass and a material for the light modulation device. Configuring as such makes it possible to prevent a breakage or a mutual peeling off due to the difference in thermal expansion between the light modulation device and package.

The projection lens fills the role of projecting the light modulated by the light modulation device.

The designing of a projection apparatus using the constituent components described above makes it possible to display a high resolution, bright image. Note that the heat retained by the light modulation device can be reduced by controlling the intensity of a laser light irradiated onto the light modulation device. For example, the changing of the intensity of a laser light source changes the intensity to be modulated by the light modulation device that is used for modulating light in accordance with an image signal. Specifically, there is a possibility that the entire screen is dark or the average brightness of the screen is low, depending on the image signal. In such a case, the heat stored in the light modulation device can be reduced by modulating light by lowering the intensity of the illumination light to 50% or 25%.

Further, when the entire screen is bluish and the modulation performed by the light modulation array corresponding to the red laser light source is finished early in a multi-panel projection apparatus comprising light modulation devices corresponding to the respective light sources of red (R), green (G) and blue (B), the red laser light source is turned OFF early by shortening the sub-frame corresponding to red. As such, it is possible to eliminate the extraneous illumination onto the light modulation device corresponding to the red laser light source and accordingly reduce the heat retained by the light modulation device due to an extraneous illumination.

Next is a description of a projection apparatus employing a mirror device as the light modulation device.

First, the resolution of an image projected by the projection apparatus is determined by the size of a mirror, the F-number of a projection lens, the numerical aperture NA of a light source, the coherency of a light flux, et cetera.

When using a laser light source, a bright image can be projected by maintaining the resolution with the numerical aperture NA of an illumination light flux as 0.1 to 0.04 because a degradation in the high frequency component of the spatial frequency of a laser light is small. Further, it is possible to maintain the resolution of a projection image even with the F-number of the projection lens increased to between 5 and 12, a larger than that of the case of using a mercury lamp or the like.

Then, a useless space between the illumination light flux and projection light flux can be reduced by determining the deflection angle of the mirror device by matching the F-number of the illumination light flux and projection light flux, and also designing a layout so as to close the distance between the illumination light flux and projection light flux. If the deflection angle of the mirror is designated at θ, the numerical aperture is let as NA=sin θ, and the F-number is let at F-number=½*NA, and thereby an approximation is possible. With this approximation equation, an appropriate F-numbers will be changed in association with the deflection angle θ of a mirror and the numerical aperture NA.

When the deflection angle θ of a mirror is ±4 degrees, the NA of an obtainable light flux is 0.070, and the preferable F-number for a projection lens can possibly be 7.2.

When the deflection angle θ of a mirror is ±5 degrees, the NA of an obtainable light flux is 0.087, and the preferable F-number for a projection lens can possibly be 5.7.

When the deflection angle θ of a mirror is ±7 degrees, the NA of an obtainable light flux is 0.122, and the preferable F-number for a projection lens can possibly be 4.1.

When the deflection angle θ of a mirror is ±9 degrees, the NA of an obtainable light flux is 0.156, and the preferable F-number for a projection lens can possibly be 3.2.

When the deflection angle θ of a mirror is ±13 degrees, the NA of an obtainable light flux is 0.225, and the preferable F-number for a projection lens can possibly be 2.2.

Based on the approximation result, when the F-number for a projection lens is determined to be 2.2 for an illumination light flux of which the numerical aperture NA emitted by, for example, a mercury lamp is 0.225, the deflection angle of a mirror element is preferred to be designated at ±13 degrees. Therefore, in a rear projection system using a mercury lamp, the numerical aperture NA is between 0.17 and 0.21, and the F-number for a projection lens to be used is designated between 2.4 and 2.8, and therefore a mirror device in which the deflection angle of a mirror element is between ±10 degrees and ±13 degrees.

Meanwhile, when using an illumination light flux of which the numerical aperture emitted from a laser light source is between 0.10 and 0.04, the F-number of a projection lens can be increased to between 5 and 12, larger than when using a mercury lamp, and the deflection angle of mirror can be reduced to between ±2.3 degrees and ±5.7 degrees.

When an aberration of light is not considered, the relationship between an appropriate F-number for a projection lens and the deflection angle of a mirror can be obtained from the pixel pitch of a mirror element and the above described relational expression of resolution.

Furthermore, a laser light is a light with a uniform phase, and therefore a clear diffracted light is generated, as compared with the light emitted from a mercury lamp. Therefore, it is possible to make it difficult for a projection lens to project the diffracted light by setting the deflection angle of mirror at larger than the appropriate deflection angle θ of mirror approximated in accordance with the numerical aperture NA of the light flux of a laser light source and the F-number of a projection lens. Considering this, the incidence of the diffracted light into the projection lens can be suppressed by setting the deflection angle of mirror larger than ±4, when the numerical aperture NA of the illumination light from the laser light source is 0.070, and the F-number of the projection lens at 7.14. As a result, the contrast of the projection image is improved.

Therefore, the projection apparatus according to the present embodiment using a laser light source is configured to set the deflection angle of mirror between ±7 degrees and ±5 degrees, even if the pitch between the mirrors is between 4.6 μm and 10 μm. Alternatively, the deflection angle θ of mirror may be set at ±4 degrees, and only the NA of the illumination light flux may reduced.

Next is a description of a suitable projection lens when a mirror device is further miniaturized.

If a mirror device with a diagonal size of 0.95 inches is used for a rear projection system with about 65-inch screen size, the required projection magnification ratio is about 68. If a mirror array with a diagonal size of 0.55 inches is used, the required projection magnification ratio is about 118. As such, the projection magnification increases in association with the miniaturization of the mirror array. This ushers in the problem of color aberration caused by a projection lens.

The focal distance of the lens needs to be shortened to increase the projection magnification. Accordingly, the F-number for the projection lens is set at 5 or higher by using a laser light source. With this, it is possible to use a projection lens with the F-number at 2 times, and the focal distance at a half, as included in a configuration of a mercury lamp and a focal distance is 15 mm with the F-number at about 2.4 for the projection lens—is this in reference to a comprisal with laser or mercury. The usage of a projection lens with a large F-number makes it possible to reduce the outer size of the projection lens. This in turn reduces the image size with which a light flux passes through the illumination optical system, thereby making it possible to suppress a color aberration caused by the projection lens.

Therefore, in the case of using a laser light source with a mirror device miniaturized to between 0.4 inches and 0.87 inches, the deflection angle of mirror can be reduced to between ±7 degrees and ±5 degrees, and the F-number for a projection lens can be increased. Alternatively, the setting of the numerical aperture NA of an illumination light flux between 0.1 and 0.04 with the deflection angle of mirror maintained at ±13 degrees makes it possible to reflect the OFF light to a large distance from the projection lens, improving the contrast of the projection image.

As described above, the projection magnification of a projection lens can be set at 75× to 120× by reducing the numerical aperture NA of the light flux emitted from a laser light source, using a miniaturized mirror device (diagonal size of 0.4 inches to 0.87 inches) with which the deflection angle of mirror is reduced to between ±7 degrees and ±5, and thereby the F-number for a projection lens is increased.

Meanwhile, when a mirror device is moved forward or backward relative to the optical axis of projection, a distance with which an image blur (i.e., out of focus) of a projected image is permissible is called a focal depth. When an image is projected with a permissible blur in a degree of the mirror size by an optical setup of the same focal distance, projection magnification and mirror size, a depth of focus is approximated as follows:

Depth of focus Z=2*(permissible blur)*(F-number)

Specifically, the depth of focus is proportional to the F-number of a projection lens. That is, the permissible distance of the shift in positions of a placed mirror device, relative to the optical axis of projection, increases with F-number. This factor is represented by the relationship between a permissible circle of confusion and a depth of focus.

As an example, where the F-number of a projection lens is “8” and the permissible blur is equivalent to a 10 μm mirror size in the above described approximation equation, the depth of focus is:

Z=2*10*8=160 [μm]

Further, where a mirror size is 5 μm and an F-number is 2.4, the depth of focus is 24 μm. Specifically, considering the errors of a projection lens and other components of the optical system, the depth of focus is preferred to be no larger than 20 μm or several micrometers or less. With this in mind, when the top or bottom surface of a package substrate is taken as reference, the difference in heights of the reflection on the surface of mirrors placed respectively on both ends of a mirror array is preferred to be no more than 20 μm.

Further, a blurred image of dust, et cetera, perched on the surface of a cover glass can be made invisible by providing a distance between the top surface of a mirror and the bottom surface of the cover glass with a distance of no less than the value of the depth of focus. It is therefore preferred to provide the distance between the top surface of the mirror and the bottom surface of the cover glass with a distance of at least 20 times, or more, of the mirror size.

Note that a projection apparatus may be a single-panel projection apparatus, sequentially illuminating the lights of colors R, G and B on a single light modulation device, or a multi-panel projection apparatus, modulating the lights of the respective colors at a plurality of light modulation devices corresponding to the plurality of color light sources. Specifically, the light modulation device may be a mirror device.

The following exemplifies a multi-panel projection apparatus according to the present embodiment. Note that the projection apparatus employs a mirror device as a light modulation device. The multi-panel projection apparatus includes a plurality of light sources, a plurality of mirror devices, a prism and a projection lens. The light source may preferably be a laser light source.

As an example, if the numerical aperture NA of the illumination light flux emitted from the laser light source of the projection apparatus is between about 0.1 and 0.07, the diameter of the illumination light flux is thin and the depth of focus is long. This fact makes it possible to increase a degree of freedom in the incident path of the illumination light flux from the light source to the incidence surface on which the laser light enters a prism within the projection apparatus. This also makes it possible to increase a degree of freedom in designing a layout of the optical system within the projection apparatus. Further, the optical path length of the illumination light path between each laser of the laser light sources to the prism or light modulation element can be modified.

Further, it may be possible to employ a light source comprising a semi-ON state (in addition to an ON state and an OFF state), in which the light source outputs an incident light with does not project an image or the light source outputs no incident light although it is being driven. Note that such a control for causing a light source to be in the ON state, semi-ON state and OFF state can be carried out with the configuration shown in the above described FIG. 23A or with the above described exemplary modification of the aforementioned configuration.

Furthermore, the light source is configured by equipping a plurality of sub-light sources respectively having a plurality of wavelengths. Each sub-light source can possibly be controlled independently. As an example, only a laser light source having a specific wavelength is turned off or the light intensity is reduced for the source. Further, pulse emission, which is difficult in the case of using a mercury lamp, can be carried out.

The prism synthesizes the reflection lights from a plurality of light modulation devices, e.g., a plurality of mirror devices. It is preferred to make the incident light enter from a direction approximately orthogonal to a surface used for synthesizing the reflection light of the prism.

When synthesizing the reflection light from different mirror arrays within a prism, a dichroic filter, which passes or reflects only a predetermined wavelength, can be placed on the synthesis plane of the prism. The dichroic filter is capable of selecting only a predetermined wavelength, thereby acting as a color filter. Further, when using a laser light source emitting a polarized light, a polarization beam splitter prism capable of light separation and synthesis, using the differences in polarizing directions, can be used.

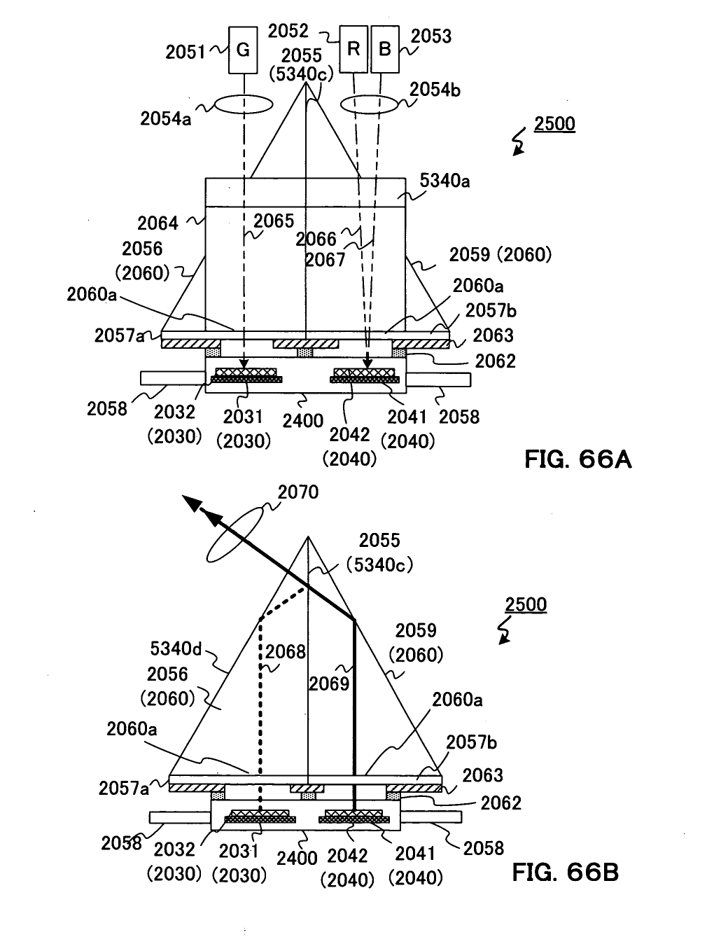

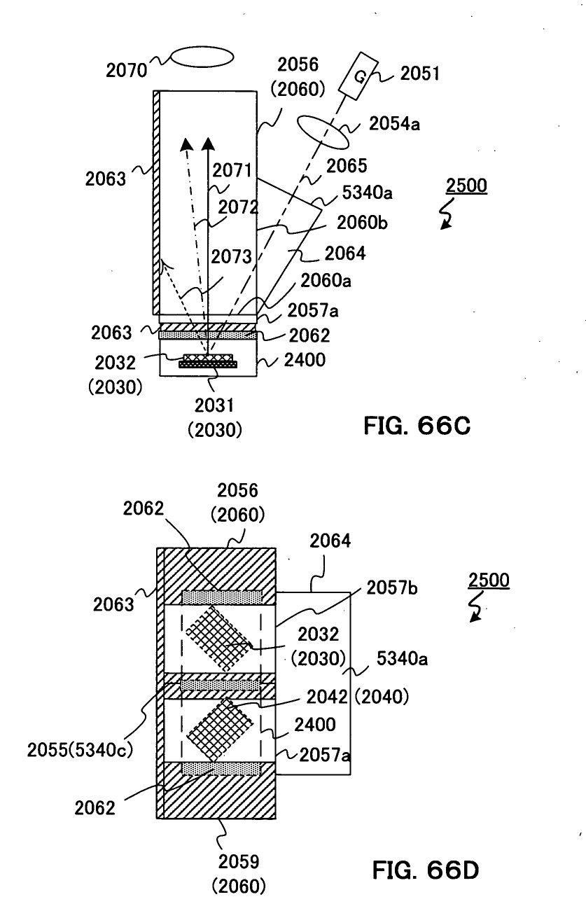

FIGS. 66A, 66B, 66C and 66D show the configuration of a two-panel projection apparatus 2500 comprising the assembly body 2400, shown in the above described FIGS. 65A through 65C, which is obtained by one package accommodating two mirror devices 2030 and 2040.

The two-panel projection apparatus 2500 does not project only one color of three colors R, G and B in sequence, nor does it project the R, G and B colors continuously and simultaneously, as in the case of a three-panel projection apparatus. A two-panel projection apparatus projects an image by continuously projecting, for example, a green light source possessing high visibility, a red light source, and a blue light source in sequence.

The two-panel projection apparatus 2500 is capable of changing over colors in high speed by means of pulse emission in 180 kHz to 720 kHz by comprising laser light sources, thereby making it possible to obscure flickers caused by changing over among the light sources of the respective colors. It may be alternatively configured to use a light emitting diode (LED) light source in place of the laser light source.

Note that the present configuration using laser light sources emitting the colors red (R), green (G) and blue (B), is arbitrary. Laser lights of colors cyan (C), magenta (M) and yellow (Y) may be also used. Further an R light closer to the wavelength of G, in place of a pure R, a G light closer to the wavelength of R or B, in place of a pure G, and a B light closer to the wavelength of G, in place of a pure B may be used. Further, laser lights of four wavelengths or more, obtained by combining the aforementioned colors, may be used.

Further, a projection method of continuously projecting the brightest color and changing over among the other colors in sequence on the basis of the image signals can also be adopted. Such a projection method can also be applied to a configuration that makes R, G and B lights correspond to the respective mirror devices, as in the three-panel projection method.

FIG. 66A is a front view diagram of a two-panel projection apparatus 2500; FIG. 66B is a rear view diagram of the two-panel projection apparatus 2500; FIG. 66C is a side view diagram of the two-panel projection apparatus 2500; and FIG. 66D is a top view diagram of the two-panel projection apparatus 2500.

The following is a description of the optical comprisal and principle of projection of the two-panel projection apparatus 2500 shown in FIGS. 66A through 66D.

The projection apparatus 2500 shown in FIGS. 66A through 66D includes a green laser light source 2051, a red laser light source 2052, a blue laser light source 2053, illumination optical systems 2054a and 2054b, two triangular prisms 2056 and 2059, ¼ wavelength plates 2057a and 2057b, two mirror devices 2030 and 2040 accommodated in a single package, a circuit board 2058, a light guide prism 2064 and a projection lens 2070.

The two triangular prisms 2056 and 2059 are joined together to constitute one color synthesis prism 2060. Further, the joined part (i.e., a surface of synthesis) between the two triangular prisms 2056 and 2059 is provided with a polarization beam splitter film 2055 or coating. The color synthesis prism 2060 primarily fills the role of synthesizing the light reflected by the two mirror devices 2030 and 2040.

The polarization beam splitter film 2055 is a filter for transmitting only an S-polarized light and reflecting P-polarized light.

A slope face of the right-angle triangle cone light guide prism 2064 is adhesively attached to the front surface (i.e., an incidence surface 2060b) of the color synthesis prism 2060, with the bottom of the light guide prism 2064 facing upward. The green laser light source 2051, the illumination optical system 2054a corresponding to the green laser light source 2051, the red laser light source 2052, the blue laser light source 2053, and the illumination optical system 2054d corresponding to the red laser light source 2052 and blue laser light source 2053 are formed beyond the bottom surface of the light guide prism 2064, with the respective optical axes of the green laser light source 2051, red laser light source 2052, blue laser light source 2053 being aligned perpendicularly to the bottom surface of the light guide prism 2064.

Specifically, the light guide prism 2064 is implemented for causing the respective lights of the green laser light source 2051, red laser light source 2052 and blue laser light source 2053 to enter perpendicularly to the color synthesis prism 2060. Such a light guide prism 2064 makes it possible to reduce the amount of the reflection light caused by the color synthesis prism 2060 when the laser light enters the color synthesis prism 2060.

Further, ¼ wavelength plates 2057a and 2057b are formed on the bottom surface of the color synthesis prism 2060 on which a light shield layer 2063 is applied in regions other than the areas where the light is irradiated on the individual mirror devices 2030 and 2040. Because of this, the light shield layer 2063 is also applied between the mirror device 2030 and mirror device 2040. Note that the ¼ wavelength plates 2057a and 2057b may alternatively be formed on the cover glass of the package.

Furthermore, a light shield layer 2063 is formed also on the rear surface (i.e., an opposite surface 2060c that is opposite to the incidence surface 2060b) of the color synthesis prism 2060.

Further, the two mirror devices 2030 and 2040, which are accommodated in a single package, are formed under the ¼ wavelength plates 2057a and 2057b. That is, the configuration is such that the two mirror devices are sealed by the bottom surface 2060a (i.e., the principal surface) of the optical member constituted by the light guide prism 2064, color synthesis prism 2060 and ¼ wavelength plates 2057a and 2057b.

Furthermore, the cover glass of the package is joined to the color synthesis prism 2060 by way of a thermal conduction member 2062. This joinder makes it possible to radiate heat from the cover glass of the package to the color synthesis prism 2060 by way of the thermal conduction member 2062. Note that the thermal conduction member 2062 has also the function as spacer. Alternatively, the thermal conduction member 2062 may be constituted by a material possessing approximately the same coefficient of thermal expansion as that of the cover glass of the package. Further, the circuit boards 2058 comprising a control circuit(s) for controlling the individual mirror devices 2030 and 2040 formed respectively on both sides of the package.

Then, the mirror devices 2030 and 2040 are respectively placed to form a 45-degree angle relative to the four sides of the outer circumference of the package on the same horizontal plane. That is, the placement the mirror devices 2030 and 2040 is such that the deflecting direction of each mirror element of the mirror devices 2030 and 2040 is approximately orthogonal to the slope face forming the color synthesis prism 2060 and to the plane on which the reflection lights are synthesized. In terms of positioning the mirror devices 2030 and 2040 in relation to the color synthesis prism 2060, a high precision positioning of the two mirror devices 2030 and 2040 within the package by means of the positioning pattern 2016 is very important.

Incidentally, the illumination optical systems 2054a and 2054b each includes a convex lens, a concave lens and other components, and the projection lens 2070 includes a plurality of lenses and other components.

The following is the principle of projection of the projection apparatus 2500 shown in FIGS. 66A through 66D.

In the projection apparatus 2500, the individual laser lights 2065, 2066 and 2067 are incident from the front direction and are reflected by the two mirror devices 2030 and 2040 toward the rear direction, and then an image is projected by way of the projection lens 2070 located in the rear.

Next is a description of the projection principle starting from the incidence of the individual laser lights 2065, 2066 and 2067 to the reflection of the respective laser lights 2065, 2066 and 2067 at the two mirror devices 2030 and 2040 toward the rear direction, with reference to the front view diagram of the two-panel projection apparatus shown in FIG. 66A.

The respective laser lights 2065, 2066 and 2067 emitted from the S-polarized green laser light source 2051, and the P-polarized red laser light source 2052 and blue laser light source 2053 are made to be incident to the color synthesis prism 2060 from the incidence surface 2060b by way of the illumination optical systems 2054a and 2054b respectively corresponding to the laser lights 2065, and 2066 and 2067, and by way of the light guide prism 2064. Then, having transmitted through the color synthesis prism 2060, the S-polarized green laser light 2065 and the P-polarized red and blue laser lights 2066 and 2067 are incident to the ¼ wavelength plates 2057a and 2057b, which are placed on the bottom surface of the color synthesis prism 2060. Having passed through the ¼ wavelength plates 2057a and 2057b, the individual laser lights 2065, 2066 and 2067 respectively change the polarization by the amount of ¼ wavelengths to become a circular polarized light state.

Then, having passed through the ¼ wavelength plates 2057a and 2057b, the circular polarized green laser light 2065 and the circular polarized red and blue laser lights 2066 and 2067 respectively incident to the two mirror devices 2030 and 2040 that are accommodated in a single package. The individual laser lights 2065, 2066 and 2067 are modulated and reflected by the correspondingly respective mirror devices so that the rotation directions of the circular polarization are reversed.

Specifically, the red laser light 2066 and blue laser light 2067 are incident to the mirror device 2040; the assumption is that the mirror device 2040 is configured to perform modulation on the basis of a video image signal corresponding to either wavelength.

Note that at least respective portions of individual light fluxes of the red laser light 2066 and blue laser light 2067 overlap with each other and mix in the illumination light paths between the red laser light source 2052 and mirror device 2040 and between the blue laser light source 2053 and mirror device 2040, and the mixed light is incident to the mirror device 2040.

Further in this event, an alternative configuration may be such that the incidence angle of the green laser light 2065, incident to the mirror device 2030, is different from that of the red laser light 2066 and blue laser light 2067, which are incident to the mirror device 2040. In such a case, each mirror device causing the above described deflection angle to be decreased to a minimum angle, which is determined by the frequency of the light as the target of modulation, makes it possible to reduce the power consumption of the mirror device and enhance the contrast of a projection image. The deflection angle may be decreased when deflecting light of a shorter wavelength versus with light of a longer wavelength.

Next is a description of the projection principle starting from the reflection of individual laser lights 2065, and 2066 and 2067 to the projection of an image with reference to the rear view diagram of the two-panel projection apparatus shown in FIG. 66B.

The ON light 2068 of the circular polarized green laser and the mixed ON light 2069 of the circular polarized red and blue lasers, which are reflected by the respective mirror devices 2030 and 2040, passes through the ¼ wavelength plates 2057a and 2057b again and enter the color synthesis prism 2060. In this event, the polarization of the green laser ON light 2068 and that of the mixed red and blue laser ON light 2069 are respectively changed by the amount of ¼ wavelengths to become a linear polarized state with 90-degree different polarization axes. That is, the green laser ON light 2068 is changed to a P-polarized light, while the mixed red and blue laser ON light 2069 is changed to an S-polarized light.

Then, the green laser ON light 2068 and the mixed red and blue laser ON light 2069 are respectively reflected by the outer side surface (i.e., a reflection surface) of the color synthesis prism 2060, and the P-polarized green laser ON light 2068 is reflected again by the polarization beam splitter film 2055. Meanwhile, the S-polarized mixed red and blue laser ON light 2069 passes through the polarization beam splitter film 2055. Then, the green laser ON light 2068 and red and blue laser mixed ON light 2069 are incident to the projection lens 2070, and thereby a color image is projected. Note that the optical axes of the respective lights incident to the projection lens 2070 from the color synthesis prism 2060 are desired to be orthogonal to the ejection surface of the color synthesis prism 2060. Alternatively, there is also a viable configuration that does not use the ¼ wavelength plates 2057a and 2057b.

With the configuration and the principle of projection as described above, an image can be projected in the two-panel projection apparatus 2500 comprising the assembly body 2400 that packages the two mirror devices 2030 and 2040, which are accommodated in a single package. Note that the assembly body 2400 in this configuration is a mirror device in a broad sense.

FIG. 66C is a side view diagram of the two-panel projection apparatus 2500.

The green laser light 2065 emitted from the green laser light source 2051 orthogonally enters the light guide prism 2064 via the illumination optical system 2054a. In this event, the reflection of the laser light 2065 can be minimized by the laser light 2065 orthogonally entering the light guide prism 2064.

Then, having passed through the light guide prism 2064, the laser light 2065 passes through the color synthesis prism 2060 and ¼ wavelength plates 2057a and 2057b, which are joined to the light guide prism 2064, and then enters the mirror array 2032 of the mirror device 2030.

In this event, having been reflected by the cover glass, the laser light 2065 is absorbed by a light shield layer 2063 applied to a surface (i.e., an opposite surface 2060c) opposite to the incidence surface 2060b before entering the mirror array 2032 of the mirror device 2030.

The mirror array 2032 reflects the laser light 2065 with the deflection angle of a mirror that puts the reflected light in any of the states, i.e., an ON light state in which the entirety of the reflection light is incident to the projection lens 2070, an intermediate light state in which a portion of the reflection light is incident to the projection lens 2070 and an OFF light state in which no portion of the reflection light is incident to the projection lens 2070.

The reflection light of a laser light (i.e., ON light) 2071, from which the ON light state is selected, is reflected by the mirror array 2032 and will be incident to the projection lens 2070.

Meanwhile, a portion of the reflection light of a laser light (i.e., intermediate light) 2072, from which the intermediate state is selected, is reflected by the mirror array 2032 and will be incident to the projection lens 2070.

Further, the reflection light of a laser light (i.e., OFF light) 2073, from which the OFF light state is selected, is reflected by the mirror array 2032 toward the light shield layer 2063, in which the reflection light is absorbed.

With this configuration, the laser light enters the projection lens 2070 at the maximum light intensity of the ON light, at an intermediate intensity between the ON light and OFF light of the intermediate light, and at the zero intensity of the OFF light. This configuration makes it possible to project an image in a high level of gradation. Note that the intermediate light state produces a reflection light reflected by a mirror of which the deflection angle is regulated between the ON light state and OFF light state.

Meanwhile, making the mirror perform a free oscillation causes it to cycle three deflection angles producing the ON light, the intermediate light and the OFF light, respectively. Specifically, the controlling of the number of free oscillations makes it possible to adjust the light intensity and obtain an image in higher level of gradation.

FIG. 66D is a top view diagram of the two-panel projection apparatus 2500.

The mirror devices 2030 and 2040 are placed in the package with them respectively forming an approximately 45-degree angle, on the same horizontal plane, in relation to the four sides of the outer circumference of the package as shown in FIG. 66D, and thereby the light in the OFF light state can be absorbed by the light shield layer 2063 without allowing the light to be reflected by the slope face of the color synthesis prism 2060 and the contrast of an image is improved.

Further, the mirror devices 2030 and 2040 are placed in the package with them respectively forming an approximately 45-degree angle, on the same horizontal plane, in relation to the package. Therefore, each of the four sides forming the contour of the mirror device is orthogonal to a respectively corresponding side of the four sides forming the contour of the mirror device 2040.

Further, the heat generated inside of the package is conducted to the color synthesis prism 2060 by way of the thermal conduction member 2062 and is radiated to the outside therefrom. As such, the conduction of the heat generated in the mirror device to the color synthesis prism 2060 improves the radiation efficiency. Further, the heat generated by absorbing light is radiated to the outside instantly because the light shield layer 2063 is exposed to the outside. That is, the light shield layer 2063 also plays the function as thermal radiation means.

When a mirror element reflects the incident light toward a projection lens 2070 at an intermediate light intensity (i.e., an intermediate state) that is the intensity between the ON light and OFF light states, an effective reflection plane needs to be conventionally taken widely in the longitudinal direction of the slope face of a prism.

In contrast, the projection apparatus 2500 is enabled to provide a wide effective reflection plane in the thickness direction of the color synthesis prism 2060 even when the mirror element as described above has the intermediate state. With this configuration, a total reflection condition with which the reflection light from the mirror element is reflected by the slope face of the color synthesis prism 2060 can be alleviated.

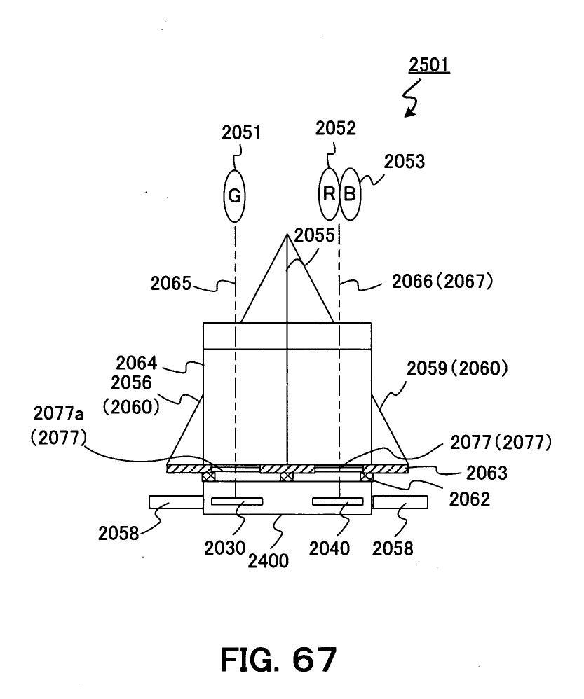

FIG. 67 is a diagram showing an exemplary modification of a projection apparatus 2500 according to the present embodiment.

The projection apparatus 2501 exemplified in FIG. 67 includes polarization elements 2077 (i.e., polarization elements 2077a and 2077b) in place of the ¼ wavelength plates 2057 (i.e., the ¼ wavelength plates 2057a and 2057b). Otherwise the configuration is similar to that of the projection apparatus 2500. The polarization elements 2077 are each optical elements, transmitting only specific polarized light. For example, the polarization element 2077a has the property of transmitting P-polarized light, while the polarization element 2077b has the property of transmitting S-polarized light.

Like the projection apparatus described above, projection apparatus 2501 also makes it possible to eliminate, from a projection light path, diffused light in which the polarizing direction is disturbed, from the reflection light reflected by the mirror devices 2030 and 2040.

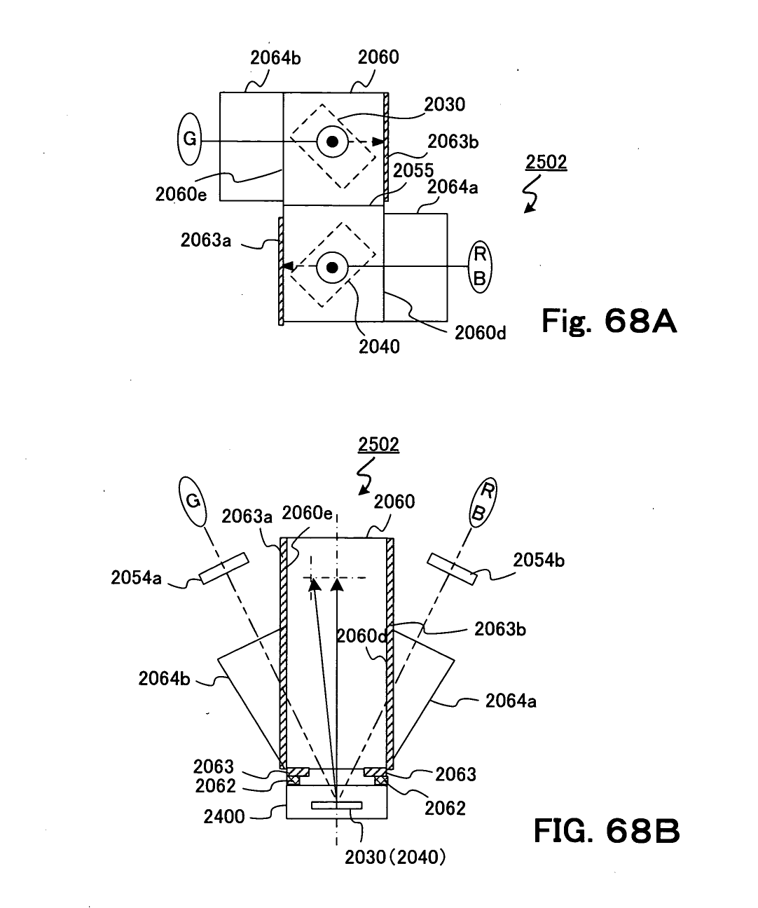

FIGS. 68A and 68B are diagrams showing another exemplary modification of the projection apparatus according to the present embodiment. FIG. 68A is a top view diagram of a projection apparatus 2502. FIG. 68B is a side view diagram of the projection apparatus 2502.

The projection apparatus 2502 is configured to guide the laser lights of individual colors to the color synthesis prism 2060 with two light guide prisms 2064a and 2064b, as exemplified in FIGS. 68A and 68B, and two incidence surfaces (i.e., incidence surfaces 2060d and 2060e) are includes. Note that both of the incidence surfaces 2060d and 2060e are oriented to cross the polarization beam splitter film 2055 (i.e., a synthesis surface) of the color synthesis prism 2060 in an approximately orthogonal direction.

The projection apparatus 2502 includes light shield layers 2063a and 2063b corresponding to the two light guide prisms 2064a and 2064b. The light guide prism 2064a and the corresponding light shield layer 2063a is placed with a shift to one direction offset in relation to the polarization beam splitter film 2055 that on the synthesis surface of the color synthesis prism 2060 not sure if this is right. The light guide prism 2064b and the corresponding light shield layer 2063b are placed with a shift to the other direction in relation to the polarization beam splitter film 2055 in the joinder part of the color synthesis prism 2060. This configuration prevents the laser lights guided by the respective guide prisms from interfering with one another. The projection apparatus 2502 of the present exemplary modification also makes it possible to obtain a benefit similar to that of the projection apparatus 2500.

If a fixed position of the assembly body 2400 is designated by the position of the polarization beam splitter film, that is, the position of the joinder surface of the two triangular prisms 2056 and 2059, in the projection apparatus illustrated in FIGS. 66A, 66B, 66C, 66D and 67, a shift in the positions of a projected image caused by the two mirror devices will not occur even if the assembly body 2400 expands a little due to a temperature rise in the apparatus, shifting the positions of the device substrates 2031 and 2041 relative to the projection optical member, because the projected image is in the direction compensating the aforementioned shift of the mirror device.

### Embodiment 6

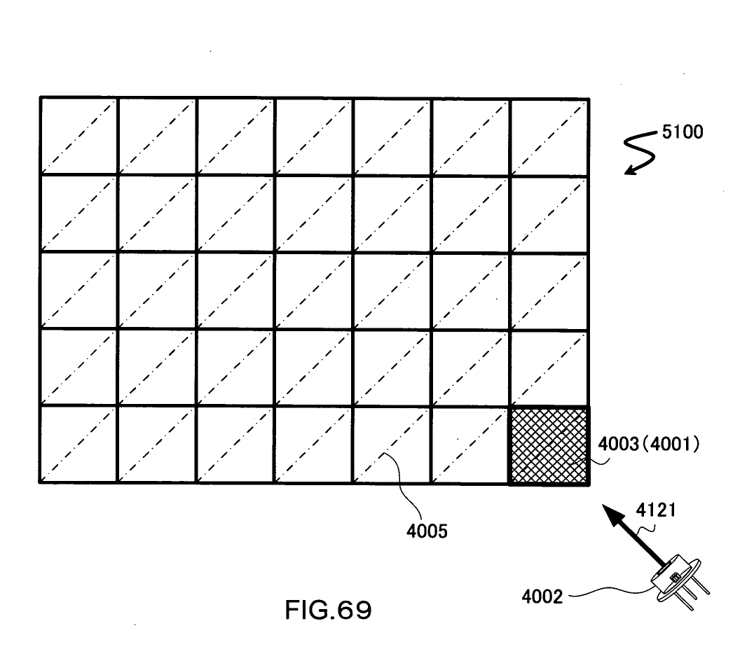

FIG. 69 is a top view diagram of the mirror array of a spatial light modulator. Each square enclosed by thick solid lines is equivalent to the mirror 4003 of one mirror element. The spatial light modulator 5100 is constituted by arraying, crosswise in two dimensions on a device substrate 4004, a plurality of mirror elements each comprising address electrodes (not shown here), elastic hinge (not shown here), and a mirror 4003 supported by the elastic hinge.

Note that the example shown in FIG. 69 looks as if adjacent mirror elements 4001 are placed without a gap between them. In actuality, the mirror elements 4001 are arrayed crosswise at predetermined intervals on the device substrate 4004.

The mirror 4003 of one mirror element 4001 is controlled by applying a voltage to the address electrode provided on the device substrate 4004.

Further, the pitch (i.e., the interval) between adjacent mirrors 4003 is preferably between 4 μm and 10 μm, taking into consideration the number of pixels required for various levels required, from a 2K×4K super hi-vision TV to a non-full hi-vision TV.

The drawing indicates the deflection axis 4005, about which a mirror 4003 is deflected, by dotted line. The light emitted from a light source 4002 possessing a coherent characteristic is made to enter the mirror 4003 so as to be in the orthogonal or diagonal direction in relation to the deflection axis 4005. The light source 4002 possessing a coherent characteristic may be, for example, a laser light source.

The following is a description of the configuration and operation of the mirror element 4001 of a spatial light modulator 5100 shown in FIG. 69, with reference to a cross-sectional diagram on a diagonal line of the mirror element 4001 there is no line in FIG. 69 other than the deflection axis, a line which is perpendicular to the deflection axis 4005.

As described previously in FIG. 27B, the individual memory cells 4010a and 4010b are controlled by signals from the COLUMN line 1, COLUMN line 2 and ROW line, and thereby the deflection angles of the mirror 4003 of each mirror element 4001 can be controlled, enabling the modulation and reflection of the incident light.

Next is a description of the deflecting operation of the mirror 4003 of the mirror element 4001 shown in FIG. 69 with reference to FIGS. 8B through 8D.

FIG. 8B is a diagram delineating the state reflecting an incident light toward a projection optical system by deflecting the mirror of a mirror element.

Giving a signal (0, 1) to the memory cells 4010a and 4010b (which are not shown here) described in FIG. 27B applies a voltage of “0” volts to the address electrode 4008a of FIG. 8B and applies a voltage of Ve volts to the address electrode 4008b. As a result, the mirror 4003 is deflected from a deflection angle of “0” degrees, i.e., the horizontal state, to that of +13 degrees attracted by a coulomb force in the direction of the address electrode 4008b to which the voltage of Ve volts is applied. This causes the incident light to be reflected by the mirror 4003 toward the projection optical system (which is called the ON light state).

Note that the present specification document defines the deflection angles of the mirror 4003 as “+” (positive) for clockwise (CW) direction and “−” (negative) for counterclockwise (CCW) direction, with “0” degrees as the initial state of the mirror 4003. Further, an insulation layer 4006 is provided on the device substrate 4004, and a hinge electrode 4009 connected to the elastic hinge 4007 is grounded through the insulation layer 4006.

It also defines that a signal (0, 1) is a state in which a signal “0” is inputted to COLUMN line 1, and a signal “1” is inputted to COLUMN line 2. The signals inputted to COLUMN line 1 and COLUMN line 2 are indicated as aforementioned in the following description.

FIG. 8C is a diagram delineating the state in which an incident light is not reflected toward a projection optical system by deflecting the mirror of a mirror element.

Giving a signal (1, 0) to the memory cells 4010a and 4010b (which are not shown here) described in FIG. 27B applies a voltage of Ve “Va” volts to the address electrode 4008a, and “0” volts to the address electrode 4008b. As a result, the mirror 4003 is deflected from a deflection angle of “0” degrees, i.e., the horizontal state, to that of −13 degrees attracted by a coulomb force in the direction of the address electrode 4008a to which the voltage of Ve volts is applied. This causes the incident light to be reflected by the mirror 4003 to elsewhere other than the light path toward the projection optical system (which is called the OFF light state).

FIG. 8D is a diagram delineating the state in which reflecting and not reflecting an incident light toward a projection optical system are repeated by free-oscillating the mirror of a mirror element.

In either of the states shown in FIGS. 8B and 8C, in which the mirror 4003 is pre-deflected, giving a signal (0, 0) to the memory cells 4010a and 4010b (which are not shown here) applies a voltage of “0” volts to the address electrodes 4008a and 4008b. As a result, the coulomb force, which has been generated between the mirror 4003 and the address electrode 4008a or 4008b, is eliminated so that the mirror 4003 performs a free oscillation within the range of the deflection angles ±13 degrees in accordance with the property of the elastic hinge 4007. The incident light is reflected toward the projection optical system only within the range of a deflection angle to produce the ON light in association with the free oscillation of the mirror 4003. The mirror 4003 repeats the free oscillations, changing over frequently between the ON light state and OFF light state. Controlling the number of changeovers makes it possible to finely adjust the intensity of light reflected toward the projection optical system (which is called a free oscillation state).

The total intensity of light reflected by means of the free oscillation toward the projection optical system is certainly lower than the intensity when the mirror 4003 is continuously in the ON light state and higher than the intensity when it is continuously in the OFF light state. That is, it is possible to make an intermediate intensity between those of the ON light state and OFF light state. Therefore, a higher gradation image can be projected than with the conventional technique by finely adjusting the intensity as described above.

Although not shown in the drawing, an alternative configuration may be such that only a portion of light is made to enter the projection optical system by reflecting an incident light in the initial state of a mirror 4003. Configuring as such, a reflection light enters the projection optical system in higher intensity than that when the mirror 4003 is continuously in the OFF light state and lower intensity than that when the mirror 4003 is continuously in the ON light state (which is called an intermediate light state).

Note that the mirror device with the oscillation state and intermediate light state is more preferable than the conventional mirror device capable of only two states, i.e., the ON light state and OFF light state.

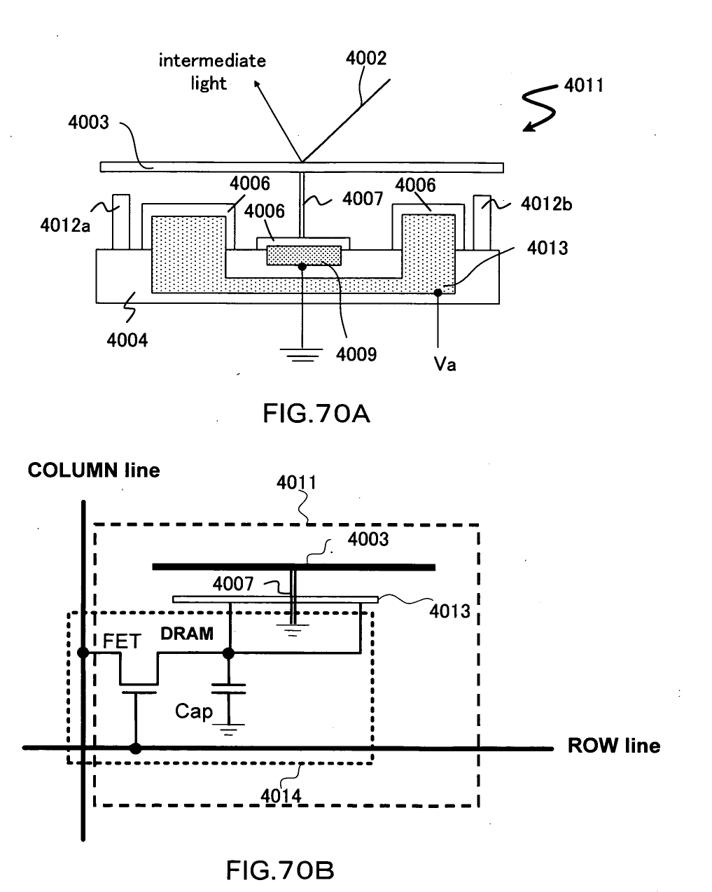

FIG. 70A shows a cross-section of a mirror element that is configured to be formed with only one address electrode and one drive circuit as another embodiment of a mirror element.

The mirror element 4011 shown in FIG. 70A includes an insulation layer 4006 on a device substrate 4004 including one drive circuit for deflecting a mirror 4003. Further, an elastic hinge 4007 is formed on the insulation layer 4006. The elastic hinge 4007 supports one mirror 4003, and one address electrode 4013, which is connected to the drive circuit, is formed under the mirror 4003.

Note that the area sizes of the address electrode 4013 exposed above the device substrate 4004 are configured to be different between the left side and right side of the deflection axis of the elastic hinge 4007, or mirror 4003, with the area size of the exposed part of the address electrode 4013 on the left side of the elastic hinge 4007 being larger than the area size on the right side, in FIG. 70A.

Specifically, the mirror 4003 is deflected by the electrical control of one address electrode 4013 and drive circuit. Further, the deflected mirror 4003 is retained at a specific deflection angle by contacting with stopper 4012a or 4012b, which are formed in the vicinity of the exposed parts on the left and right sides of the address electrode 4013.

Further, a hinge electrode 4009 connected to the elastic hinge 4007 is grounded through the insulation layer 4006. Such is the comprisal of the mirror element 4011.

Incidentally, the present specification document calls the part, which is exposed above the device substrate 4004, of the address electrode 4013 of FIG. 70A as electrode part, in specific, calls the left part as “first electrode part” and the right part as “second electrode part, with the deflection axis of the elastic hinge 4007 or mirror 4003 referred to as the border.

As such, the applying of a voltage by configuring the address electrode 4013 to be asymmetrical, that is, the left side is different from the right side, e.g., the area sizes, in relation to the deflection axis of the elastic hinge 4007 or mirror 4003 generates the difference in coulomb force between (a) and (b), where (a): a coulomb force generated between the first electrode part and mirror 4003, and (b): a coulomb force generated between the second electrode part and mirror 4003. The mirror 4003 can be deflected by differentiating the Coulomb force between the left and right sides of the deflection axis of the elastic hinge 4007 or mirror 4003.

Meanwhile, FIG. 70B is an outline diagram of a cross-section of the mirror element 4011 shown in FIG. 70A. Requiring only one address electrode 4013 makes it possible to reduce the two memory cells 4010a and 4010b, which correspond to the two address electrodes 4008a and 4008b in the configuration of FIG. 27B, to one memory cell 4014. This in turn makes it possible to reduce the number of wirings for controlling the deflection of the mirror 4003.

Other comprisals are similar to the configuration described for FIG. 27B and therefore the description is not provided here.

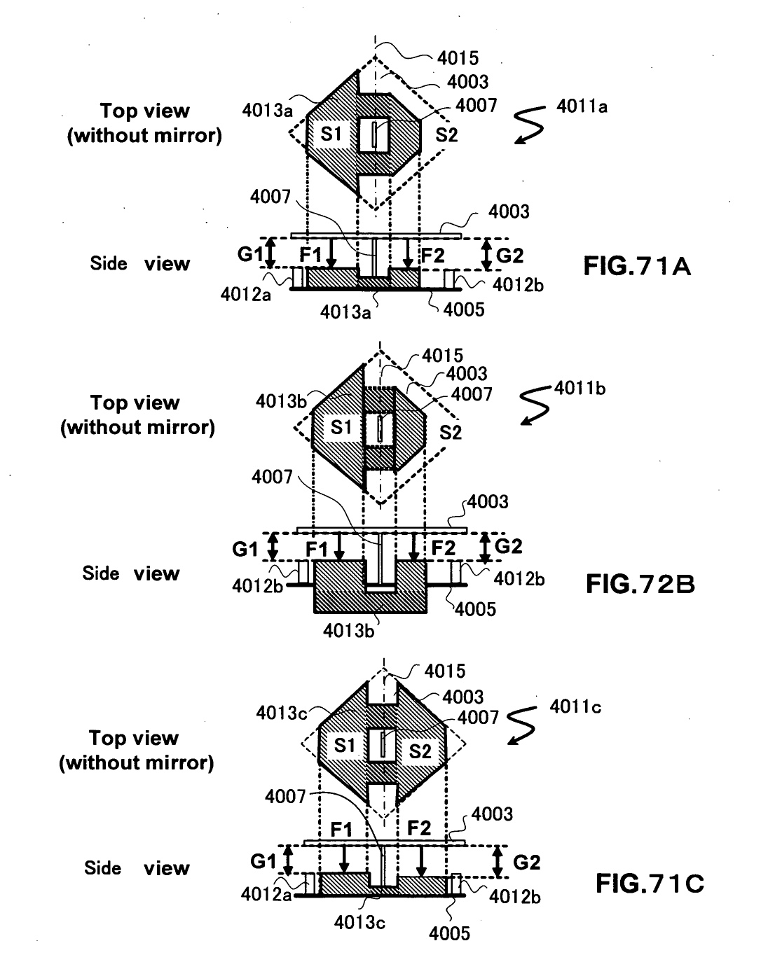

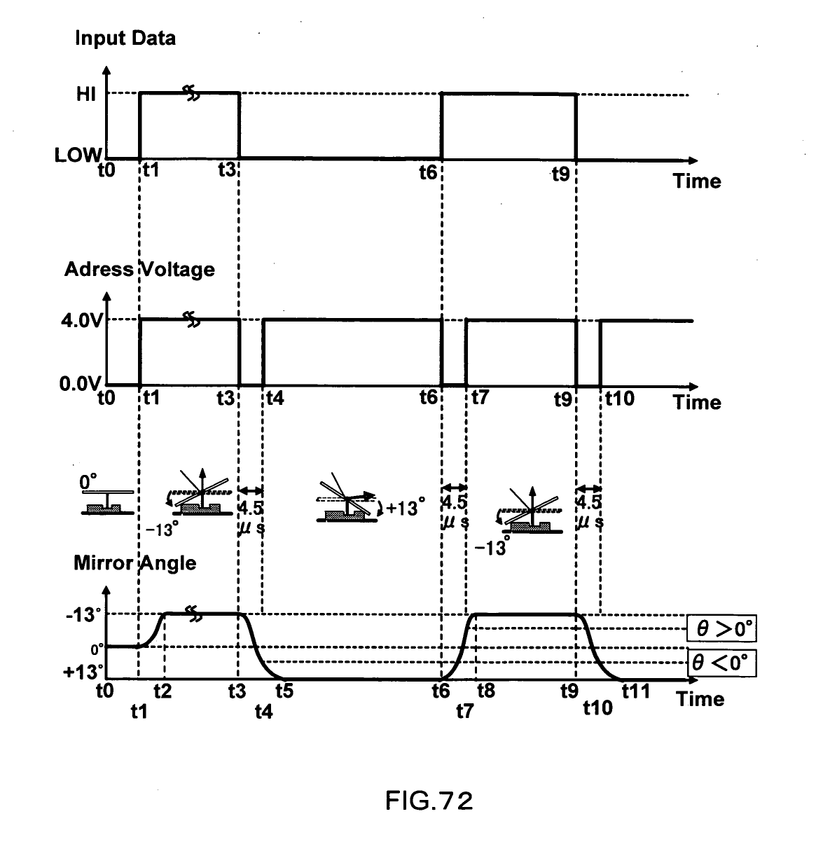

Next is a description, in detail, of a single address electrode 4013 controlling the deflection of a mirror with reference to FIGS. 71A, 71B, 71C and 72.

Mirror elements 4011a and 4011b respectively shown in FIGS. 71A and 71B each is configured such that the respective area sizes of the first and second electrode parts of one address electrode 4013 on the left and right sides, sandwiching the deflection axis 4015 of the mirror 4003, are different from each other (i.e., asymmetrical).

FIG. 71A shows a top view diagram, and a cross-sectional diagram, both of a mirror element 4011a structured such that the area size S1 of a first electrode part of one address electrode 4013a and the area size S2 of a second electrode part thereof are in the relationship of S1>S2, and such that the connection part between the first and second electrode parts exists in the same structural layer as the layer in which the first and second electrode parts exist.

In contrast, FIG. 71B shows a top view diagram, and a cross-sectional diagram, both of a mirror element 4011b structured such that the area size S1 of a first electrode part of one address electrode 4013b and the area size S2 of a second electrode part thereof are in the relationship of S1>S2, and such that the connection part between the first and second electrode parts exists in a structural layer different from the layer in which the first and second electrode parts exist.

Next is a description of the control for the deflecting operation of a mirror in the mirror element 4011a or 4011b, each respectively shown in FIG. 71A or 71B.

FIG. 72 is a diagram showing a data input to the mirror elements 4011a or 4011b, the voltage application to the address electrodes 4013a or 4013b, and the deflection angles of the mirror 4003, in a time series.

Referring to FIG. 72, the “data input” is to the mirror element 4011a or 4011b, which is controlled in two states, i.e., HI and LOW, with the HI representing a data input, that is, projecting an image and LOW representing no data input, that is, not projecting an image.

Next, the vertical axis of the “address voltage” of FIG. 72 represents the voltage values applied to the address electrode 4013a or 4013b of the mirror element 4011a or 4011b, and the voltage values applied to the address electrode 4013a or 4013b is, for example, “4” volts and “0” volts.

The vertical axis of the “mirror angle” of FIG. 72 represents the deflection angle of the mirror 4003, defining the deflection angle of the mirror 4003 in the state in which it is parallel to the device substrate 4004 to be “0” degrees. Further, with the first electrode part of the address electrode 4013a or 4013b defined as the ON light state side, the maximum deflection angle of the mirror 4003 in the ON light state is set at −13 degrees. On the other hand, with the second electrode part of the address electrode 4013a or 4013b defined as the OFF light state side, the maximum deflection angle of the mirror 4003 in the OFF light state is set at +13 degrees. Therefore, the mirror 4003 deflects within a range in which the maximum deflection angles of the ON light state and OFF light state are ±13. Further, the horizontal axis of FIG. 72 represents elapsed time t.

When the deflecting operation of the mirror 4003 is performed in the configuration of FIGS. 71A and 71B, a voltage is applied to the address electrode 4013a or 4013b at the timing on the basis of the passage of time due to a data input and a data rewrite.

Referring to FIG. 72, no data is input between the time t0 and t1, and the mirror 4003 is accordingly in the initial state. That is, the deflection angle of the mirror 4003 is “0” degrees in the state, in which no voltage is applied to the address electrode 4013a or 4013b.

At the time t1, a voltage of 4 volts is applied to the address electrode 4013a or 4013b, causing the mirror 4003 to be attracted by a coulomb force generated between the mirror 4003 and address electrode 4013a or 4013b toward the first electrode part having a large area size so that the mirror 4003 shifts from the 0-degree deflection angle at the time t1 to a −13-degree deflection angle at the time t2. Then, the mirror 4003 is retained on the stopper 4012a on the first electrode part side.

The phenomenon in which the mirror 4003 is attracted to the first electrode part, with a larger area size (than that of the second electrode part), of the address electrode 4013a or 4013b, is explained by the coulomb force F being expressed by the following equation (1):

F=1/(4**r²)*(1/ε)*q1*q2 (1),

where “r” is the distance between the address electrode 4013a or 4013b and mirror 4003, “ε” is permittivity, “q1” and “q2” are the amount of charge retained by the address electrode 4013a or 4013b and mirror 4003.

The distance G1 between the mirror 4003 and the first electrode part and the distance G2 between the mirror 4003 and the second electrode part, both when the mirror 4003 is in the initial state, are the same, and the first electrode part has a larger area than the second electrode part does, and therefore the first electrode part can retain a larger amount of charge. As a result, a larger coulomb force is generated for the first electrode part.

Between the time t2 and t3, continuously applying a voltage of 4 volts to the address electrode 4013a or 4013b in accordance with the period in response to the data input causes the mirror 4003 to be retained on the stopper 4012a on the first electrode part side.

Then, at the time t3, stopping the data input applies a voltage of “0” volts to the address electrode 4013a or 4013b. As a result, the Coulomb force generated between the address electrode 4013a or 4013b and mirror 4003 is cancelled. This causes the mirror 4003 retained on the first electrode part side to be shifted to a free oscillation due to the restoring force of the elastic hinge 4007.

Further, the deflection angle of the mirror 4003 becomes θ>0 degrees, and when a voltage of 4 volts is applied to the address electrode 4013a or 4013b at the time t4 when a coulomb force F1, that is generated between the mirror 4003 and first electrode part, and a coulomb force F2, which is generated between the mirror 4003 and second electrode part, constitutes the relationship of F1<F2, and thereby the mirror 4003 is attracted to the second electrode part. Further, the mirror 4003 is retained onto the stopper 4012b of the second electrode part at the time t5.

The reason for the above is that the second power of distance r has a larger effect on the Coulomb force represented by the expression (1) than the charge q1 and q2. Therefore, with an appropriate adjustment of the area sizes of the first and second electrode parts, a coulomb force F acts more strongly to the smaller distance G2 of the distance between the address electrode 4013a or 4013b and mirror 4003, despite that the area S2 of the second electrode part is smaller than the area S1 of the first electrode part. As a result, the mirror 4003 can be deflected to the second electrode part.

Note that the transition time of the mirror 4003 between the time t3 and t4 is preferred to be performed in about 4.5 μsec in order to obtain a high grade of gradation. Further, a control can possibly be performed in such a manner to turn off the illumination light synchronously with a transition of the mirror 4003 so as to not let the illumination light be reflected and incident to the projection light path during a data rewrite, that is, during the transition of the mirror 4003, between the time t3 and t4.

Continuously applying a voltage to the address electrode 4013a or 4013b between the time t5 and t6 causes the mirror 4003 to be continuously retained to the stopper 4012b of the second electrode part. In this event, no data is input and therefore no image is projected.

Then, at the time t6, a new data input is carried out. The voltage of 4 volts, which has been applied to the address electrode 4013a or 4013b, is changed over to “0” volts at the time t6 in accordance with the data input. This operation cancels the Coulomb force generated between the mirror 4003 retained onto the second electrode part and the address electrode 4013a or 4013b likewise the case of the time t3 so that the mirror 4003 shifts to a free oscillation state due to the restoring force of the elastic hinge 4007.

Further, a voltage of 4 volts is again applied to the address electrode 4013a or 4013b at the time t7 when a coulomb force F1, which is generated between the mirror 4003 and first electrode part, and a coulomb force F2, which is generated between the mirror 4003 and second electrode part, constitutes the relationship of F1>F2 when the deflection angle of the mirror 4003 becomes θ>0 degrees, and thereby the mirror 4003 is attracted to the first electrode part, and then the mirror 4003 is retained onto the second electrode part at the time t8.

This principle is understood from the description of the action of a coulomb force between the above described time t3 and t5. Also in this event, the transition time of the mirror 4003 between the time t3 and t4 is preferred to be performed in about 4.5 μsec, and the control is performed in such a manner to turn off the illumination light synchronously with a transition of the mirror 4003 so as to not let the illumination light be reflected and incident to the projection light path during the transition of the mirror 4003.

Then, continuously applying a voltage of 4 volts to the address electrode 4013a or 4013b between the time t8 and t9 causes the mirror 4003 to be continuously retained to the stopper 4012a of the first electrode part. In this event, data is continuously input and images are projected.

Then, the voltage applied to the address electrode 4013a or 4013b is changed from 4 volts to “0” volts as the data input is stopped at the time t9. This operation puts the mirror 4003 into the free oscillation state. Then, at the time t10, a voltage is applied to the address electrode 4013a or 4013b in a similar principle as the time from t3 to t5, from the time t6 to t8, and thereby the mirror 4003 can be retained onto the stopper 4012b of the second electrode part at the time t11.

A repetition of the similar operation enables the control for deflecting the mirror 4003.

Next is a description of the control for returning, to the initial state, the mirror 4003 retained onto the stopper 4012a of the first electrode part or onto the stopper 4012b of the second electrode part.

In order to return to the initial state, the mirror 4003 retained onto the stopper 4012a of the first electrode part or onto the stopper 4012b of the second electrode part in the state in which a voltage is applied to the address electrode 4013a or 4013b, an appropriate pulse voltage is applied.

As an example, the mirror 4003 is shifted to a free oscillation state by changing the voltage applied to the address electrode 4013a or 4013b to “0” volts in the state in which the mirror 4003 is retained onto the stopper 4012a of the first electrode part or onto the stopper 4012b of the second electrode part. In the state of the mirror performing a free oscillation, the mirror 4003 can be returned to the initial state by temporarily applying an appropriate voltage to the address electrode 4013a or 4013b, thereby generating a coulomb force pulling the mirror 4003 back toward the first electrode part or the second electrode part, either of which the mirror 4003 has been retained onto, that is, the coulomb force generating an acceleration in a direction reverse to the heading of the mirror 4003 when the distance between the address electrode 4013a or 4013b and the mirror 4003 is an appropriate length as the mirror 4003 tilts from the first electrode part side to the second electrode part side, or vice versa.

As described above, a control can be carried out to return the mirror 4003 from the state, in which the mirror 4003 is retained onto the stopper 4012a of the first electrode part or onto the stopper 4012b of the second electrode part, to the initial state by applying a pulse voltage to the address electrodes 4013a or 4013b

Considering the principle of the coulomb force between the mirror and address electrode 4013a or 4013b as described above, the applying of a voltage to the address electrode 4013a or 4013b at an appropriate distance between the mirror 4003 and address electrode 4013a or 4013b also makes it possible to retain the mirror 4003 at the deflection angle of the ON light state by returning the mirror 4003 from the ON light state, or at the deflection angle of the OFF light state by returning the mirror 4003 from the OFF light state.

Note that the control of the mirror 4003 of the mirror elements 4011a and 4011b shown in FIG. 72 is widely applicable to a mirror element that is configured to have a single address electrode and to be asymmetrical about the deflection axis of the elastic hinge or mirror.

As described above, the mirror can be deflected to the deflection angle of the ON light state or OFF light state, or put in the free oscillation state, with a single address electrode of a mirror element.

FIG. 71C shows a top view diagram, and a cross-sectional diagram, both of a mirror element 4011c structured such that the area size S1 of a first electrode part of one address electrode and the area size S2 of a second electrode part thereof are in the relationship of S1=S2, and such that the distance G1 between a mirror 4003 and the first electrode part and the distance G2 between the mirror 4003 and the second electrode part are in the relationship of G1<G2.

That is, the configuration of FIG. 71C is such that, for the address electrode 4013, the height of the first electrode part is different from that of the second electrode part and such that the distance G1 between the first electrode part and mirror 4003 and the distance G2 between the second electrode part and mirror 4003 is in the relationship of G1<G2. It is further such that the address electrode 4013c is electrically connected to the first electrode part and second electrode part on the same layer as the address electrode 4013 exists.

In the case of the mirror element 4011c as shown in FIG. 71C, the size of the coulomb force generated between the mirror 4003 and address electrode 4013c in the first electrode part is different from that generated between the mirror 4003 and address electrode 4013c in the second electrode part because the distances between the mirror 4003 and address electrode 4013 are different in the first electrode part and the second electrode part. Therefore, the deflection of the mirror 4003 can be controlled by carrying out a control similar to the case of the above described FIG. 72.

Note that the deflection angle of the mirror 4003 is retained by using the stoppers 4012a and 4012b in FIGS. 71A, 71B and 71C, the deflection angle of the mirror 4003, however, can be established by configuring an appropriate height of the address electrode 4013c to also fill the roles of the stoppers 4012a and 4012b.

Further, while the present embodiment is configured to set the control voltages at 4-volt and 0-volt applied to the address electrode 4013a, 4013b or 4013c, such control voltages, however, are arbitrary and other appropriate voltages may be used to control the mirror 4003.

Furthermore, the mirror can be controlled with multi-step voltages to be applied to the address electrode 4013a, 4013b or 4013c. As an example, if the distance between the mirror 4003 and address electrode 4013a, 4013b or 4013c, increasing a coulomb force, the mirror 4003 can be controlled with a lower voltage than that when the mirror 4003 is in the initial state.

Next is a description of each constituent part that constitutes a mirror element. The mirror is formed with a highly reflective metallic material, such as aluminum (Al) or a multi-layer film of a dielectric material. The entirety or a part of the elastic hinge (e.g., the base part, neck part or intermediate part) is constituted by a metallic material possessing a restoring force. The material for the elastic hinge uses, for example, silicon (Si), such as amorphous silicon (a-Si) or single crystal silicon, which is an elastic body. The address electrode is configured to have the same electric potential, by using, for example, aluminum (Al), copper (Cu), or tungsten (W) as a conductor.

The insulation layer uses silicon dioxide (SiO₂) and silicon carbide (SiC). The device substrate uses a silicon material. Note that materials and forms of each constituent part of a spatial light modulator may be changed to suit a different purpose.

Next is a description of the circuit configuration of a spatial light modulator used for processing input signals. The outline of the circuit configuration of a spatial light modulator used for processing input signals is similar to the circuit shown in the previously described FIG. 27A.

The spatial light modulator shown in the previously described FIG. 27A includes a timing controller 5141, a selector 5142, a ROW line decoder 5130, a plurality of column drivers 5120, and a mirror element array (memory array) 5110 arraying a plurality of memory cells in a two-dimension array comprising M columns by N rows inside of a device substrate.

The memory cell may be includes of, for example, a complementary metal oxide semiconductor (CMOS) circuit in which a wiring process rule exists.

In the previously described FIG. 27A, the timing controller 5141 controls the selector 5142 and ROW line decoder 5130 in accordance with a signal input from an external drive circuit (not shown in the drawing). The selector 5142 transfers an n-bit signal, which is transferred from the external drive circuit by way of an n-bit data bus line, to at least one column driver 5120 in accordance with the control of the timing controller 5141. The column driver 5120 outputs the n-bit signal transferred from the selector 5142 to each COLUMN line of the connected memory array, thereby driving the respective COLUMN lines placed on the device substrate of each mirror element. Further, the ROW line decoder 5130 drives an arbitrary ROW line of the memory array in accordance with the control of the timing controller 5141.

With the above described configuration in mind, first, the image data of a signal corresponding to a desired display period of time is transferred from the external drive circuit by way of the n-bit data bus line. Then, these pieces of n-bit image data are sequentially transferred to the desired column drivers 5120 by way of the selector 5142. Upon completion of the transfer of the pieces of new image data to all column drivers 5120, the ROW line decoder 5130 drives a desired ROW line in accordance with the command of the timing controller 5141. Then, a voltage applied to a predetermined memory cell is controlled by the image data from the column driver 5120 and the driving of the ROW line, according to the control mechanism.

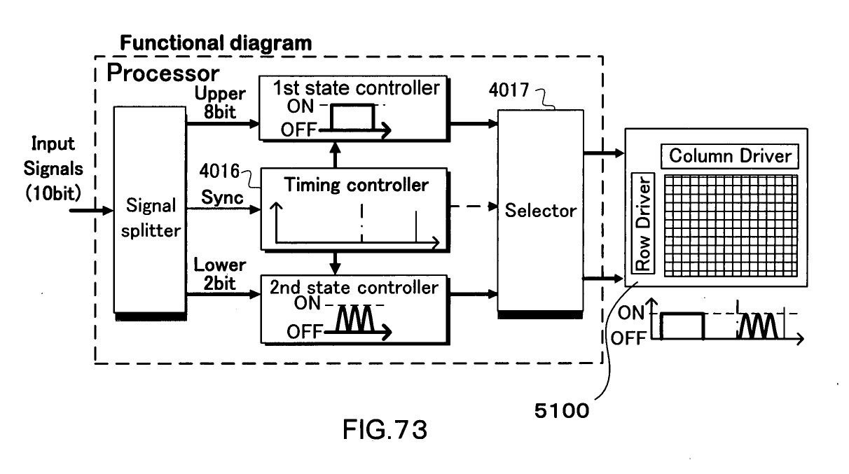

FIG. 73 illustrates an example of a system diagram of this invention. In this example, a 10 bit signal input is split into two parts, for example, upper 8 bits and lower 2 bits. The upper 8 bits are sent to the 1^{st} state controller, the lower 2 bits are sent to the 2^{nd} state controller, and the sync signal is sent to the timing controller 5141. Then, the 2^{nd} state controller converts binary data, which is the lower 2 bits, into non-binary data. Such a configuration makes it possible to control a mixture of 1^{st state and} 2^{nd} state binary data and non-binary data. Further, if such a control is applied to a single-panel projection apparatus, the 2^{nd} state is set at no less than 180 Hz, and the lights of the respective colors are sequentially projected. In this event, sub-frames determined by the 2^{nd} state can be assigned to the lights of the respective colors R, G and B. Further, an image can alternatively be projected in six colors by adding cyan, magenta and yellow.

Note that the sync signal is generated by a signal splitter. The timing controller 5141 in FIG. 73 it's 4016 controls the selector 5142 in FIG. 73 it's 4017 in accordance with the sync signal and changes over between making the 1^{st} state controller control the spatial light modulator 5100 and making the 2^{nd} state controller control the spatial light modulator 5100.

The human eye is most sensitive to wavelengths perceived as green light. Therefore, a 14-bit gray scale may be used only for green, and the 12-bit may be used for other colors.

Furthermore, there is a case in which an illumination light of white obtained by superimposing red, green and blue is illuminated. In such a case, the white may be assigned to the 1^{st} state.

The following provides a description of a projection apparatus comprising the spatial light modulator as described above.

A single-panel projection apparatus comprising a single spatial light modulator described above includes the apparatus as shown in the previously described FIG. 21. The configuration and operation are already provided and therefore they are not provided here.

In the thusly configured single-panel projection apparatus, a period (i.e., one frame) of displaying one image is divided into sub-frames, and the light of any of the color lights, R, G and B is irradiated onto the spatial light modulator within each sub-frame period. Further, the images corresponding to the lights reflected to the projection light path are projected onto a screen in sequence by the mirror element of the spatial light modulator reflecting the selectively irradiated light.

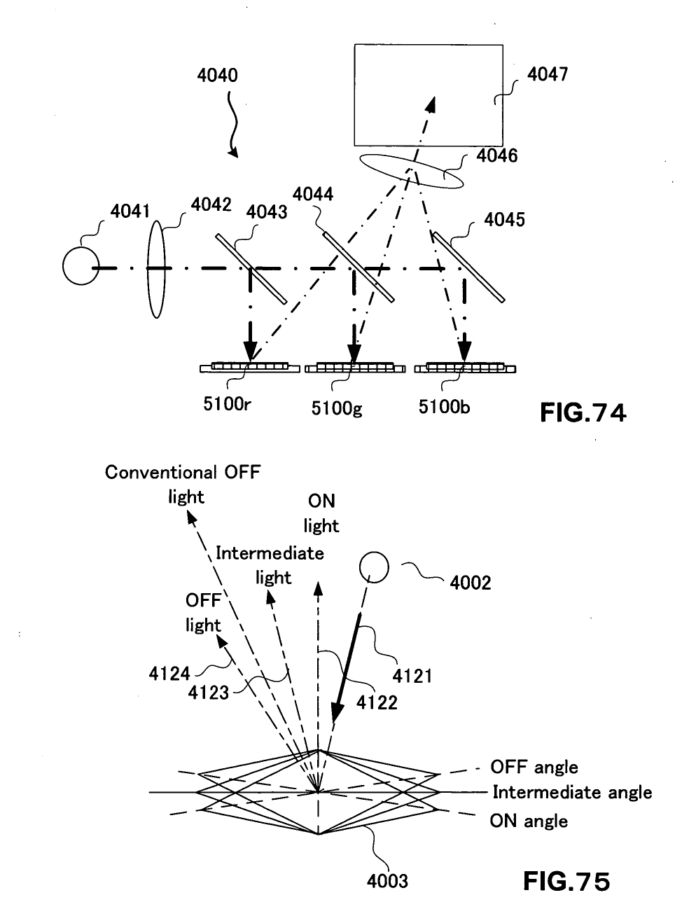

FIG. 74 is an illustrative diagram showing the configuration of a multi-panel projection apparatus 4040 comprising three spatial light modulators 5100r, 5100g and 5100b. Note that a light source in this configuration is constituted by combining a plurality of light sources of colors (i.e., wavelengths), each of which possesses a coherent characteristic.

In the multi-panel projection apparatus 4040, the light of the respective colors output from the light source 4041 passes through a condenser lens 4042. Having passed through the condenser lens 4042, only the specific wavelengths of light are respectively reflected by two dichroic mirrors 4043 and 4044, while the lights of other wavelengths pass through the mirrors. Thereby the light is separated into the lights of the respective colors R, G and B.

In the case of FIG. 74, the assumption is that the first dichroic mirror 4043 reflects only the red light and the second dichroic mirror 4044 reflects only the green color, leaving the remaining blue light to be reflected by a mirror 4045.

The lights of the separated colors red (R), green (G) and blue (B) are incident to the spatial light modulators 5100r, 5100g and 5100b, respectively corresponding to R, G and B. Then, the lights of the respective colors are selectively reflected by the individual mirror elements comprising the respective spatial light modulators 5100r, 5100g and 5100b toward a projection optical system 4046. The lights of the respective colors are then projected onto a screen 4047 by way of the projection optical system 4046, e.g., a projection lens.

In such a configured multi-panel projection apparatus 4040, the lights R, G and B are selectively reflected by the mirror elements of the respective spatial light modulators 5100r, 5100g and 5100b, corresponding to the respective lights in one frame period, and thereby the lights of the three colors can be projected continuously onto the screen 4047. Therefore, the multi-panel projection apparatus 4040 is capable of projecting the light from the light source 4041 using the entirety of one frame period, causing no color break.

Next, another multi-panel projection apparatus comprising a plurality of spatial light modulators, including the type as shown in the previously described FIG. 22B, will be described. The configuration and the principle of projection of the projection apparatus shown in the previously described FIG. 22B are similar to the above description, and therefore the description is not provided here. Note that a light source in this configuration is constituted by combining a plurality of light sources of different colors (i.e., wavelengths), each of which possesses a coherent characteristic.

There is also a projection apparatus, configured as shown in the previously described FIG. 22A, as another multi-panel projection apparatus configured to make the number of reflections of each color light in the light path equal to one another. The comprisal and projection principle of the projection apparatus shown in the previously described FIG. 22A are similar to the above described, and therefore the description is not provided here. Incidentally, a light source in this configuration is constituted by combining a plurality of light sources of colors (i.e., wavelengths), each of which possesses a coherent characteristic.

Furthermore, a projection apparatus comprising a total internal reflection (TIR) prism and Koester prism includes a type shown previously in FIG. 22C. The configuration and the principle of the projection apparatus are similar to the above description and therefore are not provided here. Incidentally, a light source in this configuration is constituted by combining a plurality of light sources of colors (i.e., wavelengths), each of which possesses a coherent characteristic. The reason for making each laser light incident orthogonally to each respective prism surface is to reduce, as much as possible, the loss of light due to the reflection on the prism surface when the light enters the prism.

The use of a light source possessing a coherent characteristic as the light source in each of the projection apparatuses described above enables an image projection using an optical component with a larger F-number (allowing small expansion of a light flux) than the case of using a conventional discharge lamp as the light source.

FIG. 75 illustrates the relationship between the deflection of a mirror and the reflecting direction of an illumination light in the configuration of FIG. 69.

When the mirror 4003 is tilted CW, the deflection angle of the mirror 4003 is in the ON light state (i.e., an ON angle), in which the illumination light is reflected to an optical axis 4122 of the ON light, that is, the entirety of light enters the projection optical system.

When the mirror 4003 is in the initial state, the deflection angle of the mirror 4003 is in an intermediate light state, in which the illumination light 4121 is reflected to an optical axis 4123 of the intermediate light, that is, a portion of light enters the projection optical system.

When the mirror 4003 is tilted CCW, the deflection angle of the mirror 4003 is in the OFF light state (i.e., an OFF angle), in which the illumination light is reflected to an optical axis 4124 of the OFF light, that is, no light enters the projection optical system.

The present embodiment aims at allowing none of the OFF light to enter the projection optical system more securely, and therefore sets the deflection angle of the mirror 4003 to be larger than a conventional angle that is theoretically led to the OFF light state. The increasing of the mirror deflection angle than the conventional makes it possible to place the OFF light further distanced from the projection optical system and accordingly prevent diffracted light or scattered light generated by the OFF light from entering the projection optical system. As a result, the image quality and contrast of the projected image are improved.

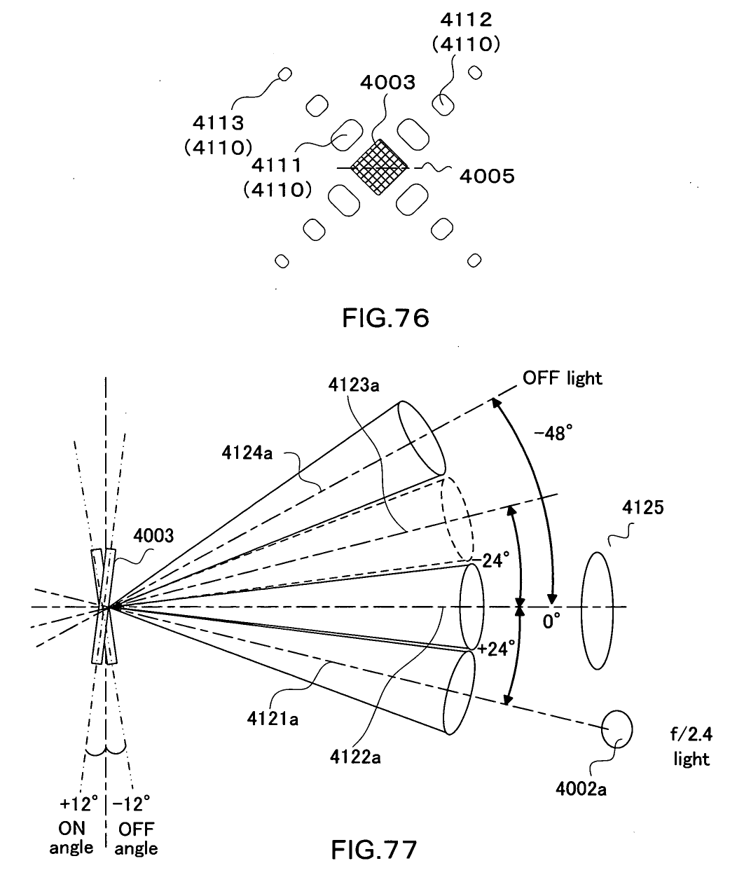

FIG. 76 is illustrative diagram showing diffracted light generated when the light is reflected by a mirror of a spatial light modulator.

As shown in the figure, the diffracted light is generated as a result of irradiating light onto a mirror, and the diffracted light 4110 spreads, that is, the primary diffracted light 4111, the secondary diffracted light 4112, the tertiary diffracted light 4113, and so on, in directions perpendicular to the four sides of the mirror 4003 shown at the center. In this event, the light intensity decreases gradually with the primary diffracted light 4111, secondary diffracted light 4112, tertiary diffracted light 4113, and so on. In the case of using a laser light source, the coherence is improved by the uniformity of the wavelength of a laser light, distinguishing the diffracted light 4110. Note that the diffracted light 4110 also possesses an expansion to the depth direction of the mirror 4003 in three dimensions.

The spatial light modulator 5100 FIG. 69 can be configured to set the diagonal direction of the mirror 4003 as the deflection axis thereof, thereby making it possible to prevent the diffracted light 4110 of light from entering the projection optical system. This configuration prevents extraneous light, that is, the diffracted light 4110, from entering the projection optical system, thereby improving the contrast of a projected image.

Meanwhile, the resolution of a projected image at a projection apparatus is determined by parameters, such as the size of a mirror, the F-number of a projection lens, the numerical aperture NA of a light source, the coherence of a light flux. Therefore, the most optimal deflection angle of the mirror 4003 needs to be set in consideration of these factors.

Where “θ” is the maximum deflection angle of a mirror and “±α” is the maximum spread angle of a reflected light flux from the optical axis, the relationship between the deflection angle θ and the maximum spread angle ±α of a reflected light flux from the optical axis is:

θ=α

Further, the numerical aperture NA equivalent to the radius of a reflected light flux is:

NA=n sin α,

where “n” is a refractive index. Further, an appropriate F-number for a projection lens can be approximated as:

F=½*NA

Considering the above-described conditions, the deflection angle of the mirror is theoretically set so that the respective light fluxes of the illumination light, ON light, intermediate light and OFF light are not overlapping with one another. The setting of such a deflection angle enables an improvement in the contrast.

Next is a description of the conventional theoretical setting of the deflection angle of mirror with reference to FIG. 77.

FIG. 77 is an illustrative cross-sectional diagram delineating a situation in which an f/2.4 light flux, which is emitted from a discharge lamp light source, is reflected by a conventional spatial light modulator for which the deflection angles of the ON light state and OFF light state of a mirror are set at ±12 degrees, respectively.

Conventionally, with the deflection angle of a mirror in the ON state being set at +12 degrees, an angle of 24 degrees is provided between the optical axis 4122a of the ON light and the optical axis 4121a of the illumination light so that the ON light enters a projection optical system 4125 without theoretically overlapping with the illumination light output from a discharge lamp light source 4002a.

That is, the maximum expansion angle from the optical axis 4121a of the light flux of the illumination light (emitted from a light source 4002) possessing a coherent characteristic is ±12 degrees when the deflection angle θ of the mirror 4003 is 12 degrees. Further, the maximum expansion angle from the optical axis 4122a reflected by the mirror 4003 is also ±12 degrees, from the above description, and therefore a provision of at least 24 degrees between the optical axis 4121a of the illumination light and the optical axis 4122a of the flux of the reflected light makes it possible, to theoretically prevent the light fluxes from overlapping with each other.

Further, with the deflection angle of the mirror 4003 in the initial state being set at “0” degrees, an angle of −24 degrees is provided between the optical axis 4123a of the light reflected by the mirror 4003 in the initial state and the optical axis 4122a of the ON light so that the reflected light does not theoretically overlap with the ON light and so that no light enters the projection optical system 4125.

Meanwhile, the conventional spatial light modulator is structured such that the deflection angle of a mirror rotates (i.e., swings) in equal swinging angles CW and CCW about the initial state of the mirror as the center, and therefore the deflection angle of mirror in the OFF state is −12 degrees in relation to the deflection angle, i.e., +12 degrees, of mirror in the ON state.

At the angle in the OFF state, an angle of −48 degrees is provided between the optical axis 4124a of the OFF light and the optical axis 4122a of the ON light so that not only does the light flux of the OFF light overlap with the light flux of the ON light theoretically, but also that of the OFF light does not overlap with the light flux reflected by the mirror 4003 in the initial state. Configuring as such prevents the diffraction light or scattered light generated by the mirror from entering the projection optical system 4125, while the usage efficiency of f/2.4 light output from the discharge lamp light source is theoretically optimized.

The present embodiment, however, does not need to consider an optimization of the usage efficiency any deeper than the case of using the discharge lamp light source, as a result of using the light source 4002 possessing a coherent characteristic, such as a laser light source.

The reason is that, when a laser light source is used as the light source 4002 possessing a coherent characteristic, brightness can be maintained even if the maximum spread angle α of the numerical aperture NA of the illumination light flux is reduced in terms of the relationship of etendue because a degradation in the high frequency component of the spatial frequency of the laser light is small. Therefore, the resolution of a projected image can be maintained even with a smaller F-number for the projection lens than an F-number in the case of using a discharge lamp light source or the like.

In addition, a larger deflection angle of mirror may be set than the theoretically calculated conventional deflection angle of mirror in this case. Further, by increasing the deflection angle of mirror, it is possible to prevent the diffraction light or scattered light generated by the mirror in the OFF light state and OFF angle from entering the projection optical system more securely. As a result, the contrast of the projected image is improved.

Further, in the case of using a laser light source, the F-number of a projection lens can be increased, and the deflection angle of mirror can be set at smaller, than in the case of using a discharge lamp light source or the like as described above.

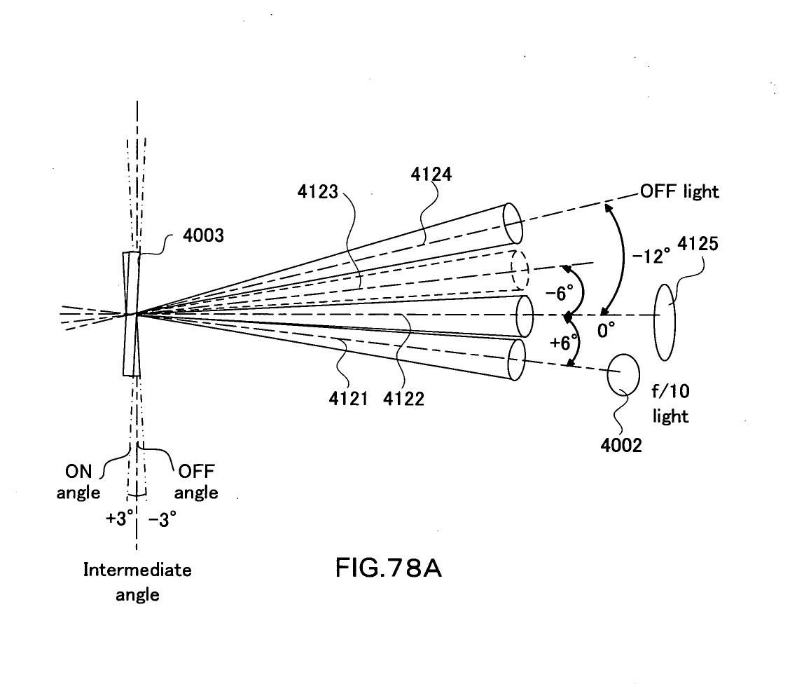

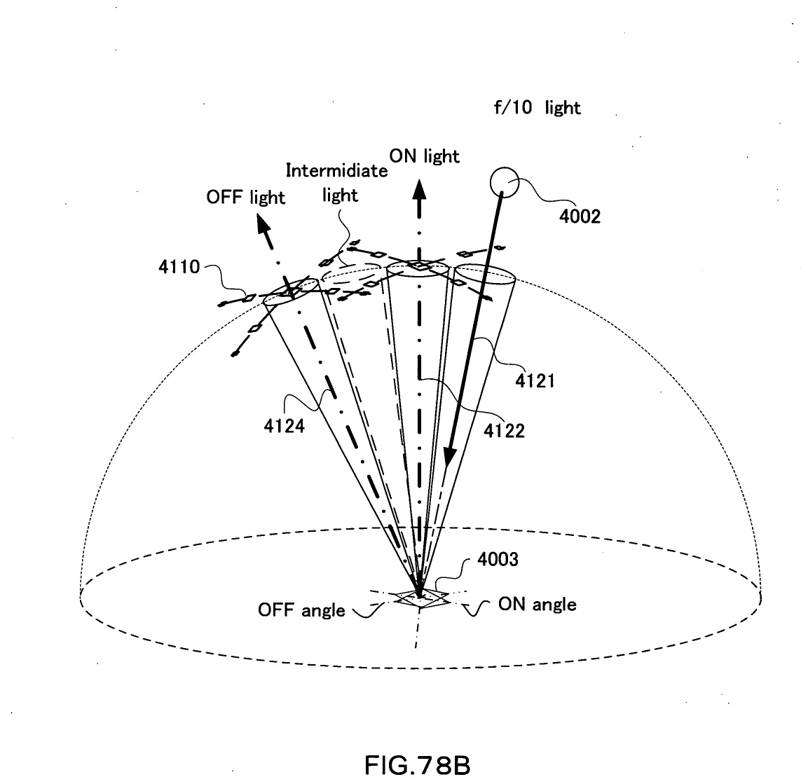

The following exemplifies the setting of the deflection angle of a mirror element of the present embodiment with reference to FIGS. 78A, 78B, 79, 80A, 80B, 81, 82 and 83. Note that the present embodiment designates the conventional optical axis 4123a of the light reflected by the mirror 4003 in the initial state as the optical axis 4123 of an intermediate light, that is, a portion of the light enters the projection optical system.

In the case of using a laser light source as the light source 4002 possessing a coherent characteristic, the numerical aperture NA of the light flux emitted from the laser light source configured as described above can be reduced, and therefore the deflection angle of the mirror 4003 can be set at smaller angle, that is, ±3 degrees, in the ON light state and OFF light state, respectively, than the conventional case when the numerical aperture NA is set at 10.

FIG. 78A is an illustrative cross-sectional diagram delineating a situation in which an f/10 light flux, which possesses a coherent characteristic, is reflected by a spatial light modulator for which the deflection angles of the ON light state and OFF light state of a mirror are set at ±3 degrees, respectively.

In the configuration of FIG. 78A, with the deflection angle of mirror in an ON light state being set at +3 degrees, an angle of +6 degrees is provided between the optical axis 4122 of an ON light and the optical axis 4121 of the illumination light so that the ON light enters the projection optical system 4125 without an overlap between the light flux of the ON light the illumination light flux.

Further, with the deflection angle of the mirror 4003 in an initial state set at 0 degrees, an angle of −6 degrees is provided between the optical axis 4123 of an intermediate light and the optical axis 4122 of the ON light so that the light flux of the intermediate light enters the projection optical system 4125 without overlapping with the light flux of the ON light.

Further, with the deflection angle of the mirror 4003 in an OFF state being set at −3 degrees, an angle of −6 degrees is provided between the optical axis 4124 of an OFF light and the optical axis 4122 of the intermediate light so that the light flux of the OFF light does not overlap not only with the light flux of the ON light but also that of the intermediate light. That is, an angle of −12 degrees is provided between the optical axis 4124 and the optical axis 4122 of the ON light.

Configuring as such makes it possible to prevent the diffraction light or scattered light generated by the mirror producing an OFF light and tilting in an OFF angle from entering the projection optical system 4125 more securely.

FIG. 78B is a diagram further showing an expansion of diffraction light by delineating, in three dimensions, the relationship, which is shown in FIG. 78A, between the deflection angle of the mirror and the light flux thereof.

While diffraction light 4110 is generated perpendicularly to the directions of the respective sides of the mirror 4003, the light does not overlap with the light path of an ON light since the deflection axis is set in the diagonal direction of the mirror 4003. Particularly, the diffraction light 4110 does not enter the projection optical system since the configuration is such that the diffraction light 4110 generated when the mirror 4003 is in an OFF state does not overlap with the light path of the ON light. As a result, the extraneous diffraction light 4110 generated by the spatial light modulator reflecting incident light does not enter the projection optical system, and thereby the contrast of an image is improved.

Further, the deflection angle of the mirror 4003 in the OFF state and ON state may be increased from the ±3 degree deflection angle shown in FIGS. 78A and 78B in order to further improve the contrast.

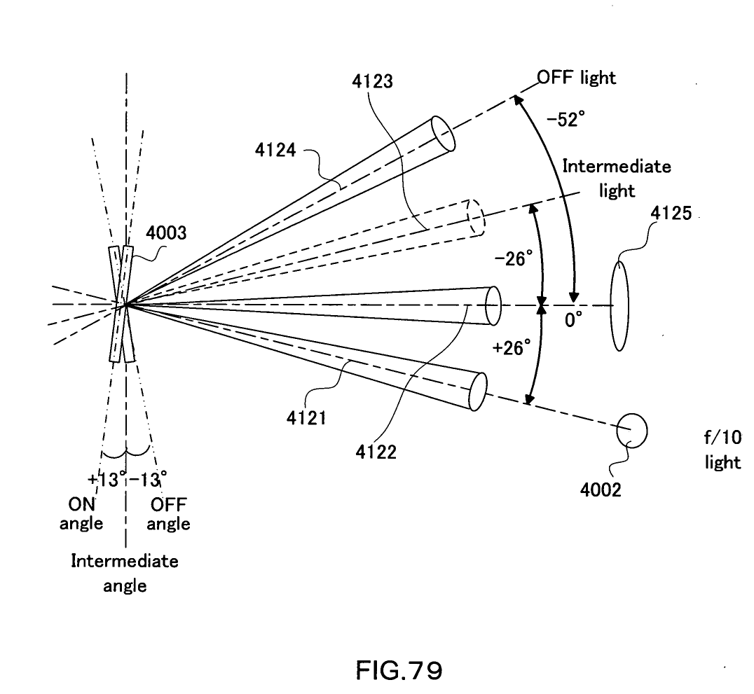

FIG. 79 is an illustrative cross-sectional diagram delineating a situation in which an f/10 light flux emitted from a light source, which possesses a coherent characteristic, is reflected by a spatial light modulator for which the deflection angles of the ON light state and OFF light state of the mirror shown in FIG. 78A are set at ±13 degrees, respectively.

The configuration of FIG. 79 sets the deflection angle of the mirror 4003 in the ON state larger, at +13 degrees, than the theoretically calculated angle, i.e., +3 degrees, from the numerical aperture NA of a laser light source. The setting of such a deflection angle of mirror designates the angle, as +26 degrees, between the optical axis 4122 of the ON light and the optical axis 4121 of the illumination light.

Further, the deflection angle of the mirror 4003 in an intermediate light state (i.e., an intermediate angle) is set at “0” degrees. The setting of such a deflection angle of mirror designates the angle, as −26 degrees, between the optical axis 4123 of the intermediate light and the optical axis 4122 of the ON light.

Further, the configuration of FIG. 79 sets the deflection angle of the mirror 4003 in the OFF state larger, at −13 degrees, than the theoretically calculated angle, i.e., −3 degrees, from the numerical aperture NA of the laser light source. The setting of such a deflection angle of mirror designates the angle, as −26 degrees, between the optical axes 4124 of the OFF light and the optical axis 4123 of the intermediate light. That is the angle between the optical axis of the OFF light and the optical axis 4122 of the ON light is −52 degrees.

As described above, each light flux can be clearly separated by using such a light source 4002 possessing a coherent characteristic and setting the deflection angle of the mirror 4003 larger than the conventional theoretically calculated deflection angle of the mirror 4003. As a result, it is possible to prevent more securely the diffraction light and/or scattered light, which are generated by a mirror producing an OFF light and tilting in an OFF angle, from entering the projection optical system 4125. As a result, the contrast of an image is improved.

Further, the setting of the deflection angle of mirror larger than a theoretically calculated value makes it possible to reduce the influence of diffraction light on a projected image even in the case of changing the deflection axis of a mirror element.

Note that the deflection angle of the mirror 4003 in the OFF state and ON state may be set at any angle provided that it is larger than the ±3-degree deflection angle shown in FIG. 78A.

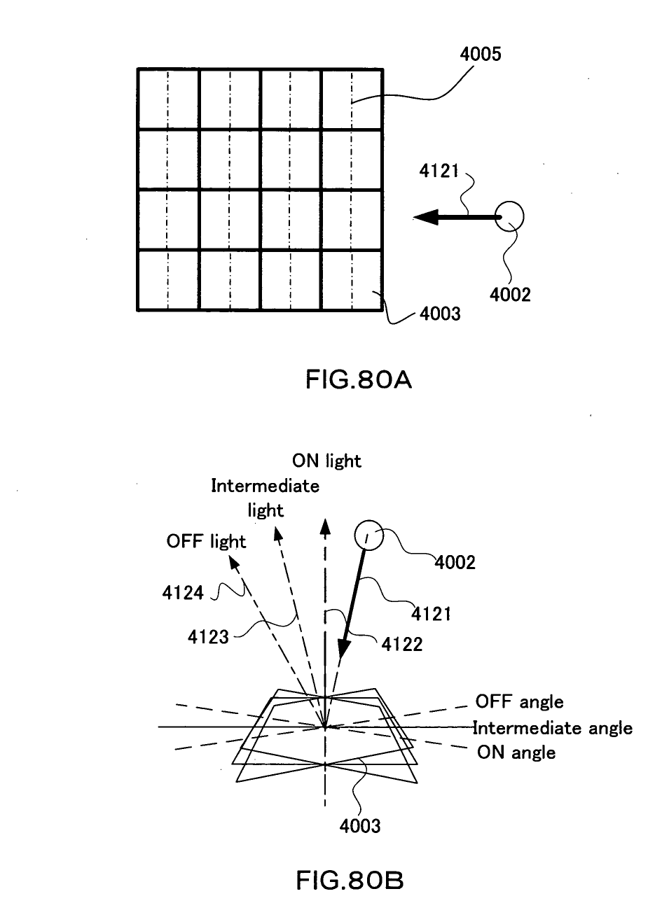

FIG. 80A is a top view diagram of a mirror array, with the deflection axis of the mirror shown in FIG. 69 changed.

The difference between FIG. 80A and FIG. 69 is where the deflection axis 4005 is placed on the center division line of the mirror 4003 in the former configuration, in stead of the diagonal direction of the mirror 4003 in the latter. Further in FIG. 80A, the optical axis 4121 of the illumination light emitted from a light source 4002 possessing a coherent characteristic is made to enter the mirror 4003 perpendicularly to the deflection axis.

FIG. 80B illustratively shows the deflection of the mirror 4003 and the reflecting direction of light in the configuration shown in FIG. 80A.

When the mirror 4003 is tilted CW, the deflection angle of the mirror 4003 is in an ON light state in which the illumination light is reflected to the optical axis 4122 of an ON light with which the entirety of light is incident toward the projection optical system.

When the mirror 4003 is in the initial state, the deflection angle thereof is in an intermediate state in which the illumination light is reflected to the optical axis 4123 of an intermediate light with which a portion of light is incident toward the projection optical system.

When the mirror 4003 is tilted CCW, the deflection angle of the mirror 4003 is in an OFF light state in which the illumination light is reflected to the optical axis 4124 of an OFF light with which no light is incident toward the projection optical system.

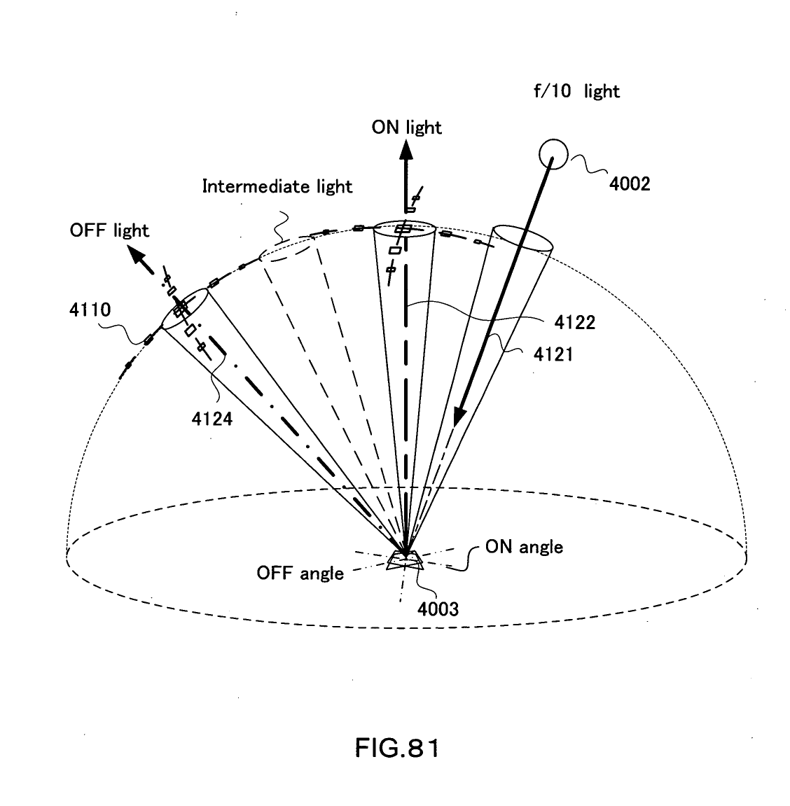

FIG. 81 is a diagram further showing the expansion of diffraction light by delineating, in three dimensions, the relationship between the deflection angle of the mirror and the light flux shown in FIG. 79 in the case in which the directions of the deflection axis of a mirror element are changed as shown in FIG. 80A.

The diffraction light of an OFF light is generated perpendicularly to the direction of the respective sides of a mirror and in the direction of the light path of an ON light starting from the optical axis of the OFF light. A larger value is provided as an angle between the optical axis of the ON light and that of the OFF light, however, and therefore the diffraction light 4110 does not enter the projection optical system. As a result, the extraneous diffraction light 4110 generated by the reflection of light by a spatial light modulator does not enter the projection optical system and thereby the contrast of the projected image is improved.

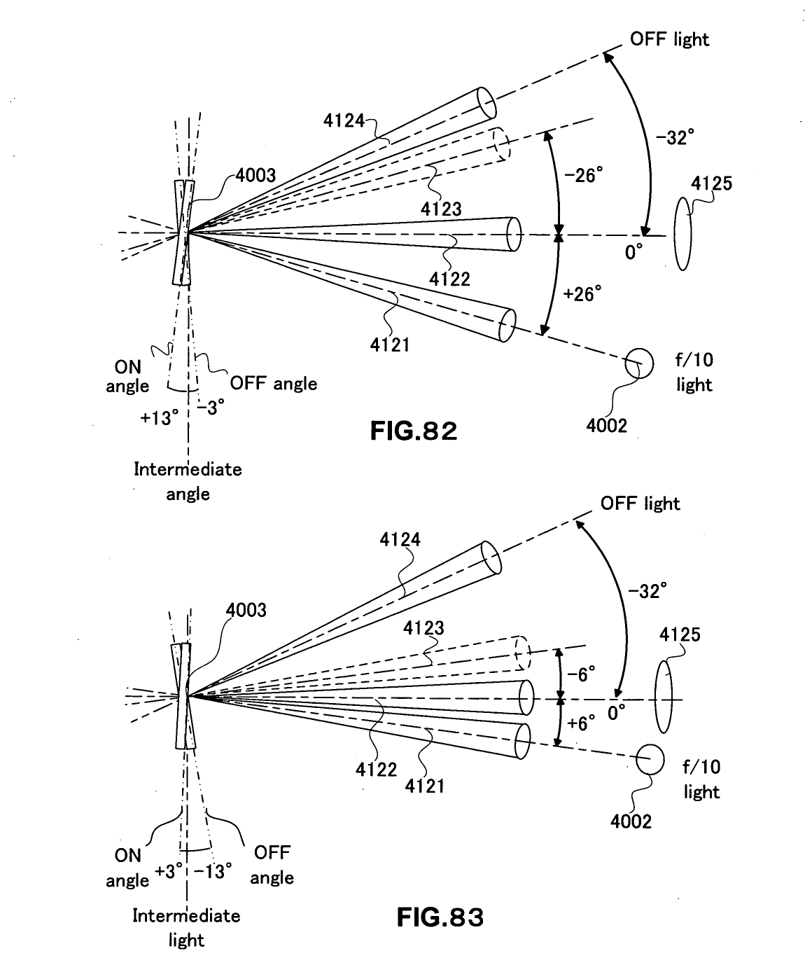

Furthermore, the present embodiment does not need to set the deflection angle of an ON light state and that of an OFF light state in an equal angle such as ±12 degrees, as in a conventional method. Accordingly, the following provides examples of different deflection angles between the ON light state of mirror and the OFF light state thereof with reference to FIGS. 82 and 83.

FIG. 82 is an illustrative cross-sectional diagram delineating a situation in which an f/10 light flux emitted from a light source 4002, which possesses a coherent characteristic, is reflected by a spatial light modulator for which the deflection angles of the ON light state and OFF light state of a mirror are set at +13 degrees and −13 degrees, respectively.

With the deflection angle of a mirror 4003 in an ON light state being set at +13 degrees, an angle of +26 degrees is provided between the optical axis 4122 of an ON light and the optical axis 4121 of an illumination light so that the light flux of the ON light enters a projection optical system 4125 without overlapping with the illumination light flux.

Further, with the deflection angle of the mirror 4003 in an intermediate state being set at “0” degrees, an angle of −26 degrees is provided between the optical axis 4123 of an intermediate light and the optical axis 4122 of the ON light so that the light flux of the intermediate light enters the projection optical system 4125 without overlapping with the flux of the ON light.

Further, with the deflection angle of the mirror 4003 in an OFF state being set at −3 degrees, an angle of −6 degrees is provided between the optical axis 4124 of an OFF light and the optical axis 4123 of the intermediate light so that the flux of the OFF light does not overlap with not only the flux of the ON light but also the flux of the intermediate light.

Configuring as described above makes it possible to prevent the diffraction light and/of scattered light generated by a mirror producing the OFF light and tilting in the OFF angle from entering the projection optical system 4125 further securely.

As exemplified in FIG. 76, Diffraction light 4110 is generated perpendicularly to the directions of the respective sides of a mirror 4003. The optical axis of an OFF light, which is designated by setting a deflection angle considering an optimization of the usage efficiency of light output from a discharge lamp light source according to the conventional method, is close to the optical axis 4122 of an ON light, allowing the diffraction light 4110 to enter the projection optical system 4125, and there is accordingly a possibility of making the projected light brighter. The present embodiment, however, using a light source possessing a coherent characteristic, is enabled to set the optical axis 4124 of an OFF light and the optical axis 4122 of an ON light sufficiently apart from the theoretical optical axis of the OFF light (i.e., the ±3-degree deflection angle of a mirror), and thereby the influence of the diffraction light 4110 on the projection optical system 4125 can be reduced. This in turn improves the contrast of an image.

FIG. 83 is an illustrative cross-sectional diagram delineating a situation in which an f/10 light flux emitted from a light source, which possesses a coherent characteristic, is reflected by a spatial light modulator for which the deflection angles of the ON light state and OFF light state of a mirror are set at +3 degrees and −13 degrees, respectively.

With the deflection angle of mirror in an ON state being set at +3 degrees, an angle of +6 degrees is provided between the optical axis 4122 of an ON light and the optical axis 4121 of an illumination light so that the flux of the ON light enters a projection optical system 4125 without overlapping with the illumination light flux.

Further, with the deflection angle of mirror in an intermediate state being set at “0” degrees, an angle of −6 degrees is provided between the optical axis 4123 of an intermediate light and the optical axis 4122 of the ON light so that the flux of the intermediate light enters the projection optical system 4125 without overlapping with the flux of the ON light.

Further, with the deflection angle of mirror in an OFF state being set at −13 degrees, an angle of −26 degrees is provided between the optical axis 4124 of the OFF light and the optical axis 4123 of the intermediate light so that the flux of the OFF light does not overlap with not only that of the ON light but also that of the intermediate light. Configuring as such makes it possible to prevent the OFF light from entering the projection optical system 4125 securely.

As exemplified in FIG. 76 unique phrase, Diffraction light 4110 is generated perpendicularly to the directions of the respective sides of a mirror 4003. The optical axis of an OFF light, which is designated by setting a deflection angle considering an optimization of the usage efficiency of light output from a discharge lamp light source according to the conventional method, is close to the optical axis 4122 of an ON light, allowing the diffraction light 4110 to enter the light path of the ON light, leading to the projection optical system 4125, and there is accordingly a possibility of making the projected light brighter. The present embodiment, however, is enabled to set the optical axis 4124 of an OFF light and the optical axis 4122 of an ON light sufficiently apart from the theoretical optical axis of the OFF light (i.e., the ±3-degree deflection angle of a mirror), and thereby the influence of the diffraction light 4110 on the projection optical system 4125 can be reduced. This in turn improves the contrast of an image.

As described thus far, the present embodiment, comprising a light source possessing a coherent characteristic, allows an appropriate alternative setting of the deflection axis of a mirror, the deflection angle of the mirror in an ON light state and that of the mirror in an OFF light state. Preferably, the deflection angle of a mirror can possibly be set in such a manner that the mirror deflects clockwise (CW) in any of ±3 degrees through ±13 degrees in relation to the initial state, and the deflection angle of the ON light state and that of the OFF light state may be asymmetrically set.

### Embodiment 7

The following is a detail description of a preferred embodiment of the present invention with reference to the accompanying drawings.

### Embodiment 7-1

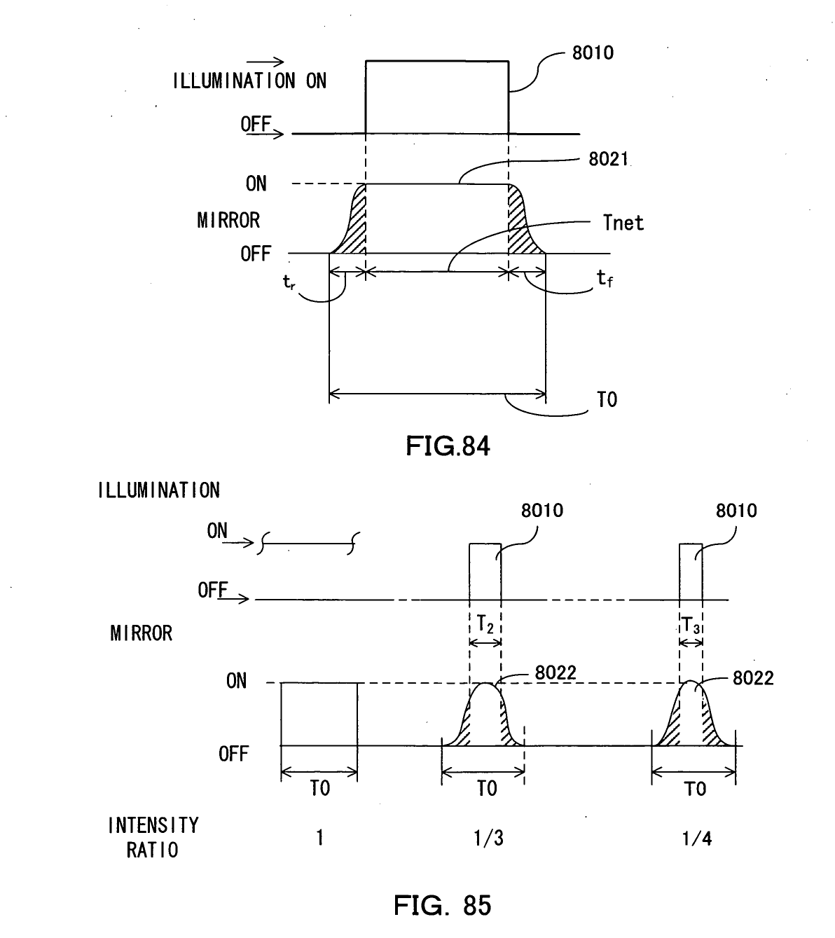

FIGS. 84 and 85 are timing diagrams for illustrating the operation sequences of a projection apparatus according to a preferred embodiment of the present invention.

A projection apparatus according to the present embodiment may be implemented according the apparatuses described as a single-panel projection apparatus 5010 that includes the optical system as depicted in the above described FIG. 21 and the control system (i.e., the control 5500 and control unit 5505) as that depicted in the above described FIG. 23A. The image projection apparatuses carryout a projection display of a color image by implementing a color sequential display method.

Furthermore, the projection display of a color image by applying a color sequential display with two-panel projection apparatus may also be implemented. The apparatuses employ a control system as that illustrated in the above described FIG. 23A and modifying the control system to a configuration suitable for use in a two-panel projection apparatus. The image projection apparatuses further implement the optical system as depicted in the above described FIGS. 66A, 66B, 66C and 66D.

Specifically, the SLM controller 5530 of the control unit 5500 as that implemented by the projection apparatus 5010 generates a light source profile control signal 5800 based on the input digital video data 5700. The light source profile control signal are then inputted to a light source control unit 5560 through a sequencer 5540.

The light source control unit 5560 controls the pulse width to project pulse emission from the red laser light source 5211, green laser light source 5212 and blue laser light source 5213 of a light source 5210 as flashing lights. The speed of flashing rates controlled by the light source profile control signal 5800 for switching between different color of laser lights has a higher speed than the rate of state changes of the mirrors 4003 implemented in spatial light modulator 5100 for modulating the lights of different colors. Specifically, FIG. 84 shows the light source control unit 5560 controls the light source 5210 to turn on only for the period when a mirror is operated at a “stable ON” time shown as Tnet i.e., a second time length. The stable ON time is shorter than one ON operation period shown as the mirror ON period TO, i.e., a first time length, of the mirror 4003 as indicated in the mirror ON/OFF control pattern 8021.

Therefore, the mirror ON period TO includes a rise time tr, a mirror stable ON time Tnet and a fall time tf. The mirror 4003 is unstable during the period of the rise time tr and fall time tf. The operation of the mirror during these unstable ON time periods generate a noise in reflection light 5602.

In order to minimize the adverse effects of the reflection during the unstable ON time periods, the present embodiment implements a light source control to turn on the light source 5210 only for a period of time of the mirror stable ON time Tnet. The light source is controlled by a light source pulse pattern 8010. With properly arranged light source control signals, the reflection light during the unstable ON periods including the rise time tr and fall time tf are eliminated because the light source is turned off during these periods. Therefore, accurately control of the intensity of the reflection light 5602 is achievable by controlling the projection periods the incident light 5601 from the light source incident to the spatial light modulator 5100.

Furthermore, the control method for controlling the mirror 4003 can also be applied to an apparatus implemented with an oscillation control. With oscillation control schemes, in addition the ON/OFF mirror states as depicted in FIG. 84, the mirror 4003 is controlled to oscillate between the ON state and OFF state. In an oscillation state of the mirror 4003, the light source pulse pattern 8010 is controlled to have variable pulse width, The light source pulse width T2 and a light source pulse width T3 are illustrated in FIG. 85. Therefore, compared with the light source that is kept on continuously, the intensity of the reflection light 5602 can be flexibly adjusted to achieve to more accurately control the light intensity to coordinate with the oscillations of the mirrors.

FIG. 85 depicts the intensity of the reflection light 5602 that is controllable by controlling the length of time in turning on the light source when the mirror 4003 is operated at an ON state. The length of time when a mirror 4003 is operated at an ON state is denoted as a period TO and the light intensity reflected from the mirror by keeping the light source 5210 continuously turned on is defined as one unit. In this embodiment, the light source 5210 is controlled to project lights as pulse emission. The light source control signal has a light source pulse width T2. The pulse width T2 is smaller than the pulse width TO when the mirror is operated at an ON state. Furthermore, the center portion of FIG. 85 shows a mirror ON period TO in which the mirror 4003 is in an oscillation state. The mirror is controlled to oscillate in accordance with a mirror oscillation control pattern 8022. Therefore, the intensity of the reflection light is controlled at ⅓ unit of the reflection light 5602 (as shown at the center of FIG. 85). Alternately, the light source 5210 is controlled to project pulse emission by controlling the light source with a light source pulse width T3 that is even smaller than the light source pulse width T2. Therefore, the intensity of the reflected light can be controlled at ¼ unit of the reflection light 5602 (as shown on the left end of FIG. 85).

With the reduced amount of light that is controllable, accurately control of the intensity of the reflection light 5602 (i.e., projection light 5603) in down to an amount of about ⅓ unit and ¼ unit is achievable by controlling the pulse emission of the light source 5210 with different pulse width. The pulse width may be flexibly controlled in a period in which the change amount of the intensities of the reflection light 5602 reflected from the mirror 4003. Generally, smallest amount of controllable light is achievable when the mirror 4003 of the spatial light modulator 5100 is operated in the oscillation state.

### Embodiment 7-2

The following is a description of an exemplary embodiment for improving a degree of freedom in a color expression. Improvements of the color temperature and color balance are achievable for a projection image by controlling the pulse emission projection of the light source 5210 without changing the input digital video data 5700.

Step 1: the control signal inputted to SLM controller 5530 as control words, shown as one frame of input digital video data 5700, are dived into R, G and B pieces of data, noted as “RBG data” hereinafter.

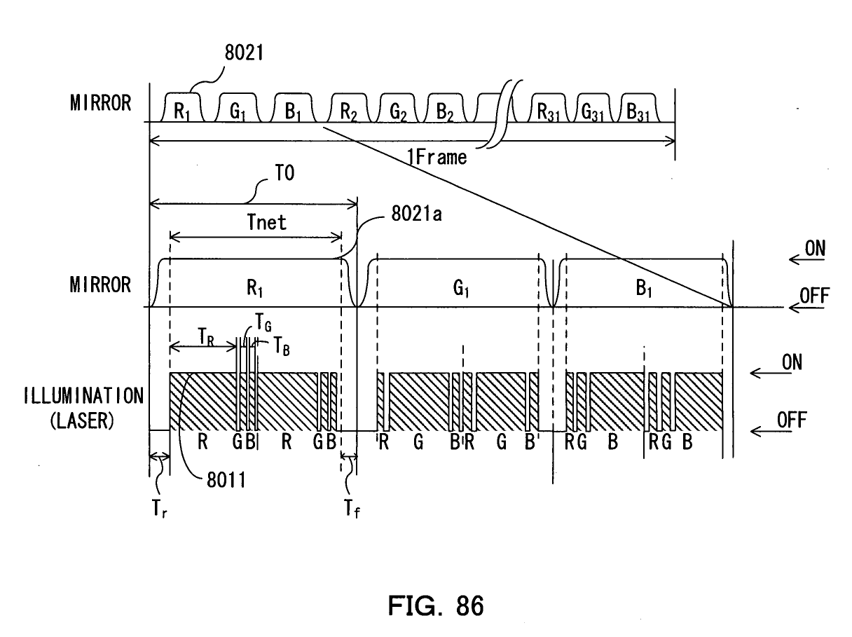

Step 2: the SLM controller 5530 further divides the RGB data into a plurality of pieces, e.g., 31 pieces when the input data is for a 5-bit gray scale; 127 pieces when the input data is for 7-bit gray scale. FIG. 86 further shows the mirror ON/OFF control patterns 8021.

Step 3: the SLM controller 5530 processes the RGB data now divided according to the R, G and B colors as sub-fields, rearranges the sub-fields in order of R, G and B, and generates a one-frame control signal (Data) (i.e., a mirror ON/OFF control pattern 8021a shown in FIG. 86) for controlling the spatial light modulator 5100.

Step 4: the SLM controller 5530 generates a control signal, i.e., a light source pulse pattern 8011 shown in FIG. 86, for the light source 5210. The light source pulse pattern 8011 inputted to the light source thus control all the red laser light source 5211, green laser light source 5212 and blue laser light source 5213 to emit the respective colors R, G and B for the respective periods of individual sub-fields.

Furthermore, the SLM controller 5530 generates the light source pulse pattern 8011 to increase the emission time length of the light source of the main color for image display in each sub-field and decrease the emission time lengths of the light source of the remaining colors. As an example, for displaying the color red (R) of the light source pulse pattern 8011 of the sub-field as shown in FIG. 86, the light source pulse pattern 8011 is generated to shorten a green light source turn-on time TG (e.g., a pulse width) and a blue light source turn-on time TB (e.g., a pulse width) relative to a red light source turn-on time TR (e.g., a pulse width) that is the main color.

Furthermore, the exemplary embodiment provides controllable lengths of time for controlling the red light source turn-on time TR, green light source turn-on time TG and blue light source turn-on time TB. These controllable lengths of time are the respective emission time lengths of the light sources of the main color (i.e., red in this case) and other colors, are set within the mirror stable ON time Tnet. Other then the main color, the lengths of time are controlled to have a shorter length than the control unit time (i.e., the mirror ON period TO) of the mirror 4003 implemented in the spatial light modulator 5100. These subfields for each color are controlled to carry out a sequential emission of the respective colors R, G and B, or two colors from among R, G and B during the display period of sub-frames on an as required basis.

FIG. 86 shows the exemplary embodiment wherein the sequential emissions of R, G and B and the length of the red light source is twice than the lengths of the turn-on time TR, green light source turn-on time TG and blue light source turn-on time TB during the mirror stable ON time Tnet.

Step 5: the SLM controller 5530 receives and applies the light source pulse pattern 8011 corresponding to the light source profile control signal 5800 to control the light source 5210 and also controls the spatial light modulator 5100 using the above described control signal (Data) of the spatial light modulator 5100.

According to the control processes, the projection apparatus 5010 controlled with a color sequential method using the input digital video data 5700 and implements the projection optical system 5400 to project a color video image on a screen 5900 using the color sequential display method Specific benefit of the present embodiment are summarize and discussed below. Changing the ratio of the time lengths (i.e., the red light source turn-on time TR, green light source turn-on time TG and blue light source turn-on time TB) of the respective color lights, i.e., R, G and B, emitted during the display period of sub-frames can achieve the desired color balance of the color video image by using the projection light 5603 projected on the screen 5900 by way of the projection optical system 5400. The color balance is achieved without changing a control signal (Data) for the spatial light modulator 5100.

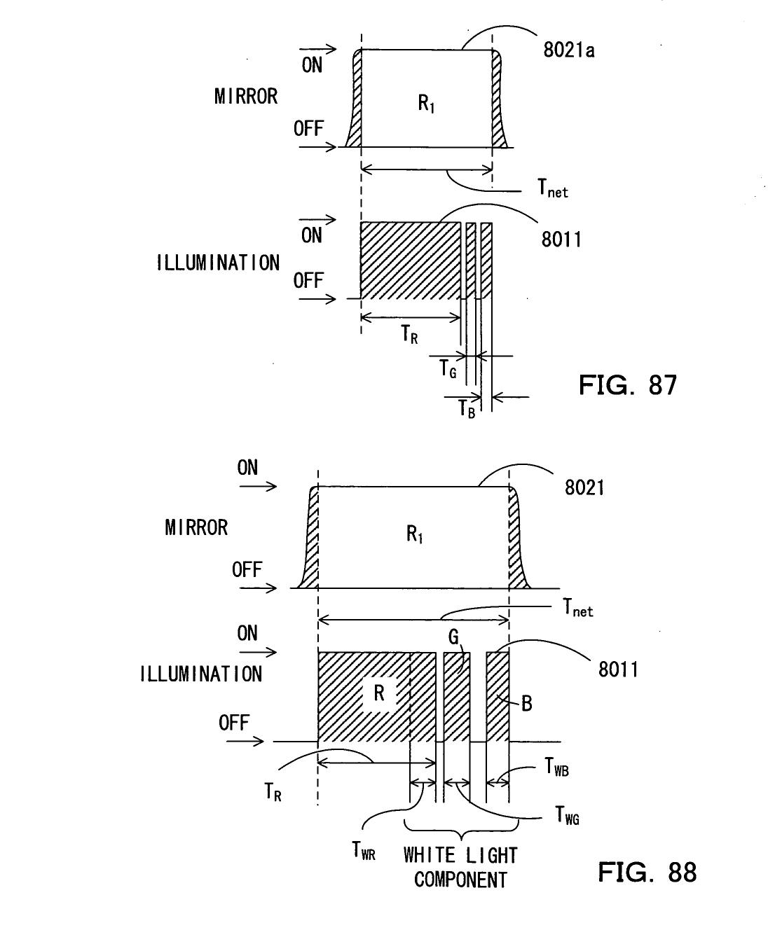

FIG. 87 is a timing diagram for illustrating an exemplary length of time TR for turning on the red light source as the main color for the period of displaying sub-frames relative to the green light source turn-on time TG and blue light source turn-on time TB. For simplicity, FIG. 87 depicts the sequential RGB turning on times in one cycle of emission during the mirror stable ON time Tnet. According to FIG. 87, the length of the turning-on time during the mirror stable ON time Tnet for each color, i.e., the red light source turn-on time TR, green light source turn-on time TG and blue light source turn-on time TB are set at a constant ratio. Alternatively, each of the red light source turn-on time TR, green light source turn-on time TG and blue light source turn-on time TB can be set at respectively a predetermined time length. Furthermore, the red light source turn-on time TR, green light source turn-on time TG and blue light source turn-on time TB can respectively be controlled as flexibly adjustable time lengths. Or, by changing the ratios appropriately among the red light source turn-on time TR, green light source turn-on time TG and blue light source turn-on time TB can further adjust the color balance. Specifically, the changing the ratios among the red light source turn-on time TR, green light source turn-on time TG and blue light source turn-on time TB, is equivalent to changing the color coordinates on a chromaticity diagram (not shown in a drawing herein). The image projection apparatus enables the control system to control the color temperature of a color video image displayed on the screen 5900 using the projected light 5603 by appropriately changing the ratio among the red light source turn-on time TR, green light source turn-on time TG and blue light source turn-on time TB.

The following summarizes a further benefit of the present embodiment that the image projection apparatus is able to enhance brightness. Brightness enhancement may be achieved by controlling the green light source turn-on time TG and blue light source turn-on time TB overlapping with time period of the red light source turn-on time TR during the display period of one main color (i.e., red in this case) according to the light source pulse pattern 8011 shown in the above described FIG. 86.

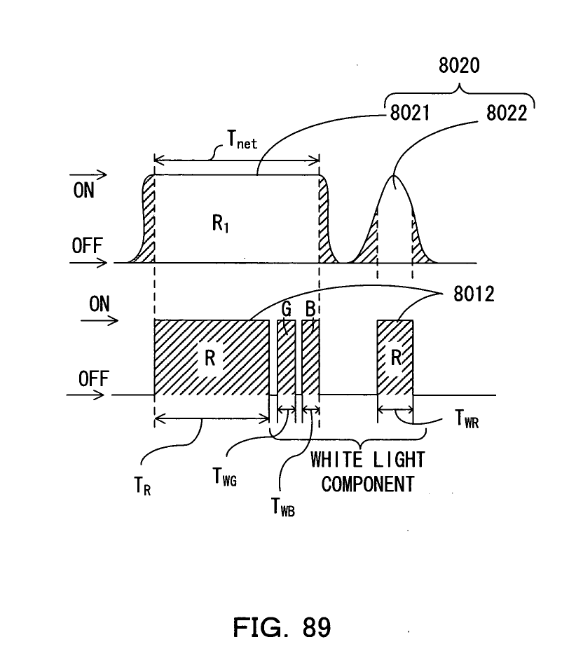

FIG. 88 is a timing diagram for illustrating the principle of improving the brightness. For simplicity, FIG. 88 depicts a display of one cycle of R, G and B during a mirror stable ON time Tnet similar to the above-described FIG. 87. Specifically, the green light source turn-on time TG (i.e., white light/green component TWG) and blue light source turn-on time TB (i.e., white light/blue component TWB) are controlled to overlap with the time period of the main red light source turn-on time TR during the mirror stable ON time Tnet. The colors are synthesized with the white light/red component TWR contained in the red light source turn-on time TR, thereby generating a white component to proportionately enhance the brightness of the projection image. FIG. 88 thus illustrates an enhancement in the brightness by increasing a white component in the case of the ON/OFF control for the mirror 4003. Enhancement of the brightness may also be achieved by combining the ON/OFF control of the mirror 4003 with an oscillation control thereof as shown in FIG. 89. Specifically, FIG. 89 depicts a light source pulse pattern 8012 to increase a white light component by combining other white light/green component TWG and white light/blue component TWB. This is achieved by controlling the mirror 4003 for combining the ON/OFF control with an oscillation control in accordance with a mirror control signal profile 8020 that includes a mirror ON/OFF control pattern 8021 and a mirror oscillation control pattern 8022. Specifically, FIG. 89 illustrates the light source pulse pattern 8012 for controlling the white light/green component TWG and white light/blue component TWB to overlap with the main red light source turn-on time TR during the ON/OFF control period corresponding with the mirror ON/OFF control pattern 8021. The white light/red component TWR has a light intensity balances with the two color components simultaneously projected during the period of the mirror oscillation control pattern 8022.

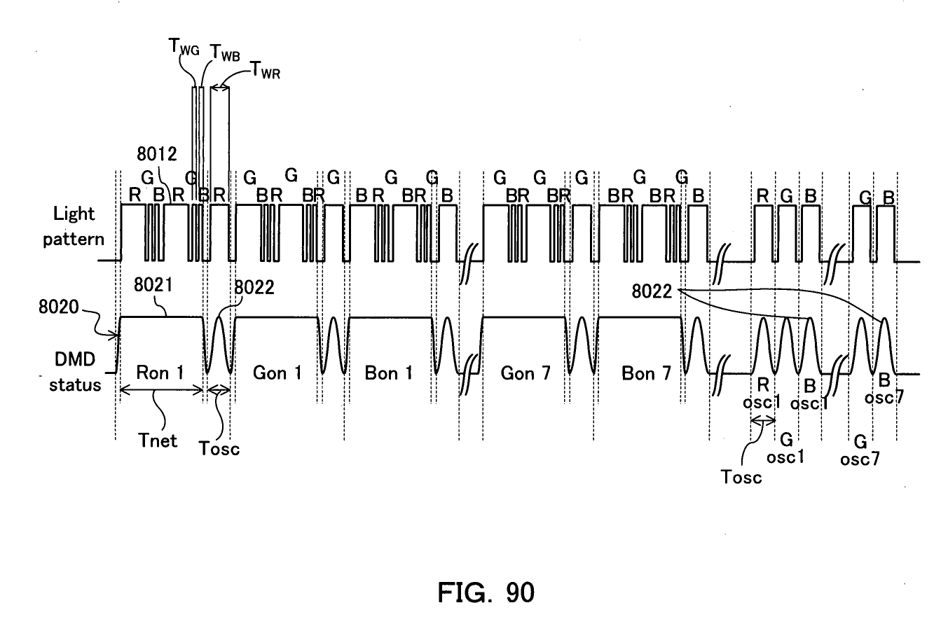

FIG. 90 depicts the control process of a 6-bit gray scale display carried out with a 3-bit ON control and a 3-bit oscillation control in order to display digital video image data (i.e., the input digital video data 5700) in 6-bit gray scale for each color. There are three bit for each color for controlling the mirror 4003 to operate at an ON state in the seven times of ON periods during the display period of one frame of a display video image according to the mirror ON/OFF control pattern 8021. Specifically, The mirror projects in each ON period a brightness equivalent to the LSB of the upper 3-bit of respective colors according to the input data during the respective ON period. In the ON periods for each color, the mirror 4003 is repeatedly operated at an ON state a plurality of times (i.e., two times in this configuration) of the pulse emission of the red laser light source 5211, green laser light source 5212 and blue laser light source 5213 of the respective colors R, G and B for a shorter time length than the ON period. The ratio of the pulse emission of the respective colors are set to maximize the ratio of the main color displayed through reflecting from a mirror 4003 that is controlled to synchronously operate at an ON state. Following each ON time for different colors, the mirror oscillation control pattern 8022 controls the mirror to operate in one oscillation state and the pulse emission (i.e., white light/red component TWR) of the main color (i.e., red (R) is projected at the beginning of the frame as shown in of FIG. 90 with the main color displayed during the previous ON time. The main color display time during last cycle has a shorter time (i.e., a second time length), that shorter than the oscillation time length (i.e., a mirror oscillation period Tosc; first time length). This control process causes a white component projected as the sum of the pulse emission (e.g., white light/red component TWR) corresponding to the oscillation state and the plus emissions (i.e., the white light/green component TWG and white light/blue component TWB) of the two lights (i.e., G and B). The projection light has brightness more than the main color emitted during the previous ON time, thereby increasing the brightness of the video image. After the mirror 4003 is controlled to operate at an ON state, the mirror is controlled to operate at an oscillation state according to the 3-bit for the respective colors, that is, 7 times of oscillation, during the display period of one frame. Specifically, The brightness is therefore equivalent to the LSB of the lower 3-bit of each color of the input data in each oscillation period. In each oscillation control, the pulse projections of a laser light source of either color of R, G and B project to the mirror 4003 during length of time that is shorter than each oscillation time length (i.e., the mirror oscillation period Tosc).

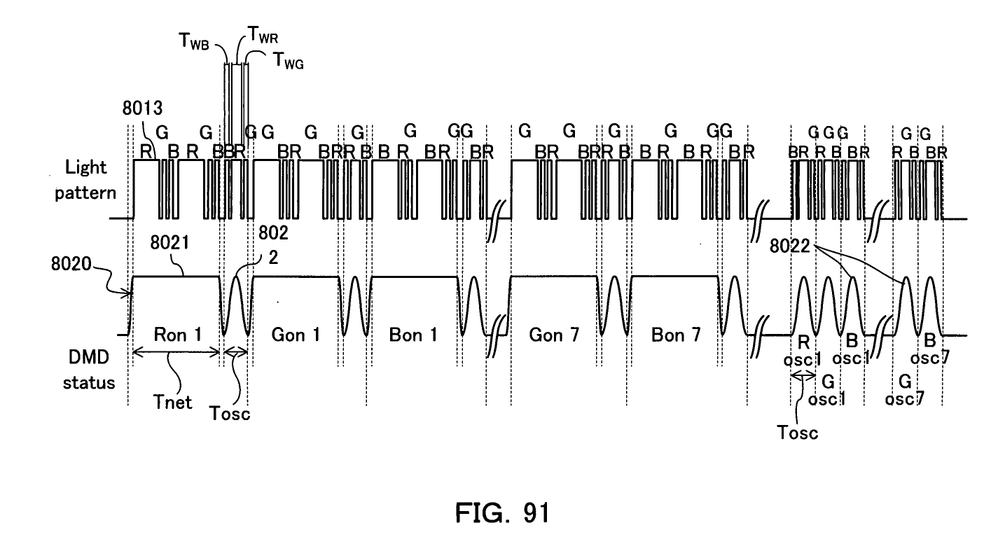

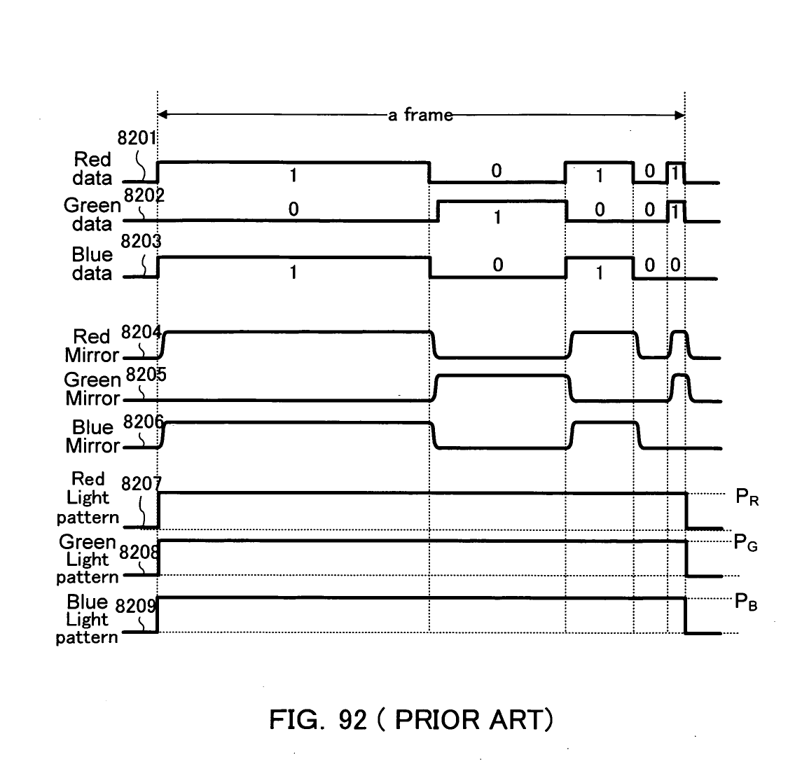

The control process described above applies a 6-bit gray scale display control for each color during the display period of one frame. Meanwhile, FIG. 91 is a timing diagram for showing the light source pulse pattern 8012 and mirror control signal profile 8020 for carrying out a 6-bit gray scale display control with a 3-bit ON control and a 3-bit oscillation control in order to display the input digital video data 5700 in 6-bit gray scale for each color. Specifically, the spatial light modulator 5100 applies the mirror ON/OFF control pattern 8021 for carrying out the mirror ON time control includes 3-bit ON period for each color. Therefore, during the display period of one frame of a display video image there are 70N times for each color. Specifically, With such control process, the brightness is equivalent to the LSB of the higher 3-bit of each color of the input digital video data 5700 inputted during each ON period.

During each ON period the pulse projection from the red laser light source 5211, green laser light source 5212 and blue laser light source 5213 of the respective colors R, G and B projects light to the mirror 4003 a plurality of times according to the mirror ON/OFF control pattern 8021, i.e., two times in the example of FIG. 91. The length of ON time has a shorter time length (i.e., the mirror stable ON time Tnet) than the ON period of the mirror. The ratio of the pulse width for projecting different colors is set to maximize the pulse width of the main color of display by controlling a mirror 4003 operated at an ON state.

Subsequent to the ON time corresponding to the mirror ON/OFF control pattern 8021 for each color, the mirror is controlled to operate at one oscillation state according to the mirror oscillation control pattern 8022. The pulse width of the main color (i.e., R in the example of the head side of FIG. 91) displayed in the previous ON time is set with a shorter time length than the oscillation time length (i.e., the mirror oscillation period Tosc).

The color balance of the display video image is adjusted by the ratio of the pulse width for each color (i.e., the white light/red component TWR) corresponds to the oscillation state. The color balance is further adjusted by taking into account the pulse width of two colors other than the main color emitted during the previous ON time, i.e., G and B, or the white light/green component TWG and white light/blue component TWB) of two colors. Subsequent to the mirror is controlled to operate at an ON state, the mirror 4004 is controlled to operate at an oscillation state according to a 3-bit oscillation control signal for the respective colors, that is, 7 times of oscillation, during the display period of one frame. Therefore, a Specifically, brightness equivalent to the brightness according to the LSB of the lower 3-bit of each color of the input data is achieved during the respective oscillation periods.

In the respective periods when the mirror is operated in the oscillation state, the mirror 4003 is irradiated by repeating a plurality of times (i.e., one time in this case) of pulse emission (i.e., the white light/blue component TWB, white light/red component TWR and white light/green component TWG) of laser light sources of three colors R, G and B. The pulse emission for each color is projected in a shorter time length than the respective oscillation time lengths. The ratio of the pulse emission of the respective colors is set to maximize the main color light projection by controlling a mirror 4003 operated in an oscillation state. The pulse emission of the mirror is controlled to be at a timing coincides with the center of the oscillation state. The color balance of the display video image is adjusted by adjusting the ratio of the reflection light intensities of the light of each colors R, G and B and adjusting the intensities reflected during the oscillation period. The control processes as described above allows the flexibility of adjusting the color balance of a displayed video image in addition to a 6-bit gray scale display for each color during the display period of one frame.

Furthermore, the present invention may be implemented in various alternated and modified embodiments within the scope of the present invention. The scope of the invention is not limited to the specifically described embodiments.

### Embodiment 8

The following description is for additional embodiments of the present invention with reference to the accompanying drawings. The following description of the preferred embodiment may further be implemented and incorporated with the configuration and operation of the projection apparatus described in the above described respective embodiments. Note that the same component sign is assigned to the same constituent component comprised in the above-described respective embodiment, and the duplicate description is not provided here.

The projection apparatus according to the present embodiment comprises at least two adjustable light sources with different colors projected at different wavelengths. At least one light source driver is implemented for driving the respective adjustable light sources. At least one timing controller controls the emission timings of the respective variable light sources. At least two spatial light modulators apply different modulation states modulate the illumination lights from the respective adjustable light sources in accordance with the display data of each pixel by means of an addressable plurality of pixel elements generally referred to as the mirror elements. At least one spatial light modulator controller selectively controls the modulation of each pixel element of the respective spatial light modulators.

In an exemplary embodiment, the projection apparatus is configured as a three-panel projection apparatus with an optical projection path implemented by the configuration shown in the above described FIG. 22A, 22B or 22C. The projection system may also be implemented by the configuration shown in the above described FIG. 23B. In the case of implementing a system with the configuration shown in FIG. 23B, a light source drive circuit 5570 (i.e., light source drive circuits 5571, 5572 and 5573) can be implemented by using the configuration shown in the above described FIG. 24A.

Likewise, when one light source drive circuit 5570 is used for each light source in a system configuration shown in FIG. 23B, a projection system according to the configuration shown in FIG. 24B may be implemented.

With the light source drive circuit 5570 shown in FIG. 24A or 24B, there is a relationship between the emission light intensity Pₙ and the current I conducted in the constant current circuit 5570a in the light source drive circuit 5570 as shown in the above described FIG. 26.

When the projection apparatus according to the present embodiment is configured as a two-panel projection apparatus, an optical projection system can be implemented according to the configurations shown in the above described FIGS. 66A, 66B, 66C and 66D. A system configuration can be implemented by changing the configuration of FIG. 23A to a configuration for use in a two-panel projection apparatus.

The projection apparatus according to the present embodiment is configured with both the timing controller (such as a light source control unit 5560) and the spatial light modulator controller (such as a SLM controller 5530), or all the timing controller, the spatial light modulator controller and light source driver (such as the light source drive circuit 5570), are incorporated on the same semiconductor chip or as proximity circuits on the same circuit substrate. The reason is that the adjustable light source and the spatial light modulator are controlled ever in high speed in keeping with the higher resolution and higher resolutions of gray scale for image display. Also the adjustable light source is controlled synchronously with the modulation operation of the spatial light modulator. Therefore, the influences of a circuit delay, a wiring delay in a signal transfer, et cetera, on a timing signal used for the aforementioned control must be reduced to a minimum as much as possible.

The following description is to explain the control processes for the spatial light modulator and variable light source for an exemplary embodiment implemented with a three-panel projection apparatus with a configuration shown in the above described FIG. 23B.

The descriptions begin with an example of the control process of the spatial light modulator and variable light source in the conventional three-panel projection apparatus. The description presents the difference between the three-panel projection apparatus according to the present embodiment and the conventional three-panel projection apparatus.

FIG. 92 is a diagram that illustrates an exemplary control operation. This conventional control process is based on an assumption that the gray scale of the respective colors, i.e., red (R), green (G) and blue (B), in one frame period is 5-bit.

In the exemplary control process shown in FIG. 92, binary data 8201, binary data 8202 and binary data 8203 are input as ON/OFF control signals for the respective one mirror elements of the spatial light modulators of respective colors R, G and B in one frame period. The control process is carried out with the light source patterns of the adjustable light sources of the respective colors R, G and B are controlled according to a light source pattern 8207 of an output P_{R}, a light source pattern 8208 of an output P_{G} and a light source pattern 8209 of an output P_{B}, respectively. Then, according to the control process, the ON/OFF state of one mirror element is corresponding to the mirror modulation control waveform 8204, mirror modulation control waveform 8205 and mirror modulation control waveform 8206, for the spatial light modulators of the respective colors R, G and B. The mirror modulation control waveform 8204, mirror modulation control waveform 8205 and mirror modulation control waveform 8206 are in accordance with the binary data 8201, binary data 8220 and binary data 8203, respectively.

With such a control process, only the light of G is projected onto a screen for over a prescribed period according to the contents of the pieces of binary data 8201, 8202 and 8203. Such projection may produce an image display with a color break that may occur when a color display is projected with a single-panel projection apparatus. Furthermore, different from a single-panel projection apparatus, the conventional three-panel projection apparatus is configured to simultaneously carry out the spatial light modulations of the respective colors R, G and B in parallel for over the period of one frame. Therefore, the light of one color may be projected onto a screen for over the period that is no less than the case of the single-panel projection apparatus depending on the contents of the respective pieces of binary data of the individual colors. Furthermore, there may be circumstances when there is a period of image projection only the light of R onto a screen, only the light of G on the screen or only the light of B on the screen. As a result, a spatial light modulation similar to the case of the single-panel projection apparatus may sometimes occur. In such a case, a color break may frequently occur.

Accordingly, a three-panel projection apparatus according to the present embodiment is configured to carry out control processes for the spatial light modulator and adjustable light source, as described in the following, The multiple panel system is implemented to eliminate an occurrence of color break that may occur due to the discontinuities of the respective pieces of binary data to display the individual colors.

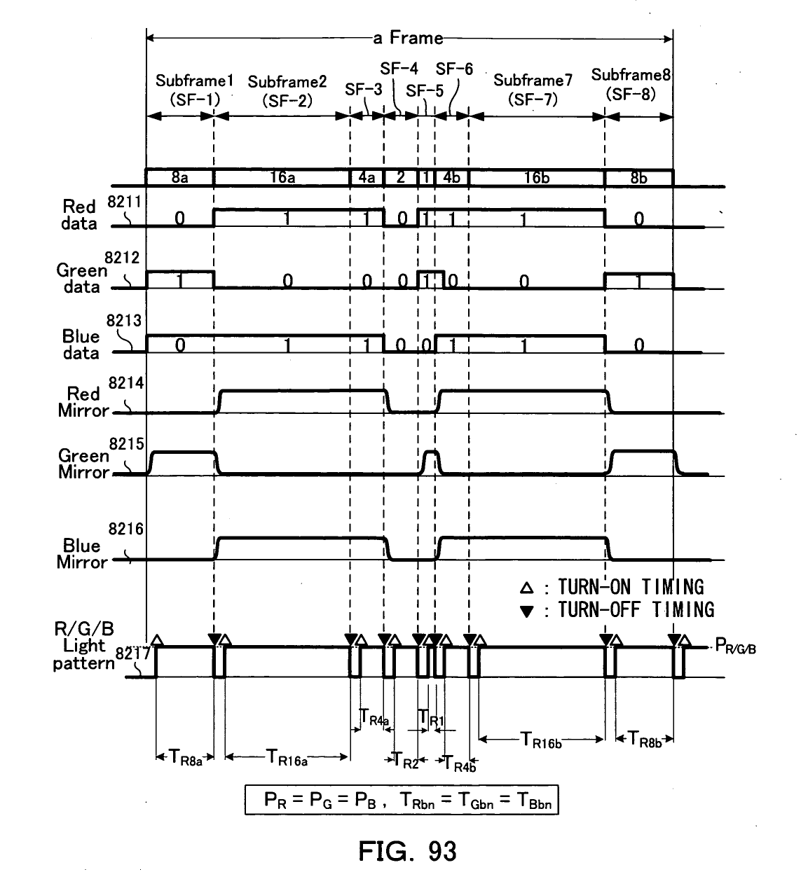

FIG. 93 is a timing diagram for illustrating the control process. Note that the present embodiment also assumes that the display gray scale of the respective colors R, G and B in one frame period is 5-bit.

In the three-panel projection apparatus according to the present embodiment, an SLM controller 5530 divides one frame into a plurality of sub-frames. The subfields are shown as SF-1 through SF-8 in a manner that the spatial light modulator 5100 has at least one modulation state as shown in FIG. 93. The subfields SF-1 and SF-8 corresponding to the fourth-bit grayscale bit, and when the sub-frame is further divided into half, one subfield is SF-1, while another subfield is SF-8. The subfields SF-2 and SF-7 are sub-frames corresponding to the fifth-bit grayscale bit (i.e. the MSB grayscale bit), and when the sub-frame is further divided into half, one subfield is SF-2, while another subfield is SF-7. The subfields SF-3 and SF-6 each are sub-frames corresponding to the third-bit grayscale bit, and when the sub-frame is further divided into half, one subfield is SF-3, while another subfield is SF-6. The subfield SF-4 is a sub-frame corresponding to the second-bit grayscale bit. The subfield SF-5 is a sub-frame corresponding to the first-bit grayscale bit, i.e., the LSB grayscale bit.

As described above, the SLM controller 5530 divides one frame into eight sub-frames. Therefore, the respective pieces of binary data of individual colors R, G and B shown in FIG. 92 are shown as binary data 8211, binary data 8212 and binary data 8213, which are shown in FIG. 93. With the conversion described above, the ON/OFF state of one mirror element of the spatial light modulators 5100 of the respective colors R, G and B is controlled according to the mirror modulation control waveform 8214, the mirror modulation control waveform 8215. The mirror modulation control waveform 8216 and these waveforms are in turn generated according to the binary data 8211, binary data 8212 and binary data 8213, respectively.

Further, in the exemplary embodiment of the three-panel projection apparatus the light source control unit 5560 includes a timing controller to carryout a control process. Each of the adjustable light sources (i.e., the red laser light source 5211, green laser light source 5212 and blue laser light source 5213) projects at least one time of pulse emission during a sub-frame period as shown in the light source pattern 8217 of an output P (i.e., the R, G and B-light source patterns of outputs P_{R}, P_{G} and P_{B}). The control process controls the respective adjustable light sources 5210 during the emission are set at the respective intensities P_{R}, P_{G} and P_{B} in accordance with the variable light sources 5210 of the respective colors R, G and B. The optical system and the visibility of an observer (not shown in a drawing herein) are taken into consideration for determining the turn-on period of the respective variable light sources for the respective sub-frames. The sub frames SF-1 through SF-8 are set at the same (i.e., T_{Rbn}=T_{Gbn}=T_{Bbn}) and such that the turn-on timing and turn-off timing of the respective variable light sources 5210 are similar to one another. Therefore, a common control operation is carried out for the respective variable light sources 5210.

The control process as described for the spatial light modulator and variable light sources divide each frame into a plurality of sub-frames. The control processes then perform the spatial light modulations of the respective colors R, G and B for each sub-frame to control the emission timings of individual colors to be coincident within each sub-frame period. A period is therefore subdivided into multiple subfields in which only the light of one color is projected onto a screen. The control process thus eliminates a circumstance with the light of only one color is projected onto the screen for an extended period of time, as in the case of the conventional three-panel projection apparatus. The control process can therefore suppress an occurrence of color break.

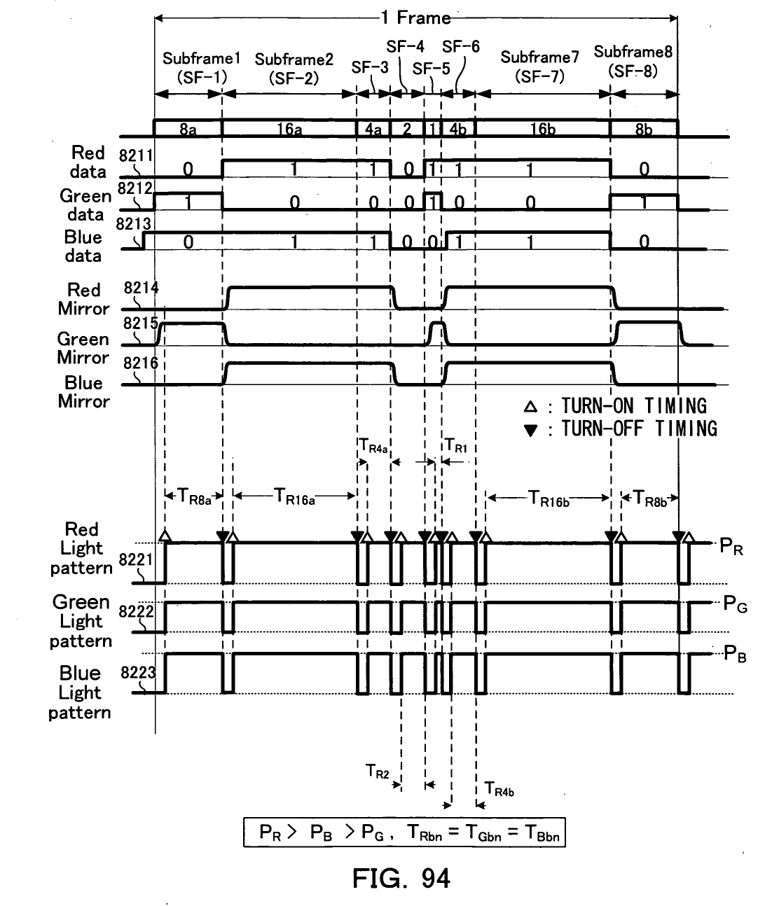

FIG. 94 is a timing diagram for showing a modified embodiment of the control process for controlling the spatial light modulator and variable light source from the control process shown in FIG. 93. In the modified embodiment shown in FIG. 94, only the control process for the adjustable light source 5210 is different from the control operation shown in FIG. 93. The control process for the adjustable light source 5210 shown in FIG. 94 include what are shown in the figure for specific light source control pattern in the case of the outputs of the individual adjustable light sources 5210 when the light emissions are different as indicated by a red (R) light source pattern 8221 with an output P_{R}, a green (G) light source pattern 8222 with an output P_{G} and a blue (B) light source pattern 8223 with an output P_{B}. Furthermore, the respective outputs are set as P_{R}>P_{B}>P_{G}. Other control processes are the same as shown in FIG. 93.

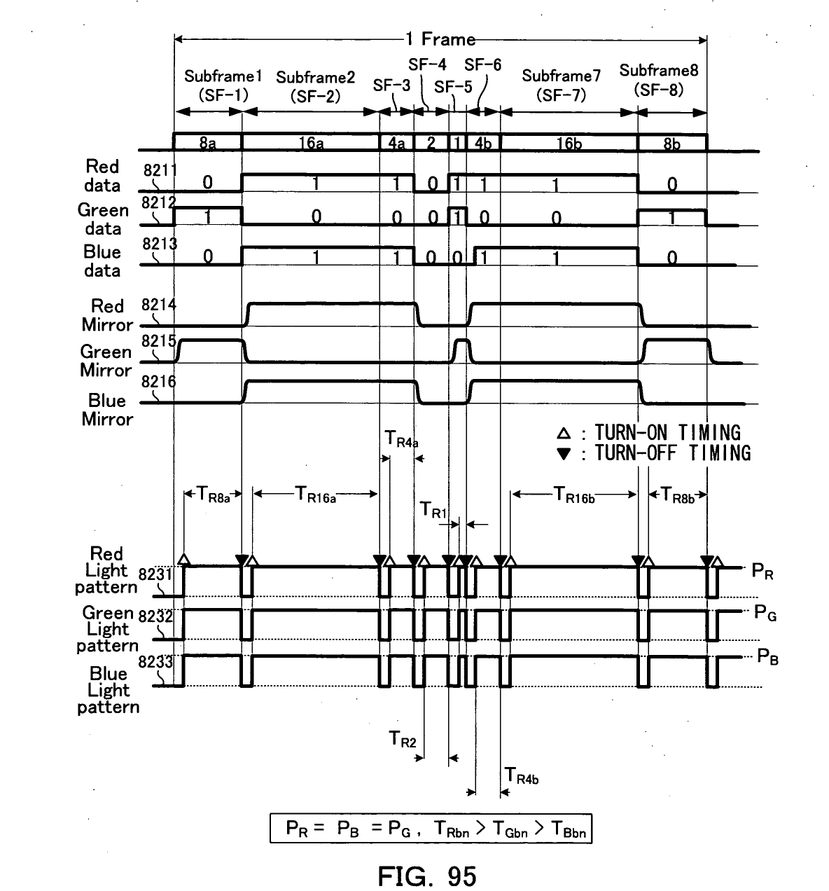

FIG. 95 is a timing diagram for showing another modified embodiment of the control processes for controlling the spatial light modulator and the adjustable light source shown in FIG. 93. Also in the modified embodiment shown in FIG. 95, only the control processes for the variable light sources 5210 is different from the control operation shown in FIG. 93. The control processes for the variable light sources 5210 shown in FIG. 95 are such that the turn-on periods of the respective adjustable light sources 5210 for the respective sub-frames SF-1 through SF-8 are different (T_{Rbn}>T_{Gbn}>T_{Bbn}). The subfields are presented by an R light source pattern 8231 with an output P_{R}, a G light source pattern 8232 with an output P_{G} and a B light source pattern 8233 with an output P_{B}. Also in this exemplary embodiment, the control process sets the turn-on timing and turn-off timing of the respective adjustable light sources 5210 for each sub-frame are also different. As a result of the control processes, the emission periods of the light sources of the respective colors are individually controlled. Therefore, the color synthesis of the final display image can be adjusted by using the emission period in addition to using the emission light intensity of each color. Therefore, a fine color adjustment may be carried out. Other control processes are the same as those shown in FIG. 93. Furthermore, the control processes for the adjustable light sources shown in FIG. 95 may alternatively be controlled to differentiate only the turn-on timings of the respective adjustable light sources 5210 for the respective sub-frames SF-1 through SF-8. The control processes may also differentiate only the turn-off timings of different colors as well.

According to the control processes shown in FIGS. 94 and 95, the color break of an image display is suppressed by dividing the frame of display cycles into subfields such that the display of a single color for a prolong time period is prevented. The control processes shown in the above-described FIGS. 93 through 95 control an integrated light intensity of the pulse emission during the period of each sub-frame in accordance with the weighting of each bit of display data. The integrated light intensity is therefore determined by an output intensity of the pulse emission that is in turn determined in accordance with the weighting. Furthermore, the output intensity may be alternately determined in accordance with the visibility. The control process shown in the above described FIGS. 93 through 95 illustrate the control signal for the mirror element as the binary data. A similar control process may be implemented with the control signal implemented as non-binary data.

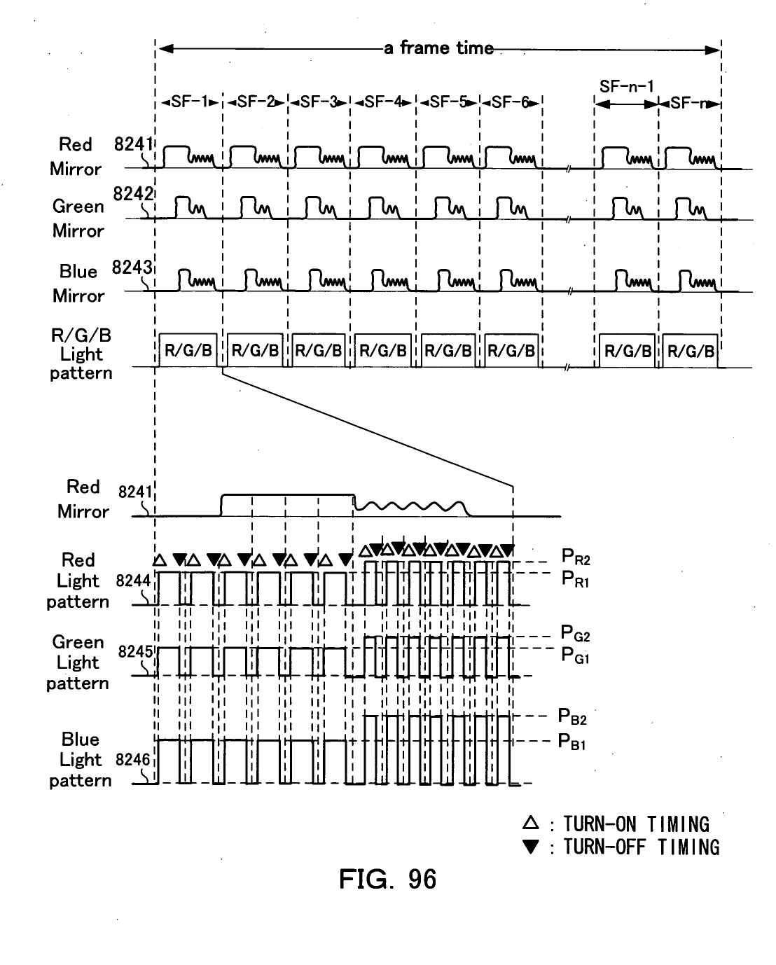

FIG. 96 is a timing diagram for illustrating the control processes for controlling the spatial light modulator and variable light source when the control signal for a mirror element is non-binary data. As shown in FIG. 96, when the control signal for a mirror element is non-binary data, the SLM controller 5530 divides one frame into a plurality of sub-frames. The spatial light modulator 5100 has at least one modulation state in each subframe, and the light source control unit 5560 carries out to control each of the adjustable light sources 5210 (i.e., the red laser light source 5211, green laser light source 5212 and blue laser light source 5213) to carry out at least one time of pulse emission during the period of a sub-frame.

In the exemplary control process shown in FIG. 96, one frame is divided into a plurality of sub-frames (i.e., SF-1 through SF-n), and the non-binary data is inputted to generate the corresponding control state to operate the mirror element of the spatial light modulator 5100 in a time slice to project each of the individual colors R, G and B according to the ON, OFF and oscillation control state in each sub-frame for each mirror element. FIG. 96 shows the mirror modulation control waveform 8241, the mirror modulation control waveform 8242 and the mirror modulation control waveform 8243 for controlling the modulation of the mirror element to display the R, G and B color respectively.

Furthermore, each of the adjustable light sources 5210 that includes the red laser light source 5211, green laser light source 5212 and blue laser light source 5213, is controlled to project a plurality of light pulses. The turn-on timings and turn-off timings during each sub-frame period are coincided as shown by an R light source pattern 8244, a G light source pattern 8245 and a B light source pattern 8246. In this specific example, the individual adjustable light sources 5210 are controlled to project light pulses with a narrow pulse width. The light source is triggered to project the light pulses with narrow pulse width at the time when the mirror element is changed from the ON state over to oscillation state within each sub-frame period. Further, the individual adjustable light sources 5210 are controlled to project different light pulses in each sub-frame period (i.e., P_{B1}>P_{R1}>P_{G1}; P_{B2}>P_{R2}>P_{G2}). Each frame is therefore divided into several sub-frames for controlling the spatial light modulator and the variable light sources. Furthermore, the spatial light modulator modulates the projections of light with different colors R, G and B in each sub-field when the control signal for the mirror element is non-binary data. The light pulses of the respective colors are coincident within each sub-field period thus dividing a period when the light of only one color is projected onto a screen to suppress an occurrence of a color break.

The control process shown in FIG. 96 may be implemented by alternate embodiments by modifying the pulse width control for each adjustable light source. The control process may be implemented to control the pulse width in each subfield corresponding to the control states of the spatial light modulator controlled with the non-binary data as described above. Improvements and modification to the image projection apparatuses and the control processes may be implemented other than the specific exemplary embodiment disclosed. The scopes of this invention are not limited by the above-described embodiments, and these improvements and modifications would be within the scopes of the present invention.

As described above, the projection apparatus includes a plurality of light sources for projecting different emission light wavelengths and implemented with a plurality of spatial light modulators according to the present embodiment can effectively suppress an occurrence of a color break Note that the individual adjustable light sources must be controlled to project light pulses in high speed by controlling the adjustable light sources as described above. Therefore, it is preferred to configure a circuit layout for forming the light source drive circuit, or an output-stage circuit for performing a high speed current drive for the light source drive circuit and a control circuit in close proximity with each other and near the individual light sources for reducing the floating capacity and parasite impedance associated with the wiring of individual circuits.

### Embodiment 9

This exemplary embodiment includes a projection apparatus implemented with a plurality of spatial light modulators with improved contrast of a projection image. The projection apparatus further has a reduced size by miniaturizing the mirror device and associated components implemented in the projection apparatus.

### Embodiment 9-1

A projection apparatus according to a preferred embodiment 9-1 comprises: a light source; a plurality of spatial light modulators. Each SLM includes a micromirror for deflecting the light emitted from the light source in directions between a first direction and a second direction that is different from the first direction. The projection light further includes the angles between the first and second directions. The projection apparatus further includes an optical prism that has surfaces (i), (ii), (iii) and (iv). The surface (i) is a first optical surface to receive two lights with mutually different frequencies. The surface (ii) is a second optical surface for reflecting the light projected to the first optical surface and reflected therefrom. The optical surface further receives projected from the light modulated by the spatial light modulator. The surface (iii) is a synthesis surface. The lights modulated by a plurality of spatial light modulators are synthesized into a light projected along a same light path. The optical surface (iv) is an ejection surface formed at a position approximately opposite to a projection lens to receive a synthesized light, wherein the locus of deflection of the modulated light deflected by a micromirror is approximately parallel to the synthesis surface. The projection apparatus can be implemented as the projection apparatus shown in FIGS. 66A through 66D. Therefore, an exemplary projection apparatus according to the embodiment 9-1 is described with reference to the projection apparatus shown in FIGS. 66A through 66D. The same numerical designations for each component are assigned to the same component as the above-described configuration, and the duplicate description is not provided here.

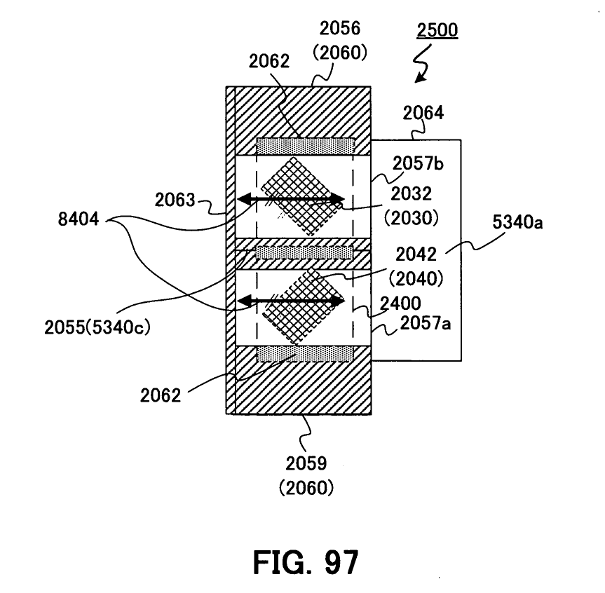

FIG. 97 is a plain view diagram of the projection apparatus shown in FIGS. 66A through 66C. FIG. 97 is referred to in this exemplary embodiment in place of FIG. 66D, in order to describe the locus of deflection of the modulation light modulated by a micromirror.

FIG. 66C shows two spatial light modulators, i.e., the mirror devices 2030 and 2040 implemented with micromirrors 4003 and the optical axis of reflection light when each mirror (i.e., micromirror) 4003 is controlled to operate in the ON state, OFF state and intermediate state (i.e., a state between the ON and OFF states) when the micromirror is deflected to different directions in each of the different states. Specifically, the optical axis of the reflection light (i.e., the laser light 2072) when the mirror 4003 is in the intermediate state shown in FIG. 66C is flexibly adjustable between the optical axis of the reflection light (i.e., the laser light 2071) in the ON state and that of the reflection light (i.e., the laser light 2073) in the OFF state.

With a configuration shown in FIGS. 66A through 66C and FIG. 97, the direction of the optical axis for the reflection light (i.e., the laser light 2071) when the mirror 4003 is controlled to operate at the ON state and the direction of the optical axis of the reflection light (i.e., the laser light 2073) when the mirror 4003 is controlled to operate in the OFF state corresponds to the first direction and second direction, respectively.

Furthermore, the optical system is implemented with a combination of the color synthesis prism 2060 with the light guide prism 2064 that corresponds to the above-described optical prism. The bottom surface 5340a of the light guide prism 2064 and the bottom surface 2060a (i.e., the primary surface) of the color synthesis prism 2060 correspond to the above-described first optical surface and second optical surface respectively. The joinder surface 5340c of the color synthesis prism 2060 (i.e., the prisms 2056 and 2059) corresponds to the above described synthesis surface. The ejection surface 5340d of the color synthesis prism 2060 corresponds to the above-described ejection surface.

Furthermore, the bottom surface 5340c of the light guide prism 2064 is implemented as one of several optional configurations to function as the first optical surface. As described above, the light guide prism 2064 serves the function of suppressing the reflection at the incidence surface 2060b of the color synthesis prism 2060 when a laser light is incident thereto. Therefore, the light guide prism 2064 may be eliminated if the incident light can be guided through the adjustment of the two spatial light modulators (i.e., the mirror devices 2030 and 2040) to project at an angle for reflection at the incidence surface 2060b. In such a case, the incidence surface 2060b of the color synthesis prism 2060 then serves the function of the first optical surface.

The above-described embodiment 5-4 includes the polarization beam splitter film 2055 placed on the joinder surface 5340c to function as the synthesis surface for synthesizing the light. In contrast, present embodiment is configured to place a dichroic filter on the joinder surface 5340c to function as the synthesis surface. Therefore, in the present embodiment, the dichroic filter reflects the red and blue lights, and transmits the green light.

Furthermore, the locus of the optical axis of the reflection light (i.e., the laser lights 2071, 2072 and 2073) in the projection apparatus as described above is further configured in accordance with the state of each mirror 4003 such as the ON state, OFF state and intermediate state. Therefore, the locus of deflection of the modulation light deflected by the mirror 4003 is approximately parallel to the joinder surface 5340c shown in FIG. 97 as the deflection locus 8404 to function as the synthesis surface.

Furthermore, the projection apparatus has an additional benefit that the undesired modulation light (e.g., the laser light 2073) is projected away and is absorbed in the light shield layer 2063 functioning as a light absorption member as shown in FIG. 66C. The random modulation light is not contributing to a projection for image display and the contrast of the image display is therefore improved. The light shield layer 2063 also functions as radiation absorber to further enhance the heat dissipation.

The projection apparatus configured according to the embodiment 9-1 has a further advantage because the optical prism is further miniaturized. In addition to the advantage of having a smaller optical prism, the image projection apparatus is assembled as a compact package by using the laser light source. Specifically, the color synthesis prism 2060 can be miniaturized because the width of the prism in a direction parallel to the deflection locus and also parallel to the bottom surface 2060a of the optical member is reduced to a width approximately equal to the diameter of the incidence pupil of a projection optical system. Therefore, the width of the ejection surface 5340d and that of the joinder surface 5340c functioning as the synthesis surface have a same diameter as the incidence pupil of a projection optical system.

Furthermore, the random modulation lights reflected from the gaps between the mirrors are not contributing to a projection for image display. Specifically, the reflection light when the mirror 4003 is in the OFF state, is absorbed by the light shield layer 2063, and thereby the contrast of the projection image is improved.

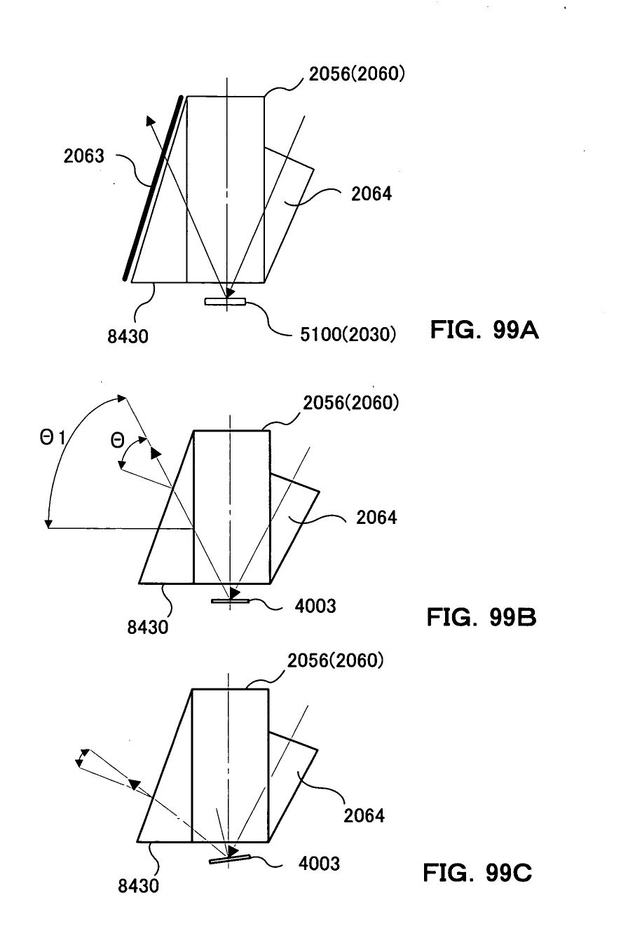

The projection apparatus according to the present embodiment 9-1 may also include the light shield layer 2063 as a light absorption body on the extension of the optical axis of the reflection light when the mirror 4003 is in the OFF state. The light shield layer 2063 may also be placed on the outside of the color synthesis prism 2060 and closely attached to, adjacent to or separated from the color synthesis prism 2060. The light shield layer 2063 is therefore placed in a manner similar to the exemplary configuration shown in FIGS. 99A through 99C described below. The light shield layer 2063 also functions as a radiation absorber to enhance the heat dissipation of the projection apparatus.

Furthermore, the green laser light source 5212, red laser light source 5211 and blue laser light source 5213, two spatial light modulators (i.e., the mirror devices 2030 and 2040) and a controller used for controlling the aforementioned components of the projection apparatus according to the embodiment 9-1 are placed on the same board. Similar configurations are also implemented in the exemplary configuration shown in FIG. 103 described below. Furthermore, in addition to the exemplary configuration shown in FIGS. 66A through 66C and FIG. 97, FIG. 98 depicts an alternate embodiment of the projection apparatus according to the embodiment 9-1.

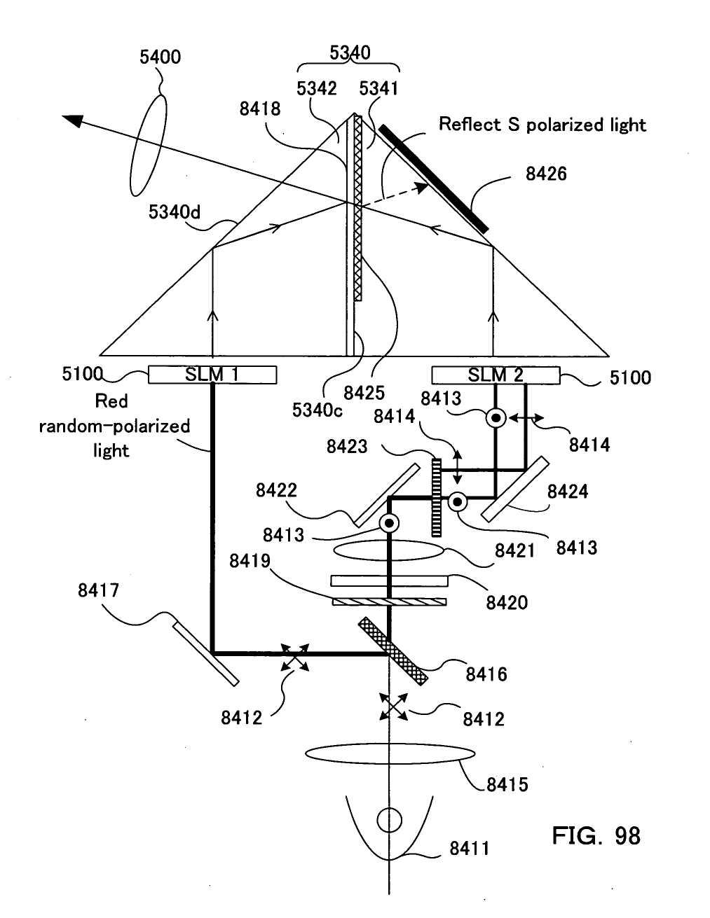

FIG. 98 shows the light source with different configuration from the exemplary configuration shown in FIGS. 66A through 66C and FIG. 97. FIG. 98 shows a different configuration between the light source and optical prism, and a partial configuration of the optical prism. Other than these differences, these two apparatuses have the same configuration.

FIG. 98 shows an image projection apparatus implemented with a light source 8411 emitting white light in a non-polarization state. The light source 8411 may be implemented with a mercury lamp, xenon lamp or a composite light source to project a lights of multiple wavelengths or light projection from a fluorescent body with a single color light source such as light emitting diode (LED).

Furthermore, the light projected from the light source as that shown FIG. 98 may include a light in the non-polarization, P-polarization and S-polarization states by using marks 8412, 8413 and 8414, respectively.

The light emitted from the light source 8411 passes through an illumination optical system 8415 then transmitting to a dichroic filter 8416. The red light (i.e., the light of red frequency component) as part of the lights projected to the dichroic filter 8416 is reflected by the dichroic filter 8416 while the green and blue lights (i.e., the lights of green and blue frequency components) transmit through the present dichroic filter 8416.

The red light reflected by the dichroic filter 8416 is then reflected by a retention mirror 8417 and projected to the first optical surface (not specifically shown) of the color synthesis prism 5340 and further projected from the second optical surface (not specifically shown) and is incident to the spatial light modulators (SLM 1) 5100. The optical path of the light after entering the spatial light modulator (SLM1) 5100 is basically the same as the optical path shown in the exemplary configuration shown in FIGS. 66A through 66C and FIG. 97. Specifically, when the mirror 4003 is operated in an ON state, the light is reflected vertically upwards by the mirror 4003 and is re-incident to the second optical surface 5340b of the color synthesis prism 5340. Then, the red light projecting to the second optical surface is reflected by the slope surface (i.e., an ejection surface 5340d) of the right-angle triangle columnar prism 5342, is further reflected by the joinder surface 5340c functioning as the synthesis surface. The light is synthesized with the light of P-polarization as described below. Then, the synthesized light is ejected from the ejection surface 5340d and is projected to a projection optical system 5400. A dichroic color filter 8418 is placed on the side of the joinder surface 5340c of the prism 5342 for reflecting the light of the red frequency component and transmits the lights of the green and blue frequency components.

Meanwhile, the green and blue lights transmitted through the dichroic filter 8416 are then polarized by a PS integrator 8419 as a linear polarized light, i.e., a P-polarization state in the present embodiment) and transmitted through a micro lens 8420 and lens 8421 and reflected by a retention mirror 8422 for projecting to a polarization conversion member 8423.

The polarization conversion member 8423 selectively rotates the polarizing direction of the light of a specific frequency component. The polarization conversion member 8423 can be implemented by using a color switch, a Faraday rotator, a photo-elastic modulator, or a wave plate that is inserted into a light path.

The polarization conversion member 8423 of the present embodiment changes the lights transmitted in different frequencies by rotating the polarizing direction. The polarizing directions of the green or blue lights are rotated by 90 degrees. The lights are converted into a S-polarization state for transmitting as output lights from the polarization conversion member 823. Specifically, the green light in the P-polarization state and the blue light in the S-polarization state are output from the polarization conversion member 8423, or the green light in the S-polarization state and the blue light in the P-polarization state are output therefrom.

The output lights of P-polarized light and S-polarized light from the polarization conversion member 8423 are then reflected by a retention mirror 8424 and incident to the first optical surface of the color synthesis prism 5340 and further ejected from the second optical surface and are incident to the spatial light modulator (SLM 2) 5100.

The optical paths of the lights after entering the spatial light modulator (SLM 2) 5100 are basically the same as the optical paths shown in the exemplary configuration as depicted in FIGS. 66A through 66C and FIG. 97. The projection apparatus shown in FIG. 98, however, is implemented on the side the joinder surface 5340c of the prism 5341 with a polarization light beam splitter (PBS) 8425, for transmitting a P-polarized light and reflecting an S-polarized light. The projection apparatus is further implemented with a light absorption member 8426 on the slope surface of the prism 5341 for absorbing the light reflected by the PBS 8425. Accordingly, the optical path when the mirror is operated in an ON state is described as the followings. Specifically, the lights projected to the spatial light modulator (SLM 2) 5100 are reflected vertically along an upward direction by the mirror 4003. The reflected lights are further transmitted to the second optical surface of the color synthesis prism 5340 and reflected by the slope surface of the right-angle triangle columnar prism 5341. The lights are then projected to the PBS 8425. Then, the P-polarized light of the lights incident to the PBS 8425 transmits through the present PBS 8425, while the S-polarized light is reflected by the present PBS 8425 and absorbed by a light absorption member 8426.

The P-polarized light (i.e., green or blue light) transmitting through the PBS 8425, further transmits through the joinder surface 5340c to pass through a dichroic color filter 8418 and synthesized with the above-described red light. The synthesized light is ejected from the ejection surface 5340d of the prism 5342 and is incident to the projection optical system 5400.

The projection apparatus according to the present embodiment 9-1 can be further miniaturized by miniaturizing the optical prism by using a projection apparatus configured as shown in FIG. 98. Similar to the exemplary configurations shown in FIGS. 66A through 66C and FIG. 97, the contrast of a projection image is also improved.

One spatial light modulator (SLM 1) 5100 of the present embodiment modulates the red light constantly. Another spatial light modulator (SLM 2) 5100 modulates the green light and blue light alternately. It is well known that the red component is the least amount among the spectrum when a high-pressure mercury lamp is used as the light source. Therefore, the present embodiment is configured to constantly project the red light to compensate a shortage of the red light in a light source. The light source with red light compensation can therefore effectively enhance the brightness of a projection image. For a light source implemented with a laser light, the laser light source is controlled to project a green light continuously due to the low emission of the green light in the laser light. As described above, it is also desirable to configure the projection apparatus for providing the best brightness and contrast of the image display by changing the allocations of the light source lights to the two spatial light modulators compatible with the characteristic of the light source.

### Embodiment 9-2

A projection apparatus according to a preferred embodiment 9-2 comprises: a light source; a plurality of spatial light modulators each comprising a micromirror capable of deflecting the light emitted from the light source in directions between a first direction and a second direction that is different from the first direction, and directions across all angles between the first and second directions. The projection apparatus further includes an optical prism comprising surfaces (i), (ii), (iii) and (iv), where optical surface (i) is a first optical surface receiving two lights with mutually different frequencies are incident. Optical surface (ii) is a second optical surface for projecting the light incident to and reflected from the first optical surface. The second optical surface further receives the light modulated and reflected by the spatial light modulator. The optical surface (iii) is a synthesis surface on which the lights respectively modulated by a plurality of spatial light modulators are synthesized into the same light path. The optical surface (iv) is an ejection surface disposed at a position approximately opposite to a projection lens and from which the synthesized light is ejected, wherein the synthesis surface is approximately vertical to the first optical surface. The above-described embodiment 9-1 can be implemented as a specific projection apparatus implemented by using the above-described prism.

The joinder surface 5340c (which is a synthesis surface) between the prism 2056 and prism 2059 is approximately vertical to the bottom surface 5340a (which is the first optical surface) of the triangle columnar light guide prism 2064 when the projection apparatus according to the embodiment 9-2 is implemented by using the exemplary configuration shown in the above described in FIGS. 66A through 66C and FIG. 97. Alternatively, the synthesis surface is approximately vertical to the first optical surface when the projection apparatus according to the embodiment 9-2 is implemented by using the exemplary configuration shown in the above-described FIG. 98.

The projection apparatus according to the embodiment 9-2 configured as described above also has a benefit similar to that of the projection apparatus according to the embodiment 9-1. Specifically, the projection apparatus according to the embodiment 9-2 may also be configured with the deflection locus of the modulation light modulated by the mirror 4003 approximately parallel to the joinder surface 5340c. The joinder surface 5340c is the synthesis surface and shown in FIG. 97 as the deflection locus 8404, and alternately the deflection locus may be arranged with a different configuration.

### Embodiment 9-3

A projection apparatus according to a preferred embodiment 9-3 comprises: a light source; a plurality of spatial light modulators each comprising a micromirror capable of deflecting the light emitted from the light source in directions between a first direction and a second direction that is different from the first direction, and all the angles between the first and second directions The projection apparatus further includes an optical prism comprising surfaces (i), (ii), (iii) and (iv), where optical surface (i) is a first optical surface to which two lights with mutually different frequencies are incident. The optical surface (ii) is a second optical surface from which the light incident to the first optical surface is ejected and to which the light modulated by the spatial light modulator is incident. The optical surface (iii) is a synthesis surface for synthesizing lights modulated by a plurality of spatial light modulators into the same light path. The optical surface (iv) is an ejection surface disposed at a position approximately opposite to a projection lens and from which the synthesized light is ejected, wherein the incidence angle of a modulation light deflected to a second direction, incident to the constituent surface of the optical prism, is no larger than a critical angle. This projection apparatus can also be implemented by using the projection apparatus according to an exemplary configuration of the above-described embodiment 9-1.

The incidence angle of the modulation light deflected toward the direction (which is the second direction) of the optical axis of the reflection light (i.e., the laser light 2073) when the mirror 4003 is in the OFF state and which is incident to the constituent surface of the color synthesis prism 2060 that is an optical prism is no larger than a critical angle when the projection apparatus according to the embodiment 9-3 is implemented with the exemplary configuration shown in the above described FIGS. 66A through 66C and FIG. 97. Alternatively, the incidence angle of the modulation light deflected toward the second direction and which is incident to the constituent surface of the optical prism is likewise no larger than a critical angle when the projection apparatus according to the embodiment 9-3 is implemented by using the exemplary configuration shown in the above described FIG. 98.

For example, when an optical prism configured by using a BK 7 (with the refractive index of 1.51467) is implemented as the color synthesis prism 2060 the critical angle θ is:

θ=sin⁻¹(1/1.51467)≈41.3 degrees,

and therefore the incidence angle is equal or smaller than 41.3 degrees. Further, by joining separate prism bodies the optical prism may be integrally configured.

An occurrence of the internal reflection of extraneous modulation light within the color synthesis optical system, i.e., an optical prism, in the projection apparatus according to the embodiment 9-3 described above is prevented. The extraneous modulation light is projected to the outside, thereby enabling elimination of the extraneous modulation light from the optical prism in early stage. As a result, the contrast of a projection image is enhanced. Further, the external ejection of the extraneous modulation light makes it more conveniently to take a countermeasure to reduce an extraneous modulation light.

The deflection locus of the modulation light modulated by the mirror 4003 may also be configured in the projection apparatus according to the embodiment 9-3 such that to be approximately parallel to the joinder surface 5340c. The joinder surface 5340c is the synthesis surface shown in FIG. 97 as the deflection locus 8404, or the deflection locus may otherwise be arranged according to a different configuration.

Further, the projection apparatus according to the embodiment 9-3 may also be configured with a right-angle triangle columnar prism 8430 is further joined to the color synthesis prism 2060 as an optical prism, and also a light shield layer 2063 is deposed along the slope surface of the joined prism 8430 as illustrated in FIG. 99A. In this configuration, an extraneous modulation light enters the joinder surface between the color synthesis prism 2060 and prism 8430. The extraneous light then enters the slope surface of the prism 8430 at an incidence angle that is no larger than a critical angle and is absorbed by the light shield layer 2063. In this case, the refractive index of the color synthesis prism 2060 is the same as that of the prism 8430. The incidence angle to the prism 8430 may be any angle because the limitation of the critical angle is no longer required.

FIGS. 99B and 99C are diagrams for illustrating the optical path of an extraneous modulation light when the refractive index of the color synthesis prism 2060 is different from that of the prism 8430. FIG. 99B illustrates the optical path of a reflection light when the mirror 4003 is horizontal. FIG. 99C illustrates the optical path of a reflection light when the mirror 4003 is in the OFF state. In either case, an OFF light projected as the extraneous light is ejected outside of the prism 8430. Therefore, either FIG. 99B nor FIG. 99C specifically show the light shield layer 2063. Furthermore, in FIG. 99B, “θ1” indicates the incident angle of a reflection light relative to the joinder surface between the color synthesis prism 2060 and prism 8430, and “θ” indicates the incident angle of the reflection light relative to the slope surface of the prism 8430. If the color synthesis prism 2060 has a different refractive index than the prism 8430, both the “θ1” and “θ” must be smaller than the critical angle that is along a direction closer to the vertical direction relative to the surface of incidence. FIG. 99A shows another exemplary configuration that may also eliminate the light shield layer 2063.

### Embodiment 9-4

A projection apparatus according to a preferred embodiment 9-4 comprises: a light source; a plurality of spatial light modulators each comprising a micromirror for deflecting the light emitted from the light source in directions between a first direction and a second direction that is different from the first direction, and all angles between the first and second directions. The projection apparatus further includes an optical prism comprising surfaces (i), (ii), (iii) and (iv). The optical surface (i) is a first optical surface to which two lights with mutually different frequencies are incident. The optical surface (ii) is a second optical surface from which the light incident to the first optical surface is ejected and to which the light modulated by the spatial light modulator is incident. The optical surface (iii) is a synthesis surface on which the lights respectively modulated by a plurality of spatial light modulators are synthesized into the same light path. The optical surface (iv) is an ejection surface which is equipped at a position approximately opposite to a projection lens and from which the synthesized light is ejected, A projection apparatus according to the embodiment 9-4 comprises a light source; a plurality of spatial light modulators each having micromirrors each of which is capable of deflecting light emitted from the light source in directions between a first direction and a second direction that is different from the first direction, and all the angles between the first and second directions. The projection apparatus further includes a first joinder prism comprising surfaces (i), (ii) and (iii); a second joinder prism comprising surfaces (iv), (v) and (vi). The optical surface (i) is a first optical surface to which at least two lights with mutually different frequencies are incident. The optical surface (ii) is a second optical surface from which the light incident to the first optical surface is ejected and to which the light modulated by the spatial light modulator is incident. The optical surface (iii) is a selective reflection surface reflecting the light from the first optical surface and transmitting a modulation light, (iv) is a third optical surface to which a modulation light ejected from the first joinder prism is incident. The optical surface (v) is a synthesis surface for synthesizing a plurality of lights incident to the third optical surface into the same light path. The optical surface (vi) is an ejection surface which is equipped at a position approximately opposite to a projection lens and from which the synthesized light is ejected, wherein the first optical surface of the first joinder prism is approximately vertical to the synthesis surface of the second joinder prism.

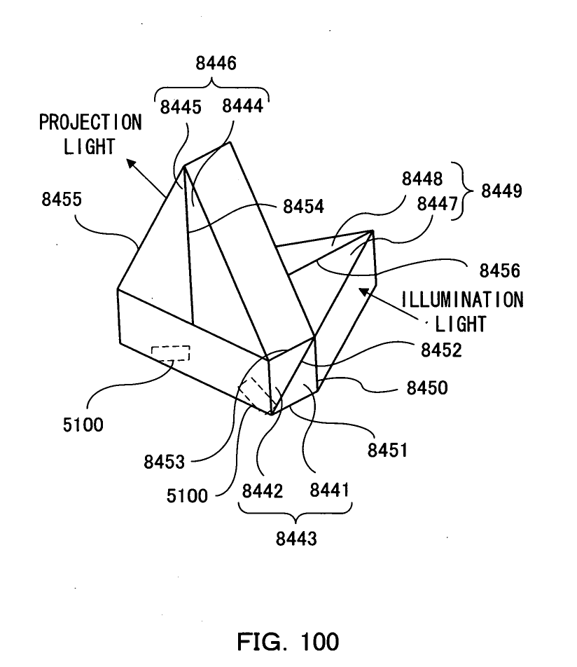

FIG. 100 is a diagram that mainly shows the optical system of an exemplary configuration of the projection apparatus according to the embodiment 9-4.

It is understood that the same numeral designations are used for different components included in different projection apparatus according to the above described embodiment 9-1 and also in the descriptions of a projection apparatus according to the embodiment 9-4 and thereafter. The duplicate descriptions are not provided here.

The exemplary configuration shown in FIG. 100 comprises a first joinder prism 8443 structured by joining two right-angle triangle columnar prisms 8441 and 8442 of approximately a same shape. The image projection apparatus further includes a second joinder prism 8446 structured by joining two right-angle triangle columnar prisms 8444 and 8445 of the same form. The image projection apparatus further includes a third joinder prism 8449 which is similar with a second joinder prism 8446, structured by joining two right-angle triangle columnar prisms 8447 and 8448 of the same form.

The joinder surface with or opposite surface to the third joinder prism 8449 the first joinder prism 8443 is a first optical surface 8450 to receive a plurality of lights with individually different frequencies. Specifically, the first optical surface 8450 is perpendicular to the synthesis surface of the second joinder prism 8446 (which is described later). Further, an optical surface 8451 on the first joinder prism 8443 is the second optical surface (noted as “second optical surface 8451” hereinafter), which ejects the light from the first optical surface 8450. Furthermore, the modulation lights modulated by two spatial light modulators 5100 disposed immediately under the first joinder prism 8443 are also projected to the second optical surface 8451. Furthermore, an optical surface 8452 is a selective reflection surface (noted as “selective reflection surface 8452” hereinafter) to serve the function of reflecting the light from the first optical surface 8450 and transmitting a modulation light.

Furthermore, the joinder surface with, or opposite surface to, the first joinder prism 8443 on the second joinder prism 8446 is the third optical surface 8453 to receive the modulation light ejected from the first joinder prism 8443. Furthermore, the joinder surface between the prisms 8444 and 8445 is the synthesis surface 8454 for synthesizing a plurality of lights incident to the third optical surface 8453 into the same light path. Furthermore, the joinder surface between the prisms 8444 and 8445 is configured with a dichroic filter for reflecting the lights of red and blue frequency components and transmitting the light of green frequency component. Furthermore, an optical surface 8455 is the ejection surface (noted as “ejection surface 8455” hereinafter) disposed at a position approximately opposite to a projection lens (i.e., a projection optical system 5400; not shown in a drawing herein) for ejecting the synthesized light. The second joinder prism 8446 is an optical prism formed by removing the prism 5343 from the color synthesis optical system 5340 as that included in the projection apparatus according to the embodiment 9-1.

Furthermore, the joinder surface joining the prisms 8447 and 8448 on the third joinder prism 8449, comprises a dichroic filter for reflecting the light of a green frequency component and transmitting the lights of red and blue frequency components. Therefore, the third joinder prism 8449 carries out a function of separating the incident light into the lights of different frequencies.

Meanwhile, the deflection loci of the modulation lights modulated by the two spatial light modulators 5100 in the exemplary configuration shown in FIG. 100 are approximately parallel to the synthesis surface 8454 of the second joinder prism 8446 similar to the projection apparatus according to the embodiment 9-1.

Therefore, when an illumination light is incident to the slope surface of the prism 8447 of the third joinder prism 8449 in the projection apparatus according to the embodiment 9-4, the green light is reflected by a joinder surface 8456, while the red or blue light is transmitted through the joinder surface 8456.

The green light reflected by the joinder surface 8456 is reflected by the slope surface of the prism 8447 and is vertically projected to the first optical surface 8450 of the first joinder prism 8443, is reflected by the selective reflection surface 8452, is ejected from the second optical surface and is incident to one spatial light modulator 5100. Then, the incident light is reflected vertically upward when the mirror 4003 is in the ON state, and projected vertically to the second optical surface 8451 and transmitted through the selective reflection surface 8452 to transmit to the third optical surface 8453 of the second joinder prism 8446. The optical path of the green light transmission thereafter is similar to the case of the projection apparatus according to the embodiment 9-1. Specifically, the green light is reflected by the slope surface of the prism 8444, transmitted through the synthesis surface 8454, and synthesized with the red or blue light (which is described later). The synthesized light is ejected from the ejection surface 8455 for projecting to a projection optical system (not specifically shown here).

Meanwhile, the red or blue light reflected by the slope surface of the prism 8448 is transmitted through the joinder surface 8456 of the third joinder prism 8449, is projected vertically to the first optical surface 8450 of the first joinder prism 8443. Similar to the above description, the light is reflected by the selective reflection surface 8452, ejected from the second optical surface and is projected to the other spatial light modulator 5100. Then, the incident light is vertically reflected along an upward direction when the mirror 4003 is in the ON state, and is projected vertically relative to the second optical surface 8451, transmitted through the selective reflection surface 8452 and then projected to the third optical surface 8453 of the second joinder prism 8446. The optical path of the red or blue light thereafter is similar to the projection apparatus according to the embodiment 9-1. The red or blue light reflected by the slope surface of the prism 8445 is reflected by the synthesis surface 8454, then is synthesized with the green light (which is described above). The synthesized light is ejected from the ejection surface 8455 and is projected to a projection optical system (not specifically shown).

An exemplary configuration of the projection apparatus is therefore described above according to the embodiment 9-4.

Furthermore, the third joinder prism 8449 in the projection apparatus according to the embodiment 9-4 can also be eliminated. A light source corresponding to the first optical surface 8450 of the first joinder prism 8443 is disposed opposite to the first optical surface 8450 similar to the projection apparatus shown in the above described FIGS. 66A through 66C and FIG. 97 according to the embodiment 9-1.

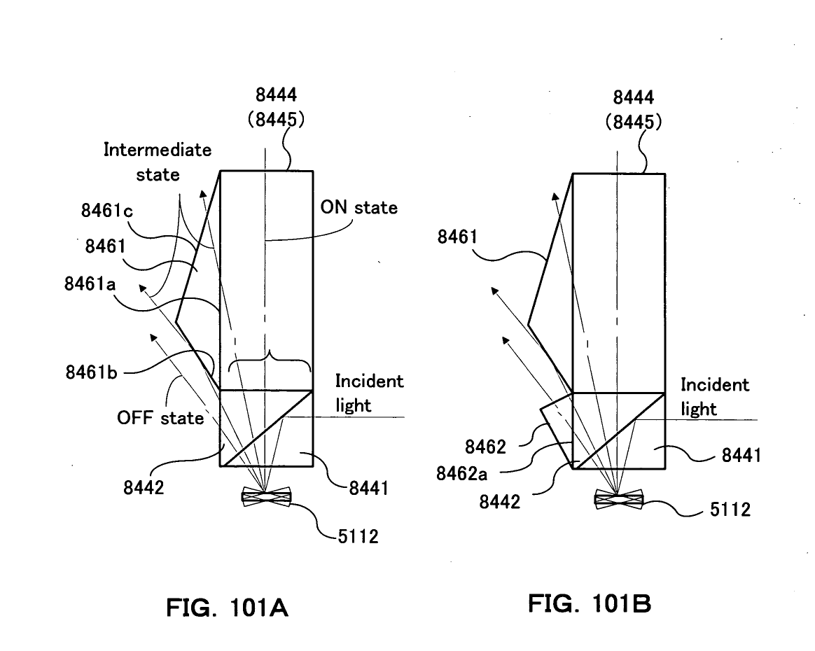

Furthermore, in order to eliminate an extraneous modulation light in early stage from the second joinder prism 8446, a triangle columnar prism 8461 of the projection apparatus according to the embodiment 9-4 can be joined to the second joinder prism 8446 as illustrated in FIG. 101A. a triangle columnar prism 8461 of the projection apparatus can also be joined to the second joinder prism 8446. In order to eliminate an extraneous modulation light from the first joinder prism 8443 and second joinder prism 8446 in early stage, a triangle columnar prism 8462 can also be joined to the prism 8442 of the first joinder prism 8443, as illustrated in FIG. 101B.

The prism 8461 includes a flat surface 8461a to receive a reflection light incident to the second joinder prism 8446 when the refractive index of the prism 8461 is different from that of the second joinder prism 8446. When the mirror 4003 is operated in an intermediate state, a portion of the reflection light, is projected at an angle no larger than a critical angle to a flat surface 8461b. Therefore, a reflection light is not reflected to the second joinder prism 844. A portion of the reflection light is irradiated at an angle no smaller than the critical angle when the mirror 4003 is in an intermediate state. Therefore, the reflection light projected to the flat surface 8461a at an angle not greater than the critical angle is transmitted through the prism 8461 and also is transmitted through a flat surface 8461c. Furthermore, an extraneous light projected to the surface 8461c at an angle smaller than the critical angle is ejected outside of the projection apparatus. Meanwhile, the reflection light irradiated on the flat surface 8461b with an incident angle smaller than the critical angle is reflected by the flat surface 8461b outside of the image projection apparatus. The extraneous light is projected or reflected by the prism 8461 outside of the image projection apparatus in the early stage of optical transmission in this configuration when the mirror 4003 is in an intermediate state. Therefore, the extraneous modulation light is eliminated and is no longer transmitted inside of the second joinder prism 8446. The contrast of a projection image is improved. The requirement for the incident angle relative to the flat surface 8461a is less stringent when the prism 8361 has a same refractive index as that of the second joinder prism 8446.

Furthermore, a reflection light is not projected to the second joinder prism 8446 and the refractive index of the prism 8462 is different from that of the joinder prism 8442, a portion of the reflection light from a flat surface 8462a of the prism 8462 is projected at an angle smaller than the critical angle when the mirror 4003 is in an intermediate state. Therefore, the reflection light projected to the flat surface 8462a at an angle smaller than the critical angle is transmitted through the prism 8462 and is ejected to the outside. The extraneous modulation light is ejected outside by the prism 8462 in an image projection apparatus with this configuration when the mirror 4003 is in the intermediate state. Therefore, the extraneous modulation light is eliminated from the first joinder prism 8443 and second joinder prism 8446, and the contrast of a projection image is further improved.

FIG. 100 shows an exemplary configuration of the projection apparatus implemented as a two-panel projection apparatus comprising two spatial light modulators according to the embodiment 9-4. As another exemplary configuration, the image projection apparatus can also be configured as a three-panel projection apparatus implemented with three spatial light modulators.

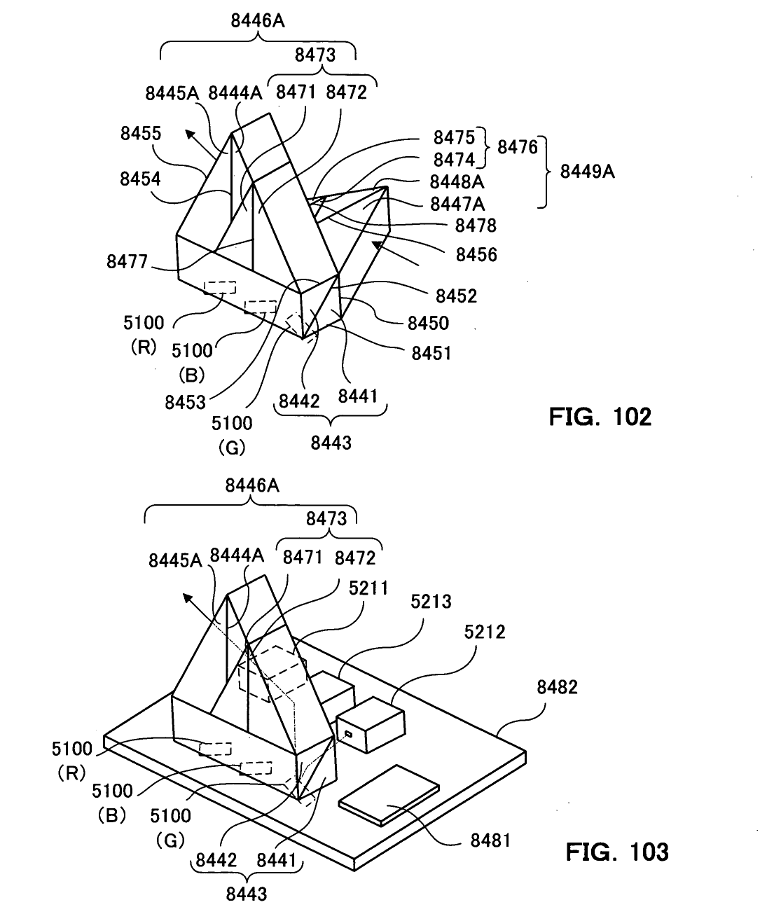

FIG. 102 is a diagram for showing the optical system of an projection apparatus implemented as a three-panel projection apparatus according to the embodiment 9-4 as another exemplary configuration, mainly showing.

The exemplary configuration shown in FIG. 102 differs from the exemplary configuration shown in FIG. 100. The apparatus with three spatial light modulators shown in FIG. 102 is configured with a second joinder prism and of a third joinder prism. In the following description, FIG. 102 shows the second joinder prism and third joinder prism as joinder prisms 8446A and 8449A, respectively.

The second joinder prism 8446A is configured by using a fourth joinder prism 8473 structured by joining together two right-angle triangle columnar prisms 8471 and 8472 of the same shape to replace a part of the second joinder prism 8446 shown in FIG. 100. The remaining parts of the prism 8445 and prism 8444 are the prism 8445A and prism 8444A respectively and both of which are parts of the second joinder prism 8446 shown in FIG. 100. The joinder surface of the prisms 8471 and 8472 on the fourth joinder prism 8473 is a synthesis surface 8477 for synthesizing the lights modulated by two spatial light modulators 5100 (G) and 5100 (B) in the same light path. Furthermore, a dichroic filter is formed on the synthesis surface for reflecting the light of the blue frequency component and transmitting the light of the green frequency component.

Furthermore, the third joinder prism 8449A is a joinder prism that is similar to the second joinder prism 8446A. A fifth joinder prism 8476 structured by joining together two right-angle triangle columnar prisms 8474 and 8475 of the same shape is configured to replace a part of the third joinder prism 8449. The remaining parts of the prism 8447 and prism 8448 are the prism 8447A and prism 8448A respectively and, both are parts of the third joinder prism 8449 shown in FIG. 100. On the fifth joinder prism 8476, a dichroic filter is formed on the joinder surface 8478 joining the prisms 8474 and 8475 for reflecting the light of the blue frequency component and transmitting the light of the red frequency component.

FIG. 102 shows the exemplary configuration with the first optical surface 8450 of the first joinder prism 8443 configured to be vertical to the synthesis surface 8454 of the second joinder prism 8446A and to the synthesis surface 8477 of the fourth joinder prism 8473. Meanwhile, similar to the configuration shown in FIG. 100, FIG. 2 shows the deflection loci of the modulation lights modulated by the three spatial light modulators 5100 are approximately parallel to the synthesis surface 8454 of the second joinder prism 8446A.

When an illumination light enters the slope surface of the prism 8447A of the third joinder prism 8449A in the projection apparatus according to the embodiment 9-4, the green light is reflected by the joinder surface 8456, and the red and blue lights is transmitted through the joinder surface 8456. Then, the red and blue lights are transmitted through the joinder surface 8456 to project to the slope surface of the prism 8474. The blue light is reflected by the joinder surface 8478, while the red light is transmitted through the joinder surface 8478.

The green light reflected by the joinder surface 8456 is reflected by the slope surface of the prism 8447A. The green light is then projected vertically to the first optical surface 8450 of the first joinder prism 8443 and is reflected by the selective reflection surface 8452 and then is ejected from the second optical surface 8451 for projecting to the spatial light modulators 5100 (G). Then, the incident light is reflected vertically upward when the mirror 4003 is in the ON state. The optical path is following a sequence that the light is projected vertically to the second optical surface 8451, transmitted through the selective reflection surface 8452 and is incident to the third optical surface 8453 of the second joinder prism 8446A. The green light then enters the third optical surface 8453, and is reflected by the slope surface of the prism 8472, transmitted through the synthesis surface 8477, and is then synthesized with the blue light (which is described later. The synthesized light is ejected from the slope surface of the prism 8471 to enter the prism 8444A. The synthesized green and blue light then enter into the prism 8444A, and is transmitted through the synthesis surface 8454, and then synthesized with the red light (which is described later) Then, the synthesized light is ejected from the ejection surface 8455 and is incident to a projection optical system (not shown here).

The blue light that is reflected by the joinder surface 8478 of the fifth joinder prism 8476 is reflected by the slope surface of the prism 8474. The optical path of the blue light is then following a sequence that the blue light is incident vertically to the first optical surface 8450 of the first joinder prism 8443, reflected by the selective reflection surface 8452, ejected from the second optical surface 8451 and is incident to the spatial light modulators 5100 (B). Then, the incident light is reflected vertically upward when the mirror is in the ON state and is incident vertically to the second optical surface 8451, transmitted through the selective reflection surface 8452 and is incident to the third optical surface 8453 of the second joinder prism 8446A. The blue light enters into the third optical surface 8453, is reflected by the slope surface of the prism 8471, and is further reflected by the synthesis surface 8477 and synthesized with the above-described green light. The synthesized light is ejected from the slope surface of the prism 8471 and is incident to the prism 8444A. The green and blue synthesized light that enter into the prism 8444A is transmitted through the synthesis surface 8454, and is then synthesized with the red light (which is described later). The synthesized light is ejected from the ejection surface 8455 and is incident to a projection optical system (not shown in a drawing herein).

The red light that is transmitted through the joinder surface 8478 of the fifth joinder prism 8476, is reflected by the slope surface of the prism 8475, is incident vertically to the first optical surface 8450 of the first joinder prism 8443, then reflected by the selective reflection surface 8452, and ejected from the second optical surface 8451 and then projected to the spatial light modulators 5100 (R). Then, the incident light is reflected vertically upward when the mirror 4003 is in the ON state and is incident vertically to the second optical surface 8451, transmitted through the selective reflection surface 8452 and is incident to the third optical surface 8453 of the second joinder prism 8446A. The red light transmitted to the third optical surface 8453, is reflected by the slope surface of the prism 8445A, and is further reflected by the synthesis surface 8454, and is then synthesized with the above described blue/green synthesized light. The synthesized light is then ejected from the ejection surface 8455 and is incident to a projection optical system (not shown in a drawing herein).

The above description completes the description of embodiment 9-4 as another exemplary configuration of the projection apparatus.

Additionally, the exemplary configuration shown in FIG. 102 can also be configured to eliminate the third joinder prism 8449. The light sources of the different colors are disposed opposite to the first optical surface 8450 of the first joinder prism 8443 in such projection apparatus.

FIG. 103 shows an alternative configuration implemented with the optical system by joining the first joinder prism 8443 and second joinder prism 8446A together and implementing the red laser light source 5211, green laser light source 5212 and blue laser light source 5213, as the light sources of the respective colors, and using the these light sources with three spatial light modulators 5100. The apparatus further implements a controller 8481 for controlling the aforementioned components on the same board 8482. Such a configuration has an advantage because the projection apparatus can be manufactured with a more compact size.

While the invention according to the preferred embodiments 9 has been described in detail thus far, the invention according to the embodiments 9 may be further improved and/or modified in various manners possible within the essential scopes of the invention. The scopes of this invention are therefore not limited by the specific details the exemplary configurations illustrated in the above-described preferred embodiments 9-1 through 9-4.

As such, the contrast of a projection image of the projection apparatuses is improved according to the preferred embodiments 9. Furthermore, the apparatus has a more compact size even that the projection apparatus now is implemented with a plurality of spatial light modulators.

### Embodiment 10

A description of the present embodiment is provided for a light source used for a projection apparatus which is capable of controlling a mirror to operate in a semi-ON state in addition to an ON state for reflecting a modulated light for projecting an image and an OFF state for projecting a dark pixel. Specifically, the semi-ON state is further described and defined below. Specific configuration of a light source for producing the semi-ON state is described first. FIG. 24B shows a light source to operate in a semi-ON state.

FIG. 24B shows a bias current circuit 5570c generates a bias current I_{b} as an output current to generate an incident light projected from the light source such that no image is projected, or alternately an incident light is not projected from the light source while the light source is being driven. Since no image is projected, all switching circuits may be turned off in response to the control signal from a light source control unit to decrease the light intensity of the light source, driving it only with the bias current I_{b}. Therefore, when no image is projected, the bias current I_{b} is continuously flown, instead of turning off the light source completely. The light source control unit therefore achieves a special operation condition as a semi-ON state. Furthermore, by maintaining the light intensity of the light source at a certain level instead of completely turning off the light source eliminates a time required for a current flowing in the circuit for turning on the light source. The timesavings are accomplished when changing over from the state in which no image is projected to the state in which an image is projected. Such operation process has an advantage of shortening an emission preparation time for preparing the light source to emit light. As a result, the activation of the light source for projecting light can be started faster.

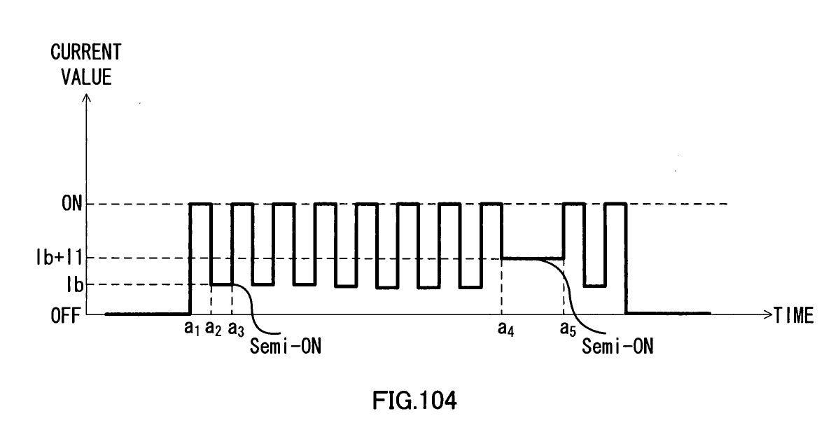

FIG. 104 shows the operation processes according to the following description of turning a light source to operate in the ON, OFF and semi-ON states.

Specifically, FIG. 104 is a timing diagram for illustrating the time sequence that an electric current drive controls a light source to operate in a semi-ON state.

The vertical axis FIG. 104 represents the amount of output current generated by a light source drive circuit, with a designation of “ON” indicating an output current to drive a light source to output an incident light for projecting an image, and “OFF” indicating an output current when the power supply for the light source is completely turned off; and the horizontal axis shows a time axis, indicating the elapsed time.

The relationship between the elapsed time and the power supplied to the light source of the present embodiment is described below:

Prior to time a₁: the power supply to the light source is completely shut off, and the current is generated from the light source drive circuit is OFF. At time a₁: the power supply to the light source is turned on for projecting an image and the current generated from the light source drive circuit is ON. As a result, the light source is projecting a light for displaying an image. Prior to time a₂: the current to the light source is maintained at ON for continuous generating a light for projecting and displaying the images. At time a₂: the current to the light source is control to a semi-ON level that is set at I_{b}. The image display is discontinued because the current is not sufficient for the light source to project a light for display images. In an exemplary embodiment, the current I_{b} is a bias current shown in the above described FIG. 24B. A specific ranges of bias current for a light source can control the light source to operate at the semi-ON state when the light source is not projecting a light for image display while a power is supplied to keep the light source drive circuit to operate at an ON condition.

Prior to time a₃: no image is projected whiling maintaining an output current I_{b} to the light source. At time a₃: the current value of the light source is set at ON for restarting the projection of an image. In this event, the light source drive circuit generate an ON current, i.e. increasing from the semi-ON current I_{b} and therefore the light source can be activated more quickly comparing with an operation of changing the current values from OFF to ON.

Prior to time a₄: the light source is controlled to perform pulse emission by repeating the processes of controlling the output current from the light source drive circuit at an ON level followed by controlling the bias current at the semi-ON current level of I_{b}.

At time a₄: in order to stop projecting an image, the current for the light source is controlled to a level of I_{b}+I₁. The I_{b}+I₁ is a current generated by adding the bias current I_{b} shown in the above described FIG. 24B and a current I₁. The current I₁ can be added to the current I_{b} by the light source control unit by controlling the switching circuit. The semi-ON state is accomplished by appropriately controlling the current I_{b}+I₁ with the light source outputs a low level of light while no visible image is projected.

Prior to time a₅: the current is maintained as a I_{b}+I₁ is level and no image is projected. At time a₅: in order to restart an image projection, the current of the light source is set at ON. In this event, the current are changed to ON from the I_{b}+I₁, and thereby the light source can be increased more quickly than changing the current values from OFF to ON or from the current value I_{b} of the bias current to the ON.

By controlling the current generated from the circuit of the light source as described above, the light source control unit is able to produce the ON, OFF and semi-ON states of the light source. A light source as that described in FIG. 23A can be controlled to operate with these control levels as show in FIG. 104.

As described above, it is possible to control a light source to operate in a semi-ON state in addition to an ON state for projecting a light for displaying an image and an OFF state by turning off the power supply for a light source. A light source implemented with a semiconductor light source such as a laser diode and a light emitting diode (LED) may also be controlled to operated with the ON/OFF and the semi-ON states.

Furthermore, the light source configured as shown in the above-described FIG. 24B includes a switching circuit to carry out the changing over operation and can therefore adjust the light intensities of the light source stepwise as shown in the above-described FIG. 26.

Furthermore, smaller intensity adjustments can be accomplished by implementing the pulse emission of a light source. For example, adjustment of the light intensity during one frame period is achievable by making the light source to perform pulse emission and then controlling the number of pulsed emissions during one frame period when an image is projected.

In addition, a light source may include a plurality of sub-light sources. An exemplary embodiment of laser light source includes a plurality of sub-laser light sources bundled together with the same wavelength. With the bundled sub-laser light source, the light intensity can easily be adjusted by controlling the turning on and off of each of the sub-laser light sources. Furthermore, more flexible control of the light source can be achieved by controlling the state of some of the individual sub-laser light sources to operate at a constantly ON state by changing these sub-laser light sources to a state of semi-ON. Likewise, control of the laser light source is achieved by turning on other sub-laser light sources originally turned off for projecting a certain image. Therefore, the light source can be more quickly activated than the light source with the entire sub-laser light sources are turned off. It is also possible to control a laser light to operate with a semi-ON state by implementing for each sub-laser light sources a bias current circuit as described above and by supplying a bias current constantly to another set of individual sub-laser light sources.

The light source with a current drive of the example shown in the above described FIG. 24B can control and change the current for adjusting the light intensities. An alternative configuration may be implemented by using a voltage-driven light source and a circuit to control a voltage for driving the light source.

The following is a description for a projection apparatus that includes a light source controllable to operate in the semi-ON state described above. The projection apparatus includes a light source controllable to operate in the semi-ON state comprises a spatial light modulator for modulating the incident light emitted from the light source. The projection apparatus further includes a light source control unit for controlling the modulation of the light source and a spatial light modulator control unit for generating, from an input image signal, a control signal used for driving the spatial light modulator.

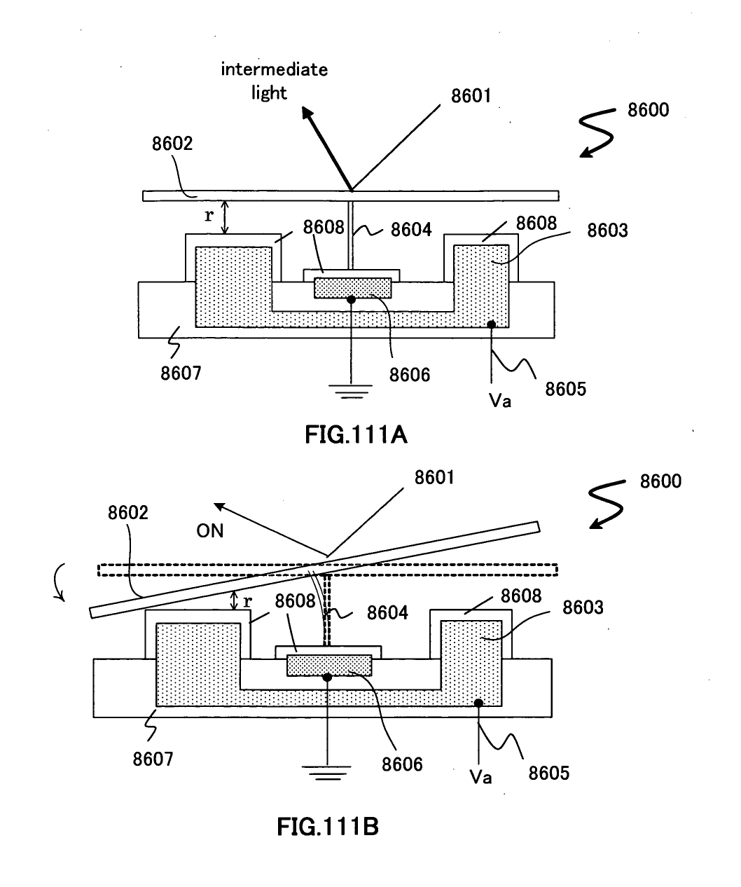

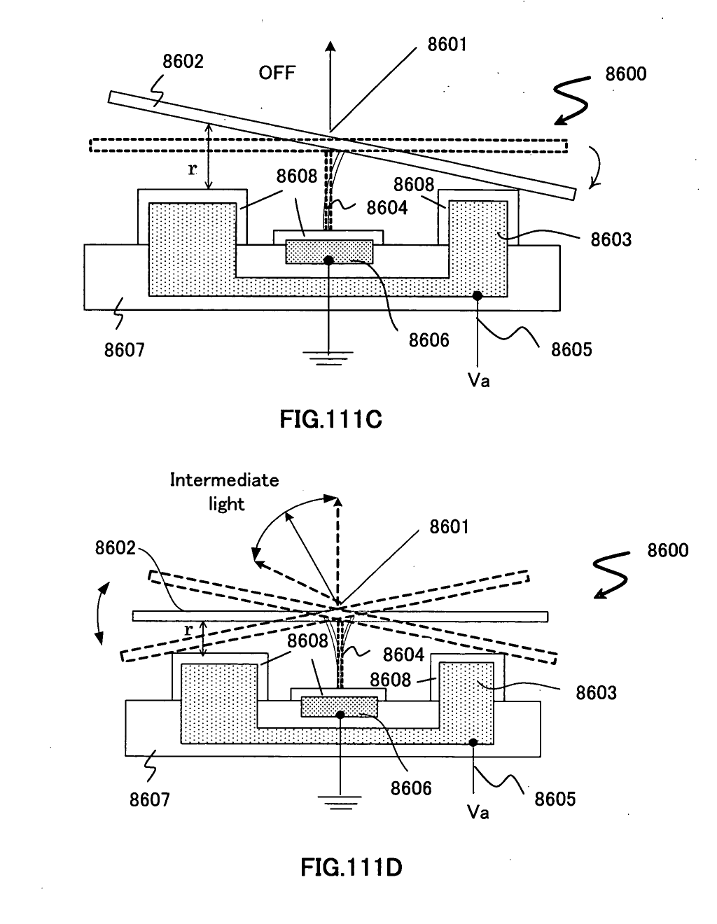

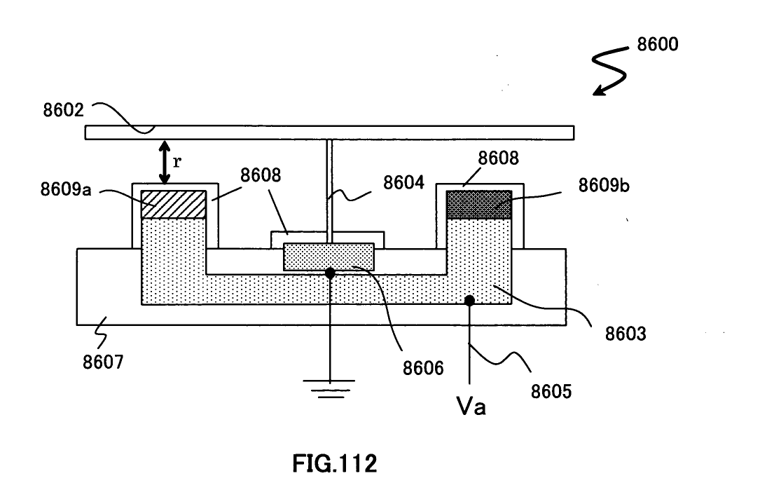

The spatial light modulator is, for example, a mirror device implemented with a plurality of mirror elements for controlling the reflecting direction of the incident light. Such a mirror device may be configured and implemented with the mirror device described in the above described FIGS. 8A through 8D, 27B, 69, 70A, 70B, 71A through 71C, 72, and later described FIGS. 111A, 111B, 111C, 111D and 112. Furthermore, a control device configured according to that described in FIG. 73 may be implemented to control the mirror device.

The light source control unit receives a control signal for controlling the light intensity to operate in the semi-ON state and controls a switching circuit for the light source as shown in FIG. 24B. As an example, the light source control unit controls the light intensity from the light source by applying a switch changeover method while synchronizing with the spatial light modulator based on the control signal received from a sequencer as shown in FIG. 24B.

Furthermore, the light source control unit also controls the pulse emission when the light source is operated in the ON state or semi-ON state by applying a switch changeover method by employing the switching circuit of a light source circuit based on the control signal as shown in FIG. 24B.

Note that the light source control unit for the light source may include a circuit to generate the drive current and/or drive voltage in the semi-ON state at lower current and/or voltage than those for the ON state and higher than those for the OFF state. Specifically, a new circuit may be implemented to generate the light intensity for emission from the light source exactly at the intensity of a semi-ON state. The new circuit for the light source is different from the ON/Off switching circuits and may be formed as a switching circuit as shown in the above described FIG. 24B that includes a circuit with branches for conducting the current for the ON state. The light source is then controllable to operate in a semi-ON state without requiring a larger current than the drive current required for the ON state with a simple circuit as shown in the above described FIG. 24B. Therefore, the circuit provides good efficiency in controlling the light source under the semi-ON state.

The spatial light modulator control unit controls a spatial light modulator in accordance with an image signal. The spatial light modulator control unit is controlled to operate synchronously with the light source control unit to accomplish the purpose of modulating the light with the spatial light modulator and project a desired image.

Therefore, the light source control unit of the projection apparatus receives a control signal for controlling a light source. The light source control unit controls the light source under an ON state with the light at an intensity for projecting an image is output when projecting the image. The light source control unit controls the light source under a semi-ON state with either the light at an intensity for not projecting an image with no light output while the power supply to the light source is kept turned on when not projecting the image, thereby enabling a changeover between projecting an image and projecting no image.

Furthermore, a projection apparatus may include a plurality of light sources with the semi-ON state for emitting the lights of different wavelengths, respectively. Furthermore, a light source controllable to operate in the semi-ON state can also be implemented in a multi-panel projection apparatus that includes a plurality of spatial light modulators as illustrated in the above described FIGS. 22A through 22C and FIGS. 66A through 66D, in addition to the single-panel projection apparatus that includes a single spatial light modulator as shown in FIG. 21. Specifically, the overall control for a single-panel projection apparatus can be carried out by the configuration illustrated as shown in FIG. 23A, and the overall control for a multi-panel projection apparatus can be carried out by the configuration illustrated as shown in FIG. 23B.

The following is a description of an exemplary embodiment for carrying out a synchronous control between a spatial light modulator and a light source controllable to operate in a semi-ON state.

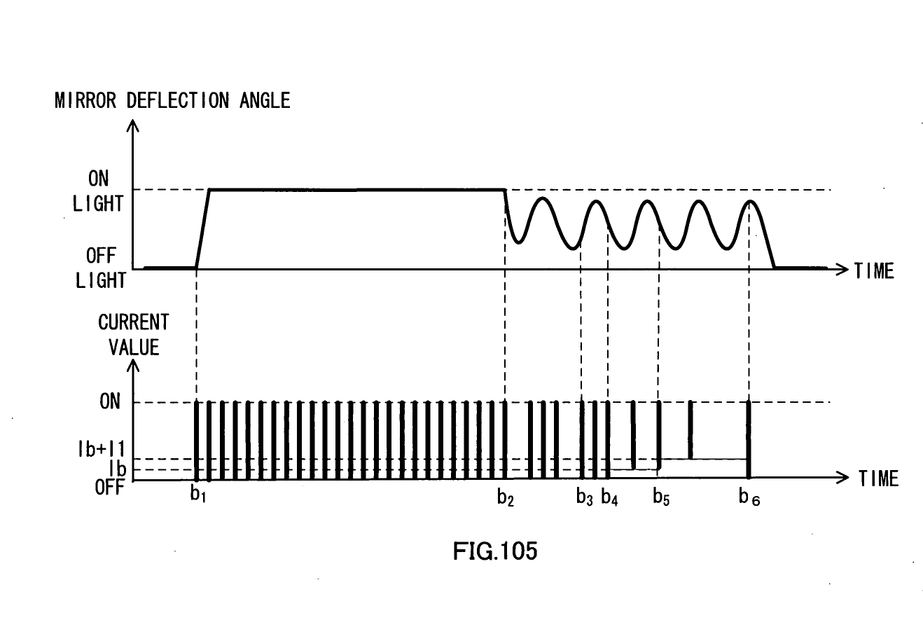

FIG. 105 is a timing diagram for showing the time sequence for controlling a light source to operate in a semi-ON state by coordinating a current driven light source that performs pulse emission with the operational states of the mirror of a mirror elements implemented in a spatial light modulator.

In FIG. 105, the vertical axis indicates the deflection angle of a mirror for defining the deflection angle of a mirror when the incident light is controlled to project an “ON light” and “OFF light”. FIG. 105 further shows the value of the electric current of the light source, for the light source to project a light with an intensity for projecting an image as “ON” light intensity, and the value of an electric current when the power supply to the light source is completely shut off and the light source is operated in an “OFF state”. Furthermore, the horizontal axis indicates a time axis, indicating the elapsed time.

The following explains the a functional relationship between time and the control processes of the light source of the present embodiment:

Prior to time b₁: the deflection angle of a mirror is controlled to deflect in an OFF direction, and the value of the electric current is OFF by completely turning off the power supply to the light source. At time b₁: the deflection angle of the mirror is controlled to deflect to an ON direction for projecting an image, and the value of the electric current is ON for turning on the power supply to the light source to project an image. Between time b₁ and time b₂: the deflection angle of the mirror is controlled to deflect to an ON direction, and the value of the current value is repeatedly pulsed between ON and OFF to project pulse emissions for projecting the images while adjusting the light intensity.

At time b₂: the voltage applied to the address electrode is terminated while retaining the deflection angle of the mirror to an ON direction and controls the mirror under a free oscillation state in which the mirror oscillates between the deflection angles of the ON light and OFF light. Furthermore, the number of times of pulse emission with the value of the electric current set at ON and OFF, is adjusted.

Between time b₂ and time b₃: the mirror is operated in a free oscillation state with the deflection angles of the mirror oscillates between ON light and OFF directions, and the number of times for projecting the pulse emission, is controlled to three times in every cycle of free oscillation for adjusting the intensity of the image projection light for projecting.

Between time b₃ and time b₄: a similar control process for controlling the deflection angle and the electric current is carried out between the time b₂ and b₃. Between time b₄ and time b₅: the number of times of pulse emission is adjusted to two times per one cycle of free oscillation with the current values set at ON and OFF, while maintaining the mirror in a free oscillation in which the deflection angle of the mirror reciprocates between ON light and OFF light. With this control, the light intensities of the light for image projection between the time b₃ and time b₄ are adjusted. Further, between the time b₄ and time b₅, the current value of the light source when no image is projected is turned OFF, as has been performed between the time b₁ and time b₂, but the value of the electric current of the light source is controlled at I_{b} when no image is projected. The current I_{b} is the bias current shown in the above described FIG. 24B. An appropriate bias current controls the light source under the semi-ON state with the light source driven by an input current with no light project therefrom. Specifically, between the time b₄ and time b₅, the pulse emission is carried out with the current value set at ON and I_{b}. By setting the current value from I_{b} to ON while controlling the light source to project the pulse emissions the current of the light source can be more rapidly increased from OFF to ON. g

Between time b₅ and time b₆: while maintaining the mirror under a free oscillation with the deflection angle of the mirror oscillates between the ON light and OFF light, the number of pulse emission, with the current values set at ON and OFF, is adjusted to two times per one cycle of free oscillation. Meanwhile, between the time b₅ and time b₆, the current value of the light source is set at I_{b}+I₁ when no image is projected, instead of being set at ON and I_{b} (as between the time b₄ and time b₅). The current value I_{b}+I₁ is the current generated by adding a current value I₁ to the current value I_{b} of the bias current shown in the above described FIG. 24B. The light source control unit controls the switching circuit to add the current value I₁ to the current I_{b} of the bias current. An appropriate setting of the current value I_{b}+I₁ makes it possible to control the light source under the semi-ON state in which it outputs an incident light with which no image is projected. Specifically, between the time b₅ and time b₆, the pulse emission can be carried out with the current value set at ON and I_{b}+I₁. In this case, when the current the light source more can be more rapidly increased from I_{b}+I₁ to ON, than increased the current from the OFF to ON, or from the current value I_{b}, of the bias current, to ON.

The light source control unit is able to perform an appropriate adjustment of the amount of light projection and intensity of the light source by controlling the current transmitted to the light source to operate the light source under the ON state, semi-ON state and OFF state.

As described above, instead of turning off the semiconductor light source completely, the present embodiment is configured to keep a semiconductor light source turned on to control the degree of brightness such that no visible image is projected while maintains a drive current for driving the light source with a drive current and keeping the light source on. The response speed of the light source is greatly improved by applying such a control process to the light source in changing over between projecting an image and projecting no image, leading to preventing a blur in a moving picture.

### Embodiment 11

A projection apparatus according to the present embodiment comprises a spatial light modulator for modulating the incident light emitted from a light source, and a wobbling device for changing the positions of reflection or transmission of the incident light by performing a wobbling process. The light source and the wobbling device are synchronized with each other so as to turn off the light source in a time period of changing the positions of reflection or transmission of the incident light. In an exemplary embodiment, an actuator connected to and fluctuate the spatial light modulator may be implemented as a wobbling device Furthermore, the light source may include a laser light source or a light emitting diode (LED) as a light source controllable to project pulsed emissions either of which is capable of performing pulse emission. The pulse emissions—can be conveniently synchronized with the operations of the wobbling device. Furthermore, the light source may be operated with a semi-ON state with the light source projects an incident light that does not project a visible image or does not project a light from the light source while the light source is driven by a low level driving current and maintained at an ON condition. The descriptions for FIGS. 104 and 105 provide the detail of the light source with the semi-ON state. The control processes for producing the ON state, semi-ON state and OFF state of the light source can be carried out with the configuration illustrated in the above described FIG. 23A.

In an exemplary embodiment, the spatial light modulator is implemented with a plurality of light modulation elements each modulating an incident light emitted from the light source and controlling the reflection light of the incident light to an ON direction for guiding the reflection light of the incident light to an image projection light path or to an OFF direction for guiding the reflection light of the incident light away from an image projection light path. One of the spatial light modulators comprising a light modulation element includes a mirror device. The mirror device includes a plurality of mirror elements each comprising both a deflectable mirror, which is supported by an elastic hinge formed on a substrate and the mirror reflects the incident light from the light source. The address electrode is formed on the substrate and under the mirror, as illustrated in the above described FIGS. 8A through 8D, 27B, 69, 70A, 70B, 71A through 71C, 72 and later described FIGS. 111A through 111D and FIG. 112. Such a mirror device is controlled by means of the configuration as illustrated in the above-described FIG. 73.

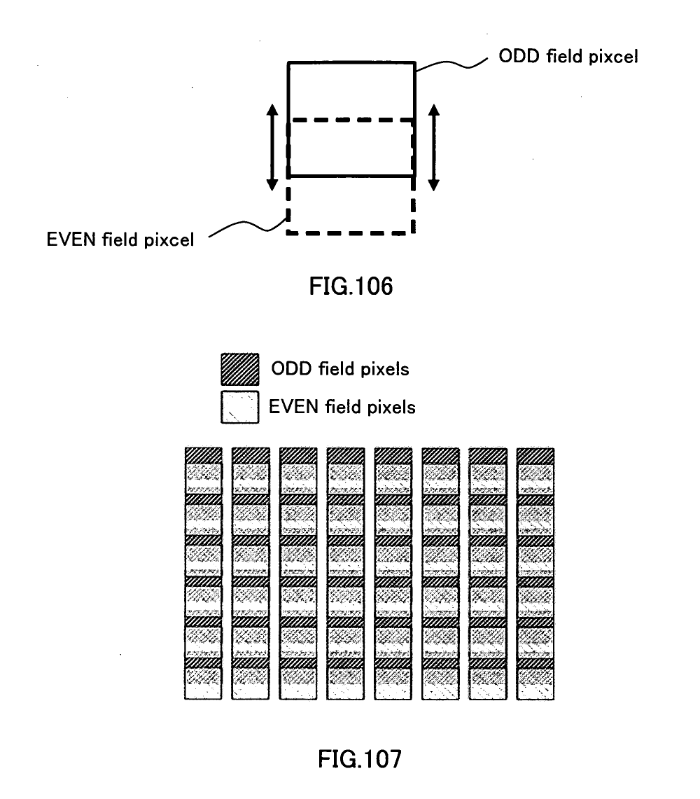

The following is a description of the operation of the light modulation element of the spatial light modulator by carrying out a wobbling process. FIG. 106 is a diagram illustrating the movements during a fluctuation process of a light modulation element of a spatial light modulator when operating a wobbling device according to the present embodiment. The spatial light modulator is configured to operate a wobbling device to fluctuate the light modulation element in the vertically upward and downward direction instead of swinging the light modulation element in a diagonal direction. With the vertically upward and downward fluctuations of the light modulation element, the projection apparatus is able to apply an interlaced signal directly to increase the image resolution without requiring an extra process.

The interlace method represents an image projection method of dividing one piece of image into two fields, i.e., odd field and even field, and displaying the image alternately with these two fields to change the images. Specifically, the odd field represents the pixels corresponding to the odd numbered rows of one piece of image, while the even field represents the pixels corresponding to the even numbered rows of one piece of image.

Displaying an image by alternating fields increases the number of changes of using different set of signals for display an image thus improving the image display to have a smooth motion. This interlace method increases the number of signal changes for a display without increasing a bandwidth or an amount of bit-rate information processing, and therefore the interlace method is commonly adopted to process the broadcast signals. For example, the interlace signal is converted into a non-interlace signal before displaying an image on a liquid crystal display (LCD) to overcome a flicker problem when a stationary image is displayed. The interlace method is also known as a progressive method wherein the amount of information is increased to two times and an image is degraded due to synthesizing the odd and even fields. Therefore, the light modulation element is fluctuated along upward and downward directions in the present embodiment when the odd field of an interlace signal is first displayed to superimpose the display of an even field with the display of the odd field to obtain an effect similar to that of the progressive method without requiring a conversion of the interlace signal into a progressive signal.

FIG. 107 is a diagram illustrating a process of wobbling the even field of an interlace signal in the vertical direction after displaying the odd field of the interlace signal. FIG. 107 shows a method to perform a wobbling process wherein a wobbling device controls the spatial light modulator after displaying the odd field of an interlace signal. The wobbling operation changes the positions of the modulation by changing the location of the incident light projecting to the light modulation element. The modulation of light is carried out at a position where the even field is superimposed on the odd field by shifting the position of the even field by approximately a half of the field where an image is originally projected.

Therefore, it is possible to obtain the benefits of reducing the process of the image data and improving the image quality of a projection image by projecting as the interlace image directly instead of carrying out extra image processing for an interlace signal. Further, the present embodiment is configured to synchronize the turn-off of the light source with the wobbling to turn off the light source during the wobbling process.

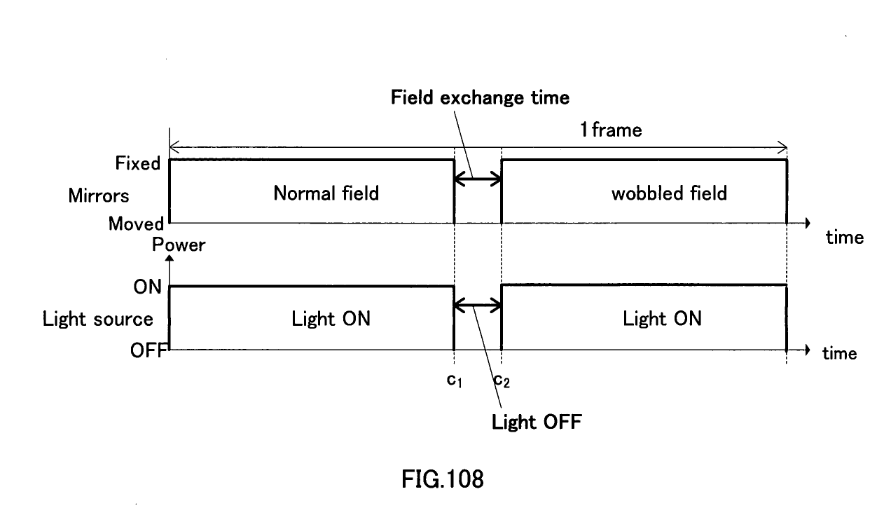

FIG. 108 is a timing diagram for illustrating the synchronization between a light source and the change in mirror positions of a mirror device by means of a wobbling process within one frame. Specifically, the spatial light modulator is implemented with a mirror device.

The vertical axis of the figure indicates the changes of the mirror positions in a mirror device and changes of the output of a light source. A term “Fixed” is defined as when the mirror is at a prescribed position and another term “Moved” defined as when the mirror is moved in the wobbling process. “Normal field” indicates the mirror position prior to being wobbled, and “wobbled field” indicates the mirror position after being wobbled. The output of the light source is defined as “ON” when the light source emits an incident light for projecting an image, and “OFF” when the power supply to the light source is completely shut off. The horizontal axes are time axes, indicating the elapsed time. Prior to time c₁: the mirror position of the mirror device is fixed at a Normal field, with the output of the light source set at ON. Therefore, if the Normal field is, for example, the odd field, the image of the odd field is projected. Between time c, and time c₂: the mirror positions are shifted by the wobbling device. While the mirror positions are being shifted by the wobbling, the power supply to the light source is turned OFF in sync with time in turning on the wobbling device. As a result, no image is projected while the mirror positions are moved during the mirror wobbling process thus projecting a black image.

At time c₂: the mirror wobbling process is completed and the wobbling device has moved the mirror to a prescribed fixed position. Then the power supply to the light source is turned ON in sync with turning off the wobbling device. This operation causes the image of the even field to be projected with the even field designated for display as the wobbled field.

Pixels are distinctively separated before and after the wobbling by the synchronization of the turn-off of the light source and wobbling device and tuning off the power supply to the light source during the wobbling as described above. Therefore, the resolution of the projection image can be improved. Furthermore, turning off of the light source during a wobbling operation interleaves a black image between projection images, further prevents a blur in dynamic images. Turning off of the light source further reduces the power consumption and the heating of the spatial light modulator. Furthermore, it is possible to configure the projection apparatus to implement a wobbling device and a spatial light modulator, which are described above.

The projection apparatuses may include a single-panel projection apparatus, which is illustrated in the above described FIG. 21 and which comprises one spatial light modulator connected to a wobbling device, and a multi-panel projection apparatus, which is illustrated in the above described FIGS. 22A through 22C and FIGS. 66A through 66D and which comprises a plurality of spatial light modulators each connected to a wobbling device.

### Embodiment 12

A projection apparatus according to the present embodiment comprises a mirror device that includes a plurality of mirror elements each modulating the incident light emitted from the light source and controlling the reflection light of the incident light to an ON direction for leading the reflection light of the incident light to a projection light path or to an OFF direction for not leading the reflection light of the incident light to a projection light path. Furthermore, the light source and mirror device are put under a pulse width modulation (PWM) control in one frame or one sub-frame. Within a time length in which the mirror of each mirror element performs an ON operation for reflecting the incident light to the ON direction and a mirror producing a maximum brightness performs the ON operation, the other mirrors finish the ON operation, while on the outside of such time length in which the mirror producing the maximum brightness performs the ON operation, the light source is turned off, within the one frame or one sub-frame. Specifically, the brightness represents the intensity of reflection light toward the projection light path.

The light source can also be implemented as a laser light source or a light emitting diode (LED), for performing pulse emission. The light source projecting pulsed emissions may be synchronized with the operation timing sequence of the mirror device. Furthermore, the light source may be controlled to operate as a light source with a semi-ON state when the light source projects an incident light that does not produce a visible image or when the light source does not project a light while kept on with a bias current and driven as described for FIGS. 104 and 105. The semi-On state is in addition to an ON state when the light source projects a light to display an image and an OFF state in which the power supply to light source is completely shut off. The control process for operating a light source with the ON state, semi-ON state and OFF state of the light source can be carried out in a projection apparatus having a configuration as shown in the above-described FIG. 23A.

The mirror device is implemented with a plurality of mirror elements arranged as two dimensional array wherein each includes a deflectable mirror supported by an elastic hinge formed on a substrate. The mirror controlled by an address electrode placed on the substrate to reflect the incident light from the light source as illustrated in the above described FIGS. 8A through 8D, 27B, 69, 70A, 70B, 71A through 71C, 72, and later described FIGS. 111A through 111D and FIG. 112. Such a mirror device is controlled by the control processes as illustrated in the above-described FIG. 73. Preferably, the mirror of the mirror device is controlled by using non-binary data generated by converting the binary data as illustrated in the above described FIGS. 48, 49, 50 and 51.

The following is a description of the operation with each mirror performs an ON operation and within a specific length of time within a frame displaying a maximum brightness after other mirrors complete the ON operation. Furthermore, the light source is turned off outside of the specific length of time for displaying the maximum brightness. The control process for controlling the image brightness and ON-OFF switching of the light source are carried out within a display frame or sub-frame. Furthermore, it is assumed that each mirror element is under a PWM control using non-binary data.

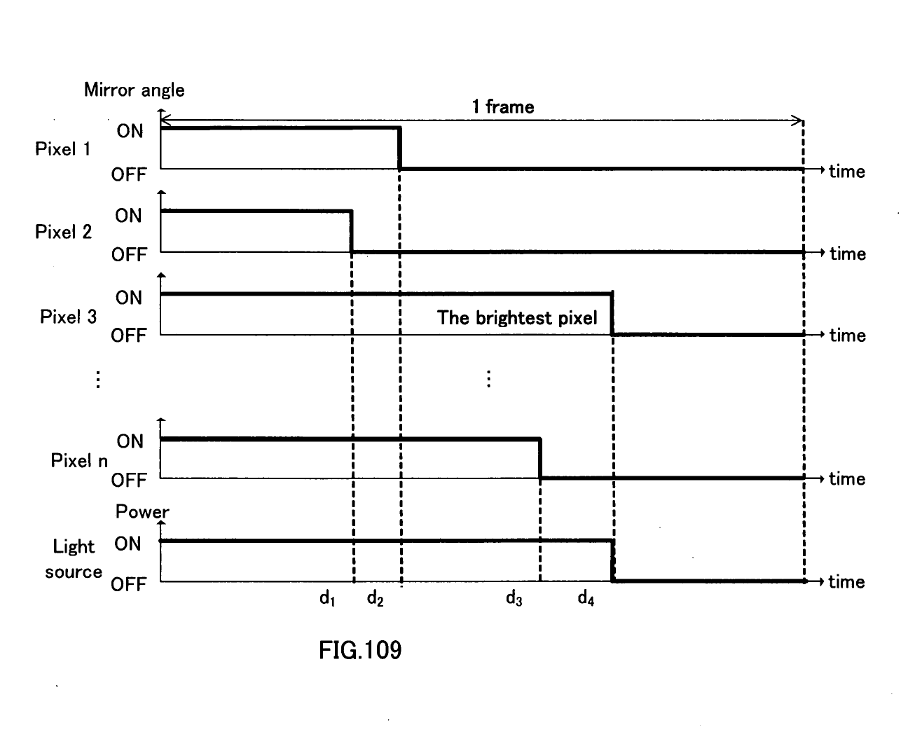

FIG. 109 is a timing diagram for showing the synchronization between a light source and the deflection angle of each mirror element. In FIG. 109, the vertical axis indicates the deflection angle of a mirror and the output of a light source, with the deflection angle of a mirror defined as “ON” when the incident light projected from the light source is operated to project an ON light. The mirror defined as “OFF” when the incident light projected from the light source is operated to project an OFF light. The output of the light source is defined as “ON” when the light source projects the incident light to display an image, and the light source is operated in an “OFF” state when the power supply to the light source is completely shut off. Furthermore, the horizontal axes indicate time axes, indicating the elapsed time. The assumption is that there are n-pieces of individual mirror elements, with the individual mirror elements display the image element commonly known as Pixel 1 through Pixel n. Further, the Pixel 3 is assumed to be a mirror element with a maximum brightness (i.e., the brightest pixel), that is, the mirror element producing the maximum intensity of reflection light (i.e., the intensity of the ON light state) to the projection light path.

Referring to FIG. 109, the brightest pixel 3 continues the ON operation prior to the time d4. All the other mirror elements have completed the ON operation by this time d4. Specifically, the brightest pixel 3 continues to operate in the ON state with the light source maintained at ON state to project an image projection light until the time d₄. The ON operation of the pixel 2 is finished at the time d₁; the ON operation of the pixel I is finished at the time d₂; and the ON operation of the pixel n is finished at the time d₃.

At time d₄, the output of the light source is turned OFF synchronously with turning OFF of the deflection angle of the mirror of the pixel 3. This series of operation concludes one frame. Such a control can also be carried out for a sub-frame.

As described above, the light source is synchronized with the operation sequence of a mirror element that projects the maximum brightness. The light source is controlled to maintain an ON state during a period when the mirror element reflects the incident light for image display with the maximum brightness. The other mirror elements have completed the operations of reflecting the incident light to the ON direction. During the time period outside of this period for projecting a maximum image brightness, the light source is turned off. Consequently, unstable reflection of the incident light during the transition operation of mirror elements can be eliminated except for a mirror element with the maximum brightness within the period of one frame or one sub-frame. Display of clear image is achieved.

Particularly, it is preferable to turn on the light source when each mirror stops and is ready to continue the ON operation, and it is preferable to turn off the light source immediately before a last mirror element finishes the display of a last pixel of all pixels for display one screen of images to enter into a period of OFF operation for reflecting the incident light to the OFF direction.

An alternate control process is discussed in the present embodiment is to operate a mirror with at least one OFF operation for reflecting the incident light to the OFF direction within one frame of image display in the midst of the ON operation of each mirror element, A pulse width modulation is applied to control the mirror element to perform an ON and OFF operation for one frame or one sub-frame.

The following is a description of the operation with each mirror element performs at least one time of the OFF operation by reflecting the incident light to the OFF direction in the midst of the ON operation of each mirror element. In the meantime, a mirror is controlled to project a maximum brightness during a period when the other mirror elements finish reflecting the incident light to the ON direction. Specifically, the assumption is that each mirror element is under a PWM control using non-binary data.

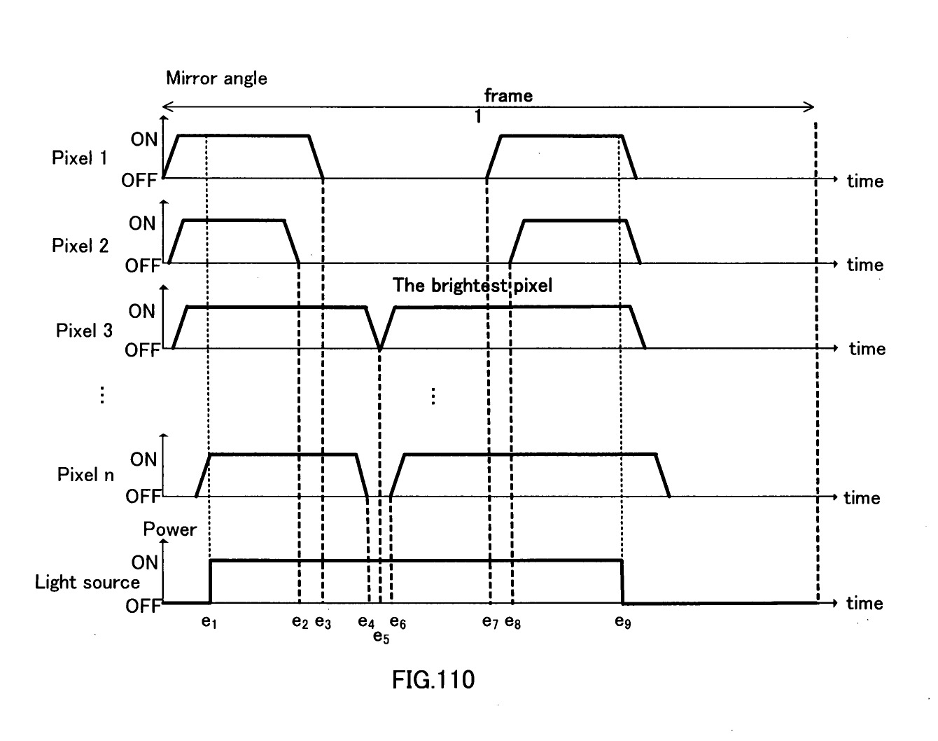

FIG. 110 is a timing for showing the process of carrying out one OFF operation of each mirror element within one frame while synchronizing the control sequence of a light source with the operation of each mirror element, according to the present embodiment.

In FIG. 110, the vertical axis indicates the deflection angle of a mirror and the output of a light source, with the deflection angle of a mirror defined as “ON” when the incident light from the light source is projected as an ON light, and the mirror defined as “OFF” when the incident light projected from the light source is an OFF light. The light projected from the light source is defined as “ON” when the light projected from light source is controlled to project a display image. The light projected from the light source is an OFF light when the power supply to the light source is completely shut off. Furthermore, the horizontal axes indicate time axes, indicating the elapsed time. The assumption is that there are n-pieces of individual mirror elements, with the individual mirror elements represented by Pixel 1 through Pixel n. The figure delineates the control for each mirror element within one frame. Other assumptions are that the output of the light source is turned ON between the time e₁ and e₉; and Pixel 3 is the mirror element with the maximum brightness (i.e., the brightest pixel), that is, the mirror element producing the maximum intensity of reflection light (i.e., the intensity of ON light state) toward a projection light path.

At time e₅: the brightest Pixel 3 performs an OFF operation. The other pixels are controlled to not turn ON while the brightest Pixel 3 is performing an OFF operation at the time e₅. Specifically, while the mirror element with the maximum brightness is operated in the OFF state, the other mirror elements are controlled to not perform ON operations. As a result, all mirror elements are in the OFF operation, and therefore a black image is inserted.

Between time e₁ and time e₅: that is, during the time length the brightest Pixel 3 performs an ON operation, the OFF operation of the Pixel 2 is performed at the time e₂, the OFF operation of the Pixel 1 is performed at the time e₃, and the OFF operation of the Pixel n is performed at the time e₄. Then, at time e₅: the brightest Pixel 3 performs an ON operation immediately after the OFF operation. Then, after the brightest Pixel 3 performs the ON operation, the other mirror elements are controlled to perform respective ON operation. Therefore, between time e₅ and time e₉: the ON operation of the Pixel n is performed at the time e₆; the ON operation of the Pixel 1 is performed at the time e₇; and the ON operation of the Pixel 2 is performed at the time e₈. Then, at time e₉: the output of the light source is turned OFF. Then one frame is finished. Note that such a control can also be carried out for sub-frames.

In FIG. 110, the output of the light source is maintained at an ON state during a period when the mirror element with the maximum brightness is in an OFF operation. Alternately, it is an option to turn ON/OFF the output of the light source in synchronous with the OFF operation or ON operation of the mirror element with the maximum brightness. Further, it may also be possible to synchronize the start and finish of the ON operations, including the OFF operations, of other mirror elements with the start and finish of the period of the ON operation and the OFF operation, of the mirror element with the maximum brightness.

With the above-described operations, each mirror element performs at least one time of OFF operation in the midst of the ON operations of the individual mirror elements within a period of one frame or one sub-frame. By inserting a black image between individual frames or sub-frames, the light and shade are enhanced, and thereby the image quality is improved. Meanwhile, by turning off of the light source the power consumption and the heating of the spatial light modulator are also reduced. In the meantime, the mirror device implementing the control processes for controlling the mirror elements can also be used for many types of projection apparatuses. For example, the projection apparatuses may include, a single-panel projection apparatus as illustrated in the above described FIG. 21 and which comprises one mirror device, and a multi-panel projection apparatus, which is illustrated in the above described FIGS. 22A through 22C and FIGS. 66A through 66D and which comprises a plurality of mirror devices.

### Embodiment 13

A mirror device according to the present embodiment includes a plurality of mirror elements arranged as two-dimensional array. Each element includes a deflectable mirror supported by an elastic hinge equipped on a substrate for reflecting the incident light emitted from a light source. A single address electrode placed on the substrate under the mirror asymmetrically about the deflection axis of the mirror disposed between the left and right sides. Further, the light source is turned off during a period when the mirror performs a series of operations starting from the initial state of the mirror to the completion of a mirror deflection to one side of the single address electrode after the mirror deflects to the other side of the single address electrode.

The light source may be a semiconductor light source such as a laser light source. Further, the light source may use a light source having a semi-ON state when the light source projects an incident light that does not display a visible image or, does not project a light while conducting a bias current to the light source and keeping the light source under a driven condition as described for FIGS. 104 and 105. The light control is in addition to an ON state in which the light source outputs the incident light for projecting and displaying an image and an OFF state when the power supply to light source is completely shut off. Note that the control process for producing the ON state, semi-ON state and OFF state of the light source as shown in FIGS. 104 and 105 can be carried out with the configuration illustrated in the above described FIG. 23A. The mirror device includes a plurality of mirror elements arranged in two dimensional array wherein each mirror comprising a deflectable mirror supported by an elastic hinge formed on a substrate and for reflecting the incident light from the light source. A single address electrode is formed on the substrate and under the mirror, as illustrated in the above described FIGS. 69, 70A, 70B, 71A through 71C and 72. Furthermore, the mirror device is controlled by the control process and circuits as illustrated in the above described FIG. 73.

As an example, FIG. 111A shows the configuration of one mirror element of the mirror device according to the present embodiment. The mirror element 8600 comprises one drive circuit formed on a substrate 8607 for deflecting a mirror 8602. Furthermore, an insulation layer 8608 is formed on the substrate 8607, and one elastic hinge 8604 is formed on the insulation layer 8608. The elastic hinge 8604 supports the mirror 8602, and a single address electrode 8603 connected to a drive circuit is formed under the mirror 8602. The mirror 8602 is electrically controlled by the single address electrode 8603, and by the drive circuit connected to the single address electrode 8603. Specifically, a hinge electrode 8606 connected to the elastic hinge 8604 is grounded by penetrating the insulation layer 8608.

The mirror element 8600 of the mirror device according to the present embodiment is described above. Furthermore, the mirror device can be implemented by placing a plurality of mirror elements 8600 on the substrate 8607 as shown in the above-described FIG. 69.

The present specification document calls the right side (as shown in the figure) of the part of the single address electrode 8603, where the part is exposed on the substrate 8607, of the mirror element 8600, as “first electrode part”, with the elastic hinge 8604 or the deflection axis of the mirror 8602 considered to be the border, and the left side thereof as “second electrode part”. A coulomb force is generated between the first electrode part and mirror 8602, and between the second electrode part and mirror 8602, by applying a voltage to the single address electrode 8603. Specifically, the word “applying a voltage” noted in the present specification document can be reworded as “changing an electric potential to a predetermined waveform”. Differentiating the Coulomb force between the left and right sides of the mirror 8602 deflects the mirror 8602 to the left and right side of the deflection axis. Incidentally, when the mirror 8602 is deflected to the left side of the deflection axis, and the right side thereof, the angle formed between the mirror and the vertical axis of the substrate 8607 is preferred to be symmetrical.

The materials for fabricating the respective components of the mirror element 8600 such as the mirror 8602 may include a high reflectance metallic material or a dielectric multi-layer film. Furthermore, a part (e.g., the base part, neck part and in between) or entirety of the elastic hinge 8604 supporting the mirror 8602 is made of a metallic material, or similar materials with a restoring force. Note that the present specification document depicts the elastic hinge 8604 as a cantilever with elasticity in a degree allowing a free oscillation of the mirror 8602. The elastic hinge 8604 may also be formed as a torsion hinge. The single address electrode 8603 is made of an electrical conductive material such as aluminum (Al), copper (Cu), or tungsten (W), and is configured to have the same potential throughout the entirety of the electrode per se. Further, the insulation layer 8608 can use, for example, SiO₂ or SiC. Further, the substrate 8607 can use, for example, Si.

Note that the material and form of each component of the mirror device 8600 illustrated in the present specification document may be appropriately changed in accordance with its purpose. In FIGS. 111B through 111D as discussed in the followings, the single address electrode 8603 is formed asymmetrical about the elastic hinge or the deflection axis of the mirror. The first electrode part of the single address electrode 8603 is formed on the OFF light side and the second electrode part is formed on the ON light side.

According to the present embodiment, the cross-sectional diagram of the mirror element as depicted in FIG. 111A shows the mirror is controlled at a horizontal direction relative to the substrate as the initial state of the mirror device. is where by. In the following description for FIG. 111A, the initial state of the mirror reflects the incident light 8601 as an intermediate light.

According to the present embodiment, FIG. 111B shows a cross-sectional diagram of a mirror element 8600, operated in an ON light state of the mirror device.

Referring to FIG. 111B, by applying a voltage to the single address electrode 8603 in the initial state shown in FIG. 111A a coulomb force F is generated between the first electrode part (and the second electrode part) and a mirror 8602 opposite to the respective electrode part. In this event, the coulomb force generated between the second electrode part and the opposite mirror 8602 is larger than the coulomb force generated between the first electrode part and opposite mirror 8602 when the area of the second electrode part is larger than that of the first electrode part. The mirror accordingly is tilted to the second electrode part. The application of a voltage to the single address electrode 8603 deflects the mirror 8602 to reflect the incident light 8601 toward an image projection path as an ON light.

According to the present embodiment FIG. 111C shows a cross-sectional diagram of a mirror element 8600 operated in an OFF light state of the mirror device.

Referring to FIG. 111B, a voltage is applied to the single address electrode 8603 to produce an ON light and then the voltage applied to the single address electrode 8603 is cut off. As a result, the mirror 8602 performs a free oscillation due to the elastic force of the elastic hinge 8604. With this free oscillation, the mirror 8602 oscillates between the deflection angle producing the ON light and that producing the OFF light.

When the distance r between the free-oscillating mirror 8602 and a part of the single address electrode 8603 tilted toward an OFF direction closer to the first electrode part, a voltage is re-applied to the single address electrode 8603 at an appropriate timing. This operation regenerates a coulomb force F between the first electrode part and the mirror now tilted to an opposite direction, and between the second electrode part and the mirror, respectively. Specifically, when the distance between the first electrode part and mirror is shorter than that between the second electrode part and mirror the coulomb force functioned to the first electrode part is larger than that functioned to the second electrode part because a coulomb force decreases proportionately to the square of the distance. Therefore, the mirror is drawn to the first electrode part to contact with the single address electrode 8603, and thereby the mirror 8602 is kept and operated at an OFF state.

When the mirror 8602 performs a free oscillation and then return to a state to a horizontal orientation relative to the substrate same as that of the initial state, it is possible to cause the mirror 8602 to stay at a fixed position by applying an appropriate pulse voltage to the single address electrode 8603 at an appropriate position of the free-oscillating mirror 8602.

In the conventional technique, a method for returning the mirror to the initial state, includes a step of applying appropriate voltages to two single address electrodes 8603 for generating similar coulomb force in order to cause a mirror to stand still.

In contrast, the method according to the present invention is to apply a pulse voltage to the single address electrode 8603 to return the mirror 8602 to the initial state. As described above, applying a voltage to the single address electrode 8603 can control the mirror to deflect to directions along the ON light and OFF light. Therefore, each mirror can be independently controlled by a smaller number of address electrodes than the conventional method. Furthermore, the drive circuit connected to the single address electrode is further reduced. Compared to the conventional configurations, the mirror device as disclosed in this invention can be further miniaturized.

Meanwhile, FIG. 111D shows a method for controlling the reflection intensity to a projection path by controlling a mirror to oscillate between the deflection angle of the mirror producing the ON light and that of the mirror producing the OFF light for projecting a determined amount of light intensity in an intermediate light.

FIG. 111D shows an oscillating mirror continuously moving to the ON light state, intermediate light state and OFF light state of the mirror 8602. Furthermore, the intensity of the incident light reflected to a projection light path is controllable by controlling the frequency of oscillation that is the number of times of oscillations in one second. Therefore, controlling the total number of times of mirror oscillation within a certain time period controls the intensities of incident light reflected toward the projection light path. Flexible control the intensity of intermediate light between the ON light state and the complete OFF light state is therefore achieved.

A mirror is controllable to operate under at least three states, i.e., the ON light, intermediate light and OFF light, and therefore three different amounts of light intensity reflected toward the projection light path can be adjusted and controlled by implementing the above described control process by using a single address electrode. Furthermore, the heights of the first electrode part and the second electrode part and also the heights of the stoppers can be adjusted also as shown in FIGS. 111A through 111D Specifically, in FIGS. 111A through 111D, the mirror in contact with the first electrode part is the initial state of a mirror. Assignment of the operation state of the mirror can flexibly assigned when the mirror is in contact with the second electrode part and the mirror state can be assigned as that the mirror is operated in an ON state, OFF state or an intermediate state.
It is also understood that the free oscillation can be controlled by using an elastic hinge with elasticity to assert a restoring force to pull back to the original position when the mirror is deflected. More specifically, the single address electrode may draw the mirror with a force that is asymmetrically relative to the deflection axis of the mirror.

According to present exemplary embodiment, FIG. 112 shows a configuration to control the mirror 8602 to operate in an ON light state and an OFF light state by applying materials with different permittivity for the upper parts of the first electrode part and second electrode part of the single address electrode 8603 for the mirror element 8600 of a mirror device. Other than the different materials as described above, the mirror element is symmetrical relative to the elastic hinge 8604 as shown in FIG. 112. The upper part of the single address electrode 8603 are formed with different permittivities between the first electrode part and second electrode part. FIG. 112 shows the cross-sectional configuration of a mirror element with the first electrode part and second electrode part of the upper parts of the single address electrode 8603 materials formed with materials of different permittivities. With the mirror made of a material based on Si or SiO₂, a material of high permittivity and different permittivities may include Si₃N₄, and HfO₂. These materials are implemented as high-k materials particularly compatible to manufacture a miniaturized semiconductor device.

The following is a description of a method for configuring the first electrode part and second electrode part of the upper part of the single address electrode 8603 by using materials with different permittivities for controlling the mirror 8602 under the ON light state and OFF light state. The control method for the mirror 8602 according to the present embodiment will be understood with reference to the control method illustrated in the above-described FIG. 72. Specifically, a brief description of the control method for the mirror element shown in FIG. 112 is provided.

According to Equation (1), when a voltage is applied to the single address electrode 860, the mirror 8602 is deflected from the initial state and tilt to the side of a material with low permittivity of the single address electrode 8603. According to Equation (1) stronger Coulomb force is generate on the part covered with a material having a lower permittivity E The mirror 8602 tilted from the initial state and starts to oscillate freely when the voltage applied to the single address electrode 8603 is temporarily cut to “0” volts. When the free-oscillating mirror 8602 comes close to the single address electrode 8603 on either the ON light side or OFF light side, an appropriate voltage is applied to the single address electrode 8603. Then the mirror 8602 can be retained onto the ON light side or OFF light side corresponding to the first electrode part or second electrode part, to control the mirror to operate in the ON light state or OFF light state. Because the coulomb force F represented by the Equation (1) has a stronger function with the square of the distance r between the mirror 8602 and single address electrode 8603 than with the permittivity ε thereof, the fact that the distance r between the single address electrode 8603 and mirror 8602 is shorter has a larger effect on the coulomb force F than the magnitude of the permittivity ε does. Therefore, when the mirror 8602 is deflected to the ON light side, or OFF light side to have a shorter distance to either of the electrodes, a voltage applied to either of the electrodes can tilt and control the mirror state that has a shorter distance to the single address electrode 8603.

The above described operation controls for the mirror 8602 to move from the initial state to the OFF light state or ON light state. Meanwhile, the control method for returning the mirror 8602 from the ON light state or OFF light state to the initial state can also be understood from the control method illustrated in the above described FIG. 72. Application of an appropriate pulse voltage in a state when the mirror is operated in the ON light state or the OFF light state can return the mirror 8602 to the initial state. As an example, the mirror 8602 is controlled to perform a free oscillation by reducing, to “0” volts. The voltage applied to a single address electrode 8603 corresponds to the voltage applied to retain the mirror 8602. Then, a voltage is temporarily applied to the single address electrode 8603 in a time when the distance r between the single address electrode 8603 and mirror 8602 is below a certain length while the mirror 8602 oscillates between two sides and not retained on either side. As a result, a coulomb force F is generated to draw the mirror 8602 back to a different side opposite from the side of the free oscillation. The acceleration of the mirror to move toward a different direction from the direction of free oscillation makes it possible to return the mirror 8602 from the ON light state or the OFF light state to the initial state. Therefore, the mirror can be returned from the ON light state or OFF light state to the initial state by applying a pulse voltage to the single address electrode 8603.

The process for controlling the mirror 8602 of the mirror device is preferred to be carried out by using non-binary data obtained by converting binary data, as the conversion methods illustrated in the above described FIGS. 48, 49, 50 and 51. Note that the present embodiment is configured to control the mirror 8602 by applying a PWM control process by using the non-binary data.

It can be understood from the above description, when the mirror 8602 is tilted first from the initial state to a side on which the Coulomb force between the mirror 8602 and single address electrode 8603 is smaller, controlling the mirror 8602 by using would require the single address electrode 8603, a “dummy operation”. The mirror 8602 is tilted toward the side where the Coulomb force between the mirror 8602 and single address electrode 8603 is larger. The present embodiment is configured to turn off the light source in synchronization with the mirror device during a period in which the mirror is carrying out the dummy operation.

The following is a description of the operation for turning off the light source in synchronization with the mirror device during a period when the mirror is carrying out a dummy operation.

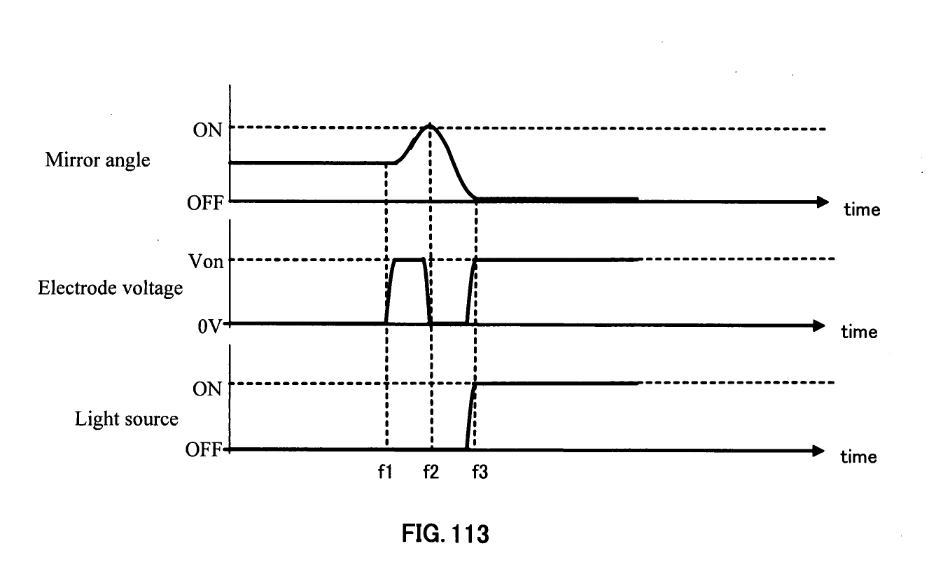

FIG. 113 is a timing diagram for illustrating an operation process for synchronously turning off a light source with a dummy operation of each mirror element.

Referring to FIG. 113, the vertical axes indicate the deflection angle of a mirror, a voltage applied to a single address electrode, and the output of a light source respectively. The deflection angle of the mirror is defined as “ON” when the incident light is projected as an ON light, and that of the mirror defined as “OFF” when the incident light is projected as an OFF light. Furthermore, the voltages are defined as “ON” when a voltage is applied to the single address electrode, and “0” volts when no voltage is applied thereto. Furthermore, the output of the light source is defined as “ON” when the light source projects an incident light to project an image, and “OFF” when the power supply to the light source is completely shut off.

Furthermore, the respective horizontal axes represent time axes, indicating the elapsed time. Note that, in the timing diagrams, the deflection angle of a mirror on a side where the Coulomb force between the mirror and single address electrode is larger is defined as “ON”, while the deflection angle of the mirror on the side where the Coulomb force between the mirror and single address electrode is smaller is defined as “OFF”, in the initial state.

Prior to time f₁: the power supplied to the light source is completely shut OFF, and a voltage is not applied to the single address electrode, i.e., and shown in the diagrams as “0” volt. The deflection angle of mirror is maintained at an angle of the initial state.

At time f₁: with the power supplied to the light source maintained at OFF, a voltage is applied to the single address electrode thus turning ON the address electrode. As a result, the mirror is deflected to the deflection angle along an ON optical path where the Coulomb force between the mirror and single address electrode is large.

Prior to time f₂: with the power supplied to the light source is maintained at an OFF state, the voltage is continuously applied to the single address electrode. The mirror accordingly continues to deflect to a deflection angle of ON, and the mirror is tilted and abuts to the single address electrode, and the deflection angle of the mirror is retained at ON.

At time f₂: with the power supplied to the light source is maintained at OFF, the voltage applied to the single address electrode is turned off, i.e. reducing to “0” volts. The termination of voltage applied to the electrode causes the mirror to perform a free oscillation.

Prior to time f₃: with the power supplied to the light source maintained at OFF, the voltage applied to the single address electrode is maintained at “0” volts. As a result, the mirror is controlled to continuously oscillate freely and oscillates with a deflection angle between the OFF and the ON states.

At time f₃: when the mirror approaches the deflection angle OFF, a voltage is applied to the single address electrode, turning ON the electrode. As a result, the mirror is controlled to tilt to an angle abuts to the single address electrode, and the deflection angle of the mirror is retained at OFF. The fact that the mirror is retained at OFF is illustrated in the above-described FIG. 72. The present specification document defines this process as “dummy operation”, the operation between the time f₁, i.e., the initial state, and the time f₃ when the mirror is retained onto the side where the Coulomb force is smaller in the initial state. Then, when the deflection angle of the mirror is securely retained onto the OFF electrode after completing the dummy operation, the output of the light source is turned ON synchronously.

As described above, the light source is controlled to synchronously turn off with the mirror device during the period when the mirror is performing a dummy operation. Unstable reflection of light in the midst of the deflecting operation of the mirror is therefore eliminated.

An unstable reflection of light in the midst of the deflecting operation of a mirror that may occur in a projection apparatus is therefore eliminated by the above-described mirror device. As a result, the quality of the display images is improved.

Control and operation process as describe above may be implemented in the projection apparatuses each comprising such a mirror device include a single-panel projection apparatus, illustrated in the above described FIG. 21 and which comprises one mirror device, and a multi-panel projection apparatus, as illustrated in the above described FIGS. 22A through 22C and FIGS. 66A through 66D and which comprises a plurality of mirror devices.

### Embodiment 14

A mirror device according to the present embodiment includes a plurality of mirror elements configured as two dimensional array each comprising a deflectable mirror supported by an elastic hinge formed on a substrate for reflecting the incident light emitted from a light source. The projection apparatus further includes an address electrode formed on a substrate under the mirror. Further, the present embodiment is configured to retain the mirror, during a period of time when the light source is turned off, to a deflecting direction reverse to the direction where the mirror has been deflected at an end of a period when the light source has been turned on.

A length of time for retaining the mirror in a reverse deflecting direction during a length of time when the light source is turned off is preferably determined proportional to the length of time when the mirror is deflected, at the end of a turn-on period of the light source.

For example, the mirror device according to the present embodiment may be implemented with any of the mirror devices illustrated in the above described FIGS. 8A through 8D, 27B, 69, 70A, 70B, 71A through 71C, 72, 111A through 111D and 112. Furthermore, the mirror device is controlled by the configuration illustrated in the above-described FIG. 73.

As an exemplary embodiment, the light source may also be implemented as a semiconductor light source such as a laser light source. Furthermore, the light source may use a light source having a semi-ON state by controlling the projection of a light from the light source that does not display a visible or, dose not project a light while the light source is driven by a bias current as described for FIGS. 104 and 105 The semi-ON state is in addition to having an ON state in which the light source outputs the incident light for displaying an image and an OFF state in which the power supply to the light source is completely shut off. Note that the control process for controlling and operate the ON state, semi-ON state and OFF state of the light source can be carried out with the configuration illustrated in the above described FIG. 24A.

Furthermore, the non-binary data obtained by converting the binary data may be applied to control a mirror of the mirror device. The conversion method is illustrated in the above described FIGS. 48, 49, 50 and 51.

The following is a description of a method to retain the mirror to a deflecting direction opposite to the moving direction of the mirror during a period of time when the light source is turned off at the end of a period when the light source has been turned on. The length of time for retaining the mirror in the opposite direction, during the period when the light source is turned off, is determined as proportional to the length of time in which the mirror has been deflected at the end of the turn-on period of the light source. The control process is disclosed based on the assumption that each mirror is controlled by using a PWM control applying the non-binary data.

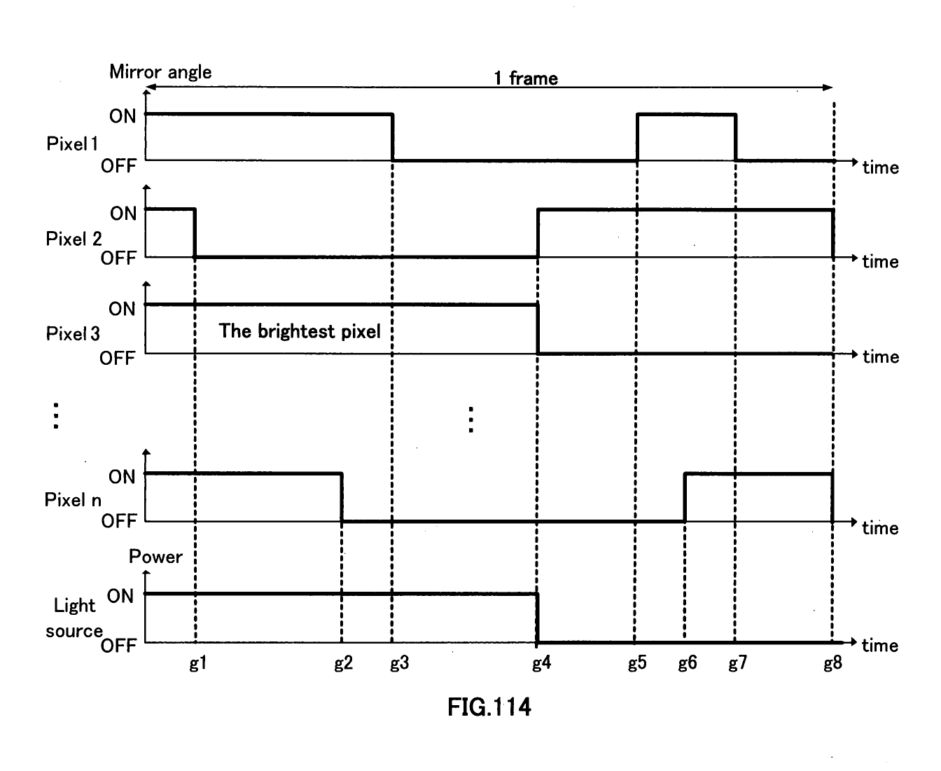

FIG. 114 is a timing diagram for illustrating synchronization between a light source and the deflection angle for each mirror element. Referring to FIG. 114, the vertical axis indicates the deflection angle of a mirror and the intensity of the light projected from a light source, with the deflection angle of the mirror defined as “ON” when the incident light constitutes an ON light, and that of the mirror defined as “OFF” when the incident light constitutes an OFF light. Furthermore, the output of the light source is defined as “ON” when the light source is controlled to emit an incident light to project an image, and “OFF” when the power supply to the light source is completely shut off. Further, the horizontal axes represent time axes, indicating the elapsed time. The assumption is that there are n-pieces of individual mirror elements, with the individual mirror elements representing Pixel 1 through Pixel n. The figure delineates the control for each mirror element within one frame. Furthermore, the Pixel 3 is assumed to be a mirror element with a maximum brightness (i.e., the brightest pixel). Specifically, the mirror element displaying Pixel 3 produces the maximum intensity of reflection light to a projection light path and that is retained onto the ON state for the longest period of time.

Furthermore, the period when the Pixel 3 producing the maximum brightness during a time period when the mirror is kept at an ON state is synchronized with the period when the light source is ON. Then, at the time g4 when the brightest Pixel 3 is turned from ON to OFF, the light source is also turned from ON to OFF. Prior to time g₁: all mirrors are maintained at ON, the light source is also maintained at ON synchronously with the ON period of the Pixel 3. Between time g₁ and time g₄: specifically, during the time length the brightest Period 3 is maintained at ON, the Pixel 2 performs the operation for turning OFF from ON at the time g₁, the Pixel n performs the operation for turning OFF from ON at the time g₂, and the Pixel 1 performs the operation for turning OFF from ON at the time g₃. The light source is maintained at ON.

At time g₄: the brightest Pixel 3 performs the operation for turning OFF from ON. Synchronously with the Pixel 3 performing the operation for turning OFF, the light source is turned off. Then, each mirror is controlled to retain onto a direction opposite to the direction, to which the mirror has been deflected at the end of the period during the period the light source had been turned on, for a length of time in proportion to the length of time the mirror has been deflected at the end of the period when the light source had been turned on. Specifically, the length of time the mirror has been deflected at the end of the period, when the light source had been turned on, is the longest for the Pixel 3, followed by the Pixels 2, n and 1.

Therefore, between time g₄ and g₈: the Pixel 3, during the time with the length of time the mirror has been deflected at the end of the period in which the light source had been turned on is the longest, continues to be deflected to OFF between the time g₄ and time g₉. Then, the Pixel 2, with the length of time the mirror has been deflected at the end of the period when the light source had been turned on is the second longest to perform the operation for turning ON from OFF and maintains the mirror deflection angle of ON between the time g₄ and time g₈. Then, the Pixel n, for which the length of time the mirror has been deflected at the end of the period in which the light source had been turned on is the longest next to the Pixel 2, performs the operation for turning ON from OFF and maintains the mirror deflection angle of ON between the time g& and time g₈. Then, the Pixel 1, for which the length of time the mirror has been deflected at the end of the period in which the light source had been turned on is the shortest, performs the operation for turning ON from OFF and maintains the mirror deflection angle of ON between the time g₅ and time g₇. Specifically, the length of time for retaining a mirror to a direction opposite to the deflection direction of the mirror at the end of the period when the light source had been turned on is the longest for the Pixel 3, followed by the Pixels 2, n and 1.

As described above, a mirror is retained, in a direction opposite to the mirror deflection direction for the period the light source is turned off. Furthermore, a length of time for retaining the mirror in the opposite direction, during the period in which the light source is turned off, is proportional to the length of time when the mirror has been deflected at the end of the turn-on period of the light source.

FIG. 114 illustrates the control process and the control process can also be carried out for a sub-field. Therefore, the elastic hinge of a mirror is prevented from being deformed by applying the operation for tilting, during the period the light source is turned off, a mirror in a direction opposite to the mirror deflection direction at the end of the period when the light source had been turned on. As a result, the life cycle of to continuously use the mirror device is extended.

Furthermore, such a mirror device can also be used for a projection apparatus. The projection apparatuses that may implement the above-describe mirror device include, for example, a single-panel projection apparatus, which is illustrated in the above described FIG. 21 and which comprises one mirror device, and a multi-panel projection apparatus, which is illustrated in the above described FIGS. 22A through 22C and FIGS. 66A through 66D and which comprises a plurality of mirror devices.

### Embodiment 15

A mirror device according to the present embodiment includes a plurality of mirror elements configured as two dimensional array each of the mirror element includes a deflectable mirror supported by an elastic hinge formed on a substrate for reflecting the incident light emitted from a light source. The projection apparatus further includes an address electrode formed on a substrate under the mirror. Furthermore, the present embodiment is controlled to have no voltage applied to the address electrode during the period in which the light source is turned off.

The mirror device according to the present embodiment is may include any of the projection apparatuses as illustrated in the above described FIGS. 8A through 8D, 27B, 69, 70A, 70B, 71A through 71C, 72, 111A through 111D, and 112. Furthermore, the mirror device is controlled by means of the configuration illustrated in the above-described FIG. 73.

The light source may use a semiconductor light source such as a laser light source. Furthermore, the light source may use a light source having a semi-ON state for controlling the light source to project an incident light with no visible image is projected or, the light source does not emit an incident light while the light source is kept driven, as described for FIGS. 104 and 105. The semi-On state is in addition to having an ON state in which the light source outputs the incident light with which an image can be projected and an OFF state when the power supply to light source completely shut off. The control processes for producing the ON state, semi-ON state and OFF state of the light source may be implemented in the configuration illustrated in the above described FIG. 24A.

Furthermore, a mirror of the mirror device is preferably controlled by using non-binary data obtained by converting the binary data. The conversion method is illustrated in the above described FIGS. 48, 49, 50 and 51.

The following is a description of the control process for applying no voltage to the address electrode during the period when the light source is turned off. Assumption is that each mirror element is controlled by using a PWM control method and applying the non-binary data.

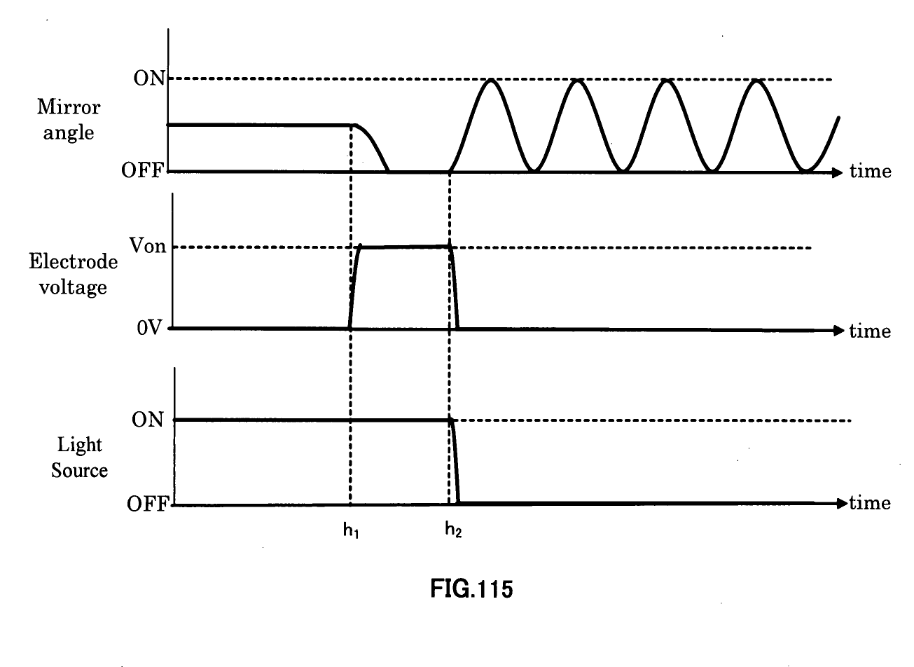

FIG. 115 is timing for illustrating the synchronization among deflection angle of each mirror element and the control signals applied to a light source, an address electrode.

Referring to FIG. 115, the vertical axes indicate the deflection angle of a mirror, a voltage applied to a address electrode, and the output of a light source. The deflection angle of the mirror is illustrated as “ON” when the incident light is projected as an ON light. The mirror is illustrated as “OFF” when the incident light is projected as an OFF light. Furthermore, the voltages are illustrated as “ON” when a voltage is applied to the address electrode, and illustrated as “0” volts when no voltage is applied thereto. Furthermore, the output of the light source is illustrated as “ON” when the light source is controlled to project an incident light to display an image, and “OFF” when the power supply to the light source is completely shut off. Furthermore, all the horizontal axes represent time axes, indicating the elapsed time.

Prior to time h₁: the deflection angle of a mirror is maintained between the deflection angles of ON and OFF, more specifically, in the initial state, and no voltage, i.e., “0” volts is applied to the address electrode with the assumption that the light source is maintained at an ON state.

At time h₁: a voltage is applied to the address electrode, i.e., the address electrode is ON, and the deflection angles of the mirror are changed from the initial state to OFF state, and meanwhile the light source is maintained at ON.

Between time h₁ and time h₂: the voltage is continuously applied to the address, i.e., the address electrode is ON, and the deflection angle of the mirror is retained at OFF, and meanwhile the light source is maintained at ON.

At time h₂: the voltage applied to the address electrode is shut off, i.e., the address electrode is OFF, to release the deflection angle of the mirror from retaining at OFF. As a result, the mirror starts to oscillate freely. At this point in time, the light source is turned OFF.

After time h₂: while the light source is maintained at OFF, the mirror is left to perform the free oscillation without applying a voltage to the address electrode.

As described above, applying no voltage to the address electrode of the mirror device during the period the light source is turned off reduces the consumption of power for driving the mirror device and alleviates the heat generated therein.

Furthermore, such a mirror device can also be implemented for multiple types of projection apparatuses. Such projection apparatuses may include a single-panel projection apparatus, which is illustrated in the above described FIG. 21 and which comprises one mirror device, and a multi-panel projection apparatus, which is illustrated in the above described FIGS. 22A through 22C and FIGS. 66A through 66D and which comprises a plurality of the mirror devices.

### Embodiment 16

A projection apparatus according to the present embodiment is a projection apparatus projecting an image by synchronously controlling a light source and a spatial light modulator.

The projection apparatus comprises a semiconductor light source includes a plurality of sub-light sources, an illumination optical system for guiding an illumination light output from the semiconductor light source, a spatial light modulator for modulating the illumination light in accordance with an image signal, and a control circuit for controlling the spatial light modulator. Furthermore, the control circuit controls or adjusts at least two of the following, i.e., the emission light intensity of the semiconductor light source, the number of times of the pulsed emissions, the emission period of the pulsed emissions, the timing of the pulsed emissions, the number and locations of the sub-light sources for carrying out the pulsed emissions.

The spatial light modulator may be implemented with a transmissive spatial light modulator, such as a liquid crystal, or a reflective spatial light modulator, such as a liquid crystal of silicon (LCOS). Furthermore, the reflective spatial light modulator may be a mirror device. The mirror device includes a mirror array configured by arraying a plurality of mirror elements each comprising a deflectable mirror supported by an elastic hinge formed on a substrate and for reflecting the incident light from the light source, and an address electrode disposed on the substrate under the mirror. Furthermore, the mirror device controls the direction for reflecting the illumination light. The mirror may reflect the illumination light to an ON direction by guiding the reflection light of the illumination light to a light path for displaying an image, an OFF direction for guiding the reflection light of the illumination light away from the projection light path, or an intermediate direction for guiding a portion of the reflection light of the illumination light to the projection light path.

The mirror device may be implemented as that illustrated in the above described FIGS. 8A through 8D, 27B, 69, 70A, 70B, 71A through 71C, 72, 111A through 111D and 112. Furthermore, the mirror device is controlled by means of the configuration illustrated in the above-described FIG. 73.

Furthermore, a non-binary data obtained by converting the binary data may be applied to control a mirror element of the mirror device; the conversion method as illustrated in the above described FIGS. 48 through 51. Furthermore, such a mirror device can also be used for various types of projection apparatuses. Such projection apparatuses may include a single-panel projection apparatus, which is illustrated in the above described FIG. 21 and which comprises one mirror device, and a multi-panel projection apparatus, which is illustrated in the above described FIGS. 22A through 22C and FIGS. 66A through 66D and which comprises a plurality of the mirror devices.

The light source may be implemented with a semiconductor light source such as a laser light source. Furthermore, the light source may use a light source having a semi-ON state to control the light source for outputting an incident light that does not display a visible image is projected or, controlling the light source for not projecting an incident light while it is kept driven, as described for FIGS. 104 and 105. The semi-ON state is in addition to having an ON state in which the light source outputs the incident light with which an image can be projected and an OFF state in which the power supply to light source is completely shut off. Note that the control processes for producing the ON state, semi-ON state and OFF state of the light source can be carried out by means of the configuration illustrated in the above described FIG. 24A.

Furthermore, when a light source of the present embodiment is implemented with sub-light sources, several sub-light sources may use a different wavelength(s). Furthermore, the light source is preferred to carry out controllable pulse emissions.

The following is a description of changing the projection images by synchronizing between the semiconductor light source and a spatial light modulator in a projection apparatus according to the present embodiment.

In general, a light source is controlled for changing either the brightness of the illumination light or the length of illumination period and control a projection image modulated by a spatial light modulator is operable either darkened or lightened.

The number of times of changeovers among sub-frames corresponding to the respective colors red (R), green (G) and blue (B), which are three primary colors of light may be increased with a light source controllable to project pulse emissions by increasing the number of emission times. Furthermore, the operations may include a process of shortening the irradiation period of lights R, G and B. A light source controlled with such flexibilities can reduce the effects of a color break to an inconspicuous level.

Furthermore, the uniformity of an illumination light flux may be adjusted by controlling the emission from the sub-light sources located at selected locations. The light source has the flexibility to generate a locally bright emission position and locally dark emission position. The light source can be controlled to adjust the intensity of the illumination light passing through the illumination optical system and provide the illumination light with a local light and shade. Furthermore, for the light source can be controlled for individual light sources to project lights of specific wavelengths in accordance with an image signal transmitted from the control circuit for controlling the spatial light modulator. The intensity of light modulated by the spatial light modulator may be adjusted based on the image display data. Furthermore, if the semiconductor light source is a laser light source, a projection light intensity may be adjusted by the diffraction angle of diffracted light by generating the diffracted light with the spatial light modulator.

The control circuit for controlling the spatial light modulator performs a synchronous control of the spatial light modulator with the emission light intensity of the semiconductor light source, the number of times of emission, the emission period, the emission timing, the number of sub-light sources of light emission and a selected set of sub-lights with predetermined locations for emitting light.

The control circuit controls the total lengths of time of a sub-frame corresponding to at least one color of an image for image projection by controlling the semiconductor light source and spatial light modulator.

Conventionally a single-panel projection apparatus comprising a mercury lamp light source and a mirror device as a spatial light modulator. The period of each sub-frame is determined based on the operational characteristics of a color wheel or the like. Therefore, the dynamic range of an image is limited by the brightness of an illumination light, that is the intensity of the illumination light.

The control circuit of present embodiment synchronously control a plurality of light sources and the spatial light modulator to change sub-frames and modulation timings corresponding to the light of each color. As an example, the intensity of an illumination light may be adjusted to a quarter (¼) of the full brightness by reducing the number of times of pulse emission of light sources emitting a specific wavelength to one half by selectively activating half of emitting sub-light sources. A light source with control flexibility described above can increase the modulation time length of light to four times when the intensity of irradiation light is desired to be adjusted to “1”. Furthermore, the control circuit controlling the semiconductor light source can also change the gray scales of the light of at least one color within one frame.

The control circuit may control a larger number of the sub-light sources in the right half of the plurality of sub-light sources of the light source to emit light. The light source can therefore control the relative intensities of light between the left half and right half. Furthermore, the control circuit may control the left half and right half of the sub-light sources to emit alternately for shifting the timings of emission. The light source is controllable to adjust the uniformities of an illumination light flux. The spatial light modulator may be implemented as a mirror device to control the deflection angle of a mirror between the ON light and OFF light (that is, in an intermediate state), only a portion of the light flux reflected by the mirror passes through the pupil of a projection optical system. Furthermore, the intensities of a part of light flux may also be flexibly controlled. The projection light intensities is controllable when the mirror is in a deflection angle of an intermediate state. An adjustment of the light intensity may be controlled to project a light of light intensities for displaying the images with a greater number of gray scales.

Furthermore, the cross-sectional region of a light flux passing through the pupil of a projection optical system may be changed by changing the diameters of the pupil of the projection optical system where the light passes through and also controlling the intensity of a light source. As a result, it is possible to finely adjust the projection light intensity.

Meanwhile, when a control circuit in a multi-panel projection apparatus controls at least one of spatial light modulators for modulating the lights of plural wavelengths, the total time lengths of a sub-frame may be changed by the same control circuit for corresponding to the light of each color and/or the gray scales of light for each color.

As an example, the sub-frame corresponding to the light of another color may shortened by extending the sub-frame corresponding to the light of a specific wavelength. Then, the gray scale of the light for which the sub-frame has been shortened is decreased by synchronously controlling the light source of the light with shortened sub-frame. Meanwhile, the level of gray scales is increased for the light of each wavelength can simply be decreased without changing a sub-frame.

Furthermore, when a mirror device is implemented as the spatial light modulator, the operation for controlling the deflection angle of each mirror simultaneously from the ON light to OFF light and that for controlling the deflection angle of each mirror simultaneously from the OFF light to ON light may be controlled to synchronize with emission/turn-off timing of the light source. As a result, the controllable intensity of reflection light can be reduced from the intensity when the deflection angle of the mirror is retained at the ON light. Therefore, the intensity of light can be controlled with a higher resolution by the number of repetitions between the operation for controlling the deflection angle of each mirror simultaneously from the ON light to OFF light and that for controlling the deflection angle of each mirror simultaneously from the OFF light to ON light synchronously with emission/turn-off timing of the light source. This control process thus increases the levels of the gray scale of the light for image display.

Alternatively, a multi-panel projection apparatus may be configured so that at least one spatial light modulator modulates the lights of a few wavelengths, among the illumination lights with a plurality of wavelengths, while the remaining spatial light modulators modulate the lights of the remaining wavelengths.

As an example, a two-panel projection apparatus is configured with one spatial light modulator modulates the illumination light with the green wavelength, while the other spatial light modulator modulates lights of red and blue wavelengths. The spatial light modulators may modulate the illumination lights of the different colors the multi-panel projection apparatus that includes a plurality of spatial light modulators.

In the meantime, the multi-panel projection apparatus may be alternatively configured with a first spatial light modulator among a plurality of spatial modulators to modulate the illumination lights of a few wavelengths, among the illumination lights with a plurality of wavelengths, while the other spatial light modulators modulate the lights of a plurality of wavelengths including those of the wavelengths modulated by the first spatial light modulator.

As an example, a two-panel projection apparatus is configured with one spatial light modulator modulates the illumination lights of the green and blue wavelengths, while the other spatial light modulator modulates the lights of the green and red wavelength. Furthermore, a three-panel projection apparatus may be alternatively configured with one spatial light modulator modulates the illumination light of the green wavelength, while another spatial light modulator modulates the lights of the red wavelength, and the remaining spatial light modulator modulates the lights of the green and blue wavelengths. As such, several spatial light modulators may modulate the illumination light of a same color in a multi-panel projection apparatus comprising a plurality of spatial light modulators.

Meanwhile, in a multi-panel projection apparatus, the control circuit for a spatial light modulator may be preferably implemented and controllable with a semiconductor light source and/or a spatial light modulator with the time lengths for modulating an illumination light within one frame performed by at least two spatial light modulators are about the same.

As an example, when the illumination lights of the respective colors R, G and B are modulated in a three-panel projection apparatus, the control circuit carries out a control to extend the period for modulating the illumination light of another color to match with a period required for modulating a color that has the maximum modulation period. Specifically, the lengths of time for modulating the illumination lights of R, G and B are aligned as much as possible. In this case, the control circuit performs a control to reduce the intensity of the illumination light of another color by controlling the number of sub-light sources for emitting lights thereby extending the length of time for modulating the illumination light. This control process is also applicable to a two-panel projection apparatus in a similar manner.

Furthermore, the control circuit for a spatial light modulator is preferred to control a semiconductor light source based on the total lengths of time of an individual sub-frame of the illumination light of each wavelength to control the ratio of brightness of the illumination light of each wavelength corresponding to the distribution of the relative visibility.

The intensity of the illumination light of each wavelength may be adjusted by adjusting the number of sub-light sources for emitting light. Furthermore, the ratio of brightness of the illumination light of each wavelength can be adjusted to be approximated to a distribution of the relative visibility on the basis of the total lengths of time of an individual sub-frame corresponding to the illumination light of each wavelength. In this event, with a same total number of the individual sub-frame of the illumination light for each wavelength, the ratio of brightness of an image may be approximated to the distribution of relative visibility by matching the ratio of intensity of the illumination light of each wavelength with the distribution of the relative visibility.

In contrast, the ratio of intensity of the illumination light of each wavelength can be approximated to the distribution of relative visibility even if the respective sub-frames of the illumination lights of individual wavelengths are different, by controlling the length of time for modulating the respective sub-frames of the illumination light of each wavelength by adjusting the intensity of the illumination light of each wavelength. Specifically, the control circuit for the spatial light modulator when implemented for adjusting the intensity of the illumination light of each wavelength can also adjust the length of time for modulating the sub-frame of the illumination light of each wavelength in line with the relative visibility.

This control process may also be carried out for each frame of the illumination light of each wavelength and additionally for each sub-frame of the illumination light of each wavelength.

Furthermore, the control circuit for the spatial light modulator may also control a semiconductor light source to change the gray scales of an image projecting the illumination light of each wavelength.

Furthermore, the control circuit for the spatial light modulator is preferred to control the semiconductor light source to change the white balances or gamma characteristics of an image to be projected. The control process may also change the pixels of a display image setting for display with a white color. Moreover, by controlling the intensity of the semiconductor light source as described above, the steps of brightness between a 100% white and a black can be changed with a higher stepwise resolution.

Preferably, the control circuit for the spatial light modulator may control a semiconductor light source to minimize the difference of the lengths of projection time for projecting the illumination lights of individual wavelengths. The control circuit for the spatial light modulator when implemented for also controlling the intensity and/or modulation time length of the illumination light of each wavelength can coordinate the lengths of time to eliminate the difference in the respective projection time lengths for projecting the illumination lights of individual wavelengths.

As an example, in a multi-panel projection apparatus, the modulation time length for the darkest color illumination light with the shortest length of time can be matched with the modulation time length of the illumination light of another wavelength by reducing the light intensity with a decrease number of sub-light sources for emitting an illumination light and extending the time length for modulating the illumination light of the aforementioned darkest color. This configuration can eliminate the difference in the respective lengths of modulation time for projecting the illumination lights of individual wavelengths and alleviate a color break in the multi-panel projection apparatus.

Furthermore, if the modulation time length of the illumination light of only one wavelength is short in a single panel projection apparatus, the intensity is reduced by decreasing the number of sub-light sources for emitting the illumination light of one wavelength and extending the modulation time length of the illumination light of one wavelength. Likewise, such process can be applied to match the modulation time length of the illumination light of another wavelength. As a result, it is possible to uniformly distribute the changeover time lengths of the illumination lights of individual wavelengths. Therefore, the control circuit gains additional time to transmit the image signal to the spatial light modulator with an extension of the length of the modulation time.

Preferably, the control circuit for the spatial light modulator can possibly control the spatial light modulator to operate with a length of the cycle of one frame for modulating an illumination light between 90 Hz and 360 Hz.

The cycle of one frame for a spatial light modulator to modulate the illumination light is commonly about 60 Hz. In the case in which a spatial light modulator is a liquid crystal such as LC and LCOS, a double-speed operation is sometimes selected for eliminating a blur in a moving image. In such an event, an interpolation image is generated for displaying an interpolated image between frames. Furthermore, the gray scales and dynamic ranges of the interpolation image can be changed. In such a case, an image of high levels of gray scale can be achieved by implementing a control circuit for the spatial light modulator for controlling the number of emitting light sources and the emission light intensity that is appropriately for the image of each frame. Furthermore, the control circuit for the spatial light modulator may also control a semiconductor light source to output an illumination light at a shorter cycle than the cycle of a sub-frame corresponding to the illumination light at the spatial light modulator. With a shorter length for the display by operating the control at a frequency of 360 Hz, the sub-frame of the illumination light of each wavelength is further shortened. In this case, the control circuit for the spatial light modulator performs a control to cause the light source to carry out pulse emission in a shorter time than the control of a sub-frame and alternately change over the emission regions of sub-light sources.

Furthermore, plural sub-light sources are preferably implemented as laser light sources, and the polarizing direction of each sub-light source may also be the same.

The modulation efficiency of light for a liquid crystal device such as LC and LCOS is degraded unless the polarizing directions of the illumination lights are aligned. As an example, when a color separation of an illumination light is carried out by a polarization beam splitter (PBS) in a two-panel projection apparatus as shown in the above described FIGS. 66A through 66D, the color separation can be carried out more conveniently by aligning the polarizing directions of the illumination lights from individual sub-light sources. Therefore, it is preferable to align the polarizing direction of the illumination lights.

In the meantime, a plurality of sub-light sources each may comprises a laser light source and at least one of the sub-light sources may have a different polarizing direction.

When using a mirror device as a spatial light modulator, adjustment of the polarizing direction of the illumination light emitted from a sub-light source may not be required because a modulation efficiency of light is not affected by the polarizing direction of the illumination light. Therefore, the illumination light emitted from the sub-light source may have a different polarizing direction.

Furthermore, the polarizing directions of the light of a specific wavelength emitted from an adjustable number of sub-light sources may be changed by rotating it by ½π, et cetera. Such a configuration makes it possible to adjust a variation of the critical angle. The adjustment is important when the illumination light of an individual wavelength is reflected by the total internal reflection (TIR) surface of a prism or a similar optical device, depending on the polarizing direction of the illumination light of an individual wavelength. Furthermore, also when using either mirror device or liquid crystal device such as LCD or LCOS, an optical element such as a polarization beam splitter (PBS) may be applied to separate an illumination light by the polarizing directions for selectively transmitting only the light of a specific polarizing direction to flexibly adjust the light intensity.

The illumination light and/or the projection light of a projection apparatus according to the present embodiment each may preferably be a polarized light and the projection apparatus preferably comprises a polarization control unit for controlling a polarizing direction.

In addition to using such a device, a liquid crystal device such as LC and LCOS allows a control of a polarizing direction; the projection apparatus may comprise a control circuit for controlling the emission light intensity and emission timing of the light source, and a polarization control unit, placed in the illumination light path of the light from the light source or a projection light path, for controlling the intensity of a transmission light. The polarization control unit may be a commercial product called a color switch that is produced by combining a liquid crystal with a polarization filter. Furthermore, the polarizing direction of the light of a plurality of wavelengths may be controlled at the polarization control unit.

Furthermore, a projection apparatus is preferred to implement a mirror device as a spatial light modulator with at least one light of a specific color, and at least one of the illumination lights has a different polarizing direction from that of the light of another wavelength.

Furthermore, a projection apparatus is preferred to implement a mirror device as a spatial light modulator for modulating illumination lights with different polarizing directions and wavelengths, respectively.

As an example, when at least one mirror device modulates both of illumination lights in two colors with different polarizing directions in a two-panel projection apparatus, a transmissive optical element, such as an LC, is placed in the projection light path to project only the light of a specific polarizing direction. Further, the lights of respective colors are projected in sequence by changing over the states of the LC in synchronization with the color of an image signal in order to separate polarized lights.

The wavelengths of light transmitting through the PBS can be changed over in sequence by sequentially changing the polarizing directions of the illumination lights of two colors by a color switch when an optical element such as a polarization light beam splitter (PBS) is placed in a projection light path in order to separate a polarized light.

This control process for sequentially changing over polarizing directions can also changeover the polarizing directions and adjust a light intensity by comprising sub-light sources with different polarizing directions, configuring a light source appropriately setting the number of emitting sub-light sources and the positions thereof for each wavelength of the light and changing over the sub-light sources in sequence on the basis of a designated polarizing direction. The light source may also implement sub-light sources to emit lights of the same wavelength with different polarizing directions. Furthermore, the sub-light sources may be made to emit light so that the lights of the same wavelength possess a plurality of polarizing directions. Thus, the sub-light sources can emit lights of the same wavelength with any polarizing direction.

Furthermore, the polarizing directions can be changed by 90 degrees by transmitting a linear-polarized light through two pieces of λ/4 plates. The two pieces of λ/4 plates are preferably placed with the polarization axis different by 90 degrees from each other. Sequential changes of the polarizing directions of is achieved through controlling the transmitting, and not transmitting, the light through these two λ/4 plates. Further, there may be one λ/4 plate so that the light transmitting through the λ/4 plate is reflected by a reflection surface placed at a later stage of the aforementioned λ/4 plate in the light path and then the light is transmitted through the same λ/4 plate.

The spatial light modulator is preferably a mirror device, and a projection apparatus can be configured to have two mirror devices with individual mirror devices modulate the illumination lights with different polarizing directions and having about a same wavelength.

The projection apparatus is configured with one mirror device for modulating the lights projected as red and green lights and the other mirror device modulate the lights projected as green and blue lights. The linear polarization green lights with polarizing directions having 90 degrees difference are irradiated on the respective mirror devices. Then, the control circuit for the mirror device carries out a control for changing the intensities and emission periods of the four lights modulates the individual lights by means of the respective mirror devices, making it possible to adjust different gray scale and brightness of the individual lights. Then, the modulated individual lights are synthesized and the synthesized light is projected through a projection optical system.

Furthermore, the spatial light modulator modulates the individual lights based on the image signals corresponding to the lights of different wavelengths. The colors of the illumination lights with different wavelengths may include lights such as cyan, magenta, yellow and white.

A projection apparatus is further preferably configured to implement the semiconductor light source as a laser light source; the spatial light modulator is a mirror device that includes a mirror array having approximately one million to two million pixels of mirror elements each controlling the reflection light of the illumination light emitted from the laser light source, with a deflectable mirror capable of deflecting the reflecting direction of the illumination light, to an ON direction guiding the reflection light of the illumination light to a projection light path or an OFF direction not guiding the reflection light of the illumination light thereto. The mirror device further modulates the illumination light; the deflection angle of the mirror of the mirror element is between ±9 degrees and ±4 degrees clockwise (CW) from the initial state; and the F number of the projection lens of a projection optical system is between 3 and 7.

The spatial light modulator of a projection apparatus according to the present embodiment is preferably a mirror device implemented with a mirror array that includes a plurality of mirror elements each comprising both a mirror for controlling the reflecting direction of an illumination light to the ON direction guiding the reflection light of the illumination light emitted from a semiconductor light source to a projection optical path or the OFF direction guiding the reflection light of the illumination light to project away from the projection optical path. The projection apparatus further includes one or two address electrodes causing the mirror to function a coulomb force and which modulates the illumination light, and the control circuit for the mirror device to control the address electrode and the semiconductor light source. Furthermore, the control circuit for the mirror device may preferably control the address electrode and semiconductor light source applying a pulse width modulation (PWM) control.

Furthermore, the control circuit for the mirror device for synchronizing the control of the address electrode with the operations of the semiconductor light source to control the amplitude modulation of the mirror device, e.g., the free oscillation state of a mirror as shown in the above described FIGS. 8D and 111D and the intermediate light state of the mirror as shown in the above described FIGS. 70A and 111A. As a result, the gradation of the light intensity for image projection can be controlled with a higher resolution to achieve a higher level of gray scales in display a higher image quality.

Furthermore, the illumination optical system of a projection apparatus according to the present embodiment may preferably comprises any of the diffractive optical element, optical fiber, micro lens array and rod pipe.

Furthermore, a projection apparatus according to the present embodiment may be configured with the optical axis of the illumination light of one wavelength misaligned with the optical axis of the illumination light of another wavelength by using a plurality of semiconductor light sources to emit the lights of a plurality of wavelengths.

A projection apparatus according to the present embodiment preferably uses a mirror device as a spatial light modulator. The mirror device is preferably controlled on the basis of non-binary data obtained by converting a binary image signal. Furthermore, the control process can control the intensity of an illumination light when the mirror device reflects the illumination light to an intermediate direction is no more than ½ of the intensity of light reflecting to an ON direction. Furthermore, the control process can also project diffraction light generated when the mirror device reflects the illumination light to the intermediate direction or ON direction.

Furthermore, a projection apparatus according to the present embodiment may implement a control circuit for a spatial light modulator for controlling a light source based on the gray scale of an input image signal, thereby controlling the gray scale of the illumination light of at least one wavelength. Furthermore, the control circuit for a spatial light modulator may also control the gray scale of the illumination light by controlling the light source on the basis of the length modulation time of the illumination light. As an example, the gray scale of a sub-frame corresponding to the illumination light of a specific wavelength with a short modulation time length can be reduced by terminating the modulation control in a predetermined time length.

Furthermore, a projection apparatus according to the present embodiment may preferably comprises a wobbling means for fluctuating an illumination light, with the wobbling means synchronized with a semiconductor light source. Particularly, the control circuit for a spatial light modulator may control the intensity of the semiconductor light source, and the like, before and after fluctuating the illumination light or in the midst of mirror fluctuations. Furthermore the wobbling may be carried out by means of the method shown in FIGS. 106 and 107. In coordination with the wobbling processes, the illumination light is directed to project in the odd and even sub-frames. Furthermore, in changing over between the odd and even sub-frames by performing the wobbling, the light source is turned OFF as shown in FIG. 108 when performing a wobbling process. As a result, a shift in image is reduced and a black image is inserted between images, and thereby the transition of images is made clearer and the contrast of the image is improved. More specifically, the sequence of the odd and even sub-frames may be changed, and the display time lengths may also be changed.

Furthermore, the control circuit for a spatial light modulator may preferably controls an illumination light to compliment a shift in images, the shift generated by the lines displaying the odd and even sub-frames. The control process is applicable to a case in which the odd and even sub-frames are alternately displayed in double speed.

Furthermore, a projection apparatus according to the present embodiment preferably comprises a mirror device to function as a spatial light modulator, with the ratio of a bright level to a dark level, of the contrast of an image by means of the mirror device, designated between a 5000:1 and a 10000:1.

Furthermore, the contrast of a video image can be improved by providing a period for displaying black by turning OFF the illumination light completely within one frame period.

Meanwhile, a projection apparatus according to an exemplary embodiment is characterized as generating an image by controlling or adjusting at least one of the following, i.e., the emission light intensity of a semiconductor light source, the number of times of emission thereof, the emission period thereof, the number of emitting sub-light sources and the emitting position thereof, and at least one of the total time length of the sub-frames of an illumination time and the gray scale of the illumination light.

Specifically, at least one color of an image may be generated by controlling or adjusting at least two of the following, i.e., the emission light intensity of a semiconductor light source, the number of times of emission thereof, the emission period thereof, the number of emitting sub-light sources and the emitting position thereof.

Furthermore, a projection apparatus may be configured to implement a laser light source as the semiconductor light source and the a control circuit controlling a spatial light modulator controls at least two of the following, i.e., the emission light intensity of a laser light source, the number of times of emission, the emission period, the number of emitting sub-light sources and the emitting position. The control circuit may comprise one or several control circuits.

Furthermore, a multi-panel projection apparatus comprising a plurality of spatial light modulators, of which at least one spatial light modulator modulates the illumination lights possessing a plurality of wavelengths on the basis of an image signal, may be configured.

Furthermore, a projection apparatus according to the present embodiment preferably comprises wobbling means for fluctuating an illumination light. The control circuit for a spatial light modulator preferably controls at least one of the following, i.e., the emission light intensity of a semiconductor light source, the number of times of emission thereof, the emission period thereof, the number of emitting sub-light sources and the position thereof, in the projection period of an image of either before or after fluctuating the illumination light.

Furthermore, the control circuit for a spatial light modulator can also control the semiconductor light source at a frame cycle that is no less than 120 Hz, and also at least one of the following, i.e., the emission light intensity of a semiconductor light source, the number of times of emission, the emission period, the number of emitting sub-light sources and the position, for each 120 Hz frame. The spatial light modulator may be implemented with any one of the above described mirror devices.

Furthermore, a projection apparatus according to the present embodiment comprises a laser light source includes a plurality of sub-light sources, a spatial light modulator includes at least one million pixels for modulating, in accordance with an image signal. The projection apparatus further includes a light source for projecting an illumination light, and a control circuit for controlling the spatial light modulator. Furthermore, the control circuit for a spatial light modulator controls at least two of the following operation and control parameters, i.e., the emission light intensity of a laser light source, the number of times of emission thereof, the emission period thereof, the number of emitting sub-light sources and the position thereof, the illumination light having at least one wavelength modulated by the spatial light modulator possesses no less than 1000 grades of gray scale. The spatial light modulator may be implemented as a mirror device described above. Furthermore, the control circuit for a spatial light modulator controls at least two of the following operation and control parameters, i.e., the emission light intensity of a laser light source, the number of times of emission thereof, the emission period thereof, the number of emitting sub-light sources and the position thereof, so that the light of at least one wavelength of the illumination light modulated by the spatial light modulator possesses no less than 40 sub-frames within one frame.

Furthermore, in the projection apparatus according to the present embodiment described thus far, the illumination light modulated by the spatial light modulator may be a white light, and the illumination light may also be a white light before and after the control circuit for a spatial light modulator controls the laser light source or sub-light source.

Furthermore, the levels of the gray scale of at least one illumination light among a plurality of modulated illumination light may be different from the levels of the gray scale of another illumination light.

Furthermore, the sub-light source may be preferably a laser light source that is desirably arranged in array.

Furthermore, the sub-light source may include a laser light source with the polarizing directions of individual sub-light sources of approximately the same wavelength are approximately the same.

Furthermore, the sub-light source is a laser light source and a plurality of sub-light sources with approximately the same wavelength may include at least one sub-light source transmitting with a different polarizing direction.

Furthermore, the sub-light source may further be implemented as a plurality of light sources.

As described above, a projection apparatus according to the present embodiment is configured to control or adjust the light source in combination with the two of the following, i.e., the emission light intensity of a light source, the number of times of emission thereof, the emission period thereof, the emission timing thereof, the number of emitting sub-light sources and the position thereof, synchronously with the spatial light modulator, thereby making it possible to improve an image to be projected to a high grade of gradation. Further, an appropriate execution of the control processes reduces the effects of a color break to a level such that the color break is inconspicuous.

Note that the mirror pitch, mirror gap, deflection angle and drive voltage of the mirror device according to the present embodiment are not limited to the values as described in the exemplary embodiments included in the above descriptions and would rather be inclusive of broad ranges as may be achieved by respective devices or systems preferably and may include the following ranges that includes both ends inclusively. These ranges include the mirror pitch is between 4 μm and 10 μm; the mirror gap is between 0.15 μm and 0.55 μm; the maximum deflection angle of mirror is between 2 degrees and 14 degrees; and the drive voltage of mirror is between 3 volts and 15 volts.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

What is claimed is:

1. A projection apparatus, comprising:
a light source;
a plurality of spatial light modulators each comprising a micromirror for deflecting and reflecting an incident light emitted from the light source in directions between a first direction and a second direction different from the first direction, and all angles between the first and second directions; and
an optical prism comprising surfaces (i), (ii), (iii) and (iv), where the surface (i) is a first optical surface with at least two lights of different frequencies are projected thereto, the surface (ii) is a second optical surface for ejecting the two lights incident to the first optical surface therefrom and a modulation light modulated by the spatial light modulator is incident thereto, the surface (iii) is a synthesis surface for synthesizing a plurality of the modulation lights modulated by a plurality of spatial light modulators into a same light path, and the surface (iv) is an ejection surface from for ejecting the synthesized light synthesized on the synthesis surface, wherein the locus of deflection of the modulation light is approximately parallel to the synthesis surface when the aforementioned locus of deflection is projected onto a flat surface perpendicular to the synthesis surface.

2. The projection apparatus according to claim 1, further comprising:
a light absorption member disposed on an extension an optical axis of the modulation light deflected in the second direction and outside of the optical prism or near one of the surface (i), the (ii) and the surface (iv) of the optical prism.

3. The projection apparatus according to claim 1, further comprising:
radiation absorber placed on an extension of an optical axis of the modulation light deflected in the second direction and outside of the optical prism or near one of the surface (i), the (ii) and the surface (iv) of the optical prism.

4. The projection apparatus according to claim 1, wherein:
the optical prism comprises a triangle columnar joinder prism formed by joining together first and second triangle columnar prisms with substantially mutual symmetrical shapes about the synthesis surface, wherein the first optical surface is either or both of the two triangular side surfaces of the triangle columnar joinder prism, the second optical surface is a side surface of the triangle columnar joinder prism formed by arranging, on the same flat surface or parallel flat surfaces, one of the rectangular side surface of the first triangle columnar prism with one of the rectangular side surface of the second triangle columnar prism, and the ejection surface is one of two side surfaces of the triangle columnar joinder prism, a surface that is different from the second optical surface.

5. The projection apparatus according to claim 1, wherein the optical prism comprises:
a triangle columnar joinder prism formed by joining together a first and a second triangle columnar prisms with substantially mutual symmetrical shapes about the synthesis surface and a third triangle columnar prism joined together, or opposite to, either or both of the two triangle side surfaces of the triangle columnar joinder prism, wherein
the first optical surface is one flat surface of the side surfaces of the third triangle columnar prism other than the joinder surface or opposite surface thereof,
the second optical surface is one side surface of the triangle columnar joinder prism that is formed by arranging, on the same flat surface or parallel flat surfaces, one of the rectangular side surface of the first triangle columnar prism with one of the rectangular side surface of the second triangle columnar prism, and
the ejection surface is one of two rectangular side surfaces of the triangle columnar joinder prism, a surface that is different from the second optical surface.

6. The projection apparatus according to claim 5, wherein:
the joinder surface or opposite surface is a side surface of the third triangle columnar prism including the longest edge of the triangle side surface thereof, wherein
the first optical surface is different from the joinder surface or an opposite surface and is a side surface on a far side from the second optical surface among the rectangular side surfaces of the third triangle columnar prism.

7. The projection apparatus according to claim 1, wherein:
the width of the ejection surface or synthesis surface in a direction parallel to the second optical surface and to the locus of deflection of the modulation light is approximately equal to the diameter of the incidence pupil of the projection optical system.

8. The projection apparatus according to claim 1, wherein:
the plurality of spatial light modulators is placed on a same substrate.

9. The projection apparatus according to claim 8, wherein:
the plurality of spatial light modulators is fixed on the same substrate near an intersection of a virtual surface extended from the synthesis surface crosses the substrate.

10. The projection apparatus according to claim 1, wherein:
the plurality of spatial light modulators and a controller for controlling at least one of the spatial light modulators and light source are formed on a same substrate.

11. The projection apparatus according to claim 1, wherein:
one of the two lights of two different frequencies projected to said first optical surface comprises a light of only one frequency component, and the other of the two lights includes a first frequency component and a second frequency component with mutually different polarizing directions.

12. The projection apparatus according to claim 11, further comprising:
a polarization conversion member for sequentially changing over polarizing directions of the first frequency component and the second frequency component.

13. The projection apparatus according to claim 1, wherein:
an angle of incidence to the first, second, and fourth optical surfaces of the optical prism, with each of the optical surfaces extended along an optical axis of the modulation light deflected in the second direction, is no larger than a critical angle.

14. A projection apparatus, comprising:
a light source;
a plurality of spatial light modulators each comprising a micromirror for deflecting and reflecting an incident light emitted from the light source in directions between a first direction and a second direction different from the first direction and all angles between the first and second directions; and
an optical prism comprising surfaces (i), (ii), (iii) and (iv),
wherein the surface (i) is a first optical surface with at least two lights of different frequencies are projected thereto, the surface (ii) is a second optical surface for ejecting the two lights incident to the first optical surface and a modulation light modulated by the spatial light modulator and is incident thereto, the surface (iii) is a synthesis surface for synthesizing a plurality of the modulation lights modulated by a plurality of spatial light modulators into a same light path, and the surface (iv) is an ejection surface disposed at a position approximately opposite to a projection lens and for ejecting the synthesized light synthesized on the synthesis surface, wherein the synthesis surface is a flat surface approximately perpendicular to the first optical surface.
